(19) United States
(12) Patent Application Publication
(10) Pub. No.: US 2009/0299853 A1
(43) Pub. Date: Dec. 3, 2009

(54) METHOD AND SYSTEM OF IMPROVING SELECTION OF SEARCH RESULTS

(75) Inventors: Scott A. Jones, Carmel, IN (US); Thomas E. Cooper, Indianapolis, IN (US); Chris Lenzo, Carmel, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 12/472,962

(22) Filed: May 27, 2009

Related U.S. Application Data
(60) Provisional application No. 61/056,294, filed on May 27, 2008.
(60) Provisional application No. 61/059,099, filed on Jun. 5, 2008.
(60) Provisional application No. 61/076,330, filed on Jun. 27, 2008.

(51) Int. Cl. G06Q 30/00; G06F 17/30

(52) U.S. Cl. 705/14.46; 707/5; 705/14.54; 705/14.69; 705/14.52; 707/E17.014

(57) ABSTRACT

A system and method utilizing human searchers and/or guides to select a search result(s) which may and/or may not be influenced by commercial or compensation information. A guide(s) may be selected and/or provided with information which may be influenced by compensation information associated with the guide(s) and/or other information. Human judgment may be used to select an organic search result(s) and/or a sponsored result. A person searching on behalf of another may make a decision regarding what will be provided to the other person based on varying degrees of commercial influence which may be explicitly and/or indirectly applied to a selection by a person.

### CROSS-REFERENCE TO RELATED APPLICATIONS

This application is related to and claims the benefit of U.S. patent application Ser. No. 12/275,864, Attorney Docket No. 1918.1034, inventor Scott A. Jones, et al., titled “METHOD AND SYSTEM FOR IMPROVING UTILIZATION OF HUMAN SEARCHERS”, filed Nov. 21, 2008; and, U.S. patent application Ser. No. 12/434,385 Attorney Docket No. 1918.1036, inventor Scott A. Jones, et al., titled “METHOD AND SYSTEM FOR IMPROVEMENT OF REQUEST PROCESSING”, filed May 1, 2009; and, U.S. patent application Ser. No. 11/774,852, Attorney Docket No. 1918.1004, inventor Scott A. Jones, et al., titled “METHOD AND SYSTEM FOR SHARING AND ACCESSING RESOURCES”, filed Jul. 9, 2007; and, U.S. patent application Ser. No. 11/835,016, Attorney Docket No. 1918.1014, inventor Scott A. Jones, et al., titled, “ELECTRONIC PREVIOUS SEARCH RESULTS LOG”, filed Aug. 7, 2007. In addition, this application is related to and claims the benefit of U.S. Provisional Application Ser. No. 61/056,294, Attorney Docket No. 1918.1052P, inventor Scott A. Jones, et al., titled “METHOD AND SYSTEM FOR ASSOCIATING VOCABULARY INFORMATION WITH AN INDEX”, filed May 27, 2008; U.S. Provisional Application Ser. No. 61/059,099 Attorney Docket No. 1918.1054P, inventor Scott A. Jones, et al., titled “METHOD AND SYSTEM FOR IMPROVING SELECTION OF SEARCH RESULTS”, filed Jun. 5, 2008, and U.S. Provisional Application Ser. No. 61/076,330, Attorney Docket No. 1918.1055P, inventor Scott A. Jones, et al., titled “METHOD AND SYSTEM FOR FACILITATING A PURCHASE”, filed Jun. 27, 2008, the contents of which are incorporated herein by reference.

### BACKGROUND

1. Field of the Invention

The present invention is related to search engine technologies and more specifically to human-assisted search engines. A method and system for utilizing human searchers to select and/or rank a search result(s) which separates or incorporates commercial consideration in the decision making process is disclosed.

2. Description of the Related Art

Search systems typically use keywords in order to rank and/or rate a search result to be provided to a user. In automated systems, a ranking algorithm is applied in order to determine the order in which a search result is provided to a user. A result with a higher ranking may be presented first in a list of search results presented in a browser window or other types of user interface. Such systems may produce a so-called ‘organic’ search result which is nominally not influenced by commercial considerations such as compensation provided to a supplier of the search service which is obtaining the search results.

In algorithmic search systems it has been shown to be beneficial to rank search results as well as sponsored search results based on an algorithm which incorporates both compensation to the search system provider, or other commercial considerations, and the merits of the search result. For example, even if an advertiser has the highest bid for a keyword, if the search result associated with the advertiser has a low merit ranking, it may not be presented to a user responsive to a query associated with the keyword. Such a system of ranking may improve the effective use of the advertisement, and thus the total revenue for a provider of search services.

A human assisted search system may similarly rank and rate search results. A search result selected by a human searcher may be ranked higher than results which are produced algorithmically as the judgment of a person may be more reliable than the judgment of an algorithmic search. A number of persons may express opinions regarding search results, which may be used to rank the results, which may improve a ranking associated with the results. Opinions of experts and/or system administrators may be used to rank search results.

By using human judgment, the quality and relevance of a search result may be improved. However, there is no known method and system whereby a human assisted search system may provide a search result which maybe similar to a ‘sponsored’ and/or ‘organic’ search result as would be produced using algorithmic search systems.

In light of the above and other existing problems, a method and system for using a human searcher to select search results which may be partially influenced by commercial factors would be greatly appreciated.

### SUMMARY

A system and method for selection of item(s) which may include commercial considerations is described. A user of a search service submits a request for information. A response or search result which may be influenced by commercial considerations is delivered. A human searcher or guide may select a search result, which may be an advertisement and/or other sponsored search result. A selection by a guide of a search result may be made based on commercial considerations which are provided to the guide directly. A selection by a guide of a search result may be made based on commercial considerations which are not explicitly revealed to the guide.

Additional aspects and/or advantages will be set forth in part in the description which follows and, in part, will be apparent from the description, or may be learned by practice of the invention.

These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is flowchart of processing a request.

FIG. 3 is flowchart of processing a query from a system server perspective.

FIG. 4 is flowchart of processing a query from a guide perspective.

FIG. 5 is flowchart of processing a query from a guide perspective.

FIG. 6 illustrates a database record for a request.

FIG. 7 illustrates a database record for a guide.

FIG. 8 illustrates a database record for a user.

FIG. 9 illustrates a database record for a profile.

FIG. 10 illustrates a database record for a category.

FIG. 11 illustrates a database record for a result.

FIG. 12 illustrates a database record for a resource.

FIG. 13 illustrates a database record for an advertisement.

FIG. 14 illustrates a database record for an advertiser.

FIG. 15 illustrates a graphical user interface (GUI).

FIG. 16 illustrates a GUI.

FIG. 17 illustrates a GUI.

FIG. 18 illustrates a GUI.

FIG. 19 is a block diagram of an exemplary system embodiment.

FIG. 20 is a flowchart of a process of handling a request.

FIG. 21 is a flowchart of a process of handling a request from a system server perspective

FIG. 22 is a flowchart of a process of handling a request from an advocate system perspective.

FIG. 23 is a flowchart of a process of handling a request from a vendor system perspective.

FIG. 24 illustrates a database record for a request.

FIG. 25 illustrates a database record for a guide.

FIG. 26 illustrates a database record for a user.

FIG. 27 illustrates a database record for a resource.

FIG. 28 illustrates a database record for an advocate.

FIG. 29 illustrates a database record for a vendor.

FIG. 30 illustrates a vendor database record for a user.

FIG. 31 illustrates a redacted data database record for a user.

FIG. 32 illustrates a database record for a category.

FIG. 33 illustrates a database record for a profile.

FIG. 34 illustrates a database relationship for selecting an item(s).

FIG. 35 illustrates a message flow diagram for an embodiment.

FIG. 36 illustrates a message flow diagram for an embodiment.

FIG. 37 illustrates a message flow diagram for an embodiment.

FIG. 38 is a block diagram of an exemplary system embodiment.

FIG. 39 is flowchart of processing a query.

FIG. 40 is an illustration of a database relationship.

FIG. 41 is an illustration of a database relationship.

FIG. 42 illustrates a database record for a categorization.

FIG. 43 illustrates a database relationship.

FIG. 44 illustrates a database record for a request.

FIG. 45 illustrates a database record for a guide.

FIG. 46 illustrates a database record for a user.

FIG. 47 illustrates a database record for a profile.

FIG. 48 illustrates a database record for a result.

FIG. 49 illustrates a database record for a resource.

FIG. 50 illustrates a database record for an advertisement.

FIG. 51 illustrates a database record for a keyword.

FIG. 52 illustrates a database record for a search session.

FIG. 53 illustrates a flowchart for processing a query.

FIG. 54 is a flowchart of a process of processing a resource.

FIG. 55 illustrates a GUI.

FIG. 56 illustrates a GUI.

FIG. 57 illustrates a GUI.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A system and method for selection of item(s) which may include commercial consideration(s) is described. A user of a search service submits a request for information. A response or search result which may be influenced by commercial considerations is delivered. A human searcher or guide may select a search result, which may be an advertisement and/or other sponsored search result. A selection by a guide of a search result may be made based on commercial consideration(s) which are provided to the guide directly. A selection by a guide of a search result may be made based on commercial consideration(s) which are not explicitly revealed to the guide.

Historical information of guide selection(s) may be used to select a sponsored result. A result which is unsponsored and a result which is sponsored may be selected and provided. An advertiser may be associated with a guide, which may modify a ranking of a result selected by the guide and/or search resources presented to the guide.

A system is provided which allows communication to be established between “users” or information seekers, human assistants or “guides”, sources of information or “resources” and providers of promotional media or “advertisers”. A search system allows communication to be established between the various elements of the system using available communication networks and services. The system includes a database which records and maintains information of the various elements of the system. The database includes records associated with guides, users, advertisers, resources, as well as information of search requests, search sessions, keywords, categories, profiles and other information which may be used to select items and to allow the system to respond to a user request.

A query or search query or search request or “request” may include a keyword(s), a category(ies), a fully formed question(s), a statement(s), any type of media, implicit data such as information associated with a user identifier(s) and/or device(s). A request may include any media which may be provided by a user. A request may receive a response or search result or ‘result’ which is produced automatically and/or using the assistance of a number of guides. A result may be any type of information which is provided responsive to a request. A result(s) may or may not be associated with a sponsor or “advertiser”.

If multiple result(s) are associated with a request(s) the result(s) may be ranked to determine an order in which the result(s) may be presented to a user(s). A ranking of a result(s) may be based on any type of information associated with the result(s). A request is identified and may be assigned a unique identifier. Information such as a category(ies), geographic information and/or a profile(s) may be selected to be associated with a request which may be used in processing of the request. A request and/or any information associated with the request may be presented to a guide. An indicator of items such as a category(ies), keyword(s) or keyphrase(s) or ‘interests’, geographic information, time information, previous activities and/or other information associated with a request may be provided to a guide(s) selected to respond to the request. A guide(s) may be selected based on association of a guide with any or all information associated with a “reference item”, which may be associated with a search request(s). A “reference item” is any information which may be used to link one item to another item. For example, a keyword associated with a request based on content of the request may act as reference item to rank a search result(s) which may be linked to the request, or a category associated with a guide may be used to rank resources which may be presented to the guide to perform a task, etc. A guide may be provided with information of a number of items, such as a category(ies), a keyword(s), a tag(s), an advertisement(s), a profile(s), or any sort of content, which a guide may elect to associate with a request and/or to transmit to a user(s).

An ‘interest’ or keyword is any type of information which may be associated with a request and/or other information for the purposes of this disclosure. While text-based searching may use words, phrases or other elements, other forms of information might also be utilized in a search. For example, if a request indicated visual, audio, or other types of media which may be compared to any elements of a resource, such elements or ‘atoms’ might be used individually and/or in combination to rank and/or rate an item(s).

A guide, who may be any person, may be associated with one or more keywords, or topics or categories, and/or an advertiser(s). A guide may be associated with any information required by a search system in order that a guide may be identified and may be associated with one or more keywords, categories, topics and/or other reference items. In at least one embodiment, a guide may be required to establish a login account and/or provide information which may be used to establish communication with the guide. A guide who is associated with a category may be provided with access to a resource(s) which may include content and/or other information which may be indexed in order that it may be searched to obtain a search result(s) utilizing a resource(s). A guide(s) may be provided with a resource(s) based on association of a guide(s) with an advertiser(s). For example, a guide may be provided with a resource(s) if a guide elects to provide a search result(s) which may be sponsored by an advertiser, and/or to receive compensation of some type associated with an advertiser(s), as will be described further herein below. Content and/or resource(s) indicated in a database associated with a category(ies) may be compared to keywords and/or other information associated with a request in order to rank a category(ies) which may be presented to a user(s) and/or a guide in order to assist in obtaining a search result(s). Likewise, content associated with a request may be used to determine whether a matching request exists, which may be presented to a user(s) and/or may be used to provide a result(s) or response(s) to the user(s).

A method and system are disclosed to improve the selection of guides and/or other information responsive to a request. A request may be provided to a number of guides who may select a number of results responsive to the request. A guide selecting a result may be provided with a number of resources, results, and/or other information which may be selected based at least in part on commercial considerations. In at least one embodiment, a selection may be made based on information which does not include commercial considerations, and a selection may be made based on information which does include commercial considerations. A person making the selection may or may not be aware of the commercial considerations.

A guide may be associated with a keyword(s), category(ies) and/or other information which may be used at least in part to select a guide to respond to a request. A guide may provide information which may be associated with the guide, which may be used to select a guide for a task(s) associated with a request. A guide may be compensated for a search activity. Compensation provided to a guide may be based at least in part on acceptance and/or use of a search result. A guide may be associated with a number of advertisers. Association with an advertiser may be based on any action(s) of a guide(s), which may include selection of the guide by the advertiser, and/or selection of the advertiser by the guide.

An advertiser may be associated with a keyword(s), category(ies) and/or other information which may be used at least in part to select an advertiser(s) and/or an advertisement(s) to respond to a request. An advertiser may provide information which may be associated with the advertiser, which may be used to select an advertisement(s) and/or a guide(s). An advertiser may offer compensation for an activity. Compensation provided by an advertiser may be based at least in part on acceptance and/or use of a search result(s). An advertiser may be able to elect to be associated with a number of guides. Association with a guide may be based on any action(s) of an advertiser(s). An advertiser may indicate a number of resource(s) which may be associated with an advertiser(s). An advertiser may target information to a guide(s) based on information associated with the guide(s).

A user may be associated with a keyword(s), category(ies) and/or other information which may be used at least in part to select a guide(s) and/or an advertisement(s) to respond to a request. A user may provide information which may be associated with the user, which may be used to select an advertisement(s) and/or a guide(s). A user may offer compensation for an activity. Compensation provided by a user may be based at least in part on acceptance and/or use of a search result(s). A user may be able to elect to be associated with a number of guide(s). Association with a guide may be based on any action(s) of a user(s). A user may indicate any or all resource(s) which may be associated with a user(s). A user may target information such as a request(s) to a guide(s) based on information associated with the guide(s).

A user query is received, and may be compared to a database of requests or queries. If a matching request is located, a response based on stored information associated with a request may be provided to the user. A request may be processed in order to identify a keyword(s), a category(ies), an advertisement(s), a location(s), a user(s), and/or other information which may be associated with the request. A request may be directed to a number of guides. A result(s) may be obtained based on information which is not intentionally influenced by commercial and/or compensation considerations. For example, a resource(s), a result(s), and/or a guide(s) may be selected without regard to compensation information including but not limited to applicability (relevancy) of the result as determined by one or more guides, popularity of the result information, etc. A result(s) may be obtained based on information which is intentionally influenced by commercial and/or compensation considerations. For example, a resource(s), a result(s), and/or a guide(s) may be selected based at least in part on information related to compensation. Different types of compensation information may be used to influence selection of a result(s), and/or other item(s) as is further described herein below. A result(s) which may have been obtained based on commercial information may be identified, which may affect presentation of a result(s).

A database of information associated with a category(ies) or topic(s) and/or a keyword(s) may be created using various methods. A database may be created and/or modified by a human editor or taxonomist, who may be able to create associations between categories. Various methods may be used to create an index which may be used to select a guide(s), a result(s), a resource(s), an advertisement(s), a user(s), an advertiser(s), or other item(s). A rating(s) and/or ranking(s) associated with an item(s) may be influenced at least in part based on commercial information, which may affect compensation of a user(s), a guide(s), an advertiser(s), a resource(s), and/or a provider(s) of a search service(s). An exemplary system for creation of an index is further described in the related U.S. patent application Ser. No. 12/434,385 previously mentioned.

A search facility may be associated with a category(ies). For example, a custom search engine may be associated with a category(ies) which may be customized by a person(s), who may be a guide(s), which may be used to locate information related to the category(ies). A search facility may be dynamically updated in order to search any or all information associated with any or all category(ies) indicated in a database. A database may be created and/or modified which may be used to modify the performance of a custom search tool(s). A search facility associated with a category may access resources and/or may have a modified weighting of resources based on commercial considerations associated with a request.

A user request is received and may be compared to a database of queries or requests. If an exact match and/or an indexed exact match is identified, a result(s) associated with the matching query(ies) may be returned to a user. If a suitable match is not identified, a guide may be selected. Any or all information associated with a request may be compared to information associated with an index. For example, keywords of a request may be compared to keywords or ‘interests’ associated with an index of categories. Likewise, geographic information associated with a request, such as an area code, zip code, street address, or GPS coordinates, etc. may be compared to a database of locations, which may include names of places, which are ranked according to proximity or other criteria. Any reference items which may be associated with a request may be used to determine whether a request is a match to a request.

Selection of a result(s), a resource(s), an advertisement(s), a guide(s), a user(s), a profile(s), etc. may utilize information which might be influenced based on compensation and/or other commercial consideration(s). In at least one embodiment, an item may be selected based upon information indicated in an index which does not intentionally influence rating and/or ranking of an item based on commercial consideration(s). A result(s) which is based on information which is intended to be unbiased by any commercial consideration may be referred to as an ‘organic’ result(s). A result(s) which is based on information which is known to be biased by at least one commercial consideration may be referred to as a ‘sponsored’ result(s). In at least one embodiment, a first search is directed to producing at least one organic result, and a second search is directed to producing at least one ‘sponsored’ result(s). Any number of searches may be conducted responsive to a request, which may have different levels of influence by different types of commercial consideration(s). For example, a search for a sponsored link(s) might have different selection criteria than a search for organic links, which might have different selection criteria than a search for organic and/or sponsored images, text, audio, media, etc. In at least one embodiment, an organic and a sponsored selection of a guide(s) are performed.

Information associated with an index may be provided for any purpose. For example, an advertiser(s) might be presented with information of keywords and/or associated categories in order to more precisely target ads, or guides might be shown traffic information or ‘hits’ associated with a keyword(s) for which, for example, no guides are registered. Information provided might be used to allow guides and/or advertisers to modify their associations and/or to find categories which are associated with an area of expertise, or to provide resources which might be relevant, etc. Information of hits to categories and/or hits to specific keywords might be used to solicit guides who are associated with the category to undergo training, demonstrate proficiency, or otherwise associate information with the index based on information provided. A “taxonomist” or system administrator who is authorized to modify at least some elements of an index may be provided with information of an index in order to determine if a new node(s) might be created. If a node has a large number of highly rated keyword(s), a taxonomist may elect to create a more specific category(ies). Information associated with a category(ies) may be assigned to more specific category(ies) using suitable processing which may include automated and/or human-assisted activities.

Information of a guide(s), an advertiser(s), an advertisement(s), a user(s), etc. which may be associated with an index may be provided to an advertiser(s) for purposes such as bidding, review, billing, etc. For example, efficacy of advertising might be assessed based on a profile(s) of a guide(s) who selected advertisements based on expected compensation which is related to use of the advertisement by a user(s) which is identical regardless of the source of the advertisement(s). Such information might allow an advertiser to determine which types of marketing campaigns appeal to a given audience segment represented by aggregated information of guides. Likewise, current bids for placement of advertisements within an interface and/or other resource(s) available to a guide(s) might be provided to an advertiser(s), who might make decisions based on that information.

Moreover, information of a guide(s), an advertiser(s), an advertisement(s), a user(s), etc. which may be associated with an index may be provided to a guides(s) for purposes such as bidding, review, billing, etc. For example, information of compensation provided by an advertiser(s) might be presented to a guide(s), who might elect to participate in a compensation plan proposed by an advertiser. Such information might allow a guide to improve compensation provided to a guide(s). Likewise, if a particular advertisement(s) has received high conversion rates, the advertisement might be presented to a guide(s) in an order reflecting that information, or a search facility associated with a guide(s) might be influenced by commercial information associated with item(s) which may be indicated in a search space associated with for example, a keyword(s) or ‘interest’, a categorization(s), a tag(s), etc. which may be associated with a guide(s) and/or a request(s).

A “user” is any person or entity which may submit a request or search request. A “request” or “search request” or “query” is any request for information which may be originated by a person and/or a device or system. A user may be referred to as a “requester”, information seeker or InfoSeeker™.

A “guide” is any person who may be compensated and/or may be a volunteer who may respond to and/or assist with a request. An “ambassador” is a guide who may perform processing of a request and/or a search result(s). A “searcher” is a guide who may perform an information search responsive to a request. A “transcriber” who may also be a guide may convert a spoken portion of a request into text, and/or may otherwise convert information of a request from one form to another. A guide may be referred to as a “human assistant” or “human searcher” or “searcher”. A guide may perform any type of task. Any guide may act in any defined guide role. However, a human assistant who performs a task and a guide who conducts a search may not necessarily be the same. For example, a human assistant may perform a task to facilitate a search which is conducted by another person who is registered as a guide.

An “identifier” or ID may include character(s), number(s) and/or other type(s) of information which may be used to identify an item including item(s) of a database. Items may include but are not limited to a guide(s), a user(s), a resource(s), an advertisement(s), a keyword(s), a category(ies), a search result(s), a search request(s), a query(ies), a rating(s), ranking(s), a message(s) and/or a profile(s).

A “guided request” is a request which uses the assistance of one or more guides.

A “result” or “search result” or “answer” is any information which may be provided responsive to a request. A result includes, but is not limited to, any of an advertisement(s), a link to a web page, a message of any sort, image, audio, text, games, interactive media and/or software of any sort.

A “search resource” or “resource” is any source of information which may be used to obtain a search result. A search resource includes automated and/or human-assisted systems, any repository of information, and any type of media and/or systems which may provide information. A resource may be a provider or source of item(s) and/or service(s). For example, a resource might provide an item such as a ringtone, a media file (e.g., audio, video, images, games, etc.), information such as news, lyrics, song titles, translations or any other type of information. A resource may be automated, and/or may utilize the assistance of a person(s).

A “profile” is one or more characteristics which may be associated with a person. Profile characteristics include but are not limited to demographic, geographic, personality, affiliations, areas of interest, historical actions, preferences, memberships, associations, etc.

An “advertisement” is any information which may be delivered to a user including to promote a provider, a product, a service, etc. An advertisement may include text, links, audio, video, images, printed materials, interactive media such as a game, or other forms of media which may be provided to a user device.

A “category” or “taxonomy branch” or “categorization” is a unique node within an index which may be associated with any number of items. If a request is associated with a category, items associated with the category may be more likely to be selected responsive to the request.

A “path term” is a word or phrase which may be used to define a category in an index. A “path root term” is a top-level node within a taxonomy. A “proper path” is a sequence of path terms which defines a category which begins with a path root term. A “path snippet” is a sequence of path terms which does not begin with a path root term. A “guide topic” or “interest” is a word or phrase which may be associated with a category which may be used at least in part to associate an item such as a query with a category.

The terms voice and speech are used interchangeably herein. A user, a resource, an advertiser(s) and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, an API, regular mail or any other type of communication. A connection or communication session(s) may be established using any device which is capable of utilizing a communication service. For example, a wireless device such as a cell phone, PDA, smart phone, etc. might be used to establish a communication session using voice, SMS, IM, email and/or internet protocols. A desktop, portable or server computer system might be used to establish a communication session. A landline phone, a specialized communication terminal, a set-top box, or any other communication device might be used to establish a communication session.

Communication between a guide, a user, an advertiser, a resource and/or a search system may include conversion of text to speech and speech to text. Conversion and/or other processing of information which may facilitate communication between a user(s), a guide(s), an advertiser(s), a resource(s) and/or a search system(s) may be performed. Any type of media which can be sent and/or received using a communication system may be part of a communication session. A communication session may be conducted using any or all communication service(s) associated with a user, an advertiser, a resource and/or a guide. Any communication session may include communication via multiple service(s) and/or device(s). For example, a request may be submitted as a voice query, which might indicate an image located on a resource(s) accessible to a user(s) and/or a guide(s), the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions between a user, a guide and/or a search system. A resource, a guide, a user and/or an advertisement may be rated. Rating information may be obtained from a user(s), a guide(s), an advertiser(s), a resource(s) and/or a search system. Rating information may be used to select a resource(s), a guide(s), an advertisement(s) and/or any item(s) based on information associated with an item(s) indicated in a database. A search service may be compensated by advertising revenue. Advertising or content may be delivered to a user(s), an advertiser(s) and/or guide(s) using any service(s) associated with a user(s), an advertiser(s) and/or guide(s)

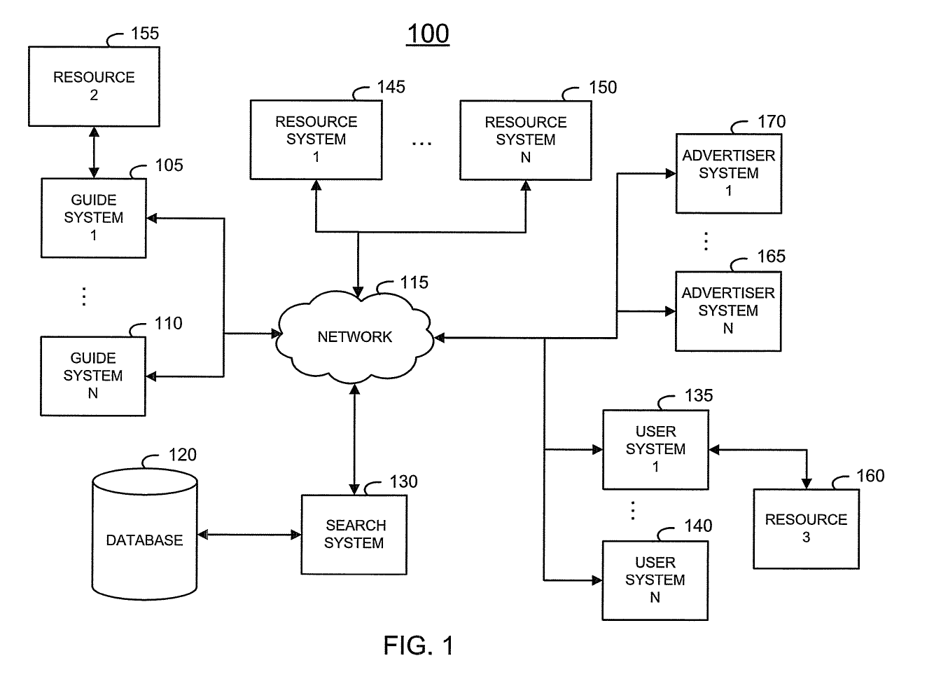

As illustrated in FIG. 1, system 100 includes guide system(s) 105, 110, a network 115 such as the Internet, a search system 130, user system(s) 135, 140, a database 120, which may comprise various records, resource systems 145, 150, resources 155, 160, and advertiser systems 165, 170.

While only a limited number of systems associated with a guide, resource, user, advertiser and as a search system are depicted in FIG. 1, it is within the scope of the disclosure for multiple systems for guide, resource, information seeker, advertiser and search systems to be utilized.

Any user system (e.g., the user systems 135, 140) can be operated by an information seeker or user, who may be a person or entity, to submit a request(s) and/or receive a search result(s) and/or other information. Any guide system (e.g., the guide systems 105, 110) can be operated by a guide to obtain a search result for an information seeker located at a user system (e.g., the user systems 135, 140). Any resource system (e.g., the resource systems 145, 150) may be operated by a human provider of information and/or may be an automated system which may provide a result(s) and/or other information to a guide and/or a user. A resource may be a system such as a search engine, a database, a system which may perform tasks such as image recognition, voice recognition, translation, transcription, or other forms of information processing, a local information source of a guide system such as a disk drive, built-in or removable memory, an application and/or database accessible from a user system(s), and/or a guide system, etc. A resource may not be accessible using the network 115. For example, a resource such as the ‘Resource 2’ resource 155 may be accessible to a guide operating a guide system such as the guide system 105, or a resource such as the ‘Resource 3’ resource 160 may be accessible to a user operating a user system such as the user system 135. A resource might include printed materials, images, video, and/or audio information, a software application(s), any information accessible to a guide(s), and advertiser(s) and/or a user(s), a database(s), and/or any combination thereof.

The network 115 (FIG. 1) may be a global public network of networks (the Internet) and/or consist in whole or in part of one or more private networks and communicatively couples the guide systems 105, 110, the resource systems 145, 150 and the user systems 135, 140 with the other components of the system such as the search system 130, and the database 120. The network 115 may include one or more wireless networks which may enable wireless communication between the various elements of the system 100. For example, a mobile phone carrier network might be used to connect a user device to the search system 130.

The search system 130 allows interaction to occur among the guide systems 105, 110, the resource systems 145, 150, the advertiser systems 165, 170 and the user systems 135, 140. For example, an information search query(ies) can be transmitted from the user systems 135, 140 to the search system 130, where a search query(ies) can be accessed by the guide systems 105, 110 and/or the resource systems 145, 150. Similarly, a search result(s) or response produced from the resource systems 145, 150 using the guide systems 105, 110 in response to a search query(ies) submitted by the user systems 135, 140 may be transmitted to the search system 130, where it may be stored by the search system 130 and/or may be transmitted to the user systems 135, 140. Similarly, the search system 130 may obtain an advertisement from the advertiser system 170, which may be provided to the user system 140. Any type of communication between a user(s), a guide(s), and advertiser(s) and a resource(s) may be mediated and/or facilitated by the search system 130, and/or other elements of the system 100.

The search system 130 is communicatively coupled with the database 120. As will be described herein in further detail below, the database 120 includes data that is processed in association with operation(s) of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or all of the database 120.

The user systems 135, 140, the guide systems 105, 110, the search system 130 the resource systems 145, 150 and the advertiser systems 165, 170 may include equipment, software, systems and personnel required to send and/or receive messages between a user system, a guide system, an advertiser system, a resource system and/or the search system using the network 115. The database 120 includes information which may allow the search system 130 to establish communication between any or all of the elements of the system 100.

A user system, a guide system, an advertiser system, and/or a resource may be a desktop or mobile PC or Mac®, a mobile phone, a smart phone, a PDA, a server system, a landline phone, a specialized communication terminal, a terminal connected to a mainframe, or any other communication device and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as user systems, guide systems, advertiser systems, resources, and/or to implement the search system 130.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of guide system 105, 110 in order to communicate with the search system 130. Multiple communication services may be associated with a guide and may allow a communication session to be established between a guide system such as the guide system 105 and a user system, an advertiser system, a resource system and/or the search system 130. Multiple identifiers of a guide may be associated with each other. Information such as IM credential(s), an email address(es), a phone number(s), a URL, a username, etc. of a guide may be identified which may allow the search system 130 to establish a communication session between a guide system and a user system, an advertiser system, a resource system, and/or the search system 130.

When a guide registers with the search system 130 the guide may be associated with one or more keywords, categories, and/or other information. For example a keyword(s) or category(ies) may be selected by a guide, or may be associated with a guide based on a test(s) administered to a guide and/or other information provided during and/or after a registration process. Information associated with a guide may be stored in the database 120 and may be used for purposes such as matching a guide to a request, determining and/or providing compensation for a guide, communicating with a guide, etc. as will be described further herein below. A guide may be associated with a number of advertisers. Registration and/or other information of a guide(s) may be provided by an advertiser(s).

A user may be identified by the search system 130. When a user system such as the user system 135 establishes a communication session with the search system 130, an identifier of a user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 135 and a guide system, an advertiser system, a resource system and/or the search system 130. Information such as a keyword(s), a category(ies), a user profile(s), a previous search request(s), a search result(s), etc. may be associated with a user. Information of a user may be stored in the database 120.

A resource, which may be a person(s), an entity(ies), a search engine, a database, a software application, a corpus of one or more types of media such as text or printed information, images, audio, video, etc. or a combination thereof, may be identified by the search system 130. Any source of information may be a resource within the context of the disclosure herein. Information of at least one method of communication is associated with a resource system which allows a communication session to be established between the search system 130, a user system 135, 140, and/or a guide system 105, 110 and a resource system such as the resource systems 145, 150. An identifier of a resource system may be associated with other information regarding a resource. A resource system may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource system such as the resource system 145 and a user system, a guide system, an advertiser system and/or the search system 130. Information such as a keyword(s), a category(ies), a profile(s), or other information may be associated with a resource. Information of a resource may be stored in the database 120.

A resource such as the resources 155, 160 and/or resources accessible via the resource systems 145, 150 may include any system(s), software, hardware, personnel and/or other facility(ies) which may provide information to a guide(s), a user(s), and/or the search system 130. For example, a resource may be a search engine, a database system, a library, a personal hard drive and/or other local storage, printed materials, recordings of any sort, a software program(s), a person or person(s), an organization, etc. A resource may be freely accessible to any user(s) and/or guide(s) and/or may be available on a restricted basis. The resource system(s) 145, 150 may include resource(s) which are available on an unrestricted and/or restricted basis. A resource may not be accessible using the network 115, but may be accessible to selected guide(s). For example, a resource such as the resource 155 may be accessible to one or more guide(s) operating a guide system(s) such as the guide system 105 using any type of communication. For example, a guide(s) may obtain information of an event(s) to provide a search result(s). Information in any form, such as printed media, audio and/or visual information, software, hardware, etc. which may be accessible to a guide(s), a user(s) and/or an operator(s) of a resource system(s) may be a resource.

An advertiser may be required to register with the search system 130. As part of a registration process, at least one communication method is associated with an advertiser. In at least one embodiment, an advertiser may register with the search system 130 and establish a username and password which are associated with the advertiser. An advertiser may login to the search system 130 using a web browser functionality of the advertiser systems 165, 170 in order to communicate with the search system 130. Multiple communication services may be associated with an advertiser and may allow a communication session to be established between an advertiser system such as the advertiser system 165 and a user system, a guide system, a resource system and/or the search system 130. Multiple identifiers of an advertiser may be associated with each other. Information such as IM credential(s), an email address(es), a phone number(s), a URL, a username, etc. of an advertiser may be identified which may allow the search system 130 to establish a communication session between an advertiser system and a user system, a guide system, a resource system, and/or the search system 130.

When an advertiser registers with the search system 130 the advertiser may be associated with one or more keywords, categories, and/or other information. For example a keyword(s) or category(ies) may be selected by an advertiser, or may be associated with an advertiser based on activities of an advertiser and/or persons associated with an advertiser(s) and/or other information provided during and/or after a registration process. Information associated with an advertiser may be stored in the database 120 and may be used for purposes such as matching an advertiser to a request(s), a user(s), a guide(s), etc., determining and/or providing compensation for an advertiser, communicating with an advertiser, etc. as will be described further herein below. An advertiser may be associated with one or more guides. Registration and/or other information of an advertiser(s) may be provided by a guide(s) and/or other person(s). An advertiser may provide information of a resource(s) which may be associated with the advertiser, and may provide access information for a resource(s).

An advertiser system may provide information of any type of content and/or other information which may be associated with sponsorship information. For example, audio, video, web pages, interactive games, software, etc. which might be sponsored by an advertiser may be provided by an advertiser system such as the advertiser systems 165, 170.

The search system 130 may establish a communication session between any user system(s), guide system(s), advertiser system(s) or resource system(s) using information indicated in the database 120. For example, the user system 135 may establish a voice communication session with the search system 130, the search system 130 may establish a voice communication session between the user system 135 and the guide system 105, the search system 130 may establish a voice connection between the user system 135 and the advertiser system 165, and the search system 130 may establish a voice communication session between the user system 135 and the resource system 145. While a voice communication session is used in this example, any type of communication session using one or more services such as SMS, EMS, MMS, email, IM, chat, web based communication, etc. may be established between any user system(s), guide system(s), advertiser system(s) and/or resource system(s) and/or the search system 130.

Information associated with a user(s), a guide(s) and/or a resource(s) may be obtained in various ways. For example, a registration process may be performed using a web form(s) provided by the search system 130, and/or information may be obtained from an external database, and/or information may be obtained based on analysis of information indicated by a user, a guide, an advertiser, and/or a resource. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device(s), service(s), transaction(s) and/or any information which might be associated with a user(s), a guide(s) and/or an advertiser(s).

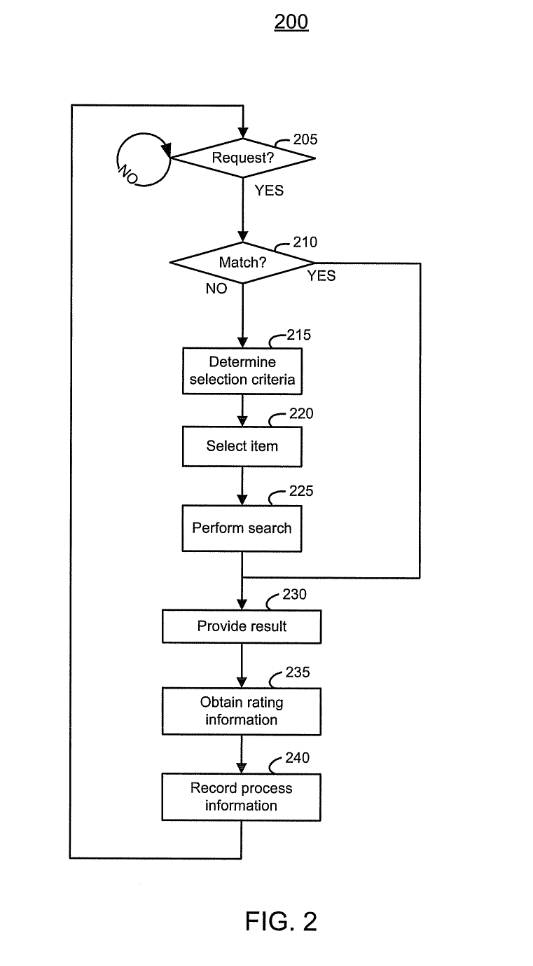

As illustrated in FIG. 2, a process 200 for performing an information search is provided. The process 200 may be operative on any or all elements of the system 100 (FIG. 1).

In operation 205, a determination is made as to whether a request is received. For example, if a search query is submitted via voice, or SMS to a server, or an email is received at an email address, or if an Instant Message (IM) is received at a IM service account associated with the search system 130 (FIG. 1), or if a request is found to require one or more search result(s), or based on other suitable criteria it may be determined that a request has been received. If it is determined in operation 205 that a request is not received control remains at operation 205 and process 200 continues. If it is determined in operation 205 that a request is received, control is passed to operation 210 and process 200 continues.

In operation 210, a determination is made as to whether a request matches an existing request. If it is determined in operation 210 (FIG. 2) that a query matches an existing request, control is passed to operation 230 and process 200 continues. If it is determined in operation 210 that a request does not match an existing request control is passed to operation 215 and process 200 continues.

The determination in operation 210 may be made based on any suitable criteria. For example, a text associated with a request may be required to match exactly the text of a query indicated in the database 120 (FIG. 1), or a request may be determined to be a match to a request based on a matching algorithm which weights content of a request, index items associated with the request, and/or information associated with a user submitting the request. A match may exist for any element(s) of a request, which may cause a result(s) to be provided while a search is conducted responsive to any element(s) of a request. For example, an advertisement(s) may be matched to a request and provided responsive to the query while a search, which may include clarifying and/or augmenting information such as a keyword, a category, a tag, a profile(s), etc. which may be associated with a request automatically and/or utilizing the assistance of a guide(s), is performed. If information is associated with a request, it may be determined that a search result(s) matches and/or does not match a request, which may cause a search request to be received as described herein above.

In operation 215, criteria for selection of a guide(s) and/or other item(s) such as a result(s), sponsored content or advertisement(s), a resource(s), an advertiser(s) are determined. A category(ies), keyword(s), profile(s), a search objective(s), etc. associated with a request may be used to determine criteria for selection of an item(s). For example, a category(ies) and/or keyword(s) and an objective of finding an organic result associated with a request may be used to select a guide(s) and/or a resource(s) which may provide a text response and a reference URL responsive to a request, while a category(ies) and/or keyword(s) and an objective of finding sponsored result associated with the request may be used to select a different guide(s) and/or resource(s) which may provide an advertisement(s) or sponsored content and/or other information responsive to the request. Control is passed to operation 220 and process 200 continues.

In operation 220, an item(s) are selected which may be utilized in performing a search(es) responsive to a request. For example, a notification table may be prepared which includes a ranked list of guide(s) eligible to perform an information search, who may be notified of a pending search(es) in an order determined at least in part on a ranking indicated in the notification table, or a list of resource(s) which may be utilized to perform a search may be compiled, and information of a resource(s) indicated in the list may be presented to a guide(s) and/or a user(s) in an order based at least in part on a ranking of the resource(s). Any number and/or type(s) of information may be selected. For example, based on criteria identified in operation 215, items indicated in the database 120 (FIG. 1) may be selected to be associated with a request, presented to a guide, and/or provided to a user. Selection criteria may be determined at least in part based on actions of a guide(s). For example, historical use of a resource(s) by a guide(s) responsive to a request(s) associated with a keyword(s) and/or category(ies) may be used to rank a resource(s). An action(s) of a guide(s) may determine a selection and/or criteria for selection of an item(s). For example, a guide may select an advertisement(s) to be delivered, which may increase or decrease a ranking or rating of an advertisement(s), or if a guide indicates that a location is not relevant to a request, selection criteria for a result may be modified. Control is passed to operation 225 and process 200 continues.

In operation 225, an information search is performed. A search may be performed by an automated resource(s), and/or may utilize one or more guide(s). Any number of searches may be conducted in any order. For example, a simultaneous search by multiple guide(s) and/or resource(s) might be performed responsive to a user request(s) based on different criteria, any of which may produce a result(s) at any time. Using a different example, a search for an image result(s) might be performed simultaneously with a search for an audio result(s). In at least one embodiment, a search for an organic result may be performed in parallel with a search for a sponsored result. Control is passed to operation 230 and process 200 continues.

In operation 230, a result is provided. A result(s) may be provided to the search system 130, which may record information of the result(s) in the database 120. A result(s) may be presented to a user(s) responsive to a request(s) associated with the user(s) via any service(s) and/or system(s) associated with the user(s). For example, an audio search result(s), which may include sponsored content, may be provided via a voice service(s), and/or an image and/or text result(s) might be provided via a messaging service such as email, SMS, or IM, and/or a result(s) might be presented using a browser functionality of a user device(s), or a result(s) might be presented using any suitable functionality such as a courier service, etc. Any or all result(s) may be provided based at least in part on a ranking and/or rating(s) associated with a result(s). A result provided may also be adjusted or changed based on a current selection criteria. For example, in an embodiment of the invention even when a match is determined in operation 210, a modified or different result may be provided if a selection criterion has changed since a result was provided to a matching request. Control is passed to operation 235 and process 200 continues.

In operation 235, rating information is obtained. In at least one embodiment, if no response is provided if a search result is provided to a user(s), a rating is assigned as a default. A user may provide rating information. For example, a user may indicate acceptance of and/or interest in a search result by activating a control associated with a result, or responding with an action such as a keyword or calling a phone number. A guide(s) may review a search result(s). For example, a guide who did not produce a search result may review a result. An automated and/or human-assisted review of a result(s) may be conducted. For example, a result and a query may be selected by an automated system and presented to a person who may indicate preference information. Any rating method or system which may indicate a rating of a search result(s) may be used to obtain rating information. In at least one embodiment, a statistical sampling of a result(s) may be conducted to select a result(s) to be rated. Control is passed to operation 240 and process 200 continues.

In operation 240 information of the process 200 is recorded. In at least one embodiment, rating, usage, and/or other information of a request(s), a guide(s), a result(s), a resource(s), an advertisement(s), an advertiser(s), a keyword(s), a categorization(s), a profile(s), etc. and/or associations of information with a request(s), a guide(s), a result(s), a resource(s), an advertisement(s), an advertiser(s), a keyword(s), a categorization(s), a profile(s), etc. is recorded and/or modified in the database 120 (FIG. 1). For example, if a guide has selected an advertisement(s) which was accepted by a user, compensation for the guide may be recorded, and a debit for the advertisement usage may be recorded. Control is passed to operation 205 and process 200 continues.

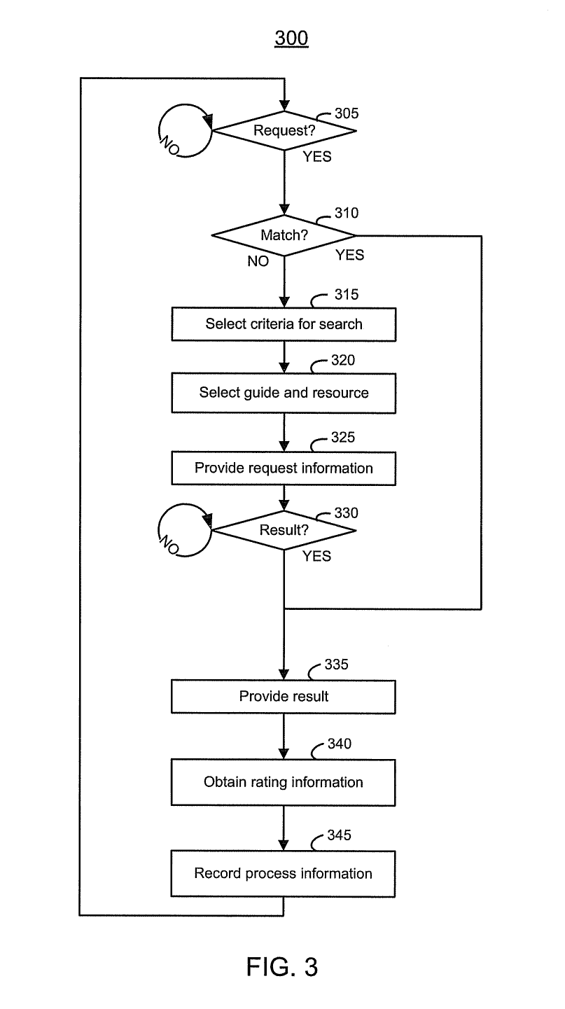

As illustrated in FIG. 3, a process 300 for performing an information search from a system server perspective is provided. The process 300 may be operative on for example the search system 130 (FIG. 1).

In operation 305, a determination is made as to whether a request is received. For example, if a search query is submitted via voice, or SMS to a server, or an email is received at an email address, or if an Instant Message is received at a IM service account associated with the search system 130 (FIG. 1), or if a request is found to require one or more result(s), or based on other suitable criteria it may be determined that a request has been received. If it is determined in operation 305 that a request is not received control remains at operation 305 and process 300 continues. If it is determined in operation 305 that a request is received, control is passed to operation 310 and process 300 continues.

In operation 310, a determination is made as to whether a request matches an existing request indicated in a database such as the database 120 (FIG. 1). If it is determined in operation 310 (FIG. 3) that a request matches an existing request, control is passed to operation 335 and process 300 continues. If it is determined in operation 310 that a request does not match an existing request control is passed to operation 315 and process 300 continues.

The determination in operation 310 may be made based on any suitable criteria. For example, a request may be required to match exactly the text of a request indicated in the database 120 (FIG. 1), or a request may be determined to match any or all elements of a request indicated in the database 120. A match may exist for any element(s) of a request, which may cause a result(s) to be provided while a search is conducted responsive to any element(s) of a request. For example, a sponsored result may be matched to a request and provided responsive to the request while a search, which may include clarifying, modifying, and/or augmenting information such as a keyword(s), a category, a tag, a profile(s), etc. which may be associated with a request automatically and/or utilizing the assistance of a guide(s), is performed. If information is associated with a request, it may be determined that a result(s) matches and/or does not match a request, which may cause a request to be received as described herein above. For example, during clarification of a request by a guide, it may be determined that a matching of a request to a request in the database is possible, or it may be determined that a different sponsored result is a closer match to a request, etc.

In operation 315, criteria for a search are selected. For example, if a request indicates that sponsored content is not to be provided, a search may be restricted to specific resources, or information of a device(s) and/or service(s) associated with a user(s) who may be associated with a request(s) may be used to determine that only media which may be delivered to the user should be searched, etc. In at least one embodiment, a search objective may be used to select search criteria. For example, if a search is to select a sponsored audio advertisement, those criteria may constrain resources which may be used select a guide(s) to perform a search. Any information indicated in the database 120 (FIG. 1) may at least in part determine criteria for an information search. Control is passed to operation 320 and process 300 continues.

In operation 320, a guide and a resource are selected. In at least one embodiment, a guide(s) are ranked and notified of a request, and information of a resource(s) which may be provided to the guide(s) is determined. For example, one or more URL's associated with a resource system such as the resource systems 145, 150 (FIG. 1), and/or an advertiser system such as the advertiser systems 165, 170, and/or other access information, etc. may be provided to a guide(s) operating a guide system and/or a user(s) operating a user system(s). A guide(s) may be selected and/or a ranking of a selected guide(s) may be performed. Likewise, a rating and/or ranking or other information of a resource(s), a result(s), a guide(s), etc. may be utilized to select a resource(s). Control is passed to operation 325 and process 300 continues.

In operation 325, information of a request is provided. Information of a request may be provided to one or more resource(s), guide(s), and/or advertiser(s), etc. Any or all information associated with a request may be provided to any elements of the system 100. For example, a guide(s) may be provided with information of a request based on a type of result(s), such as a sponsored result(s), an organic result(s), a coupon offering(s), a transaction type(s), etc. Likewise, a resource(s) may be provided with information of a request which may influence a result(s), such as a type of media (e.g., image, audio), an area of interest (e.g., news, general search, blog search, or other search verticals), etc. An advertiser(s) may be provided with information of a request which may influence a result(s), which may include sponsored content. For example, an advertiser may be provided with a profile(s), a location(s), a device characteristic(s), etc. which are associated with a request. Control is passed to operation 330 and process 300 continues.

In operation 330, a determination is made as to whether a result is received. For example, if a response is received at a server associated with the search system 130 (FIG. 1), or if a number of result(s) associated with information of a request provided in operation 325 is received, or if a time period elapses, or based on other suitable criteria it may be determined that a search result(s) or result(s) has been received. If it is determined in operation 330 that a result(s) is not received control remains at operation 330 and process 300 continues. If it is determined in operation 330 that a result(s) is received, control is passed to operation 335 and process 300 continues.

In operation 335, a result is provided. A result(s) may be provided to a user(s), a guide(s), and/or an advertiser(s). A result(s) may be provided based on any information associated with a result(s) such as a request(s), a user(s), a guide(s), a category(ies), a keyword(s), a resource(s), an advertiser(s), etc. Any or all result(s) may be provided based at least in part on a ranking and/or rating(s) associated with a result(s). A result(s) may be identified and/or presented based on criteria used to obtain a result(s). For example, a result(s) may be identified within a web page, and/or may be presented in a sequence which is based at last in part on a rating(s) and/or ranking(s) associated with the result(s). For example, a sponsored result(s) may be combined with an organic result(s) in an audio response, or a sponsored image may be blended with an organic image result(s) in an image and/or video response, etc. as further described herein below. Control is passed to operation 340 and process 300 continues.

In operation 340, rating information is obtained. In at least one embodiment, if no response is provided if a search result is provided a rating is assigned as a default. A user may provide rating information. For example, a user may indicate acceptance of and/or interest in a search result by activating a control associated with a result, and/or a guide(s) may review a search result(s), and/or an automated and/or human-assisted review of a result(s) may be conducted. Any rating method or system which may indicate a rating of a search result(s) may be used to obtain rating information. In at least one embodiment, a statistical sampling of a result(s) may be conducted to select a result(s) to be rated. Control is passed to operation 345 and process 300 continues.

In operation 345 information of the process 300 is recorded. In at least one embodiment, the database 120 (FIG. 1) is updated. Rating, usage, and/or other information of a request(s), a guide(s), a search result(s), a search resource(s), an advertisement(s), an advertiser(s), a keyword(s), a categorization(s), a profile(s), etc. and/or associations of information with a request(s), a guide(s), a search result(s), a search resource(s), an advertisement(s), an advertiser(s), a keyword(s), a categorization(s), a profile(s), etc. may be recorded and/or modified. For example, a user activity(ies) such as acceptance of an offer (e.g., a coupon), purchase of an item(s), activation of a control(s), etc. may be recorded and may be used to determine compensation of any sort. For example, compensation for a guide and/or a provider of the search service may be compensated for a number of advertisements delivered to a user, or compensation may be provided to an operator of a resource based on usage of the resource, etc. Control is passed to operation 305 and process 300 continues.

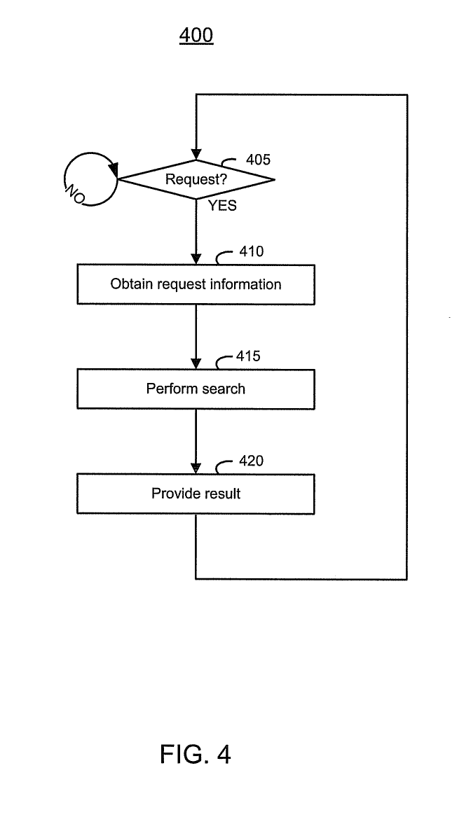

As illustrated in FIG. 4, a process 400 for performing an information search from a guide system perspective is provided. The process 400 may be operative on for example the guide system 105 (FIG. 1), but may be operative on any element(s) of the system 100.

In operation 405, a determination is made as to whether a request is received. Receipt of any type of message which may be delivered to a system such as the guide system 105 (FIG. 1) may determine that a request has been received. For example, an SMS message, an IM, an email, a voice message, a web-based communication, a courier service message, a broadcast of any sort, etc. may be received by a system associated with a guide(s), which may be used at least in part to determine whether a request is received. Information indicated in the database 120 may be used at least in part to determine that a whether a request is received. For example, an event indicated in the database 120 such as temporal information, a change in status of information, etc. may cause a request to be received. If it is determined in operation 405 that a request is not received control remains at operation 405 and process 400 continues. If it is determined in operation 405 that a request is received, control is passed to operation 410 and process 400 continues.

In operation 410, information of a request is obtained. For example, information of a request, which may indicate any or all information associated with a request may be included in a messages received in operation 405. Information of a request may include information of a type of response which is to be provided, a resource(s) which may be utilized to perform a search, compensation associated with the request, etc. In at least one embodiment, a result(s) which may meet criteria which is independent of any or all forms of compensation information and/or sponsored content may be specified as a target response to a request. Control is passed to operation 415 and process 400 continues.

In operation 415, a search is performed. In at least one embodiment, a search is performed by a guide, who may utilize any or all resources available to the guide. In at least one embodiment, a guide may be provided with information of a resource(s) which are to be used to perform a search, and may be required to provide a search result which is directly and/or indirectly related to a resource(s) of which information was provided. For example, a searcher or guide may be provided with information of a resource(s) which have been selected and/or edited so as to remove a type(s) of bias in rating and/or ranking of a resource(s) and/or a result(s). In at least one embodiment, a resource(s) indicated to a guide(s) may be created and/or selected by a human editor(s), who may be associated with information associated with a request(s). For example, a searcher may be requested to select a result produced by a resource(s) associated with a category edited to remove sites associated with a profile. Using the same example, a searcher might provide a search result from resources associated with the category ‘literature’ which excludes resources associated with young authors. Control is passed to operation 420 and process 400 continues.

According to an embodiment, a search may be automatically performed via the system 100 (FIG. 1) without requiring a guide. This may be due to a request by a user submitting the request or other conditions including but not limited to availability of a guide, qualification of an available guide, a time condition, a type of the request, etc. A search result may be provided to a user based on stored information without the assistance of a guide.

In operation 420, a result is provided. In at least one embodiment, a guide may provide information of a search result(s) to a server associated with the search system 130 (FIG. 1). Any number of search result(s) may be provided. Any type of media and/or other information which may be associated with a result(s) may be provided. For example, a URL, a search sequence and/or strategy, a ratings, temporal information, etc. may be included in information of a search result(s). Information associated with a search may be recorded in the database 120 (FIG. 1). Information of the process 400 may be recorded in local storage of a guide system and/or the database 120. Control is passed to operation 405 and process 400 continues.

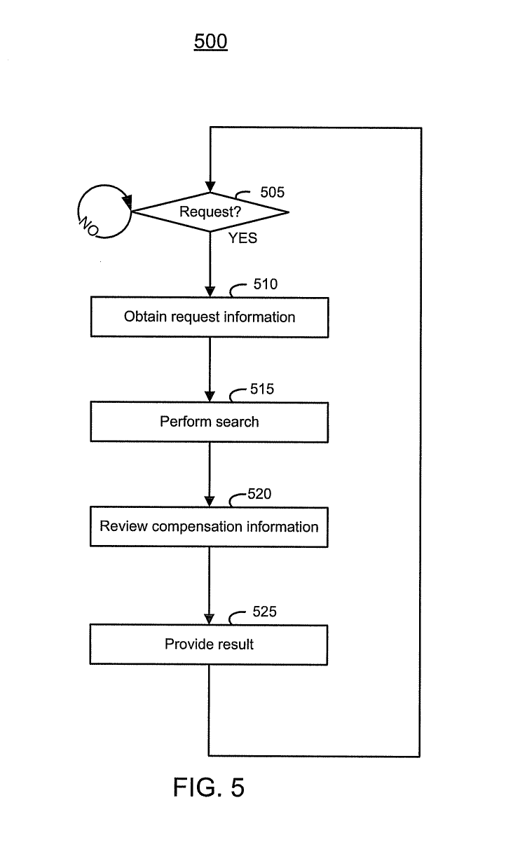

As illustrated in FIG. 5, a process 500 for performing an information search from a guide system perspective is provided. The process 500 may be operative on for example the guide system 110 (FIG. 1), but may be operative on any element(s) of the system 100.

In operation 505, a determination is made as to whether a request is received. Receipt of any type of message which may be delivered to a system such as the guide system 110 (FIG. 1) may determine that a request has been received. For example, an SMS message, an IM, an email, a voice message, a web-based communication, a courier service message, a broadcast of any sort, etc. may be received by a system associated with a guide(s), which may be used at least in part to determine whether a request is received. Information indicated in the database 120 may be used at least in part to determine that a whether a request is received. For example, an event indicated in the database 120 such as temporal information, a change in status of information, etc. may cause a request to be received. If it is determined in operation 505 that a request is not received control remains at operation 505 and process 500 continues. If it is determined in operation 505 that a request is received, control is passed to operation 510 and process 500 continues.

In operation 510, information of a request is obtained. For example, information of a request, which may indicate any or all information associated with a request may be included in a messages received in operation 505. Information of a request may include information of a type of response which is to be provided, a resource(s) which may be utilized to perform a search, etc. In at least one embodiment, a request may indicate that sponsored content such as a coupon(s), an advertisement(s), a sponsored link(s), and/or other sponsored content is to be provided. Control is passed to operation 515 and process 500 continues.

In operation 515, a search is performed. In at least one embodiment, a search is performed by a guide, who may utilize any or all resources available to the guide. In at least one embodiment, a guide may be provided with information of a resource(s) which are to be used to perform a search, and may be required to provide a search result which is directly and/or indirectly related to a resource(s) of which information was provided. For example, a searcher or guide may be provided with information of a resource(s) which have been selected and/or edited so as to include specific types of bias in rating and/or ranking of a resource(s) and/or a result(s). In at least one embodiment, a resource(s) indicated to a guide(s) may be created and/or selected by one or more advertisers, who may be associated with information associated with a request(s). For example, if one or more advertisers is associated with a category(ies), keyword(s), profile(s), guide(s), and/or other information associated with a request, information of content and/or resource(s) associated with the advertiser(s) may be included in information provided to a guide(s) selected to respond to the request. Information of a search result(s) produced by a resource(s) may be presented to a guide. For example, an order of presentation of sponsored results to a guide may be based on compensation information. Control is passed to operation 520 and process 500 continues.

In operation 520, a review of compensation information is performed. In at least one embodiment, a guide(s) may select an advertisement(s) and/or other sponsored content based on information associated with compensation of the guide(s). For example, a guide may be provided with information of use of an advertisement(s) by a user(s), such as ‘click-thru’ data, and information of compensation associated with an advertisement(s), such as ‘cost per click’ and may select an advertisement. Using a different example, a guide may be presented with information indicating ‘cost per click’ for a sponsored link(s), and/or ‘cost per use’ for a coupon(s) or other offer, and may select a search result(s) based on the information. In at least one embodiment, a guide(s) may select an advertisement(s) and/or other sponsored content based on compensation information which is not associated with a guide(s). For example, compensation information for an organization(s), an entity and/or other person(s) may be provided to a guide(s) as part of a review of compensation information. In at least one embodiment, compensation information may be reviewed by a guide(s) who did not perform a search in operation 515. Control is passed to operation 525 and process 500 continues.

In operation 525, a result is provided. In at least one embodiment, a guide may provide information of a result(s) to a server associated with the search system 130 (FIG. 1). Any number of search result(s) may be provided. Any type of media or other information which may be associated with a result(s) may be provided. For example, a URL, a search sequence and/or strategy, a ratings, temporal information, etc. may be included in information of a search result(s). Information associated with a search may be recorded in the database 120 (FIG. 1). Information of the process 500 may be recorded in local storage of a guide system and/or the database 120. Control is passed to operation 505 and process 500 continues.

The process 400 and the process 500 may be used to provide a search result(s) which may include and/or exclude various types of information from consideration by a guide(s) and/or a resource(s) performing a search. For example, using a first search process which excludes consideration of compensation, and a second search process which includes consideration of compensation may be advantageous in selecting a result to be presented to a user. Human judgment may be employed to determine whether a result which has a high economic value is to be preferred over a result which is closer to the intent of a request.

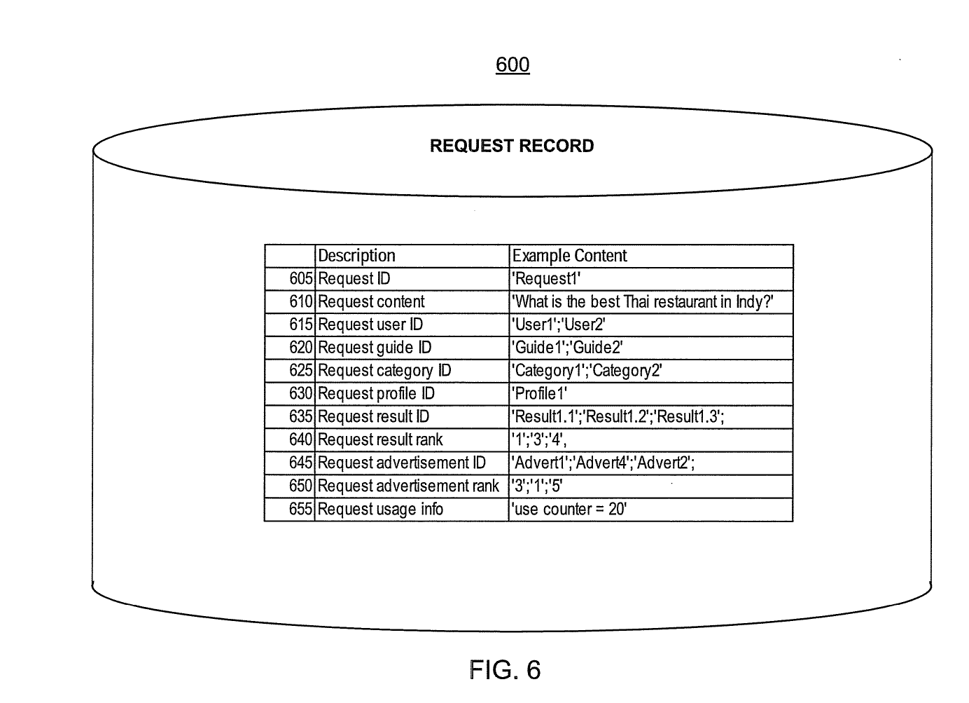

As illustrated in FIG. 6, an exemplary request record 600 is provided, of which one or more may be associated with or resident in the search database 120 (FIG. 1). The request record 600 may include a request ID field 605, a request content field 610, a request user ID field 615, a request guide ID field 620, a request category ID field 625, a request profile ID field 630, a request result ID field 635, a request result rank field 640, a request advertisement ID field 645, a request advertisement rank field 650 and a request usage info field ID 655.

A request record may be created responsive to various activities. For example, a guided search session, an interactive training session, a non-interactive training session, submission of a request by a user, and/or other types of activity may cause a request record to be created and/or modified. A request record may be imported from an external resource(s), a database, and/or any media accessible to the search system 130.

The request ID field 605 preferably contains a unique identifier of a request, which is preferably used consistently. For example, in at least one embodiment, the request ID field 605 can include a randomly generated numerical code, and/or a text string indicating the content of a request. A request ID serves to distinguish the request record associated with a request from a request record associated with other requests. Other unique identifiers of a request may be utilized without departing from the spirit and scope of the embodiments.

A unique identifier may be assigned to a request when it is received. A request may include information that is not explicitly provided by a user. For example, location information, profile information, etc. may be associated with a request. As illustrated in FIG. 6, ‘Request1’ is the request ID associated with the request record 600 (FIG. 6).

The request content field 610 may include information regarding content of a request. For example, text associated with a query submitted by a user may be indicated in the request content field 610. Content of the request content field 610 may be processed in order to associate a keyword(s) and/or category(ies) and/or other information with a request. In at least one embodiment, a structured query which conforms to a specific context may be indicated in the request content field 610. User requests which are associated with a structured query which may have been submitted by a number of users may be indicated in the request content field 610. Information such as audio recordings, images, etc. which are associated with a request may be indicated in the request content field 610. Using the example illustrated in FIG. 6, the query ‘What is the best That restaurant in Indy?.mp3’ is the content associated with the request record 600. This may indicate that the query ‘What is the best That restaurant in Indy?.mp3’ may be processed in order to respond to ‘Request1’. Information indicated in the request content field 610 may be used to determine which information associated with an index may be provided responsive to a request. For example, keywords associated with a transcription of the request ‘What is the best That restaurant in Indy?.mp3’ may compared to interests or keywords associated with an index to determine a number of categories associated with the request ‘Request1’.

The request user ID field 615 may include information of a user(s) that submitted a query. The request user ID field 615 may be used to associate any number of users with a query. In at least one embodiment, each request is uniquely associated with a single user. In at least one embodiment, if a request submitted by a user is equivalent to a previous request, multiple users may be associated with a request. In at least one embodiment, an individual user may submit a request which is associated with a group(s) of one or more users. A result(s) and/or other item(s) associated with a request may be presented responsive to a request in an order based at least in part on a ranking of the item(s) associated with the request. Information indicated in the request user ID field 615 may be used to obtain information of a user(s) using a record(s) such as the user record 800 illustrated in FIG. 8. Using the example illustrated in FIG. 6 ‘User1’ and ‘User2’ are associated with ‘Request1’.

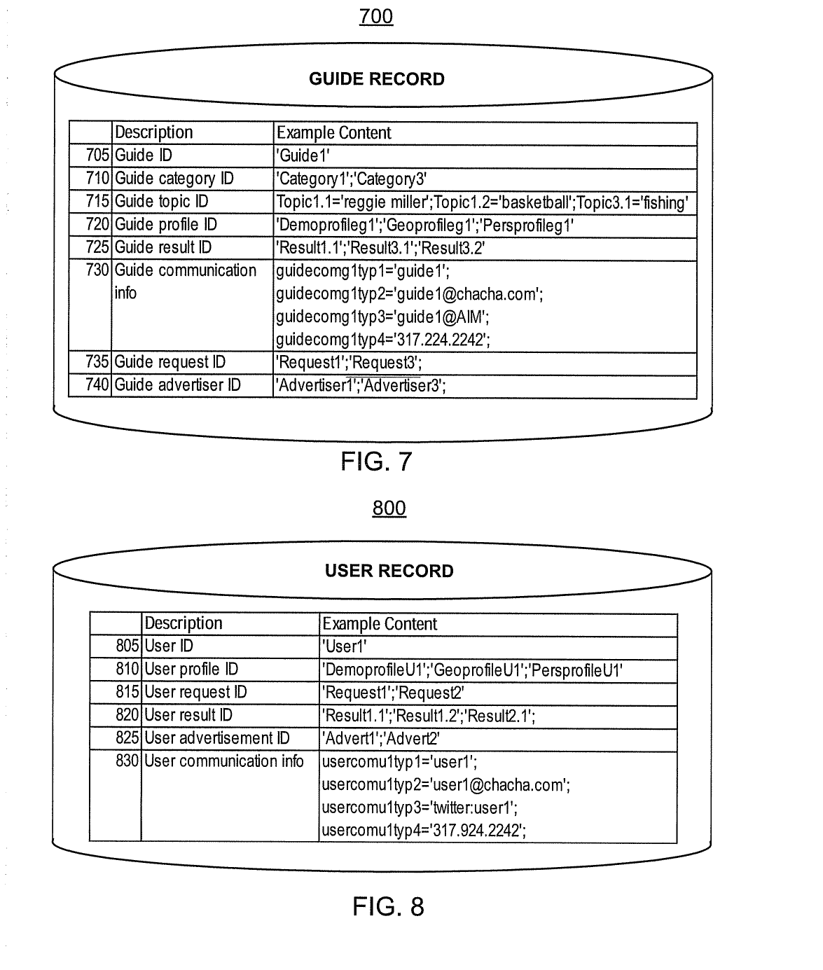

The request guide ID field 620 may include information of a number of guides associated with a request. For example, if a guide obtains a search result(s) responsive to ‘Request1’, an identifier of the guide may be indicated in the request guide ID field 620. Likewise, if a guide was selected to respond to a request, an identifier of the guide may be indicated in the request guide ID field 620. Information indicated in the request guide ID field 620 may be used to obtain information associated with a guide using a record(s) such as the guide record 700 illustrated in FIG. 7. A guide may be associated with a request if the guide has reviewed information associated with a request. Using the example illustrated in FIG. 6 the guides ‘Guide1’ and ‘Guide2’ have been associated with ‘Request1’.

The request category ID field 625 may include information of a number of categorizations and/or keywords associated with a request. Content of the request category ID field 625 may be modified by an automated classification of a request. A human may select a category(ies) and/or keyword(s) associated with a request. A categorization may be associated with a resource(s), a guide(s), an advertisement(s), training information, etc. An item(s) associated with a category may be presented to a guide(s) and/or a user(s) if a request associated with a category is submitted. An item(s) associated with a category and/or other information may be presented for review by a person(s). Association of a category with a request may be used to select items such as an advertisement(s) associated with the category to be presented responsive to a request. Association of a category with a request may be used to select a guide(s) associated with the category to vote regarding an item associated with the request. A category may be associated with a request based on any type of information associated with the request. Using the example illustrated in FIG. 6, the categories ‘Category1’ and ‘Category2’ are associated with ‘Request1’.

The request profile ID field 630 may include information of a number of profiles associated with a request. For example, a profile may be associated with a request based at least in part on a profile(s) associated with a user(s) associated with a request. For example, a geographic profile which is common to a number of users associated with a request may be associated with a request, or a guide may determine that a profile is to be associated with a request based on content and/or subject matter of a request(s) associated with a user(s), etc. A guide selected to respond to a request may be selected based at least in part on a profile(s) associated with the request. A reviewer(s) may be selected to review an item(s) associated with a request based at least in part on a profile(s) associated with a request. Using the example illustrated in FIG. 6, ‘Profile1’ is associated with ‘Request1’.

The request result ID field 635 may include information of a result(s) which is associated with a request. For example, a search result may be associated with a request when a guide obtains the search result responsive to the request. For example, if a request is submitted to the search system 130 (FIG. 1), a guide may be selected, and the guide may provide a result(s) responsive to the request. Alternately, a result(s) may be associated with a request if the request is submitted to a resource such as a search engine, database or other resource system. Any number of search results may be associated with a request. Using the example illustrated in FIG. 6, ‘Result1.1’, ‘Result1.2’, and ‘Result1.3’ have been associated with ‘Request1’.

The request result rank field 640 may include information regarding a ranking of a result(s) associated with a request. In at least one embodiment, the request result ID field 635 and the request result rank field 640 are linked by for example a pointer. Using the example illustrated in FIG. 6, ‘Result1.1’ has a ranking of ‘1’, ‘Result1.2’ has a ranking of ‘3’, and ‘Result1.3’ has a ranking of ‘4’. Content of the request result ID field 635 and the request result rank field 640 may be used at least in part to determine an order in which a search result(s) are presented to a user(s) responsive to a request. Using the example illustrated in FIG. 6, ‘Result1.1’ might be preferentially presented to a user(s) responsive to ‘Request1’. A ranking of a result may be determined based on criteria such as keyword ranking, guide ratings, etc. which may include automated and/or human assisted rating and/or ranking.

The request advertisement ID field 645 may include information of an advertisement(s) which is associated with a request. For example, an advertisement may be associated with a request when a guide selects the advertisement to be presented to a user responsive to the request. For example, if a request is submitted to the search system 130 (FIG. 1), a guide may be selected, and the guide may provide an advertisement(s) responsive to the request. Alternately, an advertisement(s) may be associated with a request automatically such as when a category(ies) and/or a keyword(s) is associated with the request. Any number of advertisements may be associated with a request. Using the example illustrated in FIG. 6, ‘Advert1’, ‘Advert4’, and ‘Advert2’ have been associated with ‘Request1’.

The request advertisement rank field 650 may include information regarding a ranking of an advertisement(s) associated with a request. In at least one embodiment, the request advertisement ID field 645 and the request advertisement rank field 650 are linked by for example a pointer. Using the example illustrated in FIG. 6, ‘Advert1’ has a ranking of ‘3’, ‘Advert4’ has a ranking of ‘1’, and ‘Advert2’ has a ranking of ‘5’. Content of the request advertisement ID field 645 and the request advertisement rank field 650 may be used at least in part to determine an order in which an advertisement(s) are presented responsive to a request. Using the example illustrated in FIG. 6, ‘Advert4’ might be preferentially presented to a user(s) responsive to ‘Request1’.

The request usage info field 655 may include information of usage of a request. For example, if multiple users submit a request which is equivalent to ‘Request1’ the request usage info field may be incremented. Content of the request usage info field 655 may be used for various purposes. For example, if a request receives high usage, it may be determined that a review of information associated with the request may be performed, or if a request receives high usage, a guide who has produced a highest ranked result associated with the request may receive recognition or compensation, etc. Using the example in FIG. 6, the usage indicator ‘use counter=20’ is associated with ‘Request1’.

As illustrated in FIG. 7, an exemplary guide record 700 is provided, of which one or more may be associated with or resident in the search database 120 (FIG. 1). The guide record 700 may include a guide ID field 705, a guide category ID field 710, a guide topic ID field 715, a guide profile ID field 720, a guide result ID field 725, a guide communication info field 730, a guide request ID field 735, and a guide advertiser ID field 740.

The guide ID field 705 preferably contains a unique identifier of a guide, which is preferably used consistently. For example, in at least one embodiment, the guide ID field 705 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 7, ‘Guide1’ is the guide ID associated with the guide record 700.

The guide category ID field 710 may include information of a number of categories associated with a guide. Content of the guide category ID field 710 may be modified based on an action(s) of a guide. A category(ies) may be associated with a guide based on one or more types of information processing. For example, the category ‘translate English to Spanish’, or ‘transcribe spoken queries’ or ‘Sports’ might be associated with a guide to indicate a skill or expertise associated with the guide. Such an association may be used in part to rate or rank a guide(s) and/or to select a guide(s). A person may select a category(ies) and/or keyword(s) which is associated with a guide. A category may be associated with a guide based on testing of a guide(s). A category may be associated with a guide based on an affiliate group associated with the guide. For example, if a guide has chosen to be affiliated with affiliate groups associated with a type of food, a category associated with the type of food might be associated with the guide. A category may signify any type of skill or expertise which may be used to match a guide to a task. A category(ies) associated with a guide may be used to select an item(s) which is to be presented to a guide. A guide(s) may be selected to review an item(s) based on the association of a guide with a category(ies). For example, a guide may be selected to review and/or provide information such as resources, media, search results, etc. based on a category associated with the guide. Using the example illustrated in FIG. 7, ‘Category1’ and ‘Category3’ are associated with ‘Guide1’.

The guide topic ID field 715 may include information of a number of topics associated with a guide. Content of the guide topic ID field 715 may be modified based on an action(s) of a guide. A person may select a topic which is associated with a guide. For example, a guide may select a topic(s) to be associated with the guide during a registration process. A topic may be associated with a guide based on testing of a guide(s). For example, a guide may be required to demonstrate knowledge of a category and/or topic(s) in order to be associated with the topic(s). Content of the guide topic ID field 715 may be compared to content of a request in order to determine a ranking of a guide(s) for responding to a request. For example, if a topic indicated in the guide topic ID field is associated with content of a request, the guide may be more likely to be selected to respond to the request. Using the example illustrated in FIG. 7, the topics ‘reggie miller’, ‘basketball’ and ‘fishing’ are associated with ‘Guide1’. This may indicate that ‘Guide1’ has indicated an interest in ‘reggie miller’, ‘basketball’ and ‘fishing’.

The guide profile ID field 720 may include information of a number of profiles associated with a guide. Content of the guide profile ID field 720 may be modified based on action(s) of a guide. A person may select a profile which is associated with a guide. For example, a guide may select a profile(s) to be associated with the guide during a registration process. A profile may be associated with a guide based on testing of a guide(s). For example, a guide may be required to demonstrate knowledge relevant to a profile(s) in order to be associated with the profile(s), or a guide may take a test which is used to generate a profile, or a guide may provide information such as demographic, geographic, personality or other information which may be indicated in a profile(s) associated with the guide. Information indicated in a guide profile may be obtained from an external database. Information indicated in the content of the guide profile ID field 720 may be compared to information indicated in the content of a profile(s) associated with a request in order to determine a ranking of a guide(s) for responding to a request. Likewise, a profile(s) associated with a guide(s) may be used to select and/or rank a guide(s). Using the example illustrated in FIG. 7, ‘Demoprofileg1’, ‘Geoprofileg1’ and ‘Persprofileg1’ are associated with ‘Guide1’. This may indicate that ‘Guide1’ has indicated and/or generated ‘Demoprofileg1’ which may be a demographic profile, ‘Geoprofileg1’ which may be a geographic profile and ‘Persprofileg1’ which might indicate personality information regarding ‘Guide1’. Any or all information indicated in a profile(s) associated with a guide may be used to determine a rating and/or ranking of a guide.

The guide result ID field 725 may include information of a result(s) associated with a guide. Content of the guide result ID field 725 may be modified based on an action(s) of a guide. If a guide produces a search result(s) responsive to a request(s), an identifier of the search result(s) may be included in the guide result ID field 725. A rating(s) and/or ranking(s) associated with a search result(s) associated with a guide may affect compensation for a guide. Likewise a usage indicator associated with a search result(s) provided by a guide may affect a rating(s) and/or ranking(s) associated with a guide. Using the example illustrated in FIG. 7, ‘Result1.1’, ‘Result3.1’ and ‘Result3.2’ are associated with ‘Guide1’. This may indicate that ‘Guide1’ has provided and/or reviewed ‘Result1.1’, ‘Result3.1’, and ‘Result3.2’.

The guide communication info field 730 may include information of a device(s) and/or service(s) associated with a guide. Content of the guide communication info field 730 may be modified based on an action(s) of a guide. If a guide establishes communications using a device(s) and/or service(s), information regarding the device(s) and/or service(s) may be included in the guide communication info field 730. Any type of communication service(s) and/or system(s) may be indicated in the guide communication info field 730. For example, a username and/or password associated with a guide may be indicated in the guide communication info field 730. Communication services such as IM, e-mail, SMS, MMS, EMS, telephone, wireless or wired communication, etc. may be indicated in the guide communication info field 730. A telephone number, an email address, an IM provider and login ID, a keyword(s) associated with a service, etc. may be indicated in the guide communication info field 730. Using the example illustrated in FIG. 7, the login ‘guide1’, the email ‘guide1@chacha.com’, the IM credential ‘guide1@AIM’ and the phone number ‘317.224.2242’ are associated with ‘Guide1’. This may indicate that ‘Guide1’ may be contacted using the login ID ‘guide1’, via email at ‘guide1@chacha.com’, via IM as ‘guide1@AIM’ and/or via voice, text, and/or other service(s) associated with the phone number ‘317.224.2242’.

The guide request ID field 735 may include information of a request(s) associated with a guide. Content of the guide request ID field 735 may be modified based on an action(s) of a guide. If a guide produces a search result(s) responsive to a request(s), an identifier of the request(s) may be included in the guide request ID field 735. A rating(s) and/or ranking(s) associated with a request(s) associated with a guide may affect compensation for a guide. Likewise a usage indicator associated with a request(s) and a guide may affect a rating(s) and/or ranking(s) associated with the guide. A request may be associated with a guide based on a vote(s) cast by a guide regarding items associated with the request. Using the example illustrated in FIG. 7, ‘Request1’, and ‘Request3’ are associated with ‘Guide1’. This may indicate that ‘Guide1’ has responded to, been selected to respond to, and/or has reviewed one or more item(s) associated with ‘Request1’, and ‘Request3’.

The guide advertiser ID field 740 may include information of an advertiser(s) associated with a guide. Content of the guide advertiser ID field 740 may be modified based on an action(s) of a guide. If a guide selects an advertisement(s) responsive to a request(s), an identifier of an advertiser(s) associated with the advertisement(s) may be included in the guide advertiser ID field 740. An advertiser may provide registration information of a guide(s), which may cause the advertiser to be indicated in the guide advertiser ID field 740. An advertiser may select a guide to be associated with the advertiser, and/or a guide may elect to be associated with an advertiser, which may affect content of the guide advertiser ID field 740. Using the example illustrated in FIG. 7, ‘Advertiser1’, and ‘Advertiser3’ are associated with ‘Guide1’. This may indicate that ‘Guide1’ has selected an advertisement associated with, been selected by, and/or has selected to be associated with ‘Advertiser1’, and ‘Advertiser3’. In at least one embodiment, association with an advertiser may permit a guide to access a resource associated with the advertiser.

As illustrated in FIG. 8, an exemplary a user record 800 is provided, of which one or more may be associated with or resident in the search database 120 (FIG. 1). The user record 800 may include a user ID field 805, a user profile ID field 810, a user request ID field 815, a user result ID field 820, a user advertisement ID field 825, and a user communication info field 830.

The user ID field 805 preferably contains a unique identifier of a user, which is preferably used consistently. For example, in at least one embodiment, the user ID field 805 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 8, ‘User1’ is the user ID associated with the user record 800.

The user profile ID field 810 may include information of a profile(s) associated with a user. Content of the user profile ID field 810 may be modified based on an action(s) of a user. A person may select a profile which is associated with a user. For example, a user may select a profile(s) to be associated with the user during a registration process. A profile may be associated with a user based on testing of a user(s) and/or information from users. For example, a user may be required to demonstrate knowledge relevant to a profile(s) in order to be associated with the profile(s), or a user may take a test which is used to generate a profile, or a user may provide information such as demographic, geographic, personality or other information which may be indicated in a profile(s) associated with the user. Historical information such as a request(s) and/or result(s) associated with a user may be used to determine profile information. Information indicated in a user profile may be obtained from an external database. A profile(s) associated with a user(s) may be used to select and/or rank a user(s) for voting. Using the example illustrated in FIG. 8, ‘DemoprofileU1’, ‘GeoprofileU1’ and ‘PersprofileU1’ are associated with the user ‘User1’. This may indicate that ‘User1’ has indicated and/or generated ‘DemoprofileU1’ which may be a demographic profile, ‘GeoprofileU1’ which may be a geographic profile and ‘PersprofileU1’ which might indicate personality information regarding ‘User1’.

The user request ID field 815 may include information of a request(s) associated with a user. Content of the user request ID field 815 may be modified based on an action(s) of a user. If a user submits a request an identifier of the request may be included in the user request ID field 815. Using the example illustrated in FIG. 8, ‘Request1’ and ‘Request2’ are associated with ‘User1’ which may indicate that ‘User1’ has submitted ‘Request1’ and ‘Request2’.

The user result ID field 820 may include information of a result(s) associated with a user. Content of the user result ID field 820 may be modified based on an action(s) of a user and/or a guide(s). If a user receives a result(s) responsive to a request(s), an identifier of the result(s) may be included in the user result ID field 820. A usage indicator associated with a result(s) provided to a user(s) may affect a rating(s) and/or ranking(s) associated with a guide. Using the example illustrated in FIG. 8, ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’.

The user advertisement ID field 825 may include information of an advertisement(s) associated with a user. Content of the user advertisement ID field 825 may be modified based on an action(s) of a user. If a user receives an advertisement(s), an identifier of the advertisement(s) may be included in the user advertisement ID field 825. A usage indicator associated with an advertisement(s) provided to a user(s) may affect a rating(s) and/or ranking(s) associated with a guide, compensation for the search system, and/or rating(s) and/or ranking(s) of an advertisement(s). Using the example illustrated in FIG. 8, ‘Advert1’ and ‘Advert2’ are associated with ‘User1’. This may indicate that ‘User1’ has been presented with ‘Advert1’, and ‘Advert2’.

The user communication info field 830 may include information of a device(s) and/or service(s) associated with a user. Content of the user communication info field 830 may be modified based on an action(s) of a user. If a user establishes communications using a device(s) and/or service(s), information regarding the device(s) and/or service(s) may be included in the user communication info field 830. Any type of communication service(s) and/or system(s) may be indicated in the user communication info field 830. For example, a username and/or password associated with a user may be indicated in the user communication info field 830. Communication services such as IM, e-mail, SMS, MMS, EMS, telephone, wireless or wired communication, etc. may be indicated in the user communication info field 830. A telephone number, an email address, an IM provider and login ID, a keyword(s) associated with a service, etc. may be indicated in the user communication info field 830. Using the example illustrated in FIG. 8, the login ‘user1’, the email ‘user1@chacha.com’, the Twitter™ service account ‘twitter:user1’ and the phone number ‘317.924.2242’ are associated with ‘User1’. This may indicate that ‘User1’ may be contacted using the login ID ‘user1’, via email at ‘user1@chacha.com’, via Twitter as ‘user1’ and/or via voice, text, and/or other service(s) associated with the phone number ‘317.924.2242’.

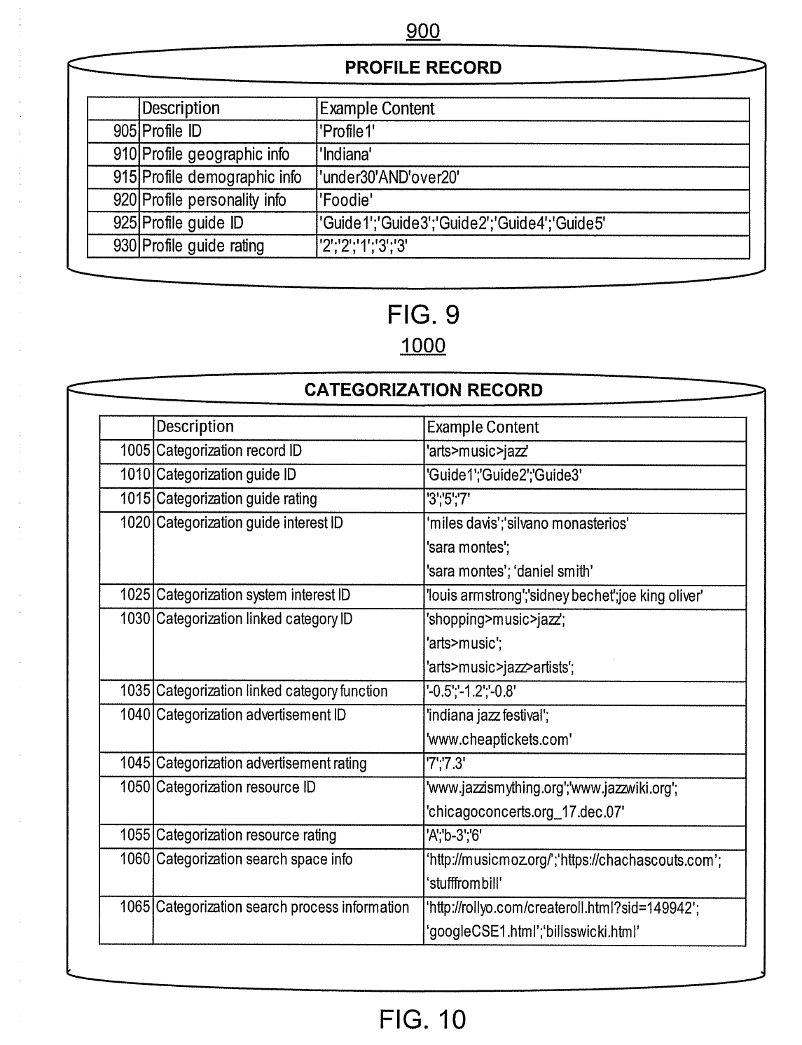

As illustrated in FIG. 9, an exemplary a profile record 900 is provided, of which one or more may be associated with or resident in the database 120 (FIG. 1). The profile record 900 may include a profile ID field 905, a profile geographic info field 910, a profile demographic info field 915, a profile personality info field 920, a profile guide ID field 925, and a profile guide rating field 930.

The profile ID field 905 preferably contains a unique identifier of a profile, which is preferably used consistently. For example, in at least one embodiment, the profile ID field 905 can include a randomly generated numerical code, and/or a text string indicating a name associated with a profile. A profile ID serves to distinguish a profile record associated with a profile from a profile record associated with other profiles. Other unique identifiers of a profile may be utilized without departing from the spirit and scope of the embodiments. In at least one embodiment, a profile ID may include a description associated with a profile. Using the example illustrated in FIG. 9, ‘Profile1’ is the profile ID associated with the profile record 900.

The profile geographic info field 910 may include geographic information associated with a profile. Any type of geographic information may be indicated in the profile geographic info field 910. For example, GPS coordinates, a street address, a neighborhood name, a postal code, a city name, a state name, etc. could be indicated in the profile geographic info field 910. Using the example illustrated in FIG. 9, the geographic information ‘Indiana’ is associated with ‘Profile1’. This may indicate for example that a person with a home address in and/or other profile information associated with geographic information of the state of ‘Indiana’ may match ‘Profile1’, or may receive a higher rating(s) and/or ranking(s) associated with ‘Profile1’.

The profile demographic info field 915 may include demographic information associated with a profile. Any type of demographic information may be indicated in the profile demographic info field 915. For example, date of birth, sex, race, political affiliation, income, number of children, marital status, membership in organizations, etc. could be indicated in the profile demographic info field 915. Using the example illustrated in FIG. 9, the demographic information ‘under30’AND‘over20’ is associated with ‘Profile1’. This may indicate that a person aged greater than 20 years and less than 30 years may receive a higher rating(s) and/or ranking(s) associated with ‘Profile1’.

The profile personality info field 920 may include personality information associated with a profile. Any type of personality information may be indicated in the profile personality info field 920. For example, information of personality traits such as aggressiveness, curiosity, friendliness, intelligence, honesty, food preference, music preference, political affiliation, etc. could be indicated in the profile personality info field 920. Using the example illustrated in FIG. 9, the characteristic ‘Foodie’ is associated with ‘Profile1’. This may indicate that persons with an interest in food and/or restaurants may receive a higher rating(s) and/or ranking(s) associated with ‘Profile1’.

The profile guide ID field 925 may include information of a guide(s) who are associated with a profile. For example, if a guide elects to receive requests associated with ‘Profile1’, or if profile information of a guide matches a profile, an identifier of the guide may be indicated in the profile guide ID field 925. Information indicated in the profile guide ID field 925 may be used to obtain information associated with a guide using a record(s) such as the guide record 700 (FIG. 7). Using the example illustrated in FIG. 9, ‘Guide1’, ‘Guide3’, ‘Guide2’, ‘Guide4’ and ‘Guide5’ have been associated with ‘Profile1’.

The profile guide rating field 930 may include information regarding a rating of a guide(s) associated with a profile. In at least one embodiment, the profile guide ID field 925 and the profile guide rating field 930 are linked by for example a pointer. Using the example illustrated in FIG. 9, ‘Guide1’ has a rating of ‘2’, ‘Guide3’ has a rating of ‘2’, ‘Guide2’ has a rating of ‘1’, ‘Guide4’ has a rating of ‘3’ and ‘Guide5’ has a rating of ‘3’. Content of the profile guide ID field 925 and the profile guide rating field 930 may be used at least in part to determine an order in which a guide(s) are notified responsive to a request, a voting activity, a review activity, or other types of tasks and/or activities associated with a profile(s). Using the example illustrated in FIG. 9, ‘Guide2’ might be preferentially notified of a request associated with ‘Profile1’. Any number of guides may be associated with a profile(s).

As illustrated in FIG. 10, an exemplary categorization record 1000 is provided, of which one or more may be associated with or resident in the database 120 (FIG. 1). The categorization record 1000 may include a categorization record ID field 1005, a categorization guide ID field 1010, a categorization guide rating field 1015, a categorization guide interest ID field 1020, a categorization system interest ID field 1025, a categorization linked category ID field 1030 a categorization linked category function field 1035, a categorization advertisement ID field 1040, a categorization advertisement rating field 1045, a categorization resource ID field 1050, a categorization resource rating field 1055, a categorization search space info field 1060, and a categorization search process information field 1065.

The categorization record ID field 1005 contains an identifier of a categorization, which is preferably unique and preferably used consistently. For example, in at least one embodiment, the categorization record ID field 1005 can include a randomly generated numerical code and/or a character string indicating a categorization. A categorization record ID serves to distinguish a categorization record associated with a categorization from a categorization record associated with other categorization(s). Although particular examples of identifiers are described herein, other types of identifiers uniquely indicating a categorization(s) may be utilized without departing from the spirit and scope of the embodiments herein. In at least one embodiment, a description of a proper path may be included in the content of the categorization record ID field 1005. A categorization record ID may include a categorization description, a random numeric code, and/or any other information uniquely identifying an element within a data structure. Using the example in FIG. 10, ‘arts>music>jazz’ is the categorization record ID associated with the categorization record 1000.

The categorization guide ID field 1010 may include one or more identifiers associated with a guide(s). The categorization guide ID 1010 may include one or more identifiers of a guide(s) which may be used to obtain further information of a guide using a record such as the guide record 700 (FIG. 7). Using the example in FIG. 10, ‘Guide1’, ‘Guide2’ and ‘Guide3’ have been associated with ‘arts>music>jazz’. While only a few guide identifiers have been illustrated in FIG. 10, any number of guide identifiers may be associated with a categorization. Association of a guide with a categorization may indicate that a guide has registered to respond to requests associated with the categorization, or that a guide may recommend, review, edit and/or otherwise associate information with the categorization.

The categorization guide rating field 1015 may include information of a number of ratings associated with a guide(s). For example, the categorization guide rating field 1015 may include a rating of a guide(s) based on result(s) produced by a guide responsive to request(s) associated with the categorization identified in the categorization record ID field 1005. In at least one embodiment, the categorization guide ID field 1010 and the categorization guide rating field 1015 may be linked by, for example, a pointer. Using the example illustrated in FIG. 10, ‘Guide1’ has the rating ‘3’, ‘Guide2’ has the rating ‘5’ and ‘Guide3’ has the rating ‘7’ associated with ‘arts>music>jazz’. This may indicate that the guide ‘Guide3’ has the highest rating and might be selected first to respond to a request associated with the category ‘arts>music>jazz’. A rating(s) of a guide(s) may be determined based on any information indicated in the database 120 (FIG. 1).

The categorization guide interest ID field 1020 may include information of one or more interests or keywords associated with a guide associated with the categorization indicated in the categorization record ID field 1005. The information indicated in the categorization guide interest ID field 1020 may be compared to information indicated in a search request which is associated with the categorization identified in the categorization record ID field 1005. A match between information associated with a search request and information indicated in the categorization guide interest ID field 1020 may modify a ranking of a guide when selecting a guide to respond to a request. In at least one embodiment, the categorization guide ID field 1010 and the categorization guide interest ID field 1020 may be linked by for example a pointer. Using the example illustrated in FIG. 10, ‘miles davis’ and ‘silvano monasteries’ have been associated with ‘Guide1’, ‘sara montes’ has been associated with ‘Guide2’ and ‘sara montes’ and ‘daniel smith’ have been associated with ‘Guide3’. This may indicate that ‘Guide1’ would be more likely to be selected to respond to a request associated with the category ‘arts>jazz>music’ which contained the phrase ‘miles davis’ even though a rating of ‘Guide1’ is lower than a rating of ‘Guide2’ and ‘Guide3’ when responding to a request associated with the category ‘arts>music>jazz’. Similarly a request associated with ‘arts>music>jazz’ which contained the keyword or interest ‘sara montes’ is received, ‘Guide3’ might be selected to respond to the request, as both ‘Guide2’ and ‘Guide3’ are associated with the interest ‘sara montes’ and ‘Guide3’ has a higher rating associated with ‘arts>music>jazz’.

The categorization system interest ID field 1025 may include information of one or more interests associated with the categorization indicated in the categorization record ID field 1005. The information indicated in the categorization system interest ID field 1025 may be compared to information indicated in a request which is associated with the categorization identified in the categorization record ID field 1005. Information indicated in the categorization system interest ID field may be obtained from a search of a resource(s). A match between information associated with a search request and information indicated in the categorization system interest ID field 1025 may modify a ranking of a categorization when selecting a guide to respond to a request. In at least one embodiment, a rating(s) or ranking of a categorization associated with an interest(s) may be obtained, which may be used at least in part to rank a categorization which may affect the probability that a category will be selected to be associated with a search request. For example, a keyword indicated in content of a request may be associated with a category, which may cause the categorization to be more likely to be associated with a request. Using the example illustrated in FIG. 10, the interests ‘louis armstrong’, ‘sidney bechet’, and ‘joe king oliver’ have been associated with the category ‘arts>jazz>music’ which may indicate that a request associated with the interests ‘louis armstrong’, ‘sidney bechet’, and ‘joe king oliver’ may be more likely to be associated with ‘arts>music>jazz’.

The categorization linked category ID field 1030 may include information of categorizations which are associated with a categorization identified in the categorization record ID field 1005. The information included in the categorization linked category ID field 1030 may be used to identify categorization records which may be associated with a guide and/or information which may be selected responsive to a search request. For example, a list of related categorization record ID's may be used to identify a categorization record(s) which may include information of a guide(s) who may have relevant knowledge regarding a request which is associated with the category ‘arts>music>jazz’. Using the example in FIG. 10, the category IDs ‘shopping>music>jazz’, ‘arts>music’ and ‘arts>music>jazz>artists’ have been associated with the categorization record 1000. This may indicate that a guide and/or item(s) associated with the categorization ‘shopping>music>jazz’, ‘arts>music’ and ‘arts>music>jazz>artists’ may be ranked responsive to a search request associated with the categorization ‘arts>music>jazz’.

The categorization linked category function field 1035 may include information of a function and/or other information associated with a linkage between a category listed in the categorization linked category ID field 1030 and a category indicated in the categorization record ID field 1005. Information indicated in the categorization linked category function field 1035 may be used to modify a rating(s) and/or ranking(s) of a guide(s) and/or other item(s) associated with a category indicated in the categorization linked category ID field 1030, for example, when selecting a guide or other information to be associated with a request determined to be associated with a categorization identified in the categorization record ID field 1005. In at least one embodiment, the categorization linked category ID field 1030 and the categorization linked category function field 1035 may be linked by, for example, a pointer. Using the example in FIG. 10, the function ‘−0.5’ has been associated with the categorization ‘shopping>music>jazz’. This may indicate that a rating of a guide associated with the categorization ‘shopping>music>jazz’ should be reduced by 0.5 when ranking guides to respond to a search request associated with the categorization ‘arts>music>jazz’. Likewise, the function ‘−1.2’ and ‘−0.8’ have been associated with the categories ‘arts>music’ and ‘arts>music>jazz>artists’, respectively. This may indicate that a rating(s) of a guide(s) associated with the category ‘arts>music’ may be reduced by 1.2, and that the rating(s) of a guide(s) associated with the category ‘arts>music>jazz>artists’ may be reduced by 0.8 when ranking guides to be selected responsive to a search request associated with the categorization ‘arts>music>jazz’. While only a few categorization IDs are illustrated in FIG. 10, any number of categorization ID's with various linked category functions may be utilized within the scope of the embodiments herein.

Information indicated in the categorization linked category ID field 1030 and the categorization linked category function field 1035 may be produced in various ways. In at least one embodiment a human taxonomist may identify linked categorizations, and may assign a strength value. Algorithmic techniques may be used in combination with human judgment to determine linked categorizations. For example, an algorithmic search may identify proper paths which may share one or more path terms, and may present the identified proper paths for consideration by a human taxonomist and/or automatically add a proper path(s) to the categorization linked category ID field 1030. Information indicated in the categorization linked category function field 1035 may be modified based on rating(s) of a search result(s) provided by a guide(s) selected using the information indicated in a linked category ID field. For example, a higher success rate by a guide(s) associated with a categorization identified in the categorization linked category ID field 1030 may decrease a difference in ratings for guides associated with the categorization. A human taxonomist may be presented with various types of information to assist in modification and/or addition of links and/or paths within a selection index or data structure, as will be described further herein below.

The categorization advertisement ID field 1040 may include one or more identifiers associated with an advertisement(s). The categorization advertisement ID field 1040 may include one or more identifiers of an advertisement(s) which may be associated with a categorization. Using the example in FIG. 10, the advertisement IDs ‘indiana jazz festival’ and ‘www.cheaptickets.com’ have been associated with the categorization record 1000, which may indicate that the advertisements ‘indiana jazz festival’ and ‘www.cheaptickets.com’ may be presented to a guide(s) and/or a user(s) responsive to a request associated with the category ‘arts>music>jazz’. While only a few advertisement identifiers have been illustrated in FIG. 10, any number of advertisement identifiers may be associated with a categorization.

The categorization advertisement rating field 1045 may include information of one or more ratings associated with an advertisement(s). For example, the categorization advertisement rating field 1045 may include a rating of an advertisement(s) based at least in part on frequency of selection of an advertisement by a guide(s) responsive to search request(s) associated with the categorization identified in the categorization record ID field 1005. In at least one embodiment, the categorization advertisement ID field 1040 and the categorization advertisement rating field 1045 may be linked by, for example, a pointer. Using the example illustrated in FIG. 10, the rating ‘7’ has been associated with the advertisement ‘indiana jazz festival’ and the rating ‘7.3’ has been associated with the advertisement ‘www.cheaptickets.com’. This may indicate that the advertisement ‘www.cheaptickets.com’ has the highest rating and might be more likely to be selected responsive to a request associated with the category ‘arts>music>jazz’.

The categorization resource ID field 1050 may include one or more identifiers of a resource(s) which may be associated with a categorization. Using the example in FIG. 10, the resources ‘www.jazzismything.org’, ‘www.jazzwiki.org’ and ‘chicagoconcerts.org_{—}17.dec.07’ have been associated with ‘arts>music>jazz’. While only a few resource identifiers have been illustrated in FIG. 10, any number of resource identifiers may be associated with a categorization. In at least one embodiment, a resource associated with a categorization may be related to an advertiser(s) and/or may be distributed to a guide(s) associated with a categorization and an advertiser(s).

The categorization resource rating field 1055 may include information of one or more ratings associated with a resource(s). For example, the categorization resource rating field 1055 may include a rating of a resource(s) based at least in part on frequency of use of a resource(s) by a guide(s) responsive to request(s) associated with the categorization identified in the categorization record ID field 1005. A rating of a resource(s) may be based on any information indicated in the database 120 (FIG. 1). In at least one embodiment, the categorization resource ID field 1050 and the categorization resource rating field 1055 may be linked by, for example, a pointer. Using the example illustrated in FIG. 10, the rating ‘A’ has been associated with the resource ‘www.jazzismything.org’, the rating ‘b-3’ has been associated with the resource ‘www.jazzwiki.org’ and the rating ‘6’ has been associated with the resource ‘chicagoconcerts.org_{—}17.dec.07’. Any type of rating information may be included in a rating field(s) such as the categorization resource rating field 1055.

The categorization search space info field 1060 may include one or more identifiers of resources, media, content, systems, or other information which may be associated with a categorization. Using the example in FIG. 10, the search space indicated in ‘http://musicmoz.org/’, ‘https://chachascouts.com’ and ‘stufffrombill’ have been associated with the categorization ‘arts>music>jazz’. This may indicate that information indicated in ‘http://musicmoz.org/’, ‘https://chachascouts.com’ and ‘stufffrombill’ may be included in a search space for a request associated with the categorization ‘arts>music>jazz’. While only a few search space identifiers have been illustrated in FIG. 10, any number of search space identifiers may be associated with a categorization. A search space identifier may indicate any type of information and may include information which may allow a guide(s), user(s), a resource(s) and/or the search system 130 (FIG. 1) to access information. In at least one embodiment, a search space indicator may be used to access a list of URLs which have been edited by one or more human editors, such as a DMOZ directory list, however information such as a collection of any sort any corpus of documents, images, and/or other media may be indicated in the categorization search space info field 1060. A search space identifier may for example indicate a search space which excludes sponsored websites, which includes only sponsored results from an advertiser(s), etc. which may cause a search results produced from a search of the indicated media to have a bias towards a particular type of search result.

The categorization search process information field 1065 may include one or more identifiers of information which may be associated with a categorization, which may be used to define parameters associated with a search process which may be applied to information indicated in a categorization search space info field(s). For example, search strategy information might indicate that a search be conducted on one or more lists of URL's, and that a number of results from each search be combined, similar to the meta-search concept. Alternately, a search strategy might specify parametric information, which might be used by an algorithmic search such as a Google® CSE which might be applied to any or all information indicated by information in a categorization search space field(s). In at least one embodiment, the categorization search space info field 1060 and the categorization search process information field 1065 may be linked by for example a pointer. Using the example illustrated in FIG. 10, the URL ‘http://rollyo.com/createroll.html?sid=149942’, the file ‘googleCSE1.html’ and the file ‘billsswicki.html’ have been associated with the categorization ‘arts>music>jazz’. This may indicate that a Rollyo™ search algorithm may be applied to the URLs indicated at ‘http://musicmoz.org/’, that a Google® CSE may be applied to the collection ‘https://chachascouts.com’ and that the swicki search ‘billsswicki.html’ is to be applied to the collection ‘stufffrombill’. Further processes may be indicated in the categorization search process information field 1065, such as a weighting or number of results, or any other processing which might be applied to a result(s) obtained from processing of a search. Information of indexing associated with one or more resources may be include in the categorization search process information field 1065, which may be utilized to identify, rate and/or rank interests and/or other information associated with a resource(s). Content of the search process information field 1065 may be used to affect a ranking of a search result(s) using various types of considerations such as compensation, information source, affiliation with a guide and/or a user, etc.

As previously noted herein, information associated with categorizations indicated in a categorization linked category ID list may be utilized in order to provide information responsive to a request. A categorization record(s) may be used for example to provide information of a request(s) to a guide(s). For example, information may be associated with a categorization(s) which is independent of consideration of compensation information, which may be presented to a guide(s) performing a search for an organic result(s), and/or information may be associated with a categorization(s) which includes consideration of any type of compensation information, which may be presented to a guide(s) performing a search for a sponsored result(s).

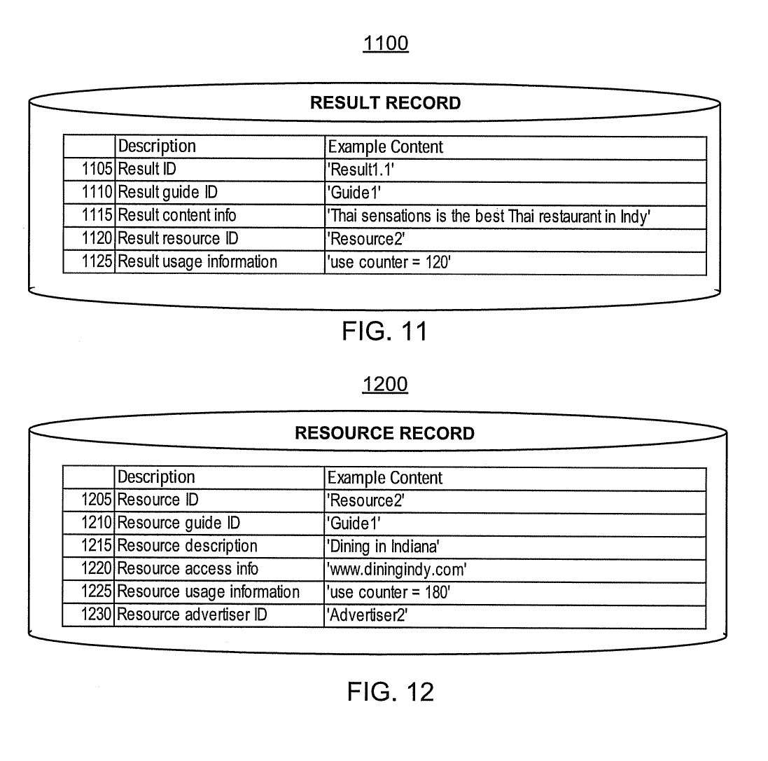

As illustrated in FIG. 11, an exemplary result record 1100 is provided, of which one or more may be associated with or resident in the search database 120 (FIG. 1). The result record 1100 may include a result ID field 1105, a result guide ID field 1110, a result content info field 1115, a result resource ID field 1120 and a result usage information field 1125.

The result ID field 1105 preferably contains a unique identifier of a result, which is preferably used consistently. For example, in at least one embodiment, the result ID field 1105 can include a randomly generated numerical code, and/or a text string indicating a name associated with a result. A result ID serves to distinguish the result record associated with a result from a result record associated with other results. Other unique identifiers of a result may be utilized without departing from the spirit and scope of the embodiments. In at least one embodiment, a result ID may include a description associated with a result. Using the example illustrated in FIG. 11, ‘Result1.1’ is the result ID associated with the result record 1100.

The result guide ID field 1110 may include information of a guide(s) associated with a result. For example, a guide who obtained a search result may be indicated in the result guide ID field 1110. In at least one embodiment a guide ID associated with a guide(s) who have voted on a result may be indicated in the result guide ID field 1110. Information contained in the result guide ID field 1110 may be used to obtain information regarding a guide associated with a search result based on records such as the guide record 700 (FIG. 7). Using the example illustrated in FIG. 11, ‘Guide1’ is associated with ‘Result1.1’ which may indicate that ‘Guide1’ has provided ‘Result1.1’.

The result content info field 1115 may include information of content of a search result. For example, a text snippet associated with a search result may be indicated in the result content info field 1115. A URL and/or other information associated with a search result may be indicated in the result content info field 1115. Information contained in the result content info field 1115 may be used to provide a search result to a user(s) and/or a guide(s). Any type of information which may be used to provide a result may be indicated in the result content info field 1115. Using the example illustrated in FIG. 11, the text snippet ‘That sensations is the best That restaurant in Indy’ is associated with ‘Result1.1’. This may indicate that the text snippet may be provided to a user if ‘Result1.1’ is selected to be presented to a user.

The result resource ID field 1120 may include information of a resource associated with a result. For example, a URL associated with a web page from which a text snippet was obtained may be indicated in the result resource ID field 1120. A URL or other information such as a search query and/or a macro instruction(s) associated with a search resource may be indicated in the result resource ID field 1120. Information contained in the result resource ID field 1120 may be used to provide access to a search resource(s) for a guide(s) and/or the search system 130 (FIG. 1). Using the example illustrated in FIG. 11, ‘Resource2’ is the resource ID associated with ‘Result1.1’. This may indicate that ‘Resource2’ was used to obtain ‘Result1.1’.

The result usage information field 1125 may include information regarding use of a search result. For example, a number of times that a search result has been presented to a user(s) may be indicated in the result usage information field 1125. Using the example illustrated in FIG. 11, the indicator ‘use counter=120’ is associated with ‘Result1.1’. This may indicate that ‘Result1.1’ has been presented to a user(s) one hundred twenty times. Information in the result usage information field 1125 may be utilized to determine whether a search result is to be reviewed, may be used to determine compensation, etc. The result usage information field 1125 may include information regarding whether a result has been associated with a sponsor or advertiser and/or provided based on sponsorship. For example, if a result has been obtained using a resource provided by an advertiser, a guide and/or the search system 130 (FIG. 1) may be compensated by the advertiser based on information indicated in the result usage information field 1125. For example if ‘Resource2’ included listings by restaurants which were provided by a listing service, the listing service might compensate a guide(s) and/or a provider of the search system 130 (FIG. 1) based on delivery of a listing to a user(s).

As illustrated in FIG. 12, an exemplary resource record 1200 is provided, of which one or more may be associated with or resident in the database 120 (FIG. 1). The resource record 1200 may include a resource ID field 1205, a resource guide ID field 1210, a resource description field 1215, a resource access info field 1220, a resource usage information field 1225, and a resource advertiser ID field 1230.

The resource ID field 1205 preferably contains a unique identifier of a resource, which is preferably used consistently. For example, in at least one embodiment, the resource ID field 1205 can include a randomly generated numerical code, and/or a string indicating a name associated with a resource. A resource ID serves to distinguish the resource record associated with a resource from a resource record associated with other resources. Other unique identifiers of a resource may be utilized without departing from the spirit and scope of the embodiments. In at least one embodiment, a resource ID may include a description associated with a resource. Using the example illustrated in FIG. 12, ‘Resource2’ is the resource ID associated with the resource record 1200.

The resource guide ID field 1210 may include information of a guide(s) associated with a resource. For example, a guide(s) who utilized a search resource may be indicated in the resource guide ID field 1210. In at least one embodiment a guide ID associated with a guide(s) who have voted on a resource may be indicated in the resource guide ID field 1210. Information contained in the resource guide ID field 1210 may be used to obtain information regarding a guide associated with a search resource based on records such as the guide record 700 (FIG. 7). Any number of guides may be associated with a resource. Using the example illustrated in FIG. 12, ‘Guide1’ is associated with the resource ‘Resource2’ which may for example indicate that ‘Guide1’ has administrative access to the resource ‘Resource2’.

The resource description field 1215 may include information of a description of a search resource. For example, a text snippet associated with a search resource may be indicated in the resource description field 1215. A URL and/or other information associated with a search resource may be indicated in the resource description field 1215. Information contained in the resource description field 1215 may be used to provide a description of search resource to a user(s) and/or a guide(s). Using the example illustrated in FIG. 12, the text snippet ‘Dining in Indiana’ is associated with the resource ‘Resource2’.

The resource access info field 1220 may include access information associated with a resource. For example, a URL associated with a web page may be indicated in the resource access info field 1220. A password, a login ID, a template for submitting a search query, an API for submitting and/or receiving information and/or any other information which may be utilized to access a resource may be indicated in the resource access info field 1220. Information contained in the resource access info field 1220 may be used to provide access to a resource(s) for a guide(s), a user(s) and/or the search system 130 (FIG. 1). Using the example illustrated in FIG. 12, the URL ‘www.diningindy.com’ is the access information associated with the resource ‘Resource2’. This may for example indicate that a result(s) associated with ‘Resource2’ may be obtained using the resources found at ‘www.diningindy.com’.

The resource usage information field 1225 may include information regarding use of a resource. For example, a number of times that a search resource has been utilized by a guide(s), an automated search, an API, etc. may be indicated in the resource usage information field 1225. Using the example illustrated in FIG. 12, the indicator ‘use counter=180’ is associated with ‘Resource2’. This may indicate that ‘Resource2’ has been utilized one hundred eighty times. Information in the resource usage information field 1225 may be utilized to determine whether a search resource is to be reviewed, a ranking(s) and/or rating(s) associated with a resource(s), compensation, etc.

The resource advertiser ID field 1230 may include information regarding an advertiser(s) associated with a resource. For example, an advertiser who may provide a resource(s) and/or may designate a resource(s) for use for any purpose(s) may be indicated in the resource advertiser ID field 1230. Using the example illustrated in FIG. 12, ‘Advertiser2’ is associated with ‘Resource2’. This may indicate that ‘Resource2’ has been designated as a resource which may be utilized by a guide(s) and/or the search system to obtain a search result(s) associated with ‘Advertiser2’. Information in the resource advertiser ID field 1230 may be utilized at least in part to determine whether a search resource is to be provided to a guide(s) and/or a ranking(s) and/or rating(s) associated with a resource(s), etc. For example if a sponsored result is to be obtained for a request, resources associated with the sponsor ‘Advertiser2’ may be ranked higher than resources which are not associated with a sponsor.

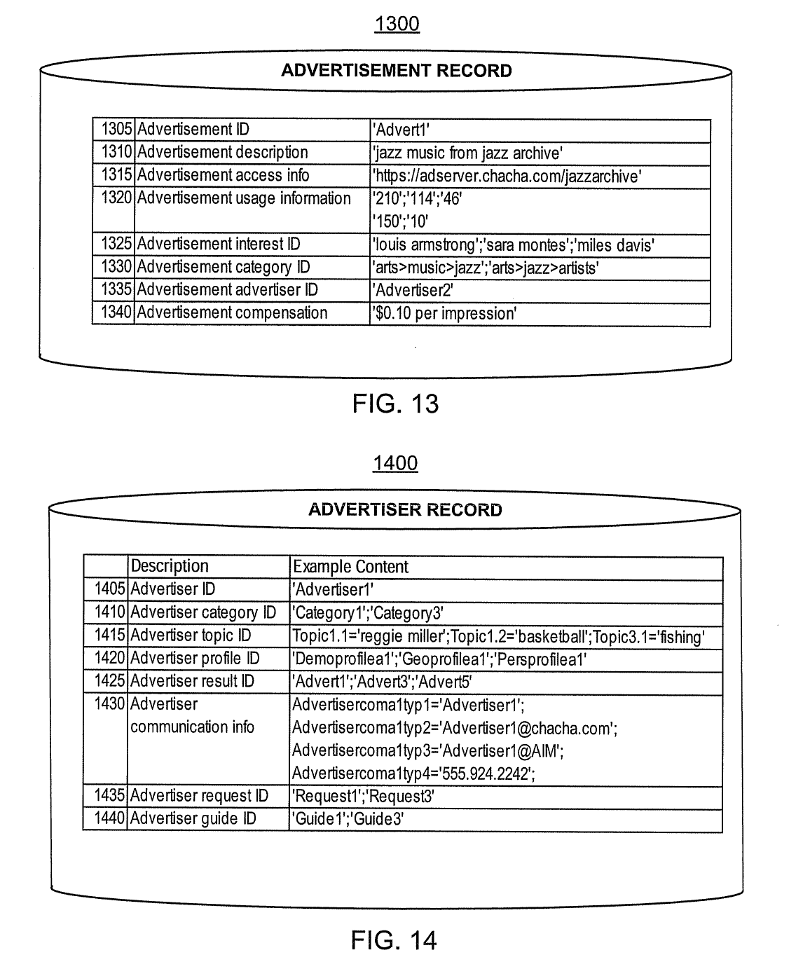

As illustrated in FIG. 13, an exemplary advertisement record 1300 is provided, of which one or more may be associated with or resident in the search database 120 (FIG. 1). and the advertisement record 1300 may include an advertisement ID field 1305, an advertisement description field 1310, an advertisement access info field 1315, an advertisement usage information field 1320, an advertisement interest ID field 1325, an advertisement category ID field 1330, an advertisement advertiser ID field 1335 and an advertisement compensation field 1340. An advertisement may include any type of content, which may be sponsored in any way.

The advertisement ID field 1305 preferably contains a unique identifier of an advertisement, which is preferably used consistently. For example, in at least one embodiment, the advertisement ID field 1305 can include a randomly generated numerical code, and/or a text string indicating a name associated with an advertisement. An advertisement ID serves to distinguish the advertisement record associated with an advertisement from an advertisement record associated with other advertisements. Other unique identifiers of an advertisement may be utilized without departing from the spirit and scope of the embodiments. In at least one embodiment, an advertisement ID may include a description associated with an advertisement. Using the example illustrated in FIG. 13, ‘Advert1’ is the advertisement ID associated with the advertisement record 1300.

The advertisement description field 1310 may include information of a description associated with an advertisement. For example, a description of an advertisement may be presented to a guide(s) in order that a guide may select an advertisement to be associated with a search request. Using the example illustrated in FIG. 13, ‘jazz music from jazz archive’ is the advertisement description associated with the advertisement ‘Advert1’. Any type of information such as text, audio, video, images, etc. may be indicated in the advertisement description field 1310.

The advertisement access info field 1315 may include access information associated with an advertisement. For example, a URL may be indicated in the advertisement access info field 1315. Information contained in the advertisement access info field 1315 may be used to provide access to an advertisement. Using the example illustrated in FIG. 13, the URL ‘https://adserver.chacha.com\jazzarchive’ is the access information associated with the advertisement ‘Advert1’. This may for example indicate that the advertisement ‘Advert1’ may be delivered using content accessed at ‘https://adserver.chacha.com\jazzarchive’. Advertisement access information may indicate a resource(s) associated with an advertisement(s).

The advertisement usage information field 1320 may include information regarding the use of an advertisement. For example, a number of times that an advertisement has been delivered to a user(s) may be indicated in the advertisement usage information field 1320. Using the example illustrated in FIG. 13, the indicators ‘210’, ‘114’, ‘46’, ‘150’ and ‘10’ are associated with ‘Advert1’. The advertisement usage information field 1320 may indicate usage of ‘Advert1’ for any purpose. Information in the advertisement usage information field 1320 may be utilized to determine whether an advertisement is to be reviewed, and may be utilized to determine compensation for a guide(s) and/or the provider of the search system 130 (FIG. 1), etc.

The advertisement interest ID field 1325 may include information of a number of keywords which may be associated with an advertisement. In at least one embodiment, the advertisement interest ID field 1325 and the advertisement usage information field 1320 may be linked by for example a pointer. Using the example illustrated in FIG. 13, the interests ‘louis armstrong’, ‘sara montes’, and ‘miles davis’ are associated with the advertisement ‘Advert1’. This may for example indicate that the advertisement ‘Advert1’ has been selected and/or presented ‘210’, ‘114’, and ‘46’ times responsive to requests associated with the keywords ‘louis armstrong’, ‘sara montes’, and ‘miles davis’, respectively. Any item(s) may be indicated in the advertisement interest ID field 1325, including but not limited to any or all of a word(s), phrase(s), sentence(s), image(s), audio, video, etc.

The advertisement category ID field 1330 may include information of one or more categories associated with an advertisement. In at least one embodiment, the advertisement category ID field 1330 and the advertisement usage information field 1320 may be linked by for example a pointer. Using the example illustrated in FIG. 13, the categories ‘arts>music>jazz’ and ‘arts>jazz>artists’ are associated with the advertisement ‘Advert1’. This may for example indicate that the advertisement ‘Advert1’ has been selected and/or presented ‘150’, and ‘10’ times in association with the categories ‘arts>music>jazz’ and ‘arts>jazz>artists’.

The advertisement advertiser ID field 1335 may include information of a number of advertisers associated with an advertisement. In at least one embodiment, information indicated in the advertisement advertiser ID field 1335 may be used to ‘look up’ information of an advertiser using a record such as the advertiser record 1400 illustrated in FIG. 14. Using the example illustrated in FIG. 13, the advertiser ‘Advertiser2’ is associated with the advertisement ‘Advert1’. This may indicate that ‘Advertiser2’ has provided information associated with the advertisement ‘Advert1’.

The advertisement compensation field 1340 may include information of compensation associated with an advertisement. Information regarding compensation for the search system 130, a guide(s), a user(s), an advertiser(s), etc. may be indicated. In at least one embodiment, compensation information may be presented to a guide(s) selecting an advertisement. Using the example illustrated in FIG. 13, the compensation information ‘$0.10 per impression’ is associated with ‘Advert1’.

As illustrated in FIG. 14, an exemplary advertiser record 1400 is provided, of which one or more may be associated with or resident in the search database 120 (FIG. 1). The advertiser record 1400 may include an advertiser ID field 1405, an advertiser category ID field 1410, an advertiser topic ID field 1415, an advertiser profile ID field 1420, an advertiser result ID field 1425, an advertiser communication info field 1430, an advertiser request ID field 1435, and an advertiser guide ID field 1440.

The advertiser ID field 1405 preferably contains a unique identifier of an advertiser, which is preferably used consistently. For example, in at least one embodiment, the advertiser ID field 1405 can include a randomly generated numerical code, and/or a text string indicating a name associated with an advertiser. An advertiser ID serves to distinguish the advertiser record associated with an advertiser from an advertiser record associated with other advertisers. Other unique identifiers of an advertiser may be utilized without departing from the spirit and scope of the embodiments. Using the example illustrated in FIG. 14, ‘Advertiser1’ is the advertiser ID associated with the advertiser record 1400.

The advertiser category ID field 1410 includes information of a category(ies) associated with an advertiser. The content of the advertiser category ID field 1410 may be modified based on actions of an advertiser. A person may select a category(ies) and/or keyword(s) which is associated with an advertiser. A category may be associated with an advertiser based on testing. A category may be associated with an advertiser based on an affiliate group associated with an advertiser. For example, if an advertiser has chosen to be associated with affiliate groups associated with basketball (e.g. Pacer fans), a category associated basketball (e.g. sports>professional) might be associated with the advertiser. A category(ies) associated with an advertiser may be used to select items which are to be presented to an advertiser. For example, information of guides, keywords and advertisements associated with ‘Category1’ might be provided to advertisers associated with ‘Category1’. Using the example illustrated in FIG. 14, the categories ‘Category1’ and ‘Category3’ are associated with the advertiser ‘Advertiser1’.

The advertiser topic ID field 1415 includes information of a topic(s) or keyword(s) associated with an advertiser. The content of the advertiser topic ID field 1415 may be modified based on actions of an advertiser. A person may select a topic or interest which is associated with an advertiser. For example, an advertiser may select a topic(s) or keyword(s) to be associated with the advertiser during a registration process. A topic may be associated with an advertiser based on voting by a guide(s). For example, an advertiser may be required to be accepted based on voting of a guide(s) associated with a category and/or topic(s) in order to be associated with the category and/or topic(s). The content of the advertiser topic ID field 1415 may be compared to the content of a search request in order to determine a ranking of an advertiser(s) for responding to a search request. Using the example illustrated in FIG. 14, the topics ‘reggie miller’, ‘basketball’ and ‘fishing’ are associated with the advertiser ‘Advertiser1’. This may for example indicate that ‘Advertiser1’ has indicated an interest in those topics.

The advertiser profile ID field 1420 includes information of a profile(s) associated with an advertiser. The content of the advertiser profile ID field 1420 may be modified based on actions of an advertiser. A person may select a profile which is associated with an advertiser. For example, an advertiser may select a profile(s) to be associated with the advertiser during a registration process. A profile may be associated with an advertiser based on actions of a user(s) and/or guide(s). For example, an advertiser may be associated with a profile(s) based on selection of advertisements associated with the advertiser by a person(s) associated with a profile(s). In order to be associated with the profile(s), or an advertiser may take a survey which is used to generate a profile, or an advertiser may provide information such as demographic, geographic, personality or other information which may be indicated in a profile(s) associated with the advertiser. Information indicated in the content of the advertiser profile ID field 1420 may be compared to information indicated in content of a profile(s) associated with a request in order to determine a ranking of an advertiser(s) for responding to a search request. Likewise, a profile(s) associated with an advertiser(s) may be used to select and/or rank an advertiser(s) for voting. Using the example illustrated in FIG. 14, the profiles ‘Demoprofilea1’, ‘Geoprofilea1’ and ‘Persprofilea1’ are associated with the advertiser ‘Advertiser1’. This may indicate that ‘Advertiser1’ has indicated and/or generated the profiles ‘Demoprofilea1’ which may be a demographic profile, ‘Geoprofilea1’ which may be a geographic profile and ‘Persprofilea1’ which might indicate personality information regarding the advertiser ‘Advertiser1’.

The advertiser result ID field 1425 includes information of a result(s) or sponsored result(s) or advertisement associated with an advertiser. The content of the advertiser result ID field 1425 may be modified based on actions of an advertiser. If an advertiser produces a search result(s) responsive to a search request(s), an identifier of the search result(s) may be included in the advertiser result ID field 1425. A rating(s) and/or ranking(s) associated with a search result(s) associated with an advertiser may affect compensation for an advertiser. Likewise a usage indicator associated with a search result(s) provided by an advertiser may affect a rating(s) or ranking(s) associated with an advertiser. Using the example illustrated in FIG. 14, the advertisements ‘Advert1’, ‘Advert3’ and ‘Advert5’ are associated with the advertiser ‘Advertiser1’. This may indicate that ‘Advertiser1’ has provided the advertisements ‘Advert1’, ‘Advert3’ and ‘Advert5’.

The advertiser communication info field 1430 includes information of a device(s) and/or service(s) associated with an advertiser. The content of the advertiser communication info field 1430 may be modified based on actions of an advertiser. If an advertiser establishes communications with the search system using a device(s) and/or service(s) information regarding the device(s) and/or service(s) may be included in the advertiser communication info field 1430. Any type of communication service(s) and/or system(s) may be indicated in the advertiser communication info field 1430. For example, a username and/or password associated with an advertiser may be indicated in the advertiser communication info field 1430. Communication services such as IM, e-mail, SMS, MMS, EMS, telephone, wireless or wired communication, etc. may be indicated in the advertiser communication info field 1430. A telephone number, an email address, an IM provider and login ID, a keyword(s) associated with a service, an IP address, a MAC address, a URL, etc. may be indicated in the advertiser communication info field 1430. Using the example illustrated in FIG. 14, the login ‘Advertiser1’, the email ‘advertiser1@chacha.com’, the IM credential ‘Advertiser1@AIM’ and the phone number ‘555.924.2242’ are associated with the advertiser ‘Advertiser1’. This may indicate that ‘Advertiser1’ may be contacted using the login ID ‘Advertiser1’, via email at ‘Advertiser1@chacha.com’, via IM as ‘Advertiser1@AIM’ and via voice, text, or other service(s) associated with the phone number ‘555.924.2242’.

The advertiser request ID field 1435 includes information of a request(s) associated with an advertiser. Content of the advertiser request ID field 1435 may be modified based on actions of an advertiser. If an advertiser and/or advertiser system produces a result(s) responsive to a request(s), an identifier of the request(s) may be included in the advertiser request ID field 1435. A rating(s) and/or ranking(s) associated with a request(s) associated with an advertiser may affect compensation for an advertiser. Likewise a usage indicator associated with a request(s) and an advertiser may affect a rating(s) or ranking(s) associated with the advertiser. Using the example illustrated in FIG. 14, the requests ‘Request1’, ‘Request3’ are associated with the advertiser ‘Advertiser1’. This may indicate that ‘Advertiser1’ has responded to, been selected to respond to, and/or has voted regarding one or more item(s) associated with the requests ‘Request1’ and ‘Request3’.

The advertiser guide ID field 1440 includes information of a guide(s) associated with an advertiser. The content of the advertiser guide ID field 1440 may be modified based on actions of an advertiser. If an advertiser system produces a search result(s) responsive to a search associated with a guide(s), an identifier of the guide(s) may be included in the advertiser guide ID field 1440. A rating(s) and/or ranking(s) associated with a guide(s) associated with an advertiser may affect compensation for a guide(s). A guide may be associated with an advertiser based on a bid(s) by an advertiser regarding items associated with the guide. In at least one embodiment, a guide may elect to be associated with an advertiser. In at least one embodiment, an advertiser(s) may select a guide(s) associated with the advertiser(s). In at least one embodiment, the search system 130 may associate an advertiser with a guide(s). Using the example illustrated in FIG. 14, the guides ‘Guide1’, ‘Guide3’ are associated with the advertiser ‘Advertiser1’. This may indicate that ‘Advertiser1’ has submitted a highest bid for the services of the guides ‘Guide1’ and ‘Guide3’.

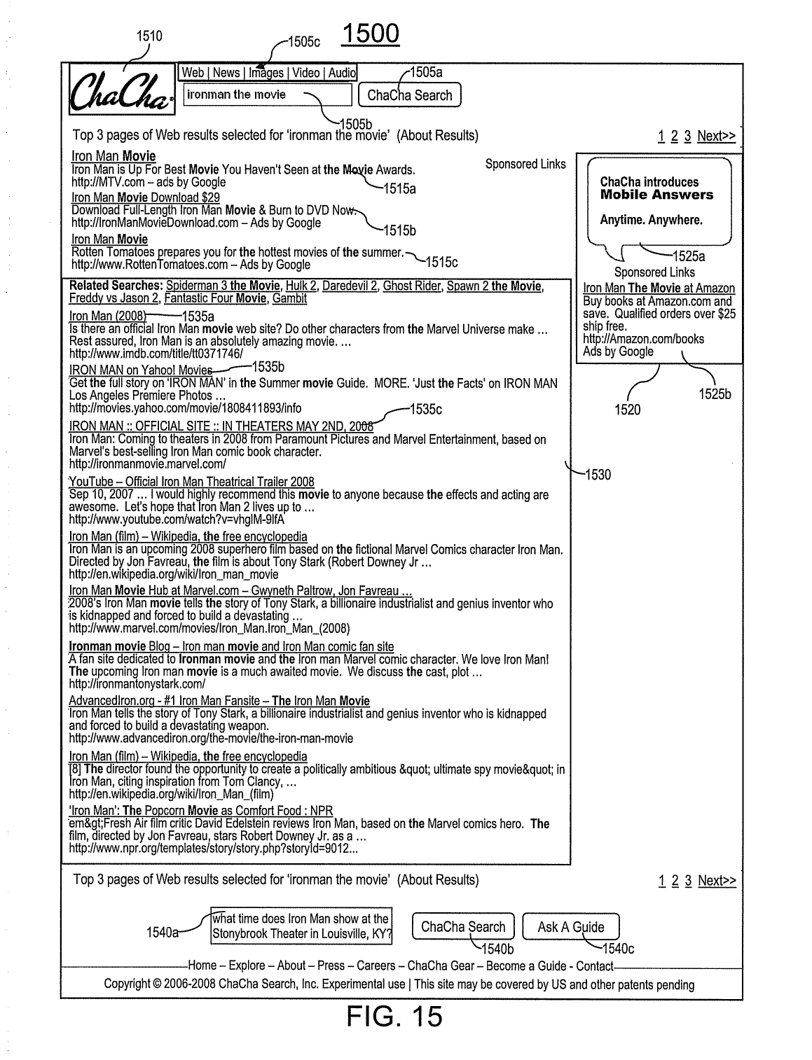

A GUI 1500 for presentation of one or more search results is illustrated in FIG. 15. The GUI 1500 may be presented on any suitable display device(s), such as a display(s) associated with the user system 135 (FIG. 1).

As illustrated in FIG. 15, the GUI 1500 may include primary search controls 1505, advertising window 1510, sponsored result indicators 1515, multimedia sponsored results window 1520, multimedia results 1525, organic results window 1530, organic result indicators 1535, and secondary search controls 1540.

The primary search controls 1505 may include search initiation control 1505a, primary search query box 1505b, and search vertical controls 1505c. The ‘ChaCha Search’ search initiation control 1505a may be used to initiate a search based on information indicated in the search vertical controls 1505c and/or the search query box 1505b. Activation of the search initiation control 1505a may cause a GUI such as the GUI 1500 to be displayed. The primary search query box 1505b may be used to provide information of a search request or query. For example the text ‘ironman the movie’ is present in the primary search query box 1505b. While text is indicated in the primary search query box 1505b for the purposes of illustration, any sort of media including text, audio, images, video, etc. and/or combination(s) thereof might be indicated in the primary search query box 1505b. The search vertical controls 1505c may be used to designate a categorization, class and/or area of search associated with a search request.

The advertising window 1510 may present any sort of sponsored result(s). Any number of advertising window(s) might be displayed in the GUI 1500. The sponsored result indicators 1515 may be used to indicate information of a sponsored result(s), and may provide access to a web page and/or other information of a sponsored result(s). The ‘Iron Man Movie’ sponsored result indicator 1515a may indicate a website associated with a search request which has a high ranking. The ‘Iron Man Movie Download’ sponsored result indicator 1515b may indicate a resource which might permit a download of a video by activating the sponsored result indicator 1515b. The ‘Iron Man Movie Rotten.’ sponsored result indicator 1515c may indicate a review of a movie.

The multimedia sponsored results window 1520 may indicate one or more sponsored content result(s). For example, the multimedia result 1525a includes an image which may contain one or more sponsored results. For example, a national advertisement for a movie (e.g., an image from Iron Man the Movie) might include a targeted local advertisement (e.g., a local theater image blended into the national advertisement). The ‘Iron Man the Movie at Amazon’ multimedia result 1525b may indicate a website of an advertiser who has made a bid to be associated with the interest or key phrase ‘Iron Man the Movie’.

The organic results window 1530 may include information regarding a search result(s) produced based upon information independent of any or all information related to compensation of any or all forms. The ‘Iron Man (2008)’ organic result indicator 1535a may indicate information of a website associated with a movie which may have a high ranking or rating(s), and may provide access to the information by activating or ‘clicking’ on the organic result indicator 1535a. The ‘IRON MAN on Yahoo! Movies’ organic result indicator 1535b may indicate information of a second ranked organic search result, and the IRON MAN: OFFICIAL SITE’ organic result indicator 1535c may indicate a third ranked organic search result. Any number of organic search result indicators 1535 may be included in the GUI 1500.

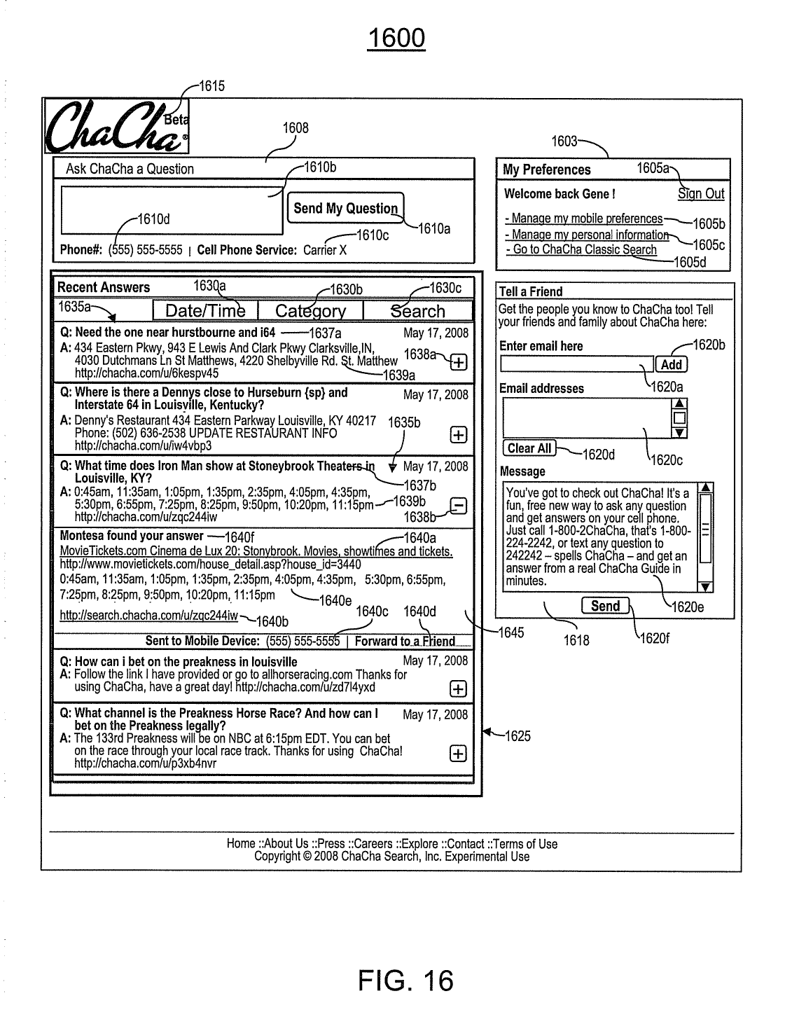

The secondary search controls 1540 may include secondary search query box 1540a, secondary search type 1 activation control 1540b, and secondary search type 2 activation control 1540c. The secondary search query box 1540a may be used to provide information of a search request or query. For example the text ‘what time does Iron Man show at the Stonybrook Theaters in Louisville, Ky.?’ is present in the secondary search query box 1540a. While text is indicated in the secondary search query box 1540a for the purposes of illustration, any sort of media including text, audio, images, video, etc. and/or combination(s) thereof might be indicated in the secondary search query box 1540a. The ‘ChaCha Search’ search activation control 1540b may be used to initiate a search which may cause a GUI such as the GUI 1500 to be presented. The ‘Ask a Guide’ search activation control 1540c may be used to initiate a search which may cause a GUI such as the GUI 1600 (FIG. 16) to be presented.

A GUI 1600 for presentation of one or more search results is illustrated in FIG. 16. The GUI 1600 may be presented on any suitable display device(s), such as a display(s) associated with one or more user system(s) such as the user system 135 (FIG. 1).

As illustrated in FIG. 16, the GUI 1600 may include an activity control window 1603, activity controls 1605, a search activity window 1608, search controls 1610, an advertising window 1615, a search result sharing window 1618, search result sharing controls 1620, a search history window 1625, search history review controls 1630, search request indicators 1635, and search request detail window 1645.

The activity control window 1603 may include any number of activity controls 1605. The ‘Sign Out’ activity control 1605a may be used to login and/or logoff of the search system 130 (FIG. 1). The ‘manage my mobile preference’ activity control 1605b may be used to manage communication services associated with a user, and/or services which may be used to present a search result(s). For example, a communication service(s) such as the services described herein with respect the user record 800 (FIG. 8) may be identified and associated with a user. The ‘manage my personal info’ activity control 1605c may be used to access and/or modify information which may be associated with a person(s). For example, registration information, personal information such as name, address, and/or any information which may be indicated in a profile, such as a profile described herein above with respect to the profile record 900 (FIG. 9). The ‘Go to ChaCha Classic Search’ activity control 1605d may be used to present a GUI such as the GUI 1500 (FIG. 15).

The search activity window 1608 may include any number of search controls 1610. The ‘Send My Question’ search control 1610a may cause a search request to be created based at least in part on information indicated in the GUI 1600. The search query box 1610b may indicate information associated with a search request. For example, text associated with a search request may be displayed and/or entered using the search query box 1610b. While text is indicated in the search query box 1610b for the purposes of illustration, any sort of media including text, audio, images, video, etc. and/or combination(s) thereof might be indicated in the search query box 1610b. Information indicated in the GUI 1600, which may include items such as a result(s) and/or query(ies) indicated in the search history window 1625 may be associated with a search request. The ‘Phone# (555) 555-5555’ search control 1610d may indicate a communication service(s) associated with a search request. For example, a drop-down list, pick list using ‘radio’ buttons, typing box, or a GUI which may be used to indicate any or all communication service(s) associated with a search request may be selected and/or indicated using the search control 1610d. The ‘Cell Phone Service: Carrier X’ search activity control 1610c may indicate a communication service provider(s) associated with any communication service(s) associated with a search request.

The advertising window 1615 may present any sort of sponsored result(s). Any number of advertising window(s) might be displayed in the GUI 1600. The search result sharing window 1618 may indicate information which may be used to transmit information of a search request and/or search result(s) using the search result sharing controls 1620. The ‘Enter Email Here’ search result sharing control 1620a may be used to indicate information regarding a communication service(s) and/or device(s) which may receive information regarding a search request. For example, an email address, a phone number, an IM alias, a login ID to any service, etc. may be indicated and/or provided using the ‘Enter Email Here’ search result sharing control 1620a. The ‘Add’ search result sharing control 1620b may be used to add information provided using the ‘Enter Email Here’ search result sharing control 1620a to the ‘Email Addresses’ search result sharing control 1620c. The ‘Email Addresses’ search result sharing control 1620c, may be used to indicate information regarding a communication service(s) and/or device(s) which may receive information regarding a search request. The ‘clear all’ search result sharing control 1620d may be used to clear any information indicated in the ‘Email Addresses’ search result sharing control 1620c. The ‘Message’ search result sharing control 1620e may be used to indicate and/or provide information of a message which may be transmitted using a communication service(s) indicated in the ‘Email Addresses’ search result sharing control 1620c. The ‘Send’ search result sharing control 1620f may be used to transmit information indicated in the ‘Message’ search result sharing control 1620e using information indicated in the ‘Email Addresses’ search result sharing control 1620c.

The search history window 1625 may be used to provide information of a search request(s). The search history review controls 1630 may be used to modify a presentation of information associated with a search request(s). Any number of search history review controls 1630 may be presented in the search history window 1630. For example, the search history control 1630a may be used to sort information of a search request(s) based on chronological information, the search history control 1630b may be used to sort a search request(s) based on a topic(s) and/or category(ies) associated with a search request(s), the ‘search’ search history control 1630c may allow a user to search for a search request(s) associated with any type of information. For example, a query box may be presented for a user to enter a query to be searched versus available search requests and/or results if the ‘search’ search history control 1630c is activated. Any number and/or type(s) of controls which may be used to organize and/or index information which are known in the art may be provided as a search history review control 1630.

The search request indicators 1635 may be used to indicate information associated with a search request. The search request information indicator 1635a may include the search query indicator 1637a, the search detail control 1638a, and the search result indicator 1639a. The search query indicator 1637a may indicate text and/or other information associated with a search request. Activation of the search detail control 1638a may cause the search result detail window 1645 to be provided and/or suppressed. The search result indicator 1639a may provide information of a response. For example, the search request information indicator 1635b may include the search query indicator 1637b, the search detail control 1638b, and the search result indicator 1639b.

The search result detail window 1645 may be used to provide information regarding a search request. For example, activation of the search detail control 1638b may ‘toggle’ the presence of the search result detail window 1645. The search result detail indicator 1640f may indicate information of a guide who produced a search result(s) indicated in the search result detail window 1645. Activation of the search result detail indicator 1640f may cause information associated with a guide to be provided. The search result detail indicator 1640a may indicate information of a URL associated with a search result. Activation of the search result detail indicator 1640a may cause a web page or other information associated with a search result to be provided. The search result detail indicator 1640e may indicate information of a URL and/or text associated with a search result. The search result indicator 1640b may indicate information of a URL which may access a web page optimized for a device(s) and/or service(s). Activation of the search result indicator 1640b may for example cause a web page optimized for delivery to and presentation by a mobile device(s) to be provided. The ‘Sent to mobile device’ search result indicator 1640c may indicate information of a device(s) and/or service(s). Activation of the ‘Sent to mobile device’ search result indicator 1640c may for example cause a list of communication information which may be used to transmit and/or receive information to be provided. The ‘Forward to a Friend’ search result indicator 1640d may indicate information of how a search result may be shared. Activation of the ‘Forward to a Friend’ search result indicator 1640d may for example cause a GUI such as the search result sharing window 1618 to be provided.

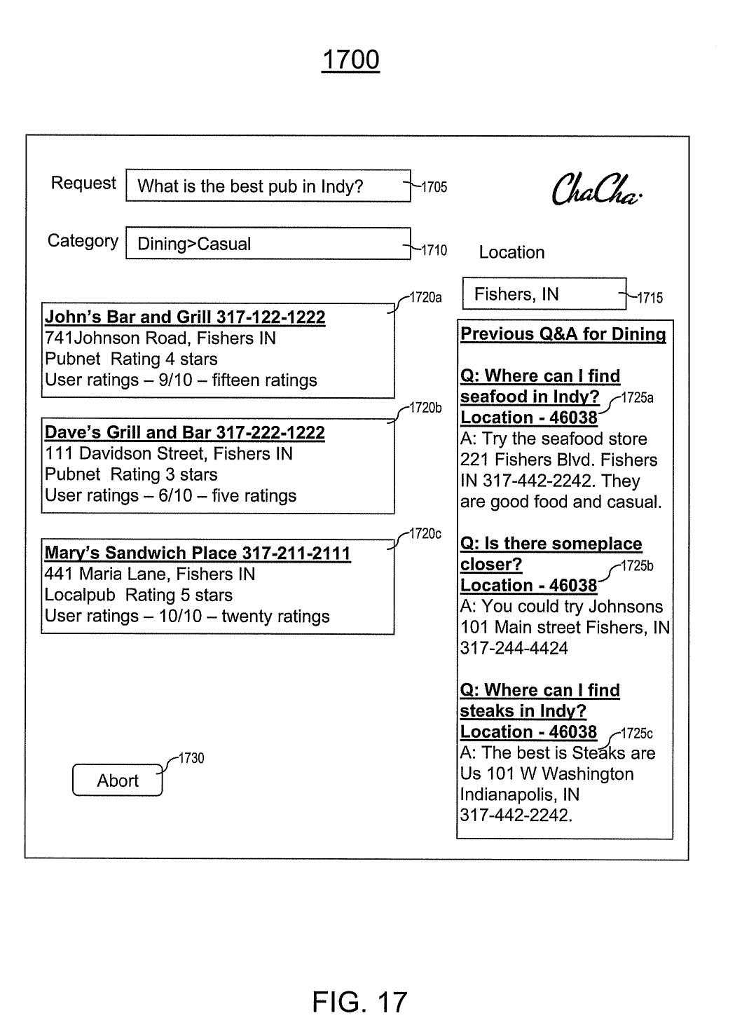

A GUI 1700 for selection of a search result is illustrated in FIG. 17. The GUI 1700 may for example be presented on a display device associated with a system such as the guide system 110 (FIG. 1).

The GUI 1700 may include a query box 1705, a category indicator 1710, a location indicator 1715, search result indicators 1720, historical query indicators 1725, and an action control 1730.

The query box 1705 may be used to indicate a query. While a text query is used in FIG. 17 for the purposes of illustration, any type of information of a query such as text, audio, video, etc. may be accessed using the query box 1705. Keywords of a query may be indicated by for example underlining, shading, or other suitable indicators, which may be used to select any or all of a query. The category indicator 1710 may be used to indicate a category associated with a query indicated in the query box 1705. A category associated with a query may be modified by for example typing in the category indicator 1710, etc. Modification of a category associated with a query may for example cause the search results indicated in the search result indicators 1720 to be modified. The location indicator 1715 may be used to indicate a location associated with a query.

The search result indicators 1720 may be used to indicate information of a search result. For example, a hyperlink, text, etc. associated with a search result may be indicated in a search result indicator. The search result indicator 1720a indicates the result ‘John's Bar and Grill’. The search result indicator 1720b indicates the result ‘Dave's Grill and Bar’. The search result indicator 1720c indicates the result ‘Mary's Sandwich Place’. Activation of the search result indicator 1720c may cause the result ‘Mary's Sandwich Place’ to be transmitted responsive to the query ‘What is the best pub in Indy?’ associated with the category ‘Dining>Casual’ and the location ‘Fishers, Ind.’. The historical query indicators 1725 may indicate information associated with previous requests. For example previous requests by a user associated with the query indicated in the query box 1705 which are associated with the category ‘Dining’ may be presented in the historical query indicators 1725. The historical query indicator 1725a indicates a question and a response associated with the question ‘Where can I find seafood in Indy?’ The historical query indicator 1725b indicates a question and a response associated with the question ‘Is there someplace closer?’ which is a response to the query indicated in the historical query indicator 1725c. The historical query indicator 1725c indicates a question and a response associated with the question ‘Where can I find steaks in Indy?’ While a few queries and responses are indicated, any number of search result indicators 1720 and historical query indicators 1725 may be provided in the GUI 1700. Activation of the ‘Abort’ action control 1730 may cause the GUI 1700 to be closed and the search request to be transferred.

The GUI 1700 may be used to select any type of item(s). In particular as no commercial information is provided in the GUI 1700, the judgment of a best item (result, advertisement, etc.) by a guide using the GUI 1700 is not directly influenced by commercial considerations. However it is important to note that commercial considerations might be used to influence a selection made using the GUI 1700. For example, the order of presentation of the search result indicators, resources used to select the search results provided and/or a categorization associated with a query might be influenced by commercial considerations. Various ways of influencing how a search result is obtained and/or ranked as previously described herein with respect to FIG. 10 may be utilized. Likewise, a guide selected to use the GUI 1700 may be chosen based on commercial considerations which are not directly visible to the guide. For example, if a guide is associated with an affiliate group, the guide might be preferentially selected to obtain a search result which might indirectly affect a search result.

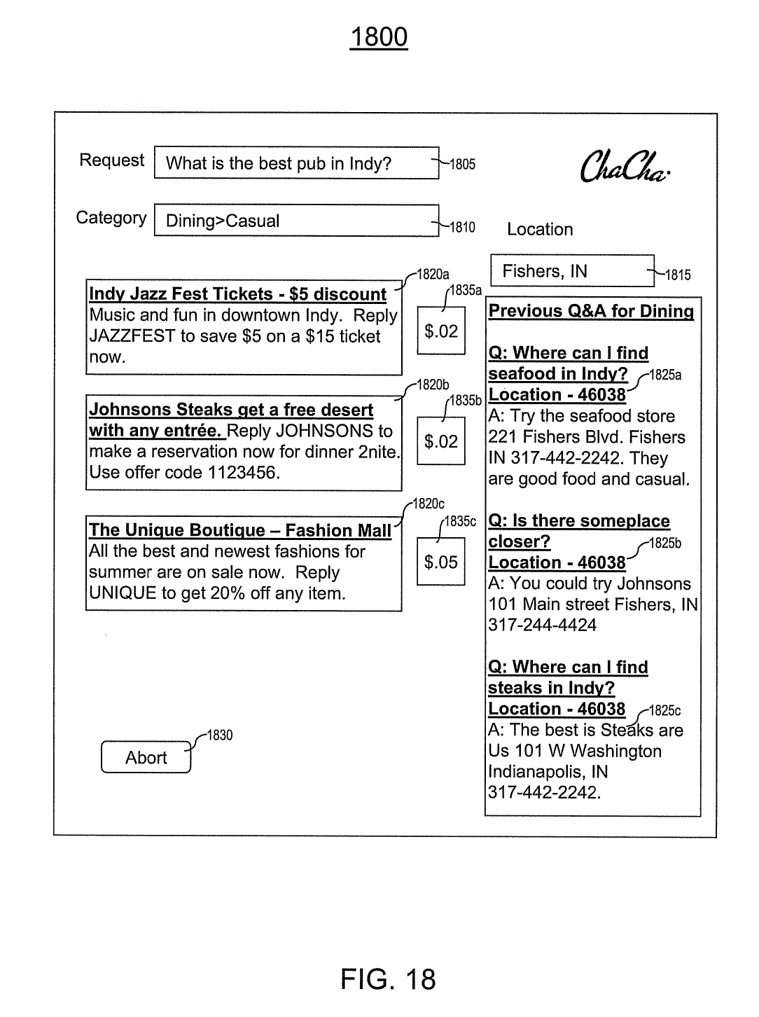

A GUI 1800 for selection of a search result based on a commercial consideration is illustrated in FIG. 18. The GUI 1800 may for example be presented on a display device associated with a system such as the guide system 110 (FIG. 1).

The GUI 1800 may include a query box 1805, a category indicator 1810, a location indicator 1815, search result indicators 1820, historical query indicators 1825, an action control 1830, and compensation indicators 1835.

The query box 1805 may be used to indicate a query. While a text query is used in FIG. 18 for the purposes of illustration, any type of information of a query such as text, audio, video, etc. may be accessed using the query box 1805. Keywords of a query may be indicated by for example underlining, shading, or other suitable indicators, which may be used to select any or all of a query. The category indicator 1810 may be used to indicate a category associated with a query indicated in the query box 1805. A category associated with a query may be modified by for example typing in the category indicator 1810, etc. Modification of a category associated with a query may for example cause the search results indicated in the search result indicators 1820 to be modified. The location indicator 1815 may be used to indicate a location associated with a query.

The search result indicators 1820 may be used to indicate information of a search result. For example, a hyperlink, text, etc. associated with a search result may be indicated in a search result indicator. The search result indicator 1820a indicates the result ‘Indy Jazz Fest Tickets’. The search result indicator 1820b indicates the result ‘Johnsons Steaks’. The search result indicator 1820c indicates the result ‘The Unique Boutique’. Activation of the search result indicator 1820b may cause the result ‘Johnsons Steaks’ to be transmitted responsive to the query ‘What is the best pub in Indy?’ associated with the category ‘Dining>Casual’ and the location ‘Fishers, IN’. The historical query indicators 1825 may indicate information associated with previous requests. For example previous requests by a user associated with the query indicated in the query box 1805 which are associated with the category ‘Dining’ may be presented in the historical query indicators 1825. The historical query indicator 1825a indicates a question and a response associated with the question ‘Where can I find seafood in Indy?’ The historical query indicator 1825b indicates a question and a response associated with the question ‘Is there someplace closer?’ which is a response to the query indicated in the historical query indicator 1825c. The historical query indicator 1825c indicates a question and a response associated with the question ‘Where can I find steaks in Indy?’

The compensation indicators 1835 may be used to indicate compensation associated with a search result indicated in the search result indicators 1820. The compensation indicator 1835a indicates that the result ‘Indy Jazz Fest Tickets’ has a value of ‘$0.02’. The compensation indicator 1835a indicates that the result ‘Johnsons Steaks’ has a value of ‘$0.02’. The compensation indicator 1835a indicates that the result ‘The Unique Boutique’ has a value of ‘$0.05’. If the search result indicated in a search result indicator is accepted, compensation indicated in the compensation indicator 1835 may be provided to a guide.

While a few queries and responses are indicated, any number of search result indicators 1820, historical query indicators 1825, and compensation indicators 1835 may be provided in the GUI 1800. Activation of the ‘Abort’ action button 1830 may cause the GUI 1800 to be closed and the search request to be transferred.

The GUI 1800 allows a guide to make a selection of a result based on commercial considerations. For example, a guide might elect to activate the ‘Unique Boutique’ search result indicator 1820c as it has the highest direct compensation. Likewise, a guide might choose to activate the ‘Johnsons Steaks’ search result indicator 1820b as it has a lower compensation value, but the user has previously visited that business and may be more likely to accept the offer. Alternately the guide might choose to activate the ‘Indy Jazz Fest’ search result indicator 1820c as it has equal compensation value to ‘Johnsons Steaks’ but the user may be more likely to accept a better discount offer. Any type of information may be provided to a guide when making a judgment regarding selection of a search result. For example, a guide may obtain previous query information of a user relating to a category selected by the guide, may directly obtain a search result from a resource, may activate a hyperlink to view greater details of a result, etc.

In the case of the GUI 1800, multiple compensation factors, and other judgment criteria are presented. By presenting context to a human observer, the guide, a judgment may be made which is more optimal than a decision based an economic considerations and algorithmic ranking of a search result, advertisement, or other item(s).

While the system described may be used to select a single result responsive to a single query, it may further be used to select a result which may be presented responsive to multiple queries. For example, if a query is frequently asked by users, a guide may be asked to select a best result, a best advertisement, etc. which may be presented to any user who submits the query. In this way, the improved targeting of an advertisement along with high frequency of use may greatly offset the cost associated with human review of the results. Likewise, a guide associated with a profile might be asked to select an advertisement associated with a category which might be preferentially provided to users associated with a similar profile when the users submit a query related to the category. Targeting based on the judgment of a guide may be used to offset the cost of human effort as the number of queries associated with a category and a profile may be large. Various combinations and/and permutations of targeting will immediately occur to one of ordinary skill on the relevant art and are within the scope of the disclosure herein.

As the system and method provides a guide with information of compensation associated with a search result, judgment of the guide may be aligned with that of a provider of a search service. However, it is not necessary that compensation be financial and/or personal. For example, a guide might earn credibility ‘points’ based on acceptance of a search result which might increase a quality rating of the guide. Likewise, a group of guides working for a charitable entity might obtain revenue for the charity if advertisements selected by the group are more frequently used. Any sort of compensation information might be provided.

As previously mentioned, a selection of a search result by a guide may be indirectly influenced. For example, compensation information may be biased, or an order of presentation of a search result(s) or a resource(s), search strategy, a ranking algorithm, etc. used to obtain a result may be affected, etc. based on compensation information. As both the type of items provided for review and information provided to a guide in order to perform a review may be influenced algorithmically, a selection by a guide may be influenced while still allowing the guide to have the perception that no commercial consideration has been applied.

A system is disclosed whereby a human guide(s) may be utilized to select an ‘organic’ search result(s) and/or a sponsored result(s) which may be selected according to any criteria which may be determined to be suitable. A guide is selected and is presented with information of a request and a search result(s) which may match the request. A guide selects a search result. A selection by a guide may be indirectly influenced by commercial considerations such as changing an order of results to be selected, or changing a type of resources provided to a guide, etc. A selection by a guide may be directly influenced by commercial considerations. A guide may be presented with compensation information which is associated with a search result.

An advertiser(s) may elect to provide a resource(s), sponsored content and/or other information which might be associated with a guide(s) and/or an advertiser. A guide may be able to select sponsored content based on compensation information provided to the guide. A guide(s) may be presented with sponsored resource(s) which may be associated any number of advertisers, which may improve selection of a sponsored result and/or sponsored content. GUIs and data structures for operating the embodiments are disclosed.

The system provides a search result(s) to a user responsive to a request. One or more search results, which may be identified as to the type of result (i.e., sponsored, not sponsored, etc.) are selected. A guide may be selected and provided with information which might produce a search result which is not intentionally influenced by commercial considerations. A guide might produce a search result which is intentionally influenced by commercial considerations. A ranking(s) of a search result(s) may be based on commercial considerations, and/or may be variously influenced by commercial considerations. In at least one embodiment, a human selected search result(s) may be provided responsive to a request based on stored information. A guide may be compensated based on re-use of a search result(s) selected by the guide. A guide may be explicitly aware of a commercial consideration(s), and/or a guide may be presented with item(s) such as a resource(s), etc. which are influenced by commercial considerations without explicit information that such influences have been applied.

An advertiser may be provided with information of a guide(s), a keyword(s), a category(ies), a profile, etc. which may allow an advertiser to bid for placement of advertisements. For example, an advertiser may bid to be associated with a highly rated guide(s), might select to present information to a guide(s) associated with demographic and/or other information (i.e., a profile), or might bid to associate sponsored content with a guide(s) associated with a category(ies) and/or keywords. Methods for associating sponsored content and/or other resource(s) with persons and/or other information indicated in the system database are provided. In this way, a search result such as an advertisement and/or other search result may be selected to be associated with a profile, a category, a keyword and/or combination thereof based on commercial considerations as viewed by a number of guides associated with a characteristic(s).

Methods for selecting a guide(s), a search result(s), resource(s) and/or other information which may be influenced in various ways by commercial considerations are described. In lieu of selecting items based solely on commercial considerations (e.g. the highest bidder) or solely on a figure of merit associated with the items, human judgment may be applied to a selection which includes consideration of both commercial factors, merit and/or other decision making elements. A decision making process which includes commercial considerations is effectively separated from a selection process based on relevance of a result.

Search systems have become commonly used in order to obtain information. In particular many users may find information regarding products and services using search services. For example, a search on the Google™ search service for ‘Samsung LCD TV’ may produce shopping results for dozens of stores and/or shopping services such as eBay or Amazon. In the case of mobile search, users have begun to use smart phones, and/or text enabled phones to obtain information. However, all such systems presume some level of knowledge of a product. In order to obtain product information, a user may be required to delve into websites, acquire in formation from multiple sources of unknown reliability, and make a buying decision only after extensive effort.

Likewise, diverse websites have been created for various types of shopping. Websites such as eBay®, or Amazon® allow a user to obtain information of available products as provided by the seller, and select a product based on various search criteria. Such sites may provide good value to a user. A price and/or product offered may or may not be superior to an offer from other retailers, etc. However, in order to make an informed buying decision, a user may need to have a level of domain specific expertise which requires a significant investment of time and/or effort in order obtain a suitable product at an acceptable price.

While mobile devices continue to achieve progressively greater capabilities, the limited size, bandwidth and user interface of a mobile device may make using a purchasing website difficult and/or unworkable. A user may have difficulty to request assistance with a product purchase. Information may be located in diverse locations and provided by various sources such as magazine/websites, product producers, retailers, and/or wholesalers, etc.

A search service may miss an opportunity to consummate a transaction between a user and a provider of goods and/or services if a user simply can not determine a best option, or may perceive a low level of customer service associated with an automated browsing facility. As a consequence a vendor may miss a revenue opportunity, a search service may miss an opportunity to monetize advertising at a buying moment, and a user may miss an advantageous offer to purchase a suitable product.

A method and system are disclosed to facilitate a purchase by providing a human assistant who may have relevant expertise responsive to a user request. A user may submit a request for information, which may be determined to include a request to make a purchase. For example, a user might submit a request regarding a type of product, and might indicate intent to purchase the product. A human assistant who may be selected to assist with an information search or ‘guide’ may be provided to respond to a user request. A number of human assistants with relevant knowledge regarding an item(s) and/or service(s) or ‘advocates’, who may also be guides, may be identified to respond to a user request. An advocate may utilize any available resource(s) to select an item(s) and/or service(s) responsive to a user request. An advocate may select a provider of an item(s), information and/or service(s) or ‘vendor’ who may provide an item(s) and/or service(s) to a user. A user may confirm the intent to make a purchase. Information required to make a purchase and/or fulfill a purchase request may be provided. An advocate may be compensated. A system database is provided which includes information of requests, users, guides, advocates, vendors, resources and/or other items which may be used to select a guide, an advocate, a vendor, a resource, and/or other information responsive to a user request.

If a request is received, a unique identifier may be associated with the request and with a user submitting the request. A determination is made as to whether a request includes an indication of the intent to purchase an item(s) and/or service(s). An advocate(s), who may facilitate a purchase is selected based at least in part on information indicated in a database which may include information of an advocate(s), user(s), guide(s), request(s), vendor(s), resource(s), etc. An advocate may provide information regarding a user, a request, and/or other information to a resource(s) and/or a vendor(s), and/or an advocate(s) in order to assist a user in making a purchase. Activities associated with an advocate may be tracked, and may be used to determine compensation of an advocate.

A system is provided which allows a user who may be any person to submit a search request or search query or request to a search service and receive a response to the search request. A system which allows communication to occur between a user(s), a guide(s) or human assistant(s), a resource(s), an advocate(s) or human purchase assistant(s), a vendor(s) and/or the search system allows requests to be processed. A database comprising information regarding a user(s), a guide(s), an advocate(s), a vendor(s), a resource(s), a request(s), a profile(s), etc. is provided.

A request submitted by a user may receive a response which is produced automatically and/or utilizing assistance of one or more guides. In at least one embodiment, a request submitted by a user is compared to a database of request(s) in order to determine if a matching request is found in the database. If a matching request is found, a result(s) associated with the matching request(s) may be presented to a user(s) responsive to a request(s) or search request(s).

A user request(s) may be determined to include a request to purchase an item(s) and/or service(s). An item(s) and/or service(s) to be purchased may be identified, and a request may be associated with a categorization, a keyword(s), a profile(s) and/or other information which may be used to select a number of advocates to respond to a request to purchase or ‘purchase request’. A human assistant may interact with a user in order to clarify and/or confirm information of a request. Information of a request and/or information associated with a request(s) may be utilized to provide compensation to an advocate(s). Compensation may be provided to an advocate(s) by any or all of a user(s), a vendor(s) and/or a search system(s). Ranking and/or rating of advocates associated with a category(ies), keyword(s), or other information which may be associated with a request may improve matching of an advocate with a purchase request.

Various sources of information or ‘resources’ may be provided to an advocate. An advocate may be provided with information associated with one or more ‘vendors’ or suppliers or providers of an item(s) and/or service(s) based on information associated with the advocate. For example, a public resource may be available to any advocate, while restricted information such as inventory information, pricing information, or other information which may be controlled by a vendor may be provided to an advocate based on an affiliation between an advocate and a vendor. Likewise, a vendor(s) might provide a different access privilege(s), and/or access to a resource(s) based on any information associated with an advocate(s). For example, an advocate who produced a high level of sales for a vendor might be provided with information which is not available to a different advocate(s).

A vendor(s) may be provided with information of an advocate(s). For example, a vendor(s) may select an advocate(s) based on a category(ies), a keyword(s), a tag(s), transactions(s), etc. and may be presented with information of advocates associated with the designated information. A vendor(s) may contact an advocate(s) without having personally identifying information of the advocate. Likewise an advocate may be presented with information of a vendor(s). An advocate(s) may contact a vendor(s) based on information indicated in a system database.

User information which may be used to facilitate a purchase may be provided to a search system, which may be provided to a vendor(s) by the search system without revealing the user information to an advocate(s), and/or a guide(s).

In one embodiment, an ‘expeditor’ guise may determine if a request includes a request to purchase an item. A request to purchase an item may be referred to as a ‘purchase request’. A purchase request may be provided to an advocate who is selected. For example, an advocate may be selected based on keywords and/or categories associated with a request.

An advocate may be compensated according to various models. In at least one embodiment, an advocate may be compensated by a search service. For example, the search service may make purchases as proxy for the customer from various merchants and may charge the customer a convenience fee which is shared with the advocate who executed the transaction. Alternately, a request to a merchant via a web communication may include an affiliate code which indicates a customer who has been qualified, which may result in a payment to a search service such as a ‘finder's fee’ which may be shared with an advocate. In at least one embodiment, an advocate may be an independent contractor who may make purchases and resell the items and/or services to a user(s).

An advocate may be associated with a vendor in various ways. In at least one embodiment, an advocate has no direct relationship with a vendor and may be selected based on criteria determined by a search service. For example, a ranking or rating of an advocate may be based on ratings by users related to transactions, on total transactions, on transaction dollar volume, etc. which may be related to categories, keywords, and/or other items. In at least one embodiment, an advocate is exclusively associated with a vendor. A vendor may provide registration information, resources, and/or other information regarding an advocate which may be used to assist the advocate in selling items associated with the vendor, In at least one embodiment, a vendor may select an advocate to be associated with the vendor, but the advocate may not be exclusively associated with the vendor. Any combination of affiliations and compensation for various persons may be chosen as determined to be suitable by a provider of a search system.

A guide who directs a transaction to an advocate and/or a vendor may be compensated. For example, a successful transaction, any referral, a referral of a transaction which includes a particular action, etc. may determine compensation for a guide. An advocate may bid to receive referrals relating to categories and/or keywords, profiles, etc. An advocate may bid for referrals which a guide has determined are qualified at various levels. For example, a user who has responded to an advertisement may be judged to have a higher level of qualification than a user who has submitted an undirected query. A vendor may similarly bid on qualified requests for an item.

The terms voice and speech are used interchangeably herein. A user, a resource, an advocate, a vendor, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, a web service, an API, regular mail or any other type of communication. A connection may be established using any device which is capable of utilizing a communication service. For example, a wireless device such as a cell phone, PDA, smart phone, etc. might be used to establish a communication session using voice, SMS, IM, email and/or internet protocols. A desktop, laptop or server system might be used to establish a communication session. A landline phone, a specialized communication terminal, or any other communication device might be used to establish a communication session.

Communication between a guide, a user, a resource, an advocate, a vendor and/or a search system may include conversion of text to speech and speech to text, or other types of information conversion. Any type of media which can be sent or received using a communication system may be part of a communication session. A communication session may be conducted using any or all communication service(s) associated with a user, a resource, an advocate, a vendor and/or a guide.

A resource, a guide, an advocate, and/or a vendor may be rated. Rating information may be obtained from a user, a guide(s), an advocate(s), a vendor(s) and/or a search system. Rating information may be used to select a resource(s), a guide(s), an advocate(s), a vendor(s) and/or any item(s) based on information associated with an item indicated in a database. The search service may be compensated by advertising revenue, and/or by payments from a user(s), an advocate(s), a vendor(s) and/or a guide(s).

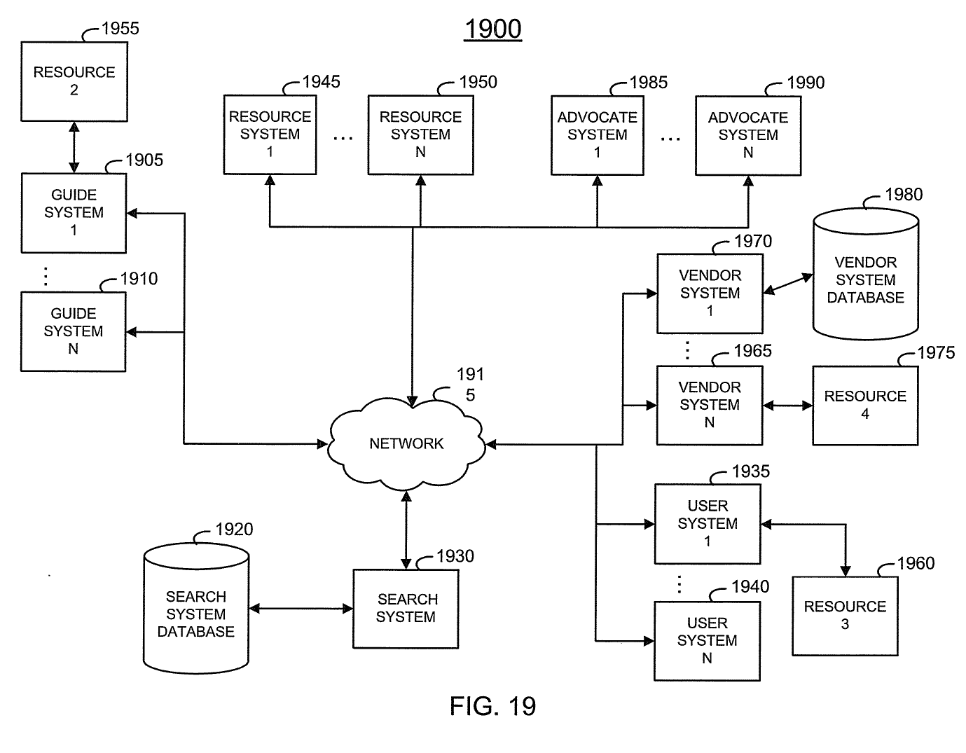

As illustrated in FIG. 19, system 1900 includes guide system(s) 1905, 1910, a network 1915 such as the Internet, a search system 1930, user system(s) or information seeker system(s) 1935, 1940, a search system database 1920, which may comprise various records, resources 1945, 1950, 1955, 1960, 1975, vendor systems 1965, 1970, a vendor system database 1980, and advocate systems 1985, 1990.

While only a limited number of systems associated with a guide, resource, user, vendor, advocate and as a search system are depicted in FIG. 19, it is within the scope of the disclosure for multiple systems for guide, resource, user, vendor, advocate and search systems to be utilized.

Any user system (e.g., the user systems 1935, 1940) can be operated by a user, who may be a person, to submit a request to the search system 1930 and/or receive a search result(s) and/or other information. Any guide system (e.g., the guide systems 1905, 1910) can be operated by a guide or human assistant to obtain a search result(s) for a user located at a user system. Any resource system (e.g., the resource systems 1945, 1950) may be operated by a human provider of information and/or may be an automated system which may provide a result(s) and/or other information to a guide and/or a user, such as a search engine, a database, a system which may perform tasks such as image recognition, voice recognition, translation, transcription, or other forms of information processing, a local information source of a guide system such as a disk or removable memory, an application and/or database accessible from a user system(s), and/or a guide system, etc. A resource may not be accessible using the network 1915. For example, a resource such as the resource ‘Resource 2’ 1955 may be accessible to a guide operating a guide system such as the guide system 1905, or a resource such as the resource ‘Resource 3’ 1960 may be accessible to a user operating a user system such as the user system 1935, or a resource such as the resource ‘Resource 4’ 1975 may be accessible to a vendor operating a vendor system such as the vendors system ‘Vendor System N’ 1965. A resource might include printed materials, images, video, and/or audio information, a software application(s), any information accessible to a guide(s), a vendor(s), an advocate(s), and/or a user(s), a database(s), and/or any combination thereof.

The network 1915 (FIG. 19) may be a global public network of networks (the Internet) and/or consist in whole or in part of one or more private networks and communicatively couples the guide systems 1905, 1910, the resource systems 1945, 1950, the advocate systems 1985, 1990, the vendor systems 1965, 1970 and the user systems 1935, 1940 with the other components of the system such as the search system 1930, the search system database 1920, and the vendor system database 1980. For example, a private network might be provided to enable more secure communication between a vendor system such as the vendor system 1970 and other elements of the system 1900, such as the search system 1930, and the advocate systems 1985, 1990. The network 1915 may include one or more wireless networks which may enable wireless communication between the various elements of the system 1900. For example, a mobile phone carrier network might be used to connect a user device to the search system 1930.

The search system 1930 allows interaction to occur among the guide systems 1905, 1910, the resource systems 1945, 1950, the vendor systems 1965, 1970, the advocate systems 1985, 1990 and the user systems 1935, 1940. For example, an information search query(ies) can be transmitted from the user systems 1935, 1940 to the search system 1930, where a search query(ies) can be accessed by the guide systems 1905, 1910 and/or the resource systems 1945, 1950. Similarly, a result(s) produced from the resource systems 1945, 1950 including results produced using the guide systems 1905, 1910 in response to a search query(ies) submitted by the user systems 1935, 1940 may be transmitted to the search system 1930, where it may be stored by the search system 1930 and/or may be transmitted to the user systems 1935, 1940. While a simple example is used for the purposes of explanation, no limitation is implied thereby. Any number messages using any types of communication services may be exchanged between elements of the system 1900 as may be required to operate the embodiments.

The search system 1930 is communicatively coupled with the search system database 1920. As will be described herein in further detail below, the search system database 1920 includes data that is processed in association with operation(s) of the embodiments. Although FIG. 19 illustrates the search system database 1920 as a separate component of the system, the search system database 1920 may be integrated with the search system 1930. Further, the records maintained in the search system database 1920 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the search system database 1920 may reside in any suitable elements of the system 1900.

The user systems 1935, 1940, the guide systems 1905, 1910, the search system 1930 the resource systems 1945, 1950, the vendor systems 1965, 1970, and the advocate systems 1985, 1990 may include equipment, software, systems and personnel required to send and/or receive messages between a user system, a guide system, a resource system, a vendor system, an advocate system and/or the search system using the network 1915. The search system database 1920 includes information which may allow the search system 1930 to establish communication between the other elements of the system 1900.

A user system, a guide system, an advocate system, a vendor system, and/or a resource system may be a desktop or laptop PC or Mac®, a mobile phone, a smart phone, a PDA, a server system, a landline phone, a specialized communication terminal, a terminal connected to a mainframe, or any other communication device and/or system. The search system 1930 may include one or more servers, computers, etc. For example, servers such as the PowerEdge® 2900 by Dell, or the BladeCenterJS22 by IBM, or equivalent systems might be used to implement elements of the search system 1930. The search system 1930 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as user systems, guide systems, resources, and/or to implement the search system 1930.

A guide may be required to register with the search system 1930. As part of a registration process, at least one communication method is associated with a guide. In at least one embodiment, a guide may register with the search system 1930 and establish a username and password which are associated with the guide. A guide may login to the search system 1930 using a web browser functionality of the guide system 1905 in order to communicate with the search system 1930. Multiple communication services may be associated with a guide and may allow a communication session to be established between a guide system such as the guide system 1905 and a user system, a resource system and/or the search system 1930. Multiple identifiers of a guide may be associated with each other. Information such as IM credential(s), an email address(es), a phone number(s), a URL, a username, etc. of a guide may be identified which may allow the search system 1930 to establish a communication session between a guide system, an advocate system, a vendor system and a user system, a resource system, and/or the search system 1930.

When a guide registers with the search system 1930 the guide may be associated with one or more keywords, categories, and/or other information. For example a keyword(s) or category(ies) may be selected by a guide, or may be associated with a guide based on a test(s) administered to a guide and/or other information provided during and/or after a registration process. Information associated with a guide may be stored in the search system database 1920 and may be used for purposes such as matching a guide to a user request, determining and/or providing compensation for a guide, communicating with a guide, etc. as will be described further herein below.

An advocate may be required to register with the search system 1930. As part of a registration process, at least one communication method is associated with an advocate. In at least one embodiment, an advocate may register with the search system 1930 and establish a username and password which are associated with the advocate. An advocate may login to the search system 1930 using a web browser functionality of the advocate system 1985 in order to communicate with the search system 1930. Multiple communication services may be associated with an advocate and may allow a communication session to be established between an advocate system such as the advocate system 1985 and a user system, a resource system, a vendor system, a guide system and/or the search system 1930. Multiple identifiers of an advocate may be associated with each other. Information such as IM credential(s), an email address(es), a phone number(s), a URL, a username, etc. of an advocate may be identified which may allow the search system 1930 to establish a communication session between an advocate system and a user system, a resource system, a guide system, a vendor system and/or the search system 1930. In at least one embodiment, information of an advocate may be provided by a vendor system, such as the vendor system 1970, based on information indicated in for example the vendor system database 1980.

When an advocate is registered with the search system 1930 the advocate may be associated with one or more keywords, categories, and/or other information. For example a keyword(s) or category(ies) may be selected by an advocate, or may be associated with an advocate based on a test(s) administered to an advocate and/or other information provided during and/or after a registration process. Information associated with an advocate may be stored in the search system database 1920 and may be used for purposes such as matching an advocate to a user request, determining and/or providing compensation for an advocate, communicating with an advocate, etc. as will be described further herein below.

A vendor may be required to register with the search system 1930. As part of a registration process, at least one communication method is associated with a vendor. In at least one embodiment, a vendor may register with the search system 1930 and establish a username and password which are associated with the vendor. A vendor may login to the search system 1930 using a web browser functionality of the vendor system 1965 in order to communicate with the search system 1930. Multiple communication services may be associated with a vendor and may allow a communication session to be established between a vendor system such as the vendor system 1965 and a user system, a guide system, an advocate system, a resource system and/or the search system 1930. Multiple identifiers of a vendor may be associated with each other. Information such as IM credential(s), an email address(es), a phone number(s), a URL, a username, etc. of a vendor may be identified which may allow the search system 1930 to establish a communication session between a vendor system and a user system, a resource system, a guide system, an advocate system and/or the search system 1930. In at least one embodiment, information of a vendor may be determined by a guide(s), an advocate(s), and/or a user(s). For example, an advocate may identify information of a vendor(s) which may allow communication to be established with the vendor even though the vendor may not have registered with the search system 1930.

When a vendor is registered with the search system 1930 the vendor may be associated with one or more keywords, categories, and/or other information. For example a keyword(s) or category(ies) may be selected by a vendor, or may be associated with a vendor based on a test(s) administered to a vendor and/or other information provided during and/or after a registration process. For example, if an advocate associated with a category(ies) utilizes a vendor to complete a purchase for a user(s) the vendor may be associated with the category(ies) and may be rated and/or ranked in association with the category(ies). Information associated with a vendor may be stored in the search system database 1920 and may be used for purposes such as matching a vendor to a user request, determining and/or providing compensation for a vendor, communicating with a vendor, etc. as will be described further herein below.

A user may be identified by the search system 1930. When a user system such as the user system 1935 establishes a communication session with the search system 1930, an identifier of a user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 1935 and a guide system, a resource system, an advocate system, a vendor system and/or the search system 1930. Information such as a keyword(s), a category(ies), a user profile(s), a previous search request(s), a search result(s), etc. may be associated with a user. Information of a user may be stored in the search system database 1920.

A resource, which may be a person(s), an entity(ies), a search engine, a database, a software application, a corpus of one or more types of media such as text or printed information, images, audio, video, etc. or a combination thereof, may be identified by the search system 1930. Information of at least one method of communication is associated with a resource system which allows a communication session to be established between the search system 1930, a user system a vendor system, an advocate system, and/or a guide system and a resource system such as the resource systems 1945, 1950. An identifier of a resource system may be associated with other information regarding a resource. A resource system may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource system such as the resource system 1945 and a user system, a guide system, and/or the search system 1930. Information such as a keyword(s), a category(ies), a profile(s), or other information may be associated with a resource. Information of a resource may be stored in the search system database 1920.

A resource such as the resource 1955, the resource 1960, the resource 1975 and/or resources accessible via the resource systems 1945, 1950 may include any system(s), software, hardware, personnel and/or other facility(ies) which may provide information to a guide(s), a user(s), an advocate(s), a vendor(s) and/or the search system 1930. For example, a resource may be a search engine, a database system, a library, a personal hard drive and/or other local storage, printed materials, recordings of any sort, a software program(s), a person or person(s), an organization, etc. A resource may be freely accessible to any user(s), advocate(s), vendor(s) and/or guide(s) and/or may be available on a restricted basis. The resource system(s) 1945, 1950 may include resource(s) which are available on an unrestricted and/or restricted basis. A resource may not be accessible using the network 1915, but may be accessible to a guide(s), an advocate, a vendor and/or a user(s). For example, a resource such as the resource 1955 may be accessible to one or more guide(s) operating a guide system(s) such as the guide system 1905 using any type of communication. For example, a guide(s) may obtain information of an event(s) to provide a search result(s). Information in any form, such as printed media, audio and/or visual information, software, hardware, etc. which may be accessible to a guide(s), a user(s), an advocate(s), a vendor(s) and/or an operator(s) of a resource system(s) may be a resource. Similarly, a resource such as the resource 1960 may be accessible to a user at the user system 1935. For example, the resource 1960 may be a software application(s) and/or database which may in whole or in part be accessible by the user system 1935 or a resource such as the resource 1975 may be accessible to a vendor at the vendor system 1965. For example, the resource 1975 may be a software application(s) and/or database which may in whole or in part be accessible by the vendor system 1965.

The search system 1930 may establish a communication session between any user system(s), guide system(s), advocate system(s), vendor system(s) or resource system(s) using information indicated in the search system database 1920. For example, the user system 1935 may establish a voice communication session with the search system 1930, the search system 1930 may establish a voice communication session between the user system 1935 and the guide system 1905, and the search system 1930 may establish a voice communication session between the user system 1935 and the resource system 1945. While a voice communication session is used in this example, any type of communication session using one or more services such as SMS, EMS, MMS, email, IM, chat, web based communication, etc. may be established between any user system(s), guide system(s), vendor system(s), advocate system(s) and/or resource system(s) and/or the search system 1930.

Information associated with a user(s), a guide(s), an advocate, a vendor(s) and/or a resource(s) may be obtained in various ways. For example, a registration process may be performed using a web form(s) provided by the search system 1930, information may be obtained from an external database, and/or information may be obtained based on analysis of information indicated by a user(s), a guide(s), an advocate(s), a vendor(s) and/or a resource(s). A ‘profile’ is one or more characteristics which may be associated with one or more individuals and/or entities. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device(s), service(s), transaction(s) or any other information which might be associated with a user(s), an advocate(s), a vendor(s) and/or a guide(s).

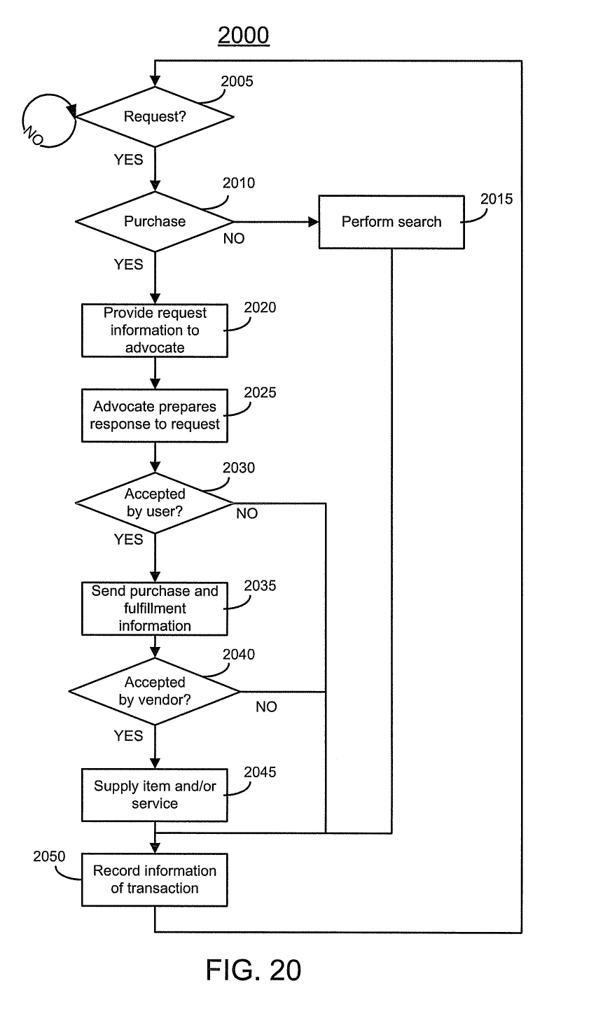

As illustrated in FIG. 20, a process 2000 for processing a facilitating a purchase using a human assistant is provided. In at least one embodiment, the process 2000 is operative in part on a guide system, a user system, a vendor system and/or the search system 1930 (FIG. 19).

In operation 2005 (FIG. 20) a determination is made as to whether a request is received. If it is determined in operation 2005 that a request is not received control remains at operation 2005 and process 2000 continues. If it is determined in operation 2005 that a request is received, control is passed to operation 2010 and process 2000 continues.

The determination in operation 2005 may be made based on various criteria. It may be determined that a request is received based on receiving a message at any device(s) associated with the search system 1930 (FIG. 19). For example, a voice message might be received at telephone number, an SMS message might be received, an IM might be received, an email might be received, a web request might be received, and/or a message using any services associated with the search system might be used to determine that a request has been received. A request may be received through an API.

In operation 2010 (FIG. 20) a determination is made as to whether a request indicates intent to make a purchase. If it is determined in operation 2010 that a request does not indicate intent to make a purchase control is passed to operation 2015 and process 2000 continues. If it is determined in operation 2010 that a request indicates intent to make a purchase, control is passed to operation 2020 and process 2000 continues.

The determination in operation 2010 may be made based on various criteria. For example, a user may activate a control in an interface, or reply to an advertising message with a keyword, or a guide may determine that a user intends to make a purchase, or the determination may be made based on information indicated in a database, or the determination may be made by an advocate, who may for example have received information of a request, etc. Any suitable criteria may be used to determine that a request indicates intent to make a purchase.

In operation 2015 an information search is conducted responsive to a user request. Any type of information search may be performed. In at least one embodiment, a human-assisted search may be performed as described further herein. Control is passed to operation 2050 and process 2000 continues.

In operation 2020, information associated with a request is provided to an advocate(s). In at least one embodiment, an advocate is selected. For example, a number of advocates may be ranked and notified of a request in an order based on the ranking, or a first available advocate may be selected, or a number of advocates may be notified until a number of advocates respond to a notification. In at least one embodiment, a resource(s) may be provided to an advocate based on information associated with a request. For example, a resource(s) may be selected based on a keyword(s), category(ies), profile(s), user, a previous request(s), etc. which may be associated with a request automatically, and/or based on actions of a guide(s). Historical information associated with a request may be provided to an advocate. Control is passed to operation 2025 and process 2000 continues.

In operation 2025 an advocate responds to a user request. An advocate may respond to a user request in various ways. For example, an advocate may provide information of a number of purchase opportunities to a user(s) based on information indicated in a request. An advocate may respond with a request for further information from a user(s). An advocate may provide a response based on stored information. A response may include any type of information which may be provided by an advocate utilizing communication services associated with the advocate. Control is passed to operation 2030 and process 2000 continues.

In operation 2030 a determination is made as to whether a user accepts a response from an advocate. If it is determined in operation 2030 that a user does not accept a response from an advocate, control is passed to operation 2050 and process 2000 continues. If it is determined in operation 2030 that a user accepts a response from an advocate, control is passed to operation 2035 and process 2000 continues.

The determination in operation 2030 may be made based on various criteria. For example, a user may indicate acceptance by replying to a text message, or a user may activate a control in an interface, or a user may speak a response, or a user may provide security information, or if a user does not respond after a time interval it may be determined that a user did not accept a response, etc. Any suitable criteria may be applied to determine whether a user accepts a response from an advocate.

In operation 2035, purchase request information is provided to a vendor. One or more vendors may be provided with information associated with a user and/or an advocate. For example, an identifier of a user may be passed to a vendor system, which may indicate payment, purchase, delivery information, etc. associated with a user. For example, information stored in the search system database 1920 may be provided to the vendor system 1970, and/or information indicated in the vendor system database 1980 may be utilized based on an identifier associated with a user, and/or information provided by an advocate may be provided to a vendor. In at least one embodiment, information of an advocate(s) who provided a response accepted by a user is provided to a vendor, and may be used to determine compensation for the advocate(s). Control is passed to operation 2040 and process 2000 continues.

In operation 2040 a determination is made as to whether a vendor accepts a purchase request. If it is determined in operation 2040 that a vendor does not accept a purchase request, control is passed to operation 2050 and process 2000 continues. If it is determined in operation 2040 that a vendor accepts a purchase request, control is passed to operation 2045 and process 2000 continues.

The determination in operation 2040 may be made based on various criteria. For example, a vendor may indicate acceptance by replying to a text message, or a vendor may provide an acceptance message via a secure network which may be included in the network 1915 (FIG. 19), or a vendor may provide a confirmation code, or a lack of a response to a purchase request message within a time interval may indicate that a purchase request is not accepted, etc. Any suitable criteria may be applied to determine whether a vendor accepts a purchase request.

In operation 2045, an item(s) and/or service(s) are provided to a user. For example, a user may be provided with information and/or other services via the network 1915, or a user may receive a product by parcel delivery, or a user may obtain an item(s) or service(s) from a facility operated by a vendor, etc. Information of the receipt of an item(s) and/or service(s) may be provided by a user, a vendor, and/or an advocate. Information of delivery of an item(s) and/or service(s) may be used to rate a vendor and/or an advocate. For example, a user rating(s) might be requested by the search system 1930, or an advocate might receive information regarding user satisfaction via a web service provided by the advocate, etc. Control is passed to operation 2050 and process 2000 continues.

In operation 2050 information of a transaction is recorded. In at least one embodiment, the search system database 1920 (FIG. 19) and/or the vendor system database 1980 is updated. For example, information associated with a request, such as a resource(s), a guide(s), a user(s), an advocate, a vendor and/or rating(s), ranking(s) and/or historical and/or usage information, etc. associated with a categorization(s), keyword(s) profile(s), etc. may be recorded and/or associated and information of the associations may be recorded in the search system database 1920 and/or the vendor system database 1980. For example, information of a request(s), which may assist an advocate in responding to a purchase request, or information of acceptance of a response from an advocate by a user, or information of acceptance of a purchase request by a vendor, or information of delivery of an item(s) and/or service(s), or information of user, vendor, guide, or advocate opinions, etc. may be recorded and/or modified. Control is passed to operation 2005 and process 2000 continues.

The process 2000 may be applied to any request. A request which may not indicate intent to purchase an item may receive a response, which may provide information which may assist a guide and/or an advocate and/or a vendor in responding to a request. For example, a user may submit a first request which does not indicate intent to purchase an item, while intent to purchase may be determined based on a combination of a first request and subsequent requests.

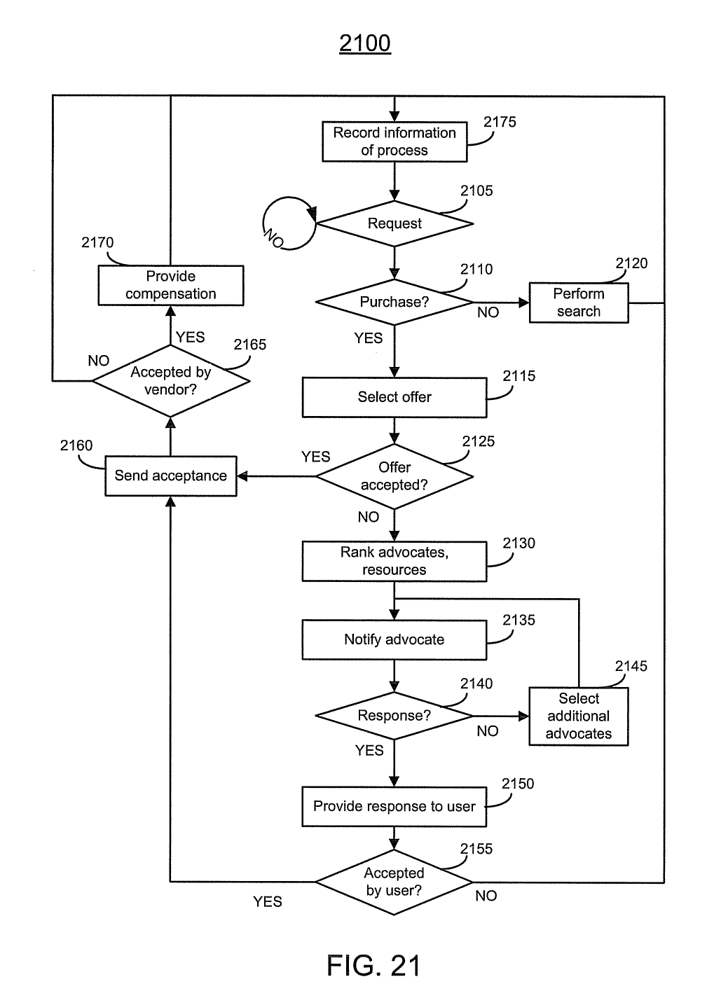

As illustrated in FIG. 21, a process 2100 for processing a request from a search system perspective is provided. The process 2100 may be operative on the search system 1930 (FIG. 19).

In operation 2105 (FIG. 21) a determination is made as to whether a request is received. If it is determined in operation 2105 that a request is not received control remains at operation 2105 and process 2100 continues to wait. If it is determined in operation 2105 that a request is received, control is passed to operation 2110 and process 2100 continues.

The determination in operation 2105 may be made based on various criteria. It may be determined that a request is received based on receiving a message at any device(s) associated with a system such as the search system 1930 (FIG. 19). For example, a voice message might be received at telephone number, an SMS message might be received, an IM might be received, an email might be received, a web request might be received, and/or a message using any services associated with a search system might be used to determine that a request has been received. In at least one embodiment, a request may be determined to have been received based on a trigger condition which may be indicated in the search system database 1920. A request may be received through an API provided in association with the search system 1930.

In operation 2110 (FIG. 21) a determination is made as to whether a request indicates intent to make a purchase. If it is determined in operation 2110 that a request does not indicate intent to make a purchase control is passed to operation 2120 and process 2100 continues. If it is determined in operation 2110 that a request indicates intent to make a purchase, control is passed to operation 2115 and process 2100 continues.

The determination in operation 2110 may be made based on various criteria. For example, a user may activate a control in an interface, or a guide selected by the system 1900 may determine that a user intends to make a purchase, or the determination may be made based on information indicated in the search system database 1920, which may match any or all elements of a request, or a resource may process a user request and may indicate that a user request indicates intent to make a purchase. Any suitable criteria may be used to determine that a request indicates intent to make a purchase.

In operation 2120 an information search is conducted responsive to a user request. Any type of information search may be performed. In at least one embodiment, a human-assisted search may be performed. Control is passed to operation 2175 and process 2100 continues.

In operation 2115 an offer is selected. An offer may be selected responsive to a user request determined to indicate intent to make a purchase. An offer may be an offer to purchase an item(s) and/or service(s). Any number of offers may be selected. For example, a purchase request may be compared to a database of purchase requests, which may be associated with one or more offers, which may be selected based on a rating and/or ranking of an offer associated with a request(s). Any information associated with a request may be used to select an offer(s). For example, a keyword(s), category(ies), user(s), profile(s), guide(s), etc. which may be associated with a request may be associated with a ranking of an offer, which may be used at least in part to select an offer. Any or all selected offers may be provided to a user. An offer may be static information and/or may be dynamically generated based on information of a request. An advocate may be associated with an offer(s), and may be compensated based on acceptance of an offer. Control is passed to operation 2125 and process 2100 continues.

In operation 2125 a determination is made as to whether an offer is accepted. If it is determined in operation 2125 that an offer is accepted control is passed to operation 2160 and process 2100 continues. If it is determined in operation 2125 that an offer is not accepted control is passed to operation 2130 and process 2100 continues.

The determination in operation 2125 may be made based on various criteria. For example, a user may activate a control in an interface or a user may send a message to a system(s) associated with the search system 1930, or a time interval may expire, etc. Any suitable criteria may be used to determine that an offer is accepted.

In operation 2130 advocates and resources which may be provided to an advocate are ranked. A ranking of an advocate may be based on rating and/or ranking information associated with an advocate. A ranking of an advocate may be based on a keyword(s), category(ies), profile(s), etc. which may be associated with an advocate. In at least one embodiment, if a keyword of a request matches a keyword associated with an advocate, a ranking of an advocate associated with the request may be increased. Any information associated with a query and an advocate may affect a ranking of an advocate associated with a request. A resource such as a website associated with a vendor (e.g., ‘circuitcity.com’), or a product information resource (e.g., ‘consumerreports.org’), or a manufacturer's website (e.g., ‘panasonic.net/products), or a search appliance associated with a website (e.g., an auction website) might be ranked based on rating information associated with the resource. Any resources which may assist an advocate in responding to a request or purchase request may be ranked. Control is passed to operation 2135 and process 2100 continues.

In operation 2135, one or more advocates are notified of a request. A request notification may be provided using any communication information associated with an advocate. For example a voice, SMS, IM, email, web-based communication, etc. which may allow the search system 1930 to communicate with an advocate may be used to notify an advocate(s) of a request. A notification may be provided to an advocate based on a ranking associated with a request. Any or all information associated with a request may be included in a notification. For example, a notification may include information of a resource(s), a user(s), a guide(s), a location(s), a category(ies), a profile(s) etc. which may be associated with a request. An advocate may establish communication with the search system 1930 (FIG. 19) using any communication service(s) associated with an advocate in order to access information associated with a request. Control is passed to operation 2140 and process 2100 continues.

In operation 2140 a determination is made as to whether a response is received. If it is determined in operation 2140 that a response is not received control is passed to operation 2145 and process 2100 continues. If it is determined in operation 2140 that a response is received control is passed to operation 2150 and process 2100 continues.

The determination in operation 2140 may be made based on various criteria. For example, a message(s) may be received by a system(s) associated with the search system 1930 (FIG. 19) from a system(s) associated with an advocate(s) such as the advocate system 1985 or a message(s) might be received from a system(s) associated with a resource system(s) and/or a vendor system(s), a guide system(s), etc. For example, an advocate may respond to a notification by routing a request to a different system which may respond on behalf of the advocate. Any suitable criteria may be used to determine that a response is received.

In operation 2145 additional advocates who may be notified of a request are selected. Advocates may be selected based on criteria such as ranking or rating(s) of an advocate, availability of the advocate, etc. In at least one embodiment, a time interval may be provided, which may allow a previously notified advocate(s) to respond to a request prior to an advocate(s) who may be selected in operation 2145. Control is passed to operation 2135 and process 2100 continues.

In operation 2150 a response is provided to a user. Information of one or more responses to a user request may be provided to a user(s) using any or all communication service(s), device(s), and/or information associated with a user(s). For example, an SMS message which might contain a URL which might include detailed information of an offer to purchase a product might be provided to a user via a mobile device(s) associated with a request or purchase request such as the user system 1935 (FIG. 19), or a URL which provides information of an offer might be delivered to a browser functionality associated with a user system such as the user system 1940, or a notification of an offer might be provided via a first user system which might allow a user to access further information of the offer via a second user system on demand. Control is passed to operation 2155 and process 2100 continues.

In operation 2155 a determination is made as to whether a response is accepted by a user. If it is determined in operation 2155 that a response is not accepted control is passed to operation 2175 and process 2100 continues. If it is determined in operation 2155 that a response is accepted control is passed to operation 2160 and process 2100 continues.

The determination in operation 2155 may be made based on various criteria. For example, a message(s) may be received by a system(s) associated with the search system 1930 (FIG. 19) from a system(s) associated with a user(s) such as the user system 1935 or a message(s) might be received from a system(s) associated with a resource system(s), and/or an advocate system(s), a vendor system(s), etc. Any suitable criteria may be used to determine that a response is accepted.

In operation 2160 information of an accepted offer(s) is sent. For example, information of an accepted offer may be transmitted to an advocate system(s) and/or a vendor system(s) in order to indicate intent to complete a purchase(s) associated with an offer(s) accepted by a user. Information indicated in a response(s) provided to a user in operation 2155 may cause information of acceptance of an offer(s) to be transmitted from a user system. Any information associated with an accepted offer may be transmitted in operation 2160. In at least one embodiment, a URL which may include information of an advocate may be provided to a vendor system. For example, a tracking URL might be assigned to the search system 1930 and/or an advocate system. Control is passed to operation 2160 and process 2100 continues.

In operation 2165 a determination is made as to whether a request is accepted by a vendor(s). If it is determined in operation 2165 that a request is not accepted control is passed to operation 2175 and process 2100 continues. If it is determined in operation 2165 that a request is accepted control is passed to operation 2170 and process 2100 continues.

The determination in operation 2165 may be made based on various criteria. For example, a message(s) may be received by a system(s) associated with the search system 1930 (FIG. 19) from a system(s) associated with a vendor(s) such as the vendor system 1970 or a message(s) might be received from a system(s) associated with a resource system(s) and/or an advocate system(s), or etc. In at least one embodiment, a message from a vendor system is received by the search system 1930 which may confirm that a purchase transaction has been completed by a user. Any suitable criteria may be used to determine that a request is accepted.

In operation 2170 compensation is provided. For example, a percentage of a purchase completed based on information provided by an advocate may be credited to an account in the search system database 1920 (FIG. 19) associated with an advocate, or an advocate may receive a fixed amount for a purchase made based on an offer accepted in operation 2125 and/or operation 2165, which may be recorded in a vendor system database based on information provided by the search system 1930. Compensation may be any sort of consideration, which may include cash, non-cash, and/or forms of remuneration which may have tangible and/or intangible value. Any number of advocates may be compensated based on a transaction accepted in operation 2165. For example, a guide(s) and/or an advocate(s) who may be associated with a previous request which may have resulted in an offer which was declined for any reason may be compensated if an offer related to the previous request is accepted, or a guide who may have selected an advocate to respond to a request may be compensated, etc.

In operation 2175 information of the process 2100 is recorded. In at least one embodiment, the search system database 1920 (FIG. 19) is updated. For example, information associated with a request, such as a resource(s), a guide(s), a user(s), an advocate, a vendor and/or rating(s), ranking(s) and/or historical and/or usage information, etc. associated with a categorization(s), a profile(s), etc. may be recorded and/or associated and information of the associations may be recorded in the search system database 1920. For example, information of a search request(s), which may assist an advocate in responding to a user request or purchase request, or information of acceptance of a response from an advocate by a user, or information of acceptance of a purchase request by a vendor, or information of delivery of an item(s) and/or service(s), or information of user, vendor, guide, or advocate opinion(s), etc. may be recorded and/or modified. Control is passed to operation 2105 and process 2100 continues.

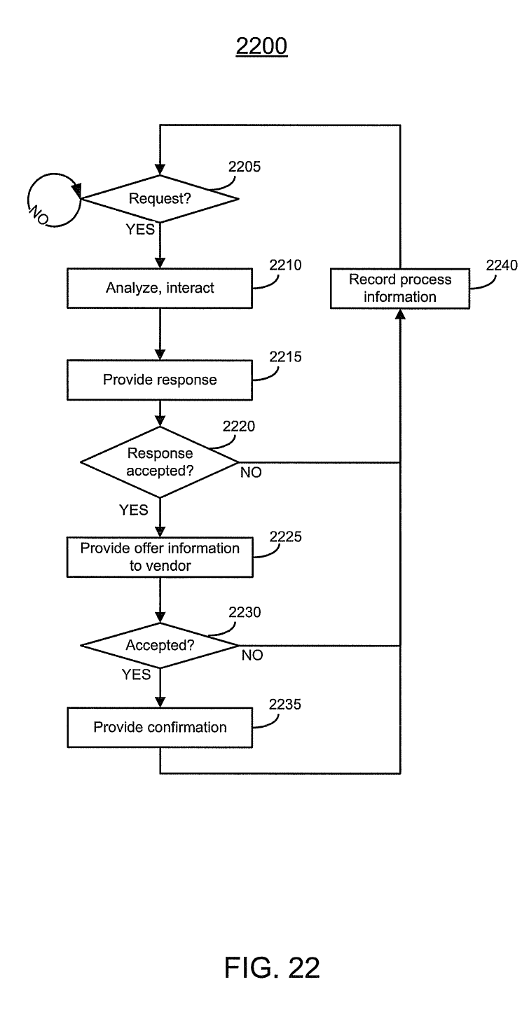

As illustrated in FIG. 22, a process 2200 for processing a request from an advocate system perspective is provided. The process 2200 may be operative on a system such as the advocate systems 1985, 1990 (FIG. 19).

In operation 2205 (FIG. 22) a determination is made as to whether a request is received. If it is determined in operation 2205 that a request is not received control remains at operation 2205 and process 2200 continues. If it is determined in operation 2205 that a request is received, control is passed to operation 2210 and process 2200 continues.

The determination in operation 2205 may be made based on various criteria. It may be determined that a request is received based on receiving a message at any device(s) associated with an advocate such as the advocate system 1985 (FIG. 19). For example, a voice message might be received at telephone number, an SMS message might be received, an IM might be received, an email might be received, a web request might be received, and/or a message using any services associated with an advocate might be used to determine that a request has been received. A request may be received using an API (Application Programming Interface).

In operation 2210, information associated with a request is obtained. Any type of information associated with a request may be obtained. For example, audio, text, video, images, media, information associated with a request(s) and/or a user(s) such as a profile, geographic, demographic, a transaction and/or query history, a category, a keyword, a vendor, etc. may be obtained by a an advocate. An advocate may interact with a user. Communication between an advocate and a user may be anonymous. An advocate may obtain information of a resource(s) which may be used to prepare a response to a request. Control is passed to operation 2215 and process 2200 continues.

In operation 2215 a response is provided by an advocate. Any or all information associated with a request may be submitted to a resource(s), which may include a vendor system(s) which may provide information which may be indicated in a response. For example, an advocate may submit information of a request to one or more resources which might provide a URL, text, images, audio, or other information which may be used to respond to a request. Information of a resource(s) may be indicated in a response provided by an advocate. Information associated with a resource may be used for purposes such as rating and/or ranking a resource. In at least one embodiment, an advocate may be provided with information of a number of offers which may be selected by the advocate responsive to a request. Control is passed to operation 2220 and process 2200 continues.

In operation 2220 a determination is made as to whether a response is accepted. If it is determined in operation 2220 that a response is not accepted control is passed to operation 2240 and process 2200 continues. If it is determined in operation 2220 that a response is accepted control is passed to operation 2225 and process 2200 continues.

The determination in operation 2220 may be made based on various criteria. For example, a message(s) may be received by a system(s) associated with an advocate from the search system 1930 (FIG. 19), a user system(s), or a vendor system associated with a response provided by an advocate, or expiration of a time interval might be used to determine whether a response is accepted. In at least one embodiment, a message from a user is received by the search system 1930 which may indicate that a response from an advocate is accepted by a user and an advocate system is notified by a message from the search system 1930. Any suitable criteria may be used to determine that a response is accepted.

In operation 2225, information of a request is provided to a vendor(s). For example, acceptance of an offer may cause information of a request to be transmitted to a vendor system by the search system 1930 automatically, or information of a request stored in an advocate system might be transmitted to the search system 1930 (FIG. 19) which may transmit any or all of the information to a vendor(s), or an advocate system might provide information of a request directly to a vendor system, etc. Control is passed to operation 2230 and process 2200 continues.

In operation 2230 a determination is made as to whether a request is accepted by a vendor(s). If it is determined in operation 2230 that a request is not accepted control is passed to operation 2240 and process 2200 continues. If it is determined in operation 2230 that a request is accepted control is passed to operation 2235 and process 2200 continues.

The determination in operation 2230 may be made based on various criteria. For example, a message(s) may be received by a system(s) associated with an advocate from the search system 1930 (FIG. 19), a vendor system(s), or a user system associated with a response provided by an advocate, or expiration of a time interval might be used to determine whether a response is accepted. In at least one embodiment, a message(s) from a vendor is received by the search system 1930 which may indicate that a response from an advocate(s) is accepted by a vendor, and any or all of a message(s) received from a vendor is transmitted to an advocate(s). Any suitable criteria may be used to determine that a request is accepted.

In operation 2235 information of confirmation of a user request by a vendor is provided. In at least one embodiment, an advocate system may transmit a message(s) to the search system 1930, which may transmit any or all of the message(s) to a user system. Alternately a message indicating acceptance of a user request may be transmitted from an advocate system(s) and/or a vendor system(s) to a user system(s) based on information provided by an advocate system(s) and/or the search system. For example, an identifier of a user may be provided to an advocate system(s) and/or a vendor system(s) by the search system 1930 which may be used to provide information of acceptance of a request to the user. Any combination of message passing between elements of the system 1900 may be used to provide confirmation information. Control is passed to operation 2240 and process 2200 continues.

In operation 2240 information of the process 2200 is recorded. In at least one embodiment, the search system database 1920 (FIG. 19) is updated. For example, information associated with a request, such as a resource(s), a vendor(s), an advocate(s), a guide(s), a user(s), and/or rating(s), ranking(s) and/or historical and/or usage information may be recorded and/or associated and information of the associations may be recorded in the search system database 1920. Information of acceptance of a response by a user(s) and/or information of acceptance by a vendor may be recorded, which may be used to rate and/or rank a vendor(s), an advocate(s), a guide(s), a resource(s), etc. For example if a response is not accepted in operation 2220, or if a request is not accepted in operation 2230, such information may affect a rating(s) of an advocate(s), a vendor(s), a resource(s), a guide(s), etc. As previously mentioned herein above, elements of the search system database 1920 may be resident in any suitable systems within the system 1900 and any storage comprised in whole or in part within a resource system, a vendor system, an advocate system, a user system and/or a guide system may be considered to be an element of the search system database 1920. For example, local storage associated with an advocate system which may be accessible to the search system 1930 may be used to record information obtained while processing a request. Control is passed to operation 2205 and process 2200 continues.

While the process 2200 is illustrated as utilizing a single advocate, it is envisioned that any number of advocates may perform any of the operations. For example, a request may be processed as a sequence of individual tasks, rather than a continuous flow.

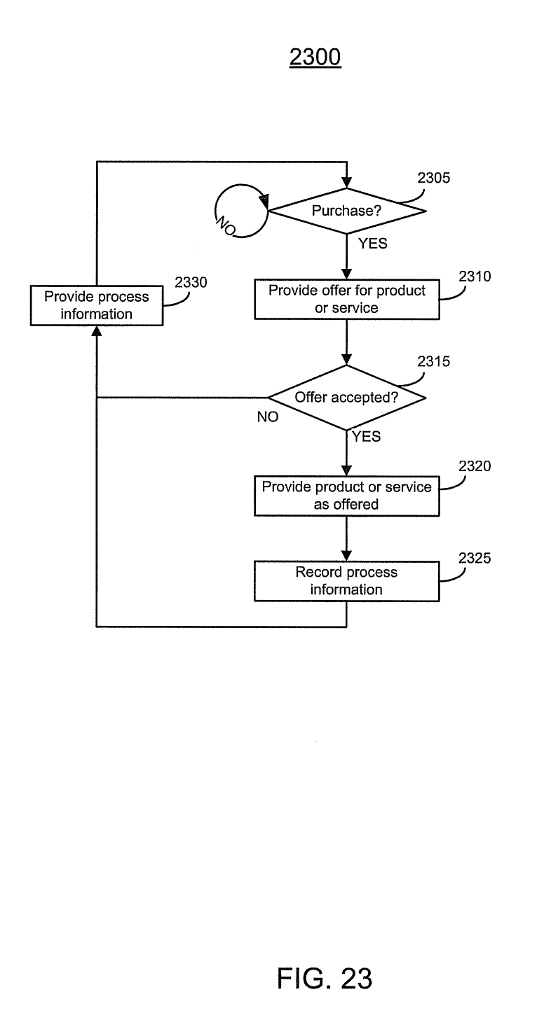

As illustrated in FIG. 23, a process 2300 for processing a request from a vendor system perspective is provided. The process 2300 may be operative on a system such as the vendor systems 1965, 1970 (FIG. 19).

In operation 2305 (FIG. 23) a determination is made as to whether a purchase request is received. If it is determined in operation 2305 that a purchase request is not received control remains at operation 2305 and process 2300 continues to wait. If it is determined in operation 2305 that a purchase request is received, control is passed to operation 2310 and process 2300 continues.

The determination in operation 2305 may be made based on various criteria. It may be determined that a request is received based on receiving a message at any device(s) associated with a vendor such as the vendor system 1965 (FIG. 19). For example, a voice message might be received at telephone number, an SMS message might be received, an IM might be received, an email might be received, a web request might be received, and/or a message using any services associated with a vendor might be used to determine that a request has been received. A request may be received through an API. A purchase request may for example be received from an advocate system, which may be made on behalf of a number of users. A purchase request may be received in part from an advocate system(s), from a user system(s), and/or from a search system. For example, an advocate(s) may select an item(s) and/or service(s) on behalf of a user(s), who may provided payment information, validation, security information, etc. The search system 1930 (FIG. 19) may provide stored information, such as provided by a user(s) and/or an advocate(s).

In operation 2310, an offer to provide an item(s) and/or service(s) is provided by a vendor. For example, a price, delivery terms, payment terms, etc. may be provided by a vendor system(s) responsive to a purchase request. Control is passed to operation 2315 and process 2300 continues.

In operation 2315 a determination is made as to whether an offer is accepted. If it is determined in operation 2315 that an offer is not accepted control is passed to operation 2330 and process 2300 continues. If it is determined in operation 2315 that an offer is accepted control is passed to operation 2320 and process 2300 continues.

The determination in operation 2315 may be made based on various criteria. For example, a message(s) may be received by a system(s) associated with a vendor from the search system 1930 (FIG. 19), or an advocate system(s), or a user system(s) associated with an offer provided by a vendor, or expiration of a time interval might be used to determine whether a response is accepted. In at least one embodiment, a message from a user is received by the search system 1930 which may indicate that an offer from a vendor is accepted by a user, and a message may be sent to a vendor system(s) responsive to the user message(s). Any suitable criteria may be used to determine that an offer is accepted.

In operation 2320 an item(s) and/or service(s) is provided by a vendor. An item(s) and/or service(s) may be provided using any suitable delivery system. For example, a software product might be provided as a download, or a product might be shipped to a user at an address indicated by the user, etc. Control is passed to operation 2325 and process 2300 continues.

In operation 2325, information of the process 2325 is recorded. In at least one embodiment the vendor system database 1980 (FIG. 19) is updated. For example, information of a purchase, an advocate(s), a user(s), the search system, a resource(s), etc. may be recorded and/or modified in a database). Information indicated in a vendor system database may or may not be available to the search system 1930 and/or the search system database 1920, as the vendor system database 1980 may for example include sensitive and/or personal information associated with a user(s). In such a case it may be that information regarding a user(s) stored in the vendor system database 1980 may not be accessible to the search system 1930 and/or a guide(s), a resource(s) and/or an advocate(s). Control is passed to operation 2330 and process 2300 continues.

In operation 2330 process information is provided. For example, information associated with a request, such as a resource(s), a vendor(s), an advocate(s), a guide(s), a user(s), and/or rating(s), ranking(s) and/or historical and/or usage information may be recorded and/or associated and information of the associations may be recorded in the search system database 1920. Information of acceptance of an offer(s) by a user(s) and/or information of acceptance by a vendor may be recorded, which may be used to rate and/or rank a vendor(s), an advocate(s), a guide(s), a resource(s), etc. For example if an offer is not accepted in operation 2315 such information may affect a rating(s) of an advocate(s), a vendor(s), a resource(s), a guide(s), etc. As previously mentioned herein above, elements of the search system database 1920 may be resident in any suitable systems within the system 1900 and any storage comprised in whole or in part within a resource system, a vendor system, an advocate system, a user system and/or a guide system may be considered to be an element of the search system database 1920. For example, storage associated with a vendor system which may be accessible to the search system 1930 may be used to provide information obtained while processing a purchase request. Control is passed to operation 2305 and process 2300 continues.

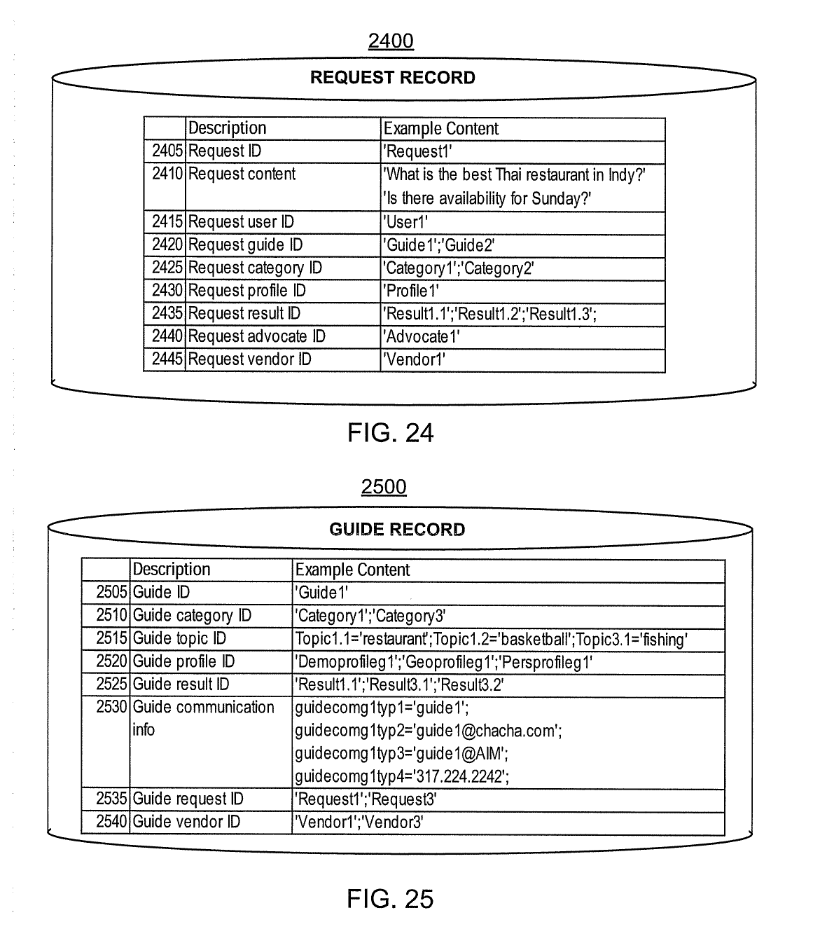

As illustrated in FIG. 24, an exemplary request record 2400 is provided, of which one or more may be associated with or resident in the search database 1920 (FIG. 19). The request record 2400 may include a request ID field 2405, a request content field 2410, a request user ID field 2415, a request guide ID field 2420, a request category ID field 2425, a request profile ID field 2430, a request result ID field 2435, a request advocate ID field 2440, and a request vendor ID field 2445.

A request record may be created by various processes, including a guided search session, an interactive training session, a non-interactive training session, may be imported from an external resource accessible to the search system, submission of a search request to a resource(s) such as a search engine(s), etc. In at least one embodiment, a request record is created when a request is received by the search system 1930 (FIG. 19).

The request ID field 2405 (FIG. 24) preferably contains a unique identifier of a request, which is preferably used consistently. For example, in at least one embodiment, the request ID field 2405 can include a randomly generated numerical code, and/or a text string indicating the content of a query. A request ID serves to distinguish the request record associated with a request from a request record associated with other requests. Other unique identifiers of a search request may be utilized without departing from the spirit and scope of the embodiments. As illustrated in FIG. 6, ‘Request1’ is the request ID associated with the request record 2400.

The request content field 2410 may include information regarding content of a search request. For example, text associated with a query submitted by a user may be indicated in the request content field 2410. Such information may be processed in order to associate a keyword(s) and/or category(ies) and/or other information with a search request. In at least one embodiment, a structured query which conforms to a specific context may be indicated in the request content field 2410. User queries which are associated with a structured query which may have been submitted by more than one user may be indicated in the request content field 2410. Information such as audio recordings, images, etc. which are associated with a search request may be indicated in the request content field 2410. Using the example illustrated in FIG. 24, the query ‘What is the best That restaurant in Indy?’ and ‘Is there availability for Sunday?’ is the query content associated with the request record 2400. This may indicate that the query ‘What is the best That restaurant in Indy?’ may have been previously submitted by ‘User1’, and that the query ‘Is there availability for Sunday?’ was submitted in a follow-up request.

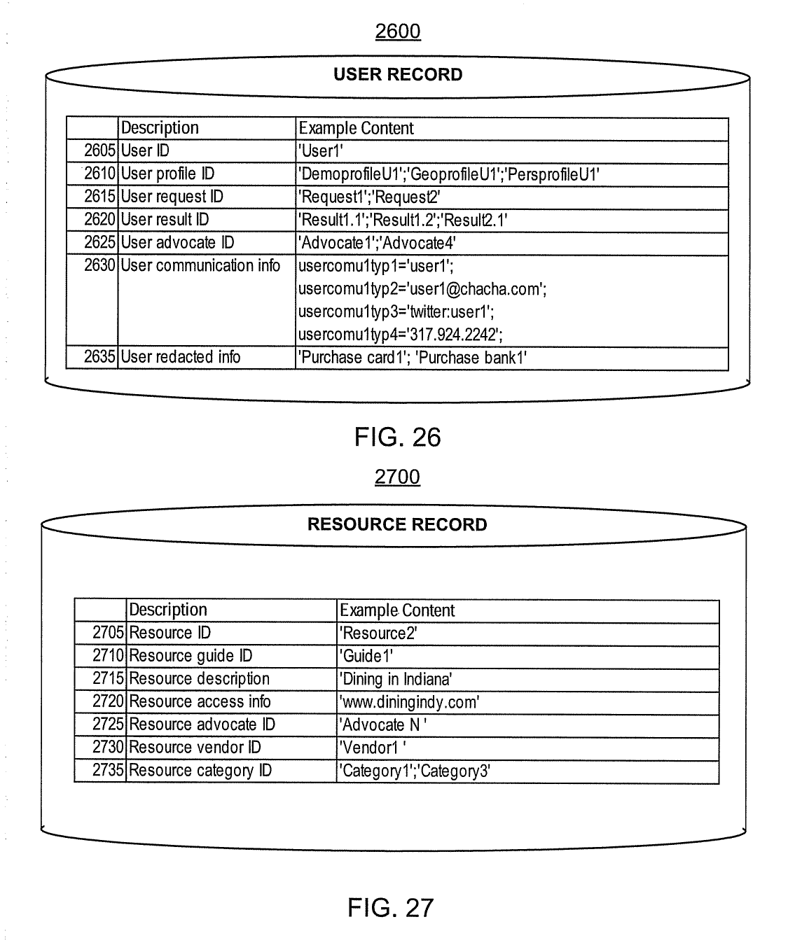

The request user ID field 2415 includes information of a user(s) that submitted a query to the search system 1930 (FIG. 19). The request user ID field 2415 (FIG. 24) may be used to associate a user(s) with a query. Multiple users may submit an equivalent search request to the search system 1930 (FIG. 19). A search result(s) and/or other item(s) associated with a search request may be presented to a user(s) and/or a guide(s) responsive to a search request in an order based at least in part on a ranking of the item(s) associated with the search request. An identifier(s) of a number of users may be indicated in the request user ID field 2415. Information indicated in the request user ID field 2415 may be used to obtain information of a user(s) using a record(s) such as the user record 2600 illustrated in FIG. 26. Using the example illustrated in FIG. 24 the user ‘User1’ has been associated with the request ‘Request1’. This may indicate that ‘User1’ submitted the request ‘Request1’.

The request guide ID field 2420 may include information of a guide(s) who are associated with a request. For example, if a guide obtains a result(s) responsive to the request ‘Request1’, an identifier of the guide may be indicated in the request guide ID field 2420. Likewise, if a guide was selected to respond to a search request, an identifier of the guide may be indicated in the request guide ID field 2420. Information indicated in the request guide ID field 2420 may be used to obtain information associated with a guide using a record(s) such as the guide record 2500 illustrated in FIG. 25. Using the example illustrated in FIG. 24 the guides ‘Guide1’ and ‘Guide2’ have been associated with ‘Request1’. This may for example indicate that ‘Guide1’ and ‘Guide 2’ were selected to respond to the request ‘Request1’. For example, ‘Guide1’ may have responded to the question ‘What is the best That restaurant in Indy’ and ‘Guide2’ may have responded to the question ‘Is there availability for Sunday?’ which may have been used to determine the intent to purchase an item(s) and/or service(s).

The request category ID field 2425 may include information of a category(ies) and/or keyword(s) associated with a request. Content of the request category ID field 2425 may be modified by an automated classification of a request. A human may select a category(ies) and/or keyword(s) which is associated with a request. For example, a request may be associated with the category “Science>Astronomy”, while another request may be associated with the category “Arts>Music”. A category may be associated with a search resource(s) such as a search engine, a website, etc., a guide(s), an advertisement(s), a vendor(s), an advocate(s), etc. An item(s) associated with a category may be presented to a guide(s) and/or a user(s) when a request associated with a category is submitted to the search system 1930 (FIG. 19). Association of a category with a request may be used to select an item(s) such as a guide(s), a vendors(s) and/or an advocate(s) associated with the category to respond to the request. Association of a category with a request may be used to select a voter(s) associated with the category to vote regarding an item associated with the request. For example, a guide(s) associated with a category may be requested to provide an opinion regarding a result(s), a vendor(s), a guide, etc. associated with a request. Using the example illustrated in FIG. 24, the categories ‘Category1’ and ‘Category2’ are associated with ‘Request1’.

The request profile ID field 2430 may include information of a profile(s) which is associated with a request. For example, a profile may be associated with a request based at least in part on a profile(s) associated with a user(s) associated with a request. For example, a geographic profile which is common to one or more users associated with a request may be associated with a request, or a guide may determine that a profile is to be associated with a request based on the content of a request(s) associated with a user(s). A guide(s) selected to respond to a request may be selected at least in part based on a profile(s) associated with the request. A voter(s) may be selected to vote regarding an item(s) associated with a request based at least in part on a profile(s) associated with a search request. For example, a guide(s) associated with a profile may be selected to provide an opinion regarding a search result(s), a vendor(s), etc. associated with a request. Using the example illustrated in FIG. 24, ‘Profile1’ is associated with ‘Request1’.

The request result ID field 2435 may include information of a result(s) which is associated with a search request. For example, a result may be associated with a search request when a guide obtains the result responsive to the request. For example, if a search request is submitted to the search system 1930 (FIG. 19), a guide may be selected, and a guide may provide a result(s) responsive to the request. Alternately, a result(s) may be associated with a request if the request is submitted to a resource such as a search engine, or other resource system. Any number of search results may be associated with a request. Using the example illustrated in FIG. 24, ‘Result1.1’, ‘Result1.2’, and ‘Result1.3’ have been associated with ‘Request1’. This may indicate that ‘Result1.1’, ‘Result1.2’, and ‘Result1.3’ have been provided responsive to ‘Request1’. A search result may include information such as an answer(s) to a query, a URL(s) associated with an answer, an advertisement(s), an offer(s), etc.

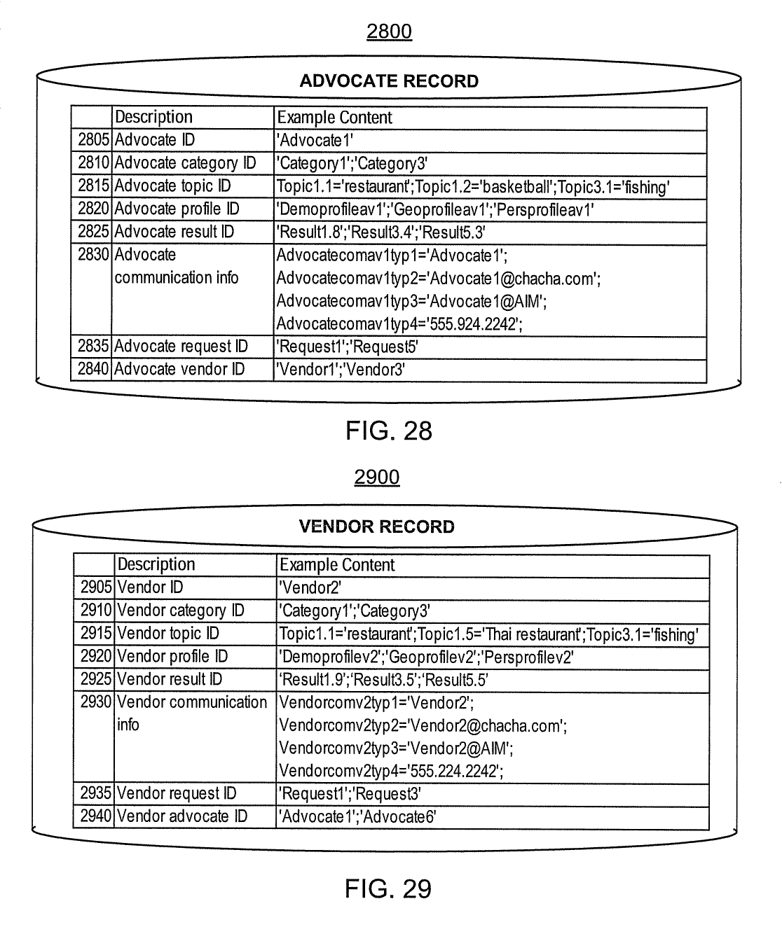

The request advocate ID field 2440 may include information of an advocate(s) who are associated with a search request. For example, if an advocate obtains a search result(s) such as an offer responsive to the request ‘Request1’, an identifier of the advocate may be indicated in the request advocate ID field 2440. Likewise, if an advocate was selected to respond to a request, an identifier of the advocate may be indicated in the request advocate ID field 2440. For example, any advocates notified of a request and/or advocates who offer a response to a request may be indicated in the request advocate ID field 2440. Information indicated in the request advocate ID field 2440 may be used to obtain information associated with an advocate using a record(s) such as the advocate record 2800 illustrated in FIG. 28. Using the example illustrated in FIG. 24 the advocate ‘Advocate1’ has been associated with the request ‘Request1’. This may for example indicate that ‘Advocate1’ was selected to respond to the request ‘Request1’.

The request vendor ID field 2445 may include information of a vendor(s) who are associated with a request. For example, if a vendor provides an item(s) and/or service(s) responsive to the request ‘Request1’, an identifier of the vendor may be indicated in the request vendor ID field 2445. Likewise, if a vendor was selected to respond to a request, an identifier of the vendor may be indicated in the request vendor ID field 2445. Information indicated in the request vendor ID field 2445 may be used to obtain information associated with a vendor using a record(s) such as the vendor record 2900 illustrated in FIG. 29. Using the example illustrated in FIG. 24 the vendor ‘Vendor1’ has been associated with the request ‘Request1’. This may for example indicate that ‘Vendor1’ was selected to provide an item(s) and/or service(s) responsive to the request ‘Request1’.

Any number of users, guides, categories, profiles, search results, advocates, and/or vendors may be associated with a search request. In at least one embodiment, information of completion of a purchase by a user may be indicated in a request record. Compensation of a guide, advocate, vendor, and/or the search system 1930 (FIG. 19) may be affected by completion of a purchase by a user. For example, an advocate may be compensated based on purchases, and/or repeated purchases by a user. Likewise, if an advocate, a vendor and/or a guide are associated with purchase by a user, a rating and/or ranking of the advocate, vendor, and/or guide may be increased, which may increase the probability of selection of the advocate, vendor and/or guide responsive to a request.

As illustrated in FIG. 25, an exemplary guide record 2500 is provided, of which one or more may be associated with or resident in the search database 1920 (FIG. 19). The guide record 2500 may include a guide ID field 2505, a guide category ID field 2510, a guide topic ID field 2515, a guide profile ID field 2520, a guide result ID field 2525, a guide communication info field 2530, and a guide request ID field 2535, and guide vendor ID field 2540.

The guide ID field 2505 preferably contains a unique identifier of a guide, which is preferably used consistently. For example, in at least one embodiment, the guide ID field 2505 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 25, ‘Guide1’ is the guide ID associated with the guide record 2500.

The guide category ID field 2510 may include information of a category(ies) associated with a guide. Content of the guide category ID field 2510 may be modified based on actions of a guide. A person may select a category(ies) and/or keyword(s) which is associated with a guide. A category may be associated with a guide based on testing of a guide(s). A category may be associated with a guide based on an affiliate group associated with a guide. For example, if a guide has chosen to be affiliated with affiliate groups associated with a type of club, a category associated with the type of club might be associated with the guide. A category(ies) associated with a guide may be used to select items which are to be presented to a guide. A guide(s) may be selected to vote regarding an item(s) based on the association of a guide with a category(ies). Using the example illustrated in FIG. 25, the categories ‘Category1’ and ‘Category3’ are associated with the guide ‘Guide1’.

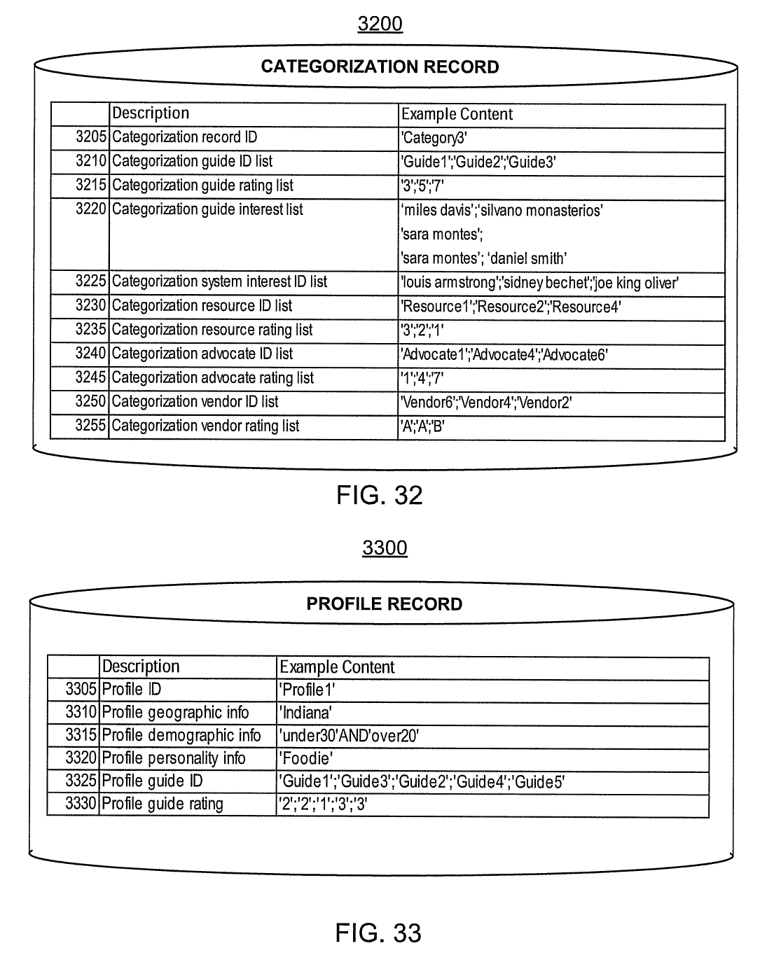

The guide topic ID field 2515 may include information of a topic(s) or interest(s) or keyword(s) associated with a guide. Content of the guide topic ID field 2515 may be modified based on actions of a guide. A person may select a topic or interest which is associated with a guide. For example, a guide may select a topic(s) or keyword(s) to be associated with the guide during a registration process. A topic may be associated with a guide based on testing of a guide(s). For example, a guide may be required to demonstrate knowledge of a category and/or topic(s) in order to be associated with the topic(s). Content of the guide topic ID field 2515 may be compared to the content of a search request in order to determine a ranking of a guide(s) for responding to a search request. Using the example illustrated in FIG. 25, the topics ‘restaurant’, ‘basketball’ and ‘fishing’ are associated with the guide ‘Guide1’. This may for example indicate that ‘Guide1’ has indicated an interest in the topics ‘restaurant’, ‘basketball’ and ‘fishing’, which may be associated with a category as further described herein with respect to FIG. 32.

The guide profile ID field 2520 may include information of a profile(s) associated with a guide. Content of the guide profile ID field 2520 may be modified based on actions of a guide. A person(s) may select a profile which is associated with a guide. For example, a guide may select a profile(s) to be associated with the guide during a registration process. A profile may be associated with a guide based on testing of a guide(s). For example, a guide may be required to demonstrate knowledge relevant to a profile(s) in order to be associated with the profile(s), or a guide may take a test which is used to generate a profile, or a guide may provide information such as demographic, geographic, personality or other information which may be indicated in a profile(s) associated with the guide. Information indicated in the content of the guide profile ID field 2520 may be compared to information indicated in the content of a profile(s) associated with a search request(s) in order to determine a ranking of a guide(s) for responding to a search request. Likewise, a profile(s) associated with a guide(s) may be used to select and/or rank a guide(s) for voting. Using the example illustrated in FIG. 25, the profiles ‘Demoprofileg1’, ‘Geoprofileg1’ and ‘Persprofileg1’ are associated with the guide ‘Guide1’. This may indicate that ‘Guide1’ has indicated and/or generated the profiles ‘Demoprofileg1’ which may be a demographic profile including demographic data such as age, sex, race, income, education, etc., ‘Geoprofileg1’ which may be a geographic profile which may include information of locations and ‘Persprofileg1’ which might indicate personality, transaction, affiliation, etc. information regarding the guide ‘Guide1’.

The guide result ID field 2525 may include information of a result(s) associated with a guide. Content of the guide result ID field 2525 may be modified based on actions of a guide. If a guide produces a search result(s) responsive to a search request(s), an identifier of the search result(s) may be included in the guide result ID field 2525. A rating(s) and/or ranking(s) associated with a search result(s) associated with a guide may affect compensation for a guide. Likewise a usage indicator associated with a search result(s) provided by a guide may affect a rating(s) or ranking(s) associated with a guide. Using the example illustrated in FIG. 25, the results ‘Result1.1’, ‘Result3.1’ and ‘Result3.2’ are associated with the guide ‘Guide1’. This may indicate that ‘Guide1’ has provided the results ‘Result1.1’, ‘Result3.1’, and ‘Result3.2’ responsive to a search request(s).

The guide communication info field 2530 may include information of a device(s) and/or service(s) associated with a guide. Content of the guide communication info field 2530 may be modified based on actions of a guide. If a guide establishes communications with the search system using a device(s) and/or service(s) information regarding the device(s) and/or service(s) may be included in the guide communication info field 2530. Any type of communication service(s) and/or system(s) may be indicated in the guide communication info field 2530. For example, a username and/or password associated with a guide may be indicated in the guide communication info field 2530. Communication services such as Instant Messaging (IM), e-mail, SMS, MMS, EMS, telephone, wireless or wired communication, etc. may be indicated in the guide communication info field 2530. A telephone number, an email address, an IM provider and login ID, a keyword(s) associated with a service, an IP address, a MAC address, a URL, etc. may be indicated in the guide communication info field 2530. Using the example illustrated in FIG. 25, the login ‘guide1’, the email ‘guide1@chacha.com’, the IM credential ‘guide1@AIM’ and the phone number ‘317.224.2242’ are associated with the guide ‘Guide1’. This may indicate that ‘Guide1’ may be contacted using the login ID ‘guide1’, via email at ‘guide1@chacha.com’, via IM as ‘guide1@AIM’ and via voice, text, or other service(s) associated with the phone number ‘317.224.2242’.

The guide request ID field 2535 may include information of a request(s) associated with a guide. Content of the guide request ID field 2535 may be modified based on actions of a guide. If a guide produces a search result(s) responsive to a search request(s), an identifier of the search request(s) may be included in the guide request ID field 2535. A rating(s) and/or ranking(s) associated with a search request(s) associated with a guide may affect compensation for a guide. Using the example illustrated in FIG. 25, the requests ‘Request1’, ‘Request3’ and others are associated with the guide ‘Guide1’. This may indicate that ‘Guide1’ has responded to, been selected to respond to, and/or has voted regarding one or more item(s) associated with the requests ‘Request1’ and ‘Request3’.

The guide vendor ID field 2540 may include information of a vendor(s) associated with a guide. Content of the guide vendor ID field 2540 may be modified based on actions of a guide. If a guide produces a search result(s) responsive to a search associated with a vendor(s), an identifier of the vendor(s) may be included in the guide vendor ID field 2540. A rating(s) and/or ranking(s) associated with a vendor(s) associated with a guide may affect compensation for a guide. A vendor may be associated with a guide based on a vote(s) cast by a guide regarding items associated with the vendor. In at least one embodiment, a guide may elect to be associated with a vendor. In at least one embodiment, a vendor(s) may select a guide(s) associated with the vendor(s). In at least one embodiment, the search system 1930 may associate a guide with a vendor(s). Using the example illustrated in FIG. 25, the vendors ‘Vendor1’, and ‘Vendor3’ are associated with the guide ‘Guide1’. This may indicate that ‘Guide1’ has responded to, been selected to respond to, and/or has voted regarding one or more item(s) associated with the vendors ‘Vendor1’ and ‘Vendor3’.

As illustrated in FIG. 26, an exemplary a user record 2600 is provided, of which one or more may be associated with or resident in the search system database 1920 (FIG. 19). The user record 2600 may include a user ID field 2605, a user profile ID field 2610, a user request ID field 2615, a user result ID field 2620, a user advocate ID field 2625, a user communication info field 2630, and a user redacted info field 2635.

The user ID field 2605 preferably contains a unique identifier of a user, which is preferably used consistently. For example, in at least one embodiment, the user ID field 2605 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 26, ‘User1’ is the user ID associated with the user record 2600.

The user profile ID field 2610 may include information of a profile(s) associated with a user. Content of the user profile ID field 2610 may be modified based on actions of a user. A person may select a profile which is associated with a user. For example, a user may select a profile(s) to be associated with the user during a registration process. A profile may be associated with a user based on testing of a user(s) and/or information from users. For example, a user may be required to demonstrate knowledge relevant to a profile(s) in order to be associated with the profile(s), or a user may take a test which is used to generate a profile, or a user may provide information such as demographic, geographic, personality or other information which may be indicated in a profile(s) associated with the user. Information indicated in a user profile may be obtained from an external database and/or system. A profile(s) associated with a user(s) may be used to select and/or rank a user(s). Using the example illustrated in FIG. 26, the profiles ‘DemoprofileU1’, ‘GeoprofileU1’ and ‘PersprofileU1’ are associated with the user ‘User1’. This may indicate that ‘User1’ has indicated and/or generated information indicated in the profiles ‘DemoprofileU1’ which may be a demographic profile, ‘GeoprofileU1’ which may be a geographic profile and ‘PersprofileU1’ which might indicate personality information regarding the user ‘User1’.

The user request ID field 2615 may include information of a request(s) associated with a user. Content of the user request ID field 2615 may be modified based on actions of a user. If a user submits a search request to the search system 1930 (FIG. 19) an identifier of the search request(s) may be included in the user request ID field 2615. Using the example illustrated in FIG. 26, the requests ‘Request1’ and ‘Request2’ are associated with the user ‘User1’. This may indicate that ‘User1’ has submitted the requests ‘Request1’ and ‘Request2’ to the search system 1930 (FIG. 19).

The user result ID field 2620 may include information of a result(s) associated with a user. Content of the user result ID field 2620 may be modified based on action(s) of a user and/or a guide(s). If a user receives a search result(s) responsive to a search request(s), an identifier of the search result(s) may be included in the user result ID field 2620. A usage indicator associated with a search result(s) provided to a user(s) may affect a rating(s) or ranking(s) associated with a guide. Using the example illustrated in FIG. 26, the results ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’ responsive to a search request(s).

The user advocate ID field 2625 may include information of an advocate(s) associated with a user. Content of the user advocate ID field 2625 may be modified based on actions of a user. If a user receives information from an advocate(s) responsive to a search request(s), an identifier of the advocate(s) may be included in the user advocate ID field 2625. A usage indicator associated with an advocate(s) may affect a rating(s) or ranking(s) associated with a guide, compensation for the search system 1930 (FIG. 19), and/or rating(s) and/or ranking(s) of an advocate(s). Using the example illustrated in FIG. 26, the advocates ‘Advert1’ and ‘Advert2’ are associated with the user ‘User1’. This may indicate that ‘User1’ has been presented with an offer(s) associated with the advocates ‘Advocate1’ and ‘Advocate4’.

The user communication info field 2630 may include information of a device(s) and/or service(s) associated with a user. Content of the user communication info field 2630 may be modified based on actions of a user. If a user establishes communications with the search system using a device(s) and/or service(s), information regarding the device(s) and/or service(s) may be included in the user communication info field 2630. Any type of communication service(s) and/or system(s) may be indicated in the user communication info field 2630. For example, a username and/or password associated with a user may be indicated in the user communication info field 2630. Communication services such as Instant Messaging (IM), e-mail, SMS, MMS, EMS, telephone, wireless or wired communication, etc. may be indicated in the user communication info field 2630. A telephone number, an email address, an IM provider and login ID, a keyword(s) associated with a service, etc. may be indicated in the user communication info field 2630. Using the example illustrated in FIG. 26, the login ‘user1’, the email ‘user1@chacha.com’, the Twitter™ service account ‘twitter:user1’ and the phone number ‘317.924.2242’ are associated with the user ‘User1’. This may indicate that ‘User1’ may be contacted using the login ID ‘user1’, via email at ‘user1@chacha.com’, via Twitter as ‘user1’ and/or via voice, text, and/or other service(s) associated with the phone number ‘317.924.2242’.

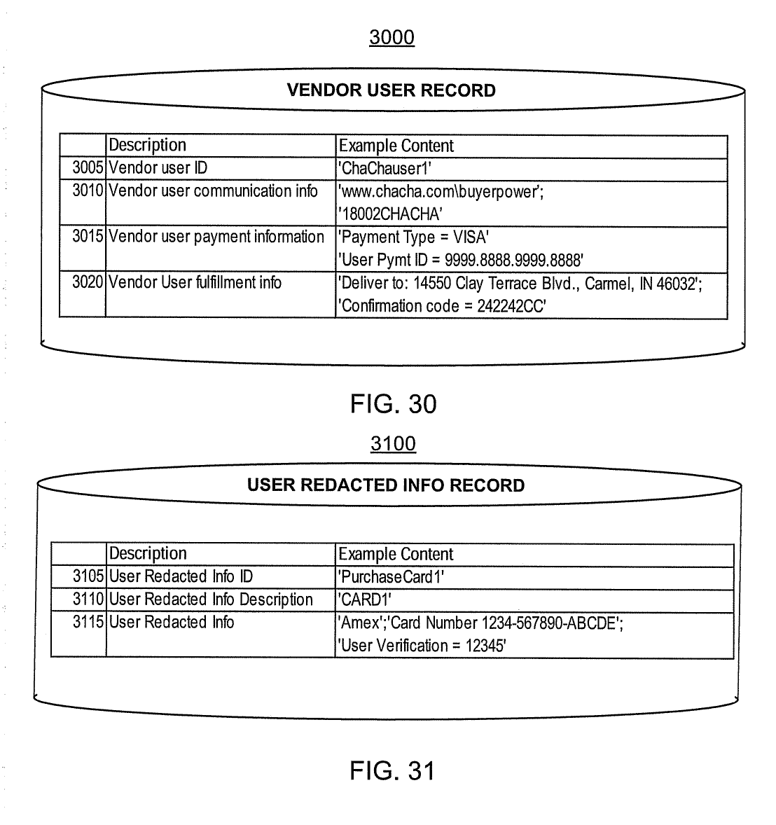

The user redacted information field 2635 may include information which may be provided to a vendor in order that a user may complete a purchase transaction and/or other user information which is selectively revealed. For example, a user may have stored information which a user may wish to reveal selectively in the search system database 1920 (FIG. 19) which may for example, be provided to a vendor in order to process payment for an item(s) and/or service(s). Redacted information may be stored in a user system resource, and/or in the search system database 1920. Redacted information may not be accessible to a guide, an advocate and/or a vendor without user permission. For example, user information may be provided to a vendor without content of the information being explicitly revealed to a third party such as a provider of the search system, an advocate, or a guide. A vendor may communicate with a user based on information indicated in a user record stored at least in part in the search system database 1920 (FIG. 19) and the vendor system database 1980. For example, information stored in a vendor user record such as the vendor user record 3000 illustrated in FIG. 30 may be compared with information of a user provided by the search system 1930 in order to associate a purchase request made to a vendor with a user.

As illustrated in FIG. 27, an exemplary a resource record 2700 is provided, of which one or more may be associated with or resident in the search system database 1920 (FIG. 19). The resource record 2700 may include a resource ID field 2705, a resource guide ID field 2710, a resource description field 2715, a resource access info field 2720, a resource advocate ID field 2725, a resource vendor ID field 2730 and a resource category ID field 2735.

The resource ID field 2705 preferably contains a unique identifier of a resource, which is preferably used consistently. For example, in at least one embodiment, the resource ID field 2705 can include a randomly generated numerical code, and/or a text string indicating a name associated with a resource. A resource ID serves to distinguish the resource record associated with a resource from a resource record associated with other resources. Other unique identifiers of a resource may be utilized without departing from the spirit and scope of the embodiments. In at least one embodiment, a resource ID may include a description associated with a resource. Using the example illustrated in FIG. 27, ‘Resource2’ is the resource ID associated with the resource record 2700.

The resource guide ID field 2710 may include information of a guide(s) associated with a resource. For example, a guide(s) who reviewed a result produced by a resource may be indicated in the resource guide ID field 2710. In at least one embodiment a guide ID associated with a guide(s) who has received information of a result(s) from a resource may be indicated in the resource guide ID field 2710. Information contained in the resource guide ID field 2710 may be used to obtain information regarding a guide associated with a search resource based on records such as the guide record 2400 (FIG. 24). Using the example illustrated in FIG. 27, the guide IDs ‘Guide1’ is associated with the resource ‘Resource2’ which may indicate that the guide ‘Guide1’ may have access to the ‘Resource2’.

The resource description field 2715 may include information of a description of a resource. For example, a text snippet associated with a search resource may be indicated in the resource description field 2715. A URL or other information associated with a search resource may be indicated in the resource description field 2715. Information contained in the resource description field 2715 may be used to provide a description of search resource. Using the example illustrated in FIG. 27, the text snippet ‘Dining in Indiana’ is associated with the resource ‘Resource2’, which may indicate that ‘Resource2’ may provide information regarding ‘Dining in Indiana’.

The resource access info field 2720 may include access information associated with a search resource. For example, a URL associated with a web page may be indicated in the resource access info field 2720. Information of a password, a login ID, a template for submitting a request, an API for submitting and/or receiving information or any other information which may be utilized to access a resource may be indicated in the resource access info field 2720. Information contained in the resource access info field 2720 may be used to provide access to a resource(s) for a user(s), a guide(s), an advocate(s), a vendor(s) and/or the search system 1930 (FIG. 19). Using the example illustrated in FIG. 27, the URL ‘www.diningindy.com’ is the access information associated with the resource ‘Resource2’. This may for example indicate that a result(s) may be obtained by providing information to a resource system associated with the URL ‘www.diningindy.com’. While a URL has been used in FIG. 27 for the purposes of illustration and simplicity, no limitation is implied thereby. Any information required to provide information to a resource and/or to obtain a result(s) from a resource may be indicated in the resource access info field 2720.

The resource advocate ID field 2725 may include information regarding an advocate associated with a resource. For example, an advocate associated with a resource may be permitted to access the resource in order to obtain information responsive to a request(s) and/or to provide an offer to a user(s). A resource may for example, provide a coupon(s) which may be presented to a user(s) as part of an offer presented in operation 2125 (FIG. 21) and/or a response provided in operation 2215 (FIG. 22). An advocate may be associated with a resource if an advocate utilizes a resource. An advocate may be associated with a resource based on an association between a vendor and a resource. For example, if a vendor is associated with a resource using information indicated in the resource vendor ID field 2730, any or all advocates and/or guides associated with a vendor, such as advocates indicated in the vendor advocate ID field 2940 (FIG. 29) may be associated with a resource. Using the example illustrated in FIG. 27, the advocate ‘AdvocateN’ has been associated with the resource ‘Resource2’ which may indicate that ‘AdvocateN’ has utilized ‘Resource2’.

The resource vendor ID field 2730 may include information regarding a vendor associated with a resource. For example, a vendor associated with a resource may provide the resource in order that an advocate may provide an offer to a user(s). A resource may for example, provide information indicated in the vendor system database 1980 (FIG. 19) to an advocate(s). A vendor may be associated with a resource if an advocate(s) associated with a vendor utilize a resource. A vendor may be associated with a resource based on an association between an advocate and a resource. For example, if an advocate is associated with a resource using information indicated in the resource advocate ID field 2725, any or all vendors and/or guides associated with an advocate, such as vendors indicated in the advocate vendor ID field 2840 (FIG. 28) may be associated with a resource. A resource may be selected by a vendor to be provided if a request is associated with the vendor. For example, a retailing website might designate resources associated with a manufacturer of a product(s) which is offered by the vendor which might be provided to a guide and/or an advocate if a request is associated with the vendor. Using the example illustrated in FIG. 27, the vendor ‘Vendor1’ has been associated with the resource ‘Resource2’ which may indicate that ‘Vendor1’ has provided information relating to ‘Resource2’.

The resource category ID field 2735 may include information of a category(ies) associated with a resource. For example, a category(s) associated with a type of result which may be produced by a resource may be indicated in the resource category ID field 2735. In at least one embodiment a category ID associated with a guide(s) who has received information of a result(s) from a resource may be indicated in the resource category ID field 2735. Information contained in the resource category ID field 2735 may be used to obtain information regarding a category associated with a resource based on records such as the category record 3200 (FIG. 32). A resource(s) may be presented in an order determined at least in part on a rating and/or ranking of a resource(s) associated with a category(ies). Using the example illustrated in FIG. 27, the category IDs ‘Category1’ and ‘Category3’ are associated with the resource ‘Resource2’ which may for example indicate that ‘Resource2’ may be selected based at least in part on a ranking(s) and/or rating(s) associated with ‘Category1’ and ‘Category3’.

As illustrated in FIG. 28, an exemplary advocate record 2800 is provided, of which one or more may be associated with or resident in the search database 1920 (FIG. 19). The advocate record 2800 may include an advocate ID field 2805, an advocate category ID field 2810, an advocate topic ID field 2815, an advocate profile ID field 2820, an advocate result ID field 2825, an advocate communication info field 2830, and an advocate request ID field 2835, and advocate vendor ID field 2840.

The advocate ID field 2805 preferably contains a unique identifier of an advocate, which is preferably used consistently. For example, in at least one embodiment, the advocate ID field 2805 can include a randomly generated numerical code, and/or a text string indicating a name associated with an advocate. An advocate ID serves to distinguish the advocate record associated with an advocate from an advocate record associated with other advocates. Other unique identifiers of an advocate may be utilized without departing from the spirit and scope of the embodiments. Using the example illustrated in FIG. 28, ‘Advocate1’ is the advocate ID associated with the advocate record 2800.

The advocate category ID field 2810 may include information of a category(ies) associated with an advocate. Content of the advocate category ID field 2810 may be modified based on actions of an advocate. A person may select a category(ies) and/or keyword(s) which is associated with an advocate. A category may be associated with an advocate based on testing of an advocate(s). A category may be associated with an advocate based on an affiliate group associated with an advocate. For example, if an advocate has chosen to be affiliated with affiliate groups associated with a type of food, a category associated with the type of food might be associated with the advocate. An advocate may be affiliated with a vendor, as described herein below, which may cause a category(ies) to be associated with an advocate. A category(ies) associated with an advocate may be used to select items which are to be presented to an advocate. An advocate(s) may be selected to vote regarding an item(s) based on the association of an advocate with a category(ies). For example, opinions of an advocate(s) regarding a vendor(s), a resource(s) or other item(s) associated with a category may be requested. Using the example illustrated in FIG. 28, the categories ‘Category1’ and ‘Category3’ are associated with the advocate ‘Advocate1’.

The advocate topic ID field 2815 may include information of a topic(s) or interest(s) or keyword(s) associated with an advocate. Content of the advocate topic ID field 2815 may be modified based on actions of an advocate. A person may select a topic or interest which is associated with an advocate. For example, an advocate may select a topic(s) or keyword(s) to be associated with the advocate during a registration process. A topic may be associated with an advocate based on testing of an advocate(s). For example, an advocate may be required to demonstrate knowledge of a category, a vendor(s) and/or topic(s) in order to be associated with the topic(s). Content of the advocate topic ID field 2815 may be compared to the content of a request in order to determine a ranking of an advocate(s) for responding to a request. Using the example illustrated in FIG. 28, the topics ‘restaurant’, ‘basketball’ and ‘fishing’ are associated with the advocate ‘Advocate1’. This may for example indicate that ‘Advocate1’ has indicated an interest in the topics ‘restaurant’, ‘basketball’ and ‘fishing’, which may be associated with a category as further described herein with respect to FIG. 32.

The advocate profile ID field 2820 may include information of a profile(s) associated with an advocate. Content of the advocate profile ID field 2820 may be modified based on actions of an advocate. A person(s) may select a profile which is associated with an advocate. For example, an advocate may select a profile(s) to be associated with the advocate during a registration process. A profile may be associated with an advocate based on testing of an advocate(s). For example, an advocate may be required to demonstrate knowledge relevant to a profile(s) in order to be associated with the profile(s), or an advocate may take a test which is used to generate a profile, or an advocate may provide information such as demographic, geographic, personality or other information which may be indicated in a profile(s) associated with the advocate. Information indicated in the content of the advocate profile ID field 2820 may be compared to information indicated in the content of a profile(s) associated with a search request(s) in order to determine a ranking of an advocate(s) for responding to a search request. Likewise, a profile(s) associated with an advocate(s) may be used to select and/or rank an advocate(s) for voting. Using the example illustrated in FIG. 28, the profiles ‘Demoprofileav1’, ‘Geoprofileav1’ and ‘Persprofileav1’ are associated with the advocate ‘Advocate1’. This may indicate that ‘Advocate1’ has indicated and/or generated the profiles ‘Demoprofileav1’ which may be a profile including demographic data such as age, sex, race, income, education, etc., ‘Geoprofileav1’ which may be a geographic profile which may include information of locations and ‘Persprofileav1’ which might indicate personality, transaction, affiliation, etc. information regarding the advocate ‘Advocate1’.

The advocate result ID field 2825 may include information of a result(s) associated with an advocate. Content of the advocate result ID field 2825 may be modified based on actions of an advocate. If an advocate produces a result(s) responsive to a search request(s), an identifier of the search result(s) may be included in the advocate result ID field 2825. A rating(s) and/or ranking(s) associated with a search result(s), which may for example be an offer to purchase a product(s), associated with an advocate may affect compensation for an advocate. Likewise a usage indicator associated with a search result(s) provided by an advocate may affect a rating(s) or ranking(s) associated with an advocate. For example, if an offer prepared by an advocate is reused and accepted, a ranking of an advocate may improve. Using the example illustrated in FIG. 28, the results ‘Result1.8’, ‘Result3.4’ and ‘Result5.3’ are associated with the advocate ‘Advocate1’. This may indicate that ‘Advocate1’ has provided the results ‘Result1.8’, ‘Result3.4’, and ‘Result5.3’ responsive to a search request(s).

The advocate communication info field 2830 may include information of a device(s) and/or service(s) associated with an advocate. Content of the advocate communication info field 2830 may be modified based on actions of an advocate. If an advocate establishes communications with the search system using a device(s) and/or service(s), information regarding the device(s) and/or service(s) may be included in the advocate communication info field 2830. Any type of communication service(s) and/or system(s) may be indicated in the advocate communication info field 2830. For example, a username and/or password associated with an advocate may be indicated in the advocate communication info field 2830. Communication services such as Instant Messaging (IM), e-mail, SMS, MMS, EMS, telephone, wireless or wired communication, etc. may be indicated in the advocate communication info field 2830. A telephone number, an email address, an IM provider and login ID, a keyword(s) associated with a service, an IP address, a MAC address, a URL, etc. may be indicated in the advocate communication info field 2830. Using the example illustrated in FIG. 28, the login ‘Advocate1’, the email ‘Advocate1@chacha.com’, the IM credential ‘Advocate1@AIM’ and the phone number ‘555.924.2242’ are associated with the advocate ‘Advocate1’. This may indicate that ‘Advocate1’ may be contacted using the login ID ‘Advocate1’, via email at ‘Advocate1@chacha.com’, via IM as ‘Advocate1@AIM’ and via voice, text, or other service(s) associated with the phone number ‘555.924.2242’.

The advocate request ID field 2835 may include information of a request(s) associated with an advocate. Content of the advocate request ID field 2835 may be modified based on actions of an advocate. If an advocate produces a search result(s) responsive to a search request(s), an identifier of the search request(s) may be included in the advocate request ID field 2835. A rating(s) and/or ranking(s) associated with a search request(s) associated with an advocate may affect compensation for an advocate. Using the example illustrated in FIG. 28, the requests ‘Request1’, ‘Request5’ and others are associated with the advocate ‘Advocate1’. This may indicate that ‘Advocate1’ has responded to, been selected to respond to, and/or has voted regarding one or more item(s) associated with the requests ‘Request1’ and ‘Request5’.

The advocate vendor ID field 2840 may include information of a vendor(s) associated with an advocate. Content of the advocate vendor ID field 2840 may be modified based on actions of an advocate. If an advocate produces a search result(s) responsive to a search associated with a vendor(s), an identifier of the vendor(s) may be included in the advocate vendor ID field 2840. A rating(s) and/or ranking(s) associated with a vendor(s) associated with an advocate may affect compensation for an advocate. A vendor may be associated with an advocate based on a vote(s) cast by an advocate regarding items associated with the vendor. In at least one embodiment, an advocate may elect to be associated with a vendor. In at least one embodiment, a vendor(s) may select an advocate(s) associated with the vendor(s). In at least one embodiment, the search system 1930 may associate an advocate with a vendor(s). Using the example illustrated in FIG. 28, the vendors ‘Vendor1’, ‘Vendor3’ are associated with the advocate ‘Advocate1’. This may indicate that ‘Advocate1’ has responded to, been selected to respond to, and/or has voted regarding one or more items associated with the vendors ‘Vendor1’ and ‘Vendor3’.

As illustrated in FIG. 29, an exemplary vendor record 2900 is provided, of which one or more may be associated with or resident in the search database 1920 (FIG. 19). The vendor record 2900 may include a vendor ID field 2905, a vendor category ID field 2910, a vendor topic ID field 2915, a vendor profile ID field 2920, a vendor result ID field 2925, a vendor communication info field 2930, a vendor request ID field 2935, and vendor advocate ID field 2940.

The vendor ID field 2905 preferably contains a unique identifier of a vendor, which is preferably used consistently. For example, in at least one embodiment, the vendor ID field 2905 can include a randomly generated numerical code, and/or a text string indicating a name associated with a vendor. A vendor ID serves to distinguish the vendor record associated with a vendor from a vendor record associated with other vendors. Other unique identifiers of a vendor may be utilized without departing from the spirit and scope of the embodiments. Using the example illustrated in FIG. 29, ‘Vendor2’ is the vendor ID associated with the vendor record 2900.

The vendor category ID field 2910 may include information of a category(ies) associated with a vendor. Content of the vendor category ID field 2910 may be modified based on actions of a vendor. A person may select a category(ies) and/or keyword(s) which is associated with a vendor. A category may be associated with a vendor based on testing of a vendor(s). A category may be associated with a vendor based on an affiliate group associated with a vendor. For example, if a vendor has chosen to be affiliated with affiliate groups associated with a type of food, a category associated with the type of food might be associated with the vendor. A vendor may be affiliated with an advocate, as described herein, which may cause a category(ies) to be associated with a vendor. A category(ies) associated with a vendor may be used to select items which are to be presented to a vendor. A vendor(s) may be selected to vote regarding an item(s) based on the association of a vendor with a category(ies). For example, opinions of a vendor(s) regarding an advocate(s), a resource(s) or other item(s) associated with a category may be requested. Using the example illustrated in FIG. 29, the categories ‘Category1’ and ‘Category3’ are associated with the vendor ‘Vendor2’.

The vendor topic ID field 2915 may include information of a topic(s) or interest(s) or keyword(s) associated with a vendor. Content of the vendor topic ID field 2915 may be modified based on actions of a vendor. A person may select a topic or interest which is associated with a vendor. For example, a vendor may select a topic(s) or keyword(s) to be associated with the vendor during a registration process. A topic may be associated with a vendor based on testing of a vendor(s). For example, a vendor may be required to demonstrate knowledge of a category and/or topic(s) in order to be associated with the topic(s). Content of the vendor topic ID field 2915 may be compared to the content of a search request in order to determine a ranking of a vendor(s) for responding to a request. Using the example illustrated in FIG. 29, the topics ‘restaurant’, ‘That restaurant’ and ‘fishing’ are associated with the vendor ‘Vendor2’. This may for example indicate that ‘Vendor2’ has indicated an interest in the topics ‘restaurant’, ‘That restaurant’ and ‘fishing’, which may be associated with a category as further described herein with respect to FIG. 32.

The vendor profile ID field 2920 may include information of a profile(s) associated with a vendor. Content of the vendor profile ID field 2920 may be modified based on actions of a vendor. A person(s) may select a profile which is associated with a vendor. For example, a vendor may select a profile(s) to be associated with the vendor during a registration process. A profile may be associated with a vendor based on testing of a vendor(s). For example, a vendor may be required to demonstrate knowledge relevant to a profile(s) in order to be associated with the profile(s), or a vendor may take a test which is used to generate a profile, or a vendor may provide information such as demographic, geographic, personality or other information which may be indicated in a profile(s) associated with the vendor. Information indicated in the content of the vendor profile ID field 2920 may be compared to information indicated in the content of a profile(s) associated with a search request(s) in order to determine a ranking of a vendor(s) for responding to a search request. Likewise, a profile(s) associated with a vendor(s) may be used to select and/or rank a vendor(s) for voting. For example, a person(s) may provide ranking(s) and/or rating(s) of a vendor(s) selected based on a profile(s) associated with the vendor(s). Using the example illustrated in FIG. 29, the profiles ‘Demoprofilev2’, ‘Geoprofilev2’ and ‘Persprofilev2’ are associated with the vendor ‘Vendor2’. This may indicate that ‘Vendor2’ has indicated and/or generated the profiles ‘Demoprofilev2’ which may be a profile including demographic data such as age, sex, race, income, education, etc., ‘Geoprofilev2’ which may be a geographic profile which may include information of locations and ‘Persprofilev2’ which might indicate personality, transaction, affiliation, etc. information regarding the vendor ‘Vendor2’.

The vendor result ID field 2925 may include information of a result(s) associated with a vendor. Content of the vendor result ID field 2925 may be modified based on actions of a vendor. If a vendor produces a search result(s) responsive to a search request(s), an identifier of the search result(s) may be included in the vendor result ID field 2925. A rating(s) and/or ranking(s) associated with a search result(s), which may for example be an offer to purchase a product(s), associated with a vendor may affect compensation for a vendor. Likewise a usage indicator associated with a search result(s) provided by a vendor may affect a rating(s) or ranking(s) associated with a vendor. For example, if an offer from a vendor is infrequently used when responding to a request associated with a category, a ranking of the vendor associated with the category may become worse. Using the example illustrated in FIG. 29, the results ‘Result1.9’, ‘Result3.5’ and ‘Result5.5’ are associated with the vendor ‘Vendor2’. This may indicate that ‘Vendor2’ has provided the results ‘Result1.9’, ‘Result3.5’ and ‘Result5.5’ responsive to a search request(s).

The vendor communication info field 2930 may include information of a device(s) and/or service(s) associated with a vendor. Content of the vendor communication info field 2930 may be modified based on actions of a vendor. If a vendor establishes communications with the search system using a device(s) and/or service(s), information regarding the device(s) and/or service(s) may be included in the vendor communication info field 2930. Any type of communication service(s) and/or system(s) may be indicated in the vendor communication info field 2930. For example, a username and/or password associated with a vendor may be indicated in the vendor communication info field 2930. Communication services such as Instant Messaging (IM), e-mail, SMS, MMS, EMS, telephone, wireless or wired communication, etc. may be indicated in the vendor communication info field 2930. A telephone number, an email address, an IM provider and login ID, a keyword(s) associated with a service, an IP address, a MAC address, a URL, etc. may be indicated in the vendor communication info field 2930. Using the example illustrated in FIG. 29, the login ‘Vendor2’, the email ‘Vendor2@chacha.com’, the IM credential ‘Vendor2@AIM’ and the phone number ‘555.224.2242’ are associated with the vendor ‘Vendor2’. This may indicate that ‘Vendor2’ may be contacted using the login ID ‘Vendor2’, via email at ‘Vendor2@chacha.com’, via IM as ‘Vendor2@AIM’ and via voice, text, or other service(s) associated with the phone number ‘555.224.2242’.

The vendor request ID field 2935 may include information of a request(s) associated with a vendor. Content of the vendor request ID field 2935 may be modified based on actions of a vendor. If a vendor produces a search result(s) responsive to a search request(s), an identifier of the search request(s) may be included in the vendor request ID field 2935. A rating(s) and/or ranking(s) associated with a search request(s) associated with a vendor may affect compensation for a vendor. Using the example illustrated in FIG. 29, the requests ‘Request1’, ‘Request3’ and others are associated with the vendor ‘Vendor2’. This may indicate that ‘Vendor2’ has responded to, been selected to respond to, and/or has voted regarding one or more item(s) associated with the requests ‘Request1’ and ‘Request3’.

The vendor advocate ID field 2940 may include information of an advocate (s) associated with a vendor. Content of the vendor advocate ID field 2940 may be modified based on actions of a vendor. If a vendor produces a search result(s) responsive to a search associated with an advocate (s), an identifier of the vendor(s) may be included in the vendor advocate ID field 2940. A rating(s) and/or ranking(s) associated with an advocate (s) associated with a vendor may affect compensation for a vendor. A vendor may be associated with an advocate based on a vote(s) cast by a vendor regarding items associated with the advocate. In at least one embodiment, an advocate may elect to be associated with a vendor. In at least one embodiment, a vendor(s) may select an advocate(s) associated with the vendor(s). In at least one embodiment, the search system 1930 may associate an advocate(s) with a vendor(s). Using the example illustrated in FIG. 29, the advocates ‘Advocate1’, ‘Advocate6’ are associated with the vendor ‘Vendor2’. This may indicate that ‘Vendor2’ has responded to, been selected to respond to, and/or has voted regarding one or more item(s) associated with the advocates ‘Advocate 1’ and ‘Advocate6’.

As illustrated in FIG. 30, an exemplary a vendor user record 3000 is provided, of which one or more may be associated with or resident in the vendor system database 1980 (FIG. 19). The vendor user record 3000 may include a vendor user ID field 3005, a vendor user communication info field 3010, a vendor user payment information field 3015, and a vendor user fulfillment field 3020.

The vendor user ID field 3005 preferably contains a unique identifier of a user, which is preferably used consistently. For example, in at least one embodiment, the vendor user ID field 3005 can include a randomly generated numerical code, and/or a text string indicating a name associated with a user. A vendor user ID serves to distinguish a vendor user record associated with a user from a vendor user record associated with other users. Other unique identifiers of a user may be utilized without departing from the spirit and scope of the embodiments. In at least one embodiment, a vendor user ID may include a phone number associated with a user. Using the example illustrated in FIG. 30, ‘ChaChauser1’ is the user ID associated with the vendor user record 3000. In at least one embodiment, the vendor user ID may be a user ID provided by the search system 1930 (FIG. 19). For example, the search system may provide an anonymous identifier of a user to a vendor which may be used until a purchase is confirmed. In such a case, a vendor may provide pricing or other terms to the search system 1930 which would otherwise be unavailable to a user(s).

The vendor user communication info field 3010 may include communication information associated with a user. Information indicated in the vendor user communication info field may be used to establish communication between a user and a vendor. In at least one embodiment, the vendor user communication info field 3010 may include information of a communication service(s) associated with the search system 1930 (FIG. 19) and a user. A communication service(s) associated with a user and the search system 1930 (FIG. 19) may be used to allow an offer to be provided by a vendor and/or to indicate acceptance of a purchase request by a user which has been mediated by the search system 1930 (FIG. 19). While other communication service(s) and/or devices may be associated with a user, a communication service(s) associated with a user and the search system 1930 may allow the search system to facilitate a purchase by a user. Using the example illustrated in FIG. 30, the URL ‘www.chacha.com\buyerpower’ and the phone number ‘18002CHACHA’ are associated with the user ‘Chachauser1’. This might for example allow a vendor to communicate with a user via a web service at <www.chacha.com\buyerpower>, and/or via a telecommunication service(s) associated with the telephone number 18002CHACHA. In at least one embodiment, a request to purchase a product may be received by a URL associated with the search system, and a user may be contacted for information regarding the request using a phone number associated with the search system 1930 (FIG. 19) which routes the call to a user.

The vendor user payment information field 3015 may include information of a payment method associated with a user. The vendor user payment information field 3015 may include information provided by the search system 1930 (FIG. 19). For example, as payment information may be sensitive information, user payment information provided to a vendor may for example be a proxy provided by the search system. For example, if a user has provided payment information to the search system, the search system may make a purchase from a vendor(s) on behalf of a user using payment information other than that provided by the user. In such an instance, aggregated sales might be charged to a payment account associated with the search system 1930, and the search system 1930 may track charges to users based on information indicated in the search system database 1920 which is not accessible to a vendor system(s). This may for example allow a mark-up between a price paid to a vendor(s) and a price paid by a user to be accounted by the search system 1930. As full transaction information that is available to the search system 1930 may not be available to a user(s) and/or a vendor(s), the search system 1930 may provide compensation to a guide(s), an advocate(s), and/or other person(s) without disclosing compensation provided and/or payment by a user for an item(s) and/or service(s). Using the example illustrated in FIG. 30, the payment information ‘Payment Type=VISA’ and ‘User Payment ID=9999.8888.9999.8888’ are associated with the vendor user ID ‘ChaChauser1’. This may indicate that a payment for a product(s) and/or service(s) ordered under the user ID ‘ChaChauser1’ is to be charged to an account associated with the payment information indicated.

The vendor user fulfillment information field 3020 may include information which allows a vendor to fulfill a user purchase request. For example, a delivery address and/or other contact information for providing a product(s) and/or service(s), or a download destination information such as an IP address, an email address, a telephone number and/or other information which may be required to deliver a product(s) or service(s) which are well known in the relevant art may be indicated in the vendor user fulfillment information field 3020. A confirmation code, which may be provided to a user in order that a user may verify a purchase at a point of delivery may be indicated in the vendor user fulfillment information field 3020. In at least one embodiment, a confirmation code provided by a vendor is provided to a user by the search system 1930 (FIG. 19). Using the example illustrated in FIG. 30, the fulfillment information ‘Deliver to: 14550 Clay Terrace Blvd., Carmel, Ind. 46032’ and ‘Confirmation code=242242CC’ are associated with the user ‘ChaChauser1’, which may indicate that a product is to be shipped to ‘14550 Clay Terrace Blvd., Carmel, Ind. 46032’, and that the confirmation code ‘242242CC’ is associated with a purchase made by the user ‘ChaChauser1’. In at least one embodiment, a confirmation code provided by a supplier may be associated with a request, which may cause the code to be provided to a user associated with the request.

Any information which may be required to complete a transaction may be indicated in the vendor system database 1980 (FIG. 19) and may be provided by the search system 1930, a guide(s), an advocate(s) and/or a user(s).

In at least one embodiment, a user may provide information which the user wishes to reveal selectively to the search system 1930, which may be stored in the search system database 1920. For example, a user may provide payment information which the search system 1930 may provide to a vendor without revealing the payment information to a guide(s), who may be an advocate(s). Such stored information may for example allow a user to make a purchase request(s) and/or to provide required information to a vendor(s) without the need to explicitly provide the information to the vendor(s). This may provide a more convenient method for processing a transaction while preventing sensitive data from being revealed to a human assistant who is acting on behalf of a user. In such an instance a user redacted information record such as the user redacted information record 3100 illustrated in FIG. 31 may be provided.

As illustrated in FIG. 31, an exemplary a user redacted information record 3100 is provided, of which one or more may be associated with or resident in the search system database 1920 (FIG. 19). The user redacted information record 3100 may include a user redacted information ID field 3105, a user redacted information description field 3110, and a user redacted information content field 3115.

The user redacted information ID field 3105 preferably contains a unique identifier of a user redacted information element, which is preferably used consistently. For example, in at least one embodiment, the user redacted information ID field 3105 can include a randomly generated numerical code, and/or a text string indicating a name associated with a user redacted information element. A user redacted information ID serves to distinguish the user redacted information record associated with a redacted information element from a user redacted information record associated with other user redacted information elements. Other unique identifiers of a user redacted information element may be utilized without departing from the spirit and scope of the embodiments. Using the example illustrated in FIG. 31, ‘Purchase card 1’ is the user redacted information ID associated with the user redacted information record 3100. The user redacted information ID may for example be linked to information indicated in the user redacted information field 2635 of a user record such as the user record 2600 (FIG. 26).

The user redacted information description field 3110 may indicate a name or other description associated with user redacted information. A name of a redacted data element may be designated by a user. For example, when redacted data is provided to the search system 1930, a user may provide a designator of the information which may be provided to a guide(s) if a user request requires the redacted data to be provided in order to process a user request(s). Alternately, a user may designate information as restricted, and a description of any or all elements of the user information may be assigned a description by the search system 1930, which may be provided to a guide(s) and/or advocated(s) in order that a transaction may be processed responsive to a user request. Using the example illustrated in FIG. 31, the description ‘CARD1’ is associated with ‘Purchase Card1’, which may indicate that a guide may communicate with a user regarding ‘PurchaseCard1’ using the pseudonym ‘CARD1’.

The user redacted information field 3115 may include information which has been designated as restricted by a user. For example, payment information which may be used to complete a purchase may be indicated in the user redacted information field 3115. Information such as user account information associated with a payment card might be indicated in the user redacted information field 3115. Using the example illustrated in FIG. 31, the information ‘Card type=AMEX’, ‘Card Number=1234-567890-ABCDE’, and ‘User Verification=12345’ are associated with the user redacted data element ‘PurchaseCard1’. This may indicate that ‘PurchaseCard1’ is associated with the specific information indicated in the user redacted information field 3115. For example, a user might indicate that ‘CARD1’ is to be used to complete a transaction, which might cause any or all information indicated in the user redacted information field 3115 to be provided to a vendor as required. For example, a web form might be completed, etc. using information indicated in the user redacted information field 3115.

In such an instance, a transaction may be mediated by a guide, for example, a supplier might be selected, one or more items might be identified, and/or other actions might be performed on behalf of a user by a guide, and if a user accepts the offered product(s) and/or service(s), a transaction may be completed based at least in part on information in a redacted data record which may not be disclosed to a guide(s) and/or advocate(s).

In order to respond to a request, a categorization and/or a profile(s) and/or other information may be associated with a request. In at least one embodiment, a categorization is associated with a request. A categorization may be associated with a request automatically. For example, an analysis of a keyword(s) and/or other content of a request (e.g. images, audio, etc.) may be performed automatically which may associate a categorization with a request. In at least one embodiment, a person may associate a categorization with a request. For example, a guide may review information of a request, may interact with a user(s) who submitted the request, and/or may associate a categorization(s) with the request.

As illustrated in FIG. 32, an exemplary categorization record 3200 is provided, of which one or more may be associated with or resident in the search database 1920 (FIG. 19), may include a categorization record ID field 3205, a categorization guide identifier list field 3210, a categorization guide rating list field 3215, a categorization guide interest list field 3220, a categorization system interest list field 3220, a categorization resource ID list 3225, a categorization resource rating list 3230, a categorization advocate ID list 3235, a categorization advocate rating list 3240, a categorization vendor ID list 3245, and a categorization vendor rating list 3250.

The categorization record ID field 3205 contains an identifier of a categorization, which is preferably unique and preferably used consistently. For example, in at least one embodiment, the categorization record ID field 3205 can include a randomly generated numerical code and/or a character string indicating a categorization. A categorization record ID serves to distinguish a categorization record associated with a categorization from a categorization record associated with other categorization(s). Although particular examples of identifiers are described herein, other types of identifiers uniquely indicating a categorization(s) may be utilized without departing from the spirit and scope of the embodiments herein. In at least one embodiment, a description of a proper path may be included in the content of the categorization record ID field 3205. A categorization record ID may include a categorization description, a random numeric code, and/or any other information uniquely identifying an element within a data structure. Using the example in FIG. 32, ‘Category3’ is the categorization record ID associated with the categorization record 3200.

The categorization guide ID list field 3210 may include one or more identifiers associated with a guide(s). The categorization guide ID list 3210 may include one or more identifiers of a guide(s) which may be used to obtain further information of a guide using a record such as the guide record 2500 illustrated FIG. 25. Using the example in FIG. 32, the guide IDs ‘Guide1’, ‘Guide2’ and ‘Guide3’ have been associated with the categorization record 3200. While only a few guide identifiers have been illustrated in FIG. 32, any number of guide identifiers may be associated with a categorization. Association of a guide ID with a categorization may indicate that a guide has registered to respond to requests associate with the categorization, or that a guide may associate, review, edit and/or otherwise associate information with a categorization.

The categorization guide rating list field 3215 may include information of one or more ratings associated with a guide(s). For example, the categorization guide rating list field 3215 may include a rating of a guide(s) based on search result(s) produced by a guide responsive to search request(s) associated with the categorization identified in the categorization record ID field 3205. In at least one embodiment, the categorization guide ID list field 3210 and the categorization guide rating list field 3215 may be linked by, for example, a pointer. Using the example illustrated in FIG. 32, the rating ‘3’ has been associated with the guide ‘Guide1’, the rating ‘5’ has been associated with the guide ‘Guide2’ and the rating ‘7’ has been associated with the guide ‘Guide3’. This may indicate that the guide ‘Guide3’ has the highest rating and might be selected first to respond to a search request associated with the category ‘Category3’. A rating(s) of a guide(s) may be determined based on any information indicated in the database 1920 (FIG. 19). In at least one embodiment, success of an advocate in completing a transaction associated with a request may be used at least in part to determine a rating(s) associated with a guide and a categorization.

The categorization guide interest list field 3220 may include information of one or more interests or keywords associated with a guide associated with the categorization indicated in the categorization record ID field 3205. The information indicated in the categorization guide interest list field 3220 may be compared to information indicated in a search request which is associated with the categorization identified in the categorization record ID field 3205. A match between information associated with a search request and information indicated in the categorization guide interest list field 3220 may modify the ranking of a guide when selecting a guide to respond to a request. In at least one embodiment, the categorization guide ID list field 3210 and the categorization guide interest list field 3220 may be linked by for example a pointer. Using the example illustrated in FIG. 32, the interests ‘miles davis’ and ‘silvano monasteries’ have been associated with the guide ‘Guide1’, the interest ‘sara montes’ has been associated with the guide ‘Guide2’ and the interests ‘sara montes’ and ‘daniel smith’ have been associated with the guide ‘Guide3’. This may indicate that ‘Guide1’ would be more likely to be selected to respond to a search request associated with the category ‘Category3’ which contained the information ‘miles davis’ even though the rating of ‘Guide1’ is lower than the rating of ‘Guide2’ and ‘Guide3’ when responding to a search request associated with the category ‘Category3’. Continuing with the example in FIG. 32, if a search request categorized as associated with the category ‘Category3’ which contained the information ‘sara montes’ is received, ‘Guide3’ might be selected to respond to the request, as both ‘Guide2’ and ‘Guide3’ are associated with the interest ‘sara montes’ and ‘Guide3’ has a higher rating associated with the category ‘Category3’.

The categorization system interest list field 3225 may include information of one or more interests or keywords associated with the categorization indicated in the categorization record ID field 3205. The information indicated in the categorization system interest list field 3225 may be compared to information indicated in a search request which is associated with the categorization identified in the categorization record ID field 3205. Information indicated in the categorization system interest list field may be obtained from a search of a resource(s). A match between information associated with a search request and information indicated in the categorization system interest list field 3225 may modify a ranking of a guide when selecting a guide to respond to a search request or request. In at least one embodiment, a rating(s) or ranking of a categorization associated with an interest(s) may be obtained, which may be used at least in part to rank a categorization which may affect the probability that a guide will be selected. For example, if a categorization is highly ranked with respect to the keyword ‘louis armstrong’ a categorization may be more likely to be associated with a request which includes the keyword or interest ‘louis armstrong’. Using the example illustrated in FIG. 32, the interests ‘louis armstrong’, ‘sidney bechet’, and ‘joe king oliver’ have been associated with the category ‘Category3’ which may indicate that a query or request associated with the interests ‘louis armstrong’, ‘sidney bechet’, and ‘joe king oliver’ may be associated with the category or node ‘Category3’.

The categorization resource ID list field 3230 may include one or more identifiers of a resource(s) which may be associated with a categorization. Using the example in FIG. 32, the resource IDs ‘Resource1’, ‘Resource2’ and ‘Resource4’ have been associated with the categorization record 3200. While only a few resource identifiers have been illustrated in FIG. 32, any number of resource identifiers may be associated with a categorization. A resource may be any source of information which may be utilized to respond to a request.

The categorization resource rating list field 3235 may include information of one or more ratings associated with a resource(s). For example, the categorization resource rating list field 3235 may include a rating of a resource(s) based at least in part on frequency of use of a resource(s) by a guide(s) responsive to search requests associated with the categorization identified in the categorization record ID field 3205. A rating of a resource(s) may be based on any information indicated in the database 1920 (FIG. 19). In at least one embodiment, the categorization resource ID list field 3230 and the categorization resource rating list field 3235 may be linked by, for example, a pointer. Using the example illustrated in FIG. 32, the rating ‘3’ has been associated with the resource ‘Resource1’, the rating ‘2’ has been associated with the resource ‘Resource2’ and the rating ‘1’ has been associated with the resource ‘Resource3’. Any type of rating information may be included in a rating field(s) such as the categorization resource rating field 3235. A rating of a resource may be associated with an advocate(s). For example, if an advocate is associated with a vendor as illustrated in the advocate record 2800 (FIG. 28), a rating of a resource(s) may be increased if a resource is associated with the vendor.

The categorization advocate ID list field 3240 may include one or more identifiers of an advocate(s) which may be associated with a categorization. Using the example in FIG. 32, the advocate IDs ‘Advocate1’, ‘Advocate4’ and ‘Advocate6’ have been associated with the categorization record 3200. While only a few advocate identifiers have been illustrated in FIG. 32, any number of advocate identifiers may be associated with a categorization.

The categorization advocate rating list field 3245 may include information of one or more ratings associated with an advocate(s). For example, the categorization advocate rating list field 3245 may include a rating of an advocate(s) based at least in part on frequency of selection of an advocate(s) by a guide(s) responsive to search requests associated with the categorization identified in the categorization record ID field 3205. A rating of an advocate(s) may be based on any information indicated in the database 1920 (FIG. 19). For example, a rating of an advocate may be based on a number of transactions success fully completed by an advocate, or revenue produced by an advocate, or margin dollars generated by an advocate, or user ratings associated with a transaction(s) associated with an advocate, etc. In at least one embodiment, the categorization advocate ID list field 3240 and the categorization advocate rating list field 3245 may be linked by, for example, a pointer. Using the example illustrated in FIG. 32, the rating ‘1’ has been associated with the advocate ‘Advocate1’, the rating ‘4’ has been associated with the advocate ‘Advocate4’ and the rating ‘7’ has been associated with the advocate ‘Advocate6’. Any type of rating information may be included in a rating field(s) such as the categorization advocate rating field 3245.

The categorization vendor ID list field 3250 may include one or more identifiers of a vendor(s) which may be associated with a categorization. Using the example in FIG. 32, the vendor IDs ‘Vendor6’, ‘Vendor4’ and ‘Vendor2’ have been associated with the categorization record 3200. While only a few vendor identifiers have been illustrated in FIG. 32, any number of vendor identifiers may be associated with a categorization.

The categorization vendor rating list field 3255 may include information of one or more ratings associated with a vendor(s). For example, the categorization vendor rating list field 3255 may include a rating of a vendor(s) based at least in part on frequency of selection of a vendor(s) by an advocate(s) responsive to requests associated with the categorization identified in the categorization record ID field 3205. A rating of a vendor(s) may be based on any information indicated in the database 1920 (FIG. 19). For example, a rating of a vendor(s) may be based on an incentive(s) provided to an advocate(s), or revenue which has been produced by transactions associated with a vendor, or a number of requests associated with a vendor, or opinions regarding a vendor provided by a guide(s) and/or advocate(s) associated with a categorization. In at least one embodiment, the categorization vendor ID list field 3250 and the categorization vendor rating list field 3255 may be linked by, for example, a pointer. Using the example illustrated in FIG. 32, the rating ‘A’ has been associated with the vendor ‘Vendor6’, the rating ‘A’ has been associated with the vendor ‘Vendor4’ and the rating ‘B’ has been associated with the vendor ‘Vendor2’. Any type of rating information may be included in a rating field(s) such as the categorization vendor rating field 3255. A rating of a vendor may affect an order of presentation of information of a vendor(s) in an interface provided for selection of a vendor(s) responsive to a request(s) associated with a categorization(s).

Information which may not be directly related to a request, but may be associated with a person(s) associated with a request may be referred to as a ‘profile’. A profile may include information such as geographic information, demographic information, personality information, affiliation information, or other information which has been associated with a person(s) such as a user(s), a guide(s), an advocate(s), etc. A profile may be used to improve matching of information with a request(s). For example, a guide(s) and/or vendor(s) who are located in closer geographic proximity to a location associated with a request may be preferentially selected, or male guides over 40 may be preferentially selected to respond to a request associated with that profile, or outgoing, happy guides may be preferentially selected to respond to a request associated with that profile.

A profile may be associated with a request in various ways. For example, a user and/or a guide may select a profile to be associated with a request, or a profile may be associated with a request by an automated process(es), which may include use of location or other geographic information.

As illustrated in FIG. 33, an exemplary profile record 3300 is provided, of which one or more may be associated with or resident in the search database 1920 (FIG. 19). The profile record 3300 may include a profile ID field 3305, a profile geographic info field 3310, a profile demographic info field 3315, a profile personality info field 3320, a profile guide ID 3325 and a profile guide rating 3330.

The profile ID field 3305 preferably contains a unique identifier of a profile, which is preferably used consistently. For example, in at least one embodiment, the profile ID field 3305 can include a randomly generated numerical code, and/or a text string indicating a name associated with a profile. A profile ID serves to distinguish a profile record associated with a profile from a profile record associated with other profiles. Other unique identifiers of a profile may be utilized without departing from the spirit and scope of the embodiments. In at least one embodiment, a profile ID may include a description associated with a profile. Using the example illustrated in FIG. 33, ‘Profile1’ is the profile ID associated with the profile record 3300.

The profile geographic info field 3310 may include geographic information associated with a profile. Any type of geographic information may be indicated in the profile geographic info field 3310. For example, GPS coordinates, a street address, a neighborhood name, a postal code, a city name, a state name, etc. could be indicated in the profile geographic info field 3310. Using the example illustrated in FIG. 33, the name ‘Indiana’ is associated with the profile ‘Profile1’. This may indicate that persons with home addresses in the state of ‘Indiana’ may have a higher rating(s) and/or ranking(s) with respect to the profile ‘Profile1’.

The profile demographic info field 3315 may include demographic information associated with a profile. Any type of demographic information may be indicated in the profile demographic info field 3315. For example, date of birth, gender, race, political affiliation, income, number of children, marital status, membership in organizations, etc. could be indicated in the profile demographic info field 3315. Using the example illustrated in FIG. 33, the profile ‘under30’AND‘over20’ is associated with the profile ‘Profile1’. This may indicate that persons with ages greater than 20 years and less than 30 years may have a higher rating(s) and/or ranking(s) with respect to the profile ‘Profile1’.

The profile personality info field 3320 may include personality information associated with a profile. Any type of personality information may be indicated in the profile personality info field 3320. For example, information of personality traits such as aggressiveness, curiosity, friendliness, intelligence, honesty, etc. could be indicated in the profile personality info field 3320. Using the example illustrated in FIG. 33, the profile ‘Foodie’ is associated with the profile ‘Profile1’. This may indicate that persons with an interest in food and restaurants may have a higher rating(s) and/or ranking(s) with respect to the profile ‘Profile1’.

The profile guide ID field 3325 may include information of a guide(s) who are associated with a profile. For example, if a guide elects to receive search requests associated with the profile ‘Profile1’, an identifier of the guide may be indicated in the profile guide ID field 3325. Information indicated in the profile guide ID field may be used to obtain information associated with a guide using a record(s) such as the guide record 2500 (FIG. 25). Using the example illustrated in FIG. 33 the guides ‘Guide1’, ‘Guide3’, ‘Guide2’, ‘Guide4’, and ‘Guide5’ have been associated with the profile ‘Profile1’.

The profile guide rating field 3330 may include information regarding a rating of a guide(s) associated with a profile. In at least one embodiment, the profile guide ID field 3325 and the profile guide rating field 3330 are linked by for example a pointer. Using the example illustrated in FIG. 33, the guide ‘Guide1’ has a rating of ‘2’, the guide ‘Guide3’ has a rating of ‘2’, the guide ‘Guide2’ has a rating of ‘1’, the guide ‘Guide4’ has a rating of ‘3’ and the guide ‘Guide5’ has a rating of ‘3’. Content of the profile guide ID field 3325 and the profile guide rating field 3330 may be used at least in part to determine an order in which a guide(s) are notified responsive to a search request, a voting activity, or other types of tasks and/or activities associated with a profile(s). Using the example illustrated in FIG. 33, the guide ‘Guide2’ might for example be preferentially notified of a search request associated with the profile ‘Profile1’.

A rating(s) associated with a profile(s) may be determined based on any suitable calculations which include information indicated in the profile and/or the search system database 1920 (FIG. 19). While the profile record 3300 illustrates a rating(s) of a guide(s), other types of information may be rated using a profile(s). For example, an advocate(s), a vendor(s), a resource(s), etc. might be rated based on information associated with a profile.

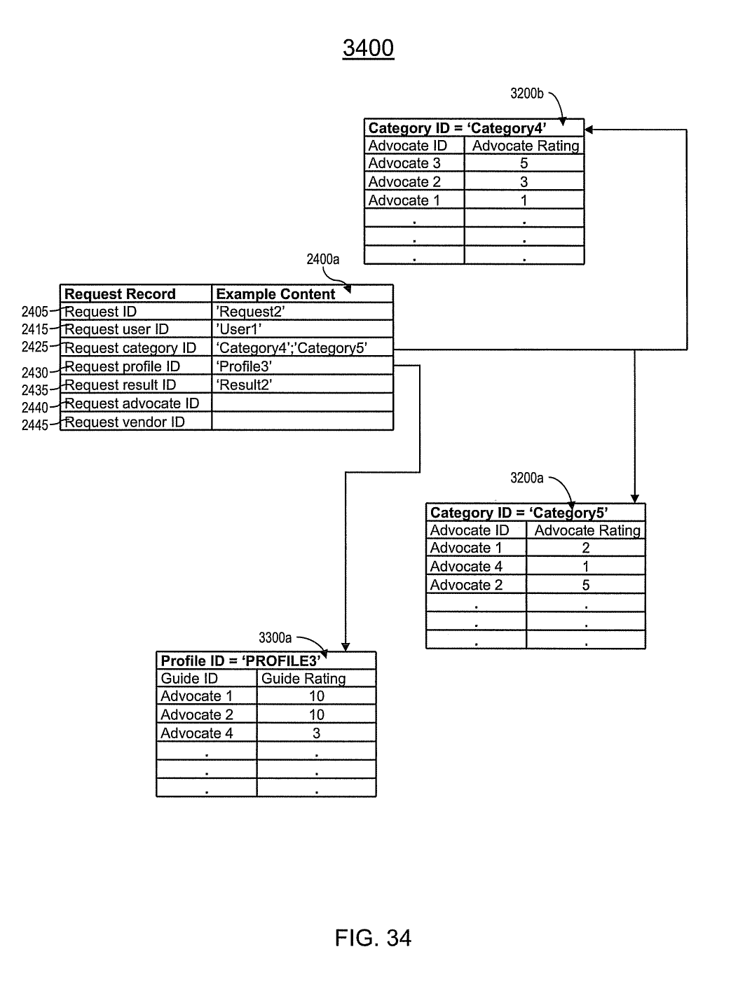

A database relationship 3400 which may be used in ranking an item(s) to be associated with a request is illustrated in FIG. 34. In the example illustrated, advocate(s) are ranked in order to select an advocate to respond to a search request which has been associated with a category(ies) and a profile(s). A ranking process may be utilized by the search system 1930 (FIG. 19) in order to rank any item(s) indicated in the search database. For example, if a guide has responded to a request, determined that the request is associated with a category, determined that an advocate is needed to respond to the request, and a profile has been associated with the request based on characteristics associated with the user submitting the request, the relationship 3400 may be utilized at least in part to select an advocate(s) who may be notified of the request in an order based at least in part on a ranking determined based on the relationship 3400.

As illustrated in FIG. 34, the request ‘Request2’ is associated with the request record 2400a as indicated in the request ID field 2405. The user ‘User1’ is associated with ‘Request2’ as indicated in the request user ID field 2415. The categories ‘Category4’ and ‘Category5’ are associated with ‘Request2’ as indicated in the request category ID field 2425. The profile ‘Profile3’ is associated with ‘Request2’ as indicated in the request profile ID field 2430. The result ‘Result2’ is associated with ‘Request2’ as indicated in the request result ID field 2435. An advocate and a vendor have not been associated with ‘Request2’ as indicated by the blank content of the request advocate ID field 2440, and the request vendor ID field 2445 of the request record 2400a.

A rating of advocates associated with ‘Category4’ might be obtained from the category record 3200b. A rating of an advocates associated with ‘Category5’ might be obtained from the category record 3200a. A rating of advocates associated with ‘Profile 3’ might be obtained from the profile record 3300a.

Any type of formula may be applied to the rating data indicated in a category record(s) and/or a profile record(s) which may be determined by the search system 1930 (FIG. 19). In the example illustrated in FIG. 34, a ranking is based on the aggregate total rating of an advocate associated with any category associated with a request added to the rating of the advocate associated with any profile(s) associated with a request. Using the example illustrated, the advocate ‘Advocate 2’ might be ranked first as his total rating is eighteen (10+5+3), ‘Advocate 1’ might be ranked second as his total rating is thirteen (10+2+1), ‘Advocate 3’ might be ranked third as his total rating is five, and ‘Advocate 4’ might be ranked fourth as his total rating is four (1+3). A ranking might be computed in for example operation 2130 (FIG. 21).

A ranking of an advocate may be used to determine an order of notification of advocates if a request associated with the categories ‘Category4’ and ‘Category5’ and the profile ‘Profile3’ is received. For example a highest ranked advocate may be notified first, and a time interval may pass before other advocates are notified as illustrated in operation 2145 (FIG. 21). If an advocate responds to a request, an identifier of the advocate may be included in the request advocate ID field 2440 associated with the request.

While a simple formula for determining a ranking and a few items associated with a request have been used for the purposes of explanation, no limitation is implied thereby any number of items associated with a request and any calculation(s) may be used to determine a ranking of item(s) which may be associated with an item(s) associated with a request.

The system 1900 may be implemented in various embodiments. For example, an advocate(s) may be compensated by a user(s). In such an embodiment, a user may be billed by the search system 1930 for services rendered by an advocate(s). The search system 1930 may provide access to a vendor(s), resource(s), and request(s) to an advocate(s), and may charge a user(s) a fee(s), which fee(s) may be shared with an advocate(s) based on completed transaction(s). The use of an advocate(s) may allow a user to access information and/or purchase a product(s) in a more convenient way, as a user(s) may be able to make a purchase using a user system(s) which may have limited capabilities, such as for example a mobile phone. Likewise the use of an advocate(s) may allow a user to make a purchase without needing to access a vendor system(s) directly. In such an instance, an advocate may perform any or all operations required to place an order for a product(s) and/or service(s) from a vendor(s) on behalf of a user(s). Relevant user information which may be required to be provided in order to process a transaction may be stored in a record(s) such as the user redacted information record 3100 (FIG. 31). Redacted information may be provided to a vendor system(s) based on an indication of the required information by an advocate(s), which may not be explicitly revealed to the advocate(s). For example, an advocate may identify a particular feature(s) in a web form which are to be completed with a type of information indicated in a user redacted information record(s). Information of the information required may be stored in association with an identifier of a vendor. User payment information may be stored in the search system database 1920. In such an embodiment, a user may provide a desired price for an item(s) and/or service(s), which information may be provided to an advocate(s).

In at least one embodiment, any or all transactions with a user(s) may be billed as activity with the search system 1930. In such a case, a user may provide one or more methods of payment to the search system 1930. An advocate(s) may prepare an offer for an item(s) and/or service(s) based on user instruction(s), and a purchase may be confirmed with a vendor(s) which is billed to a payment method(s) associated with the search system 1930. In such an instance, a user payment method(s) may be charged with an amount which may include compensation for an advocate(s) and/or other person(s) and/or the search system 1930. In such an embodiment, information of a vendor(s) may not be explicitly provided to a user. This may be advantageous to a vendor(s) if the vendor desires to provide a service(s) and/or item(s) anonymously for any reason(s) such as discounting, liquidation, etc. It may further allow the search system 1930 to provide a product(s) and/or service(s) from any vendor(s), while explicit information, which may be sensitive, such as price or vendor identification is not revealed to a user(s).

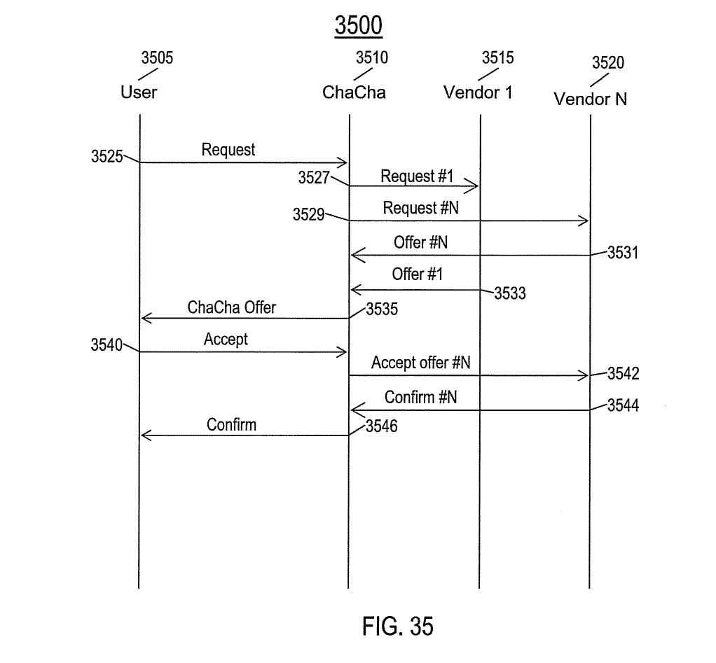

An exemplary message flow 3500 for processing a transaction is illustrated in FIG. 35. A user system 3505 sends the ‘Request’ user request message 3525 to the ‘ChaCha’ search system 3510. The ‘ChaCha’ system 3510 may send the ‘Request #1’ system request message 3527 to the ‘Vendor 1’ vendor system 3515, and/or the ‘Request #N’ system request message 3529 to the ‘Vendor N’ vendor system 3520. The ‘ChaCha’ search system 3510 may add to, modify and/or otherwise process information included in the ‘Request 1’ user request message 3525 and/or the search system database 1920 (FIG. 19) in order to select a vendor(s) and/or prepare a system request message(s). Responsive to the ‘Request #N’ system request message 3529, the ‘Vendor N’ vendor system 3520 may send the ‘Offer #N’ vendor offer message 3531 to the ‘ChaCha’ search system 3510. Responsive to the ‘Request #1’ system request message 3527, the ‘Vendor 1’ vendor system 3515 may send the ‘Offer #1’ vendor offer message 3533. Responsive to the vendor offer message(s) 3527, 3529, the ‘ChaCha’ search system 3510 may send the ‘ChaCha Offer’ system offer message 3535 to the user system 3505. The ‘ChaCha’ search system 3510 may send information to a payment system associated with a user account (not shown) in order to confirm user payment information associated with a system offer message 3535. The ‘ChaCha’ search system 3510 may record information associated with a transaction.

Responsive to the ‘ChaCha Offer’ message 3535, the user system 3505 may send the ‘Accept’ user acceptance message 3540 to the ‘ChaCha’ search system 3510. The ‘Accept’ user acceptance message 3540 may include confirmation of security information associated with a user payment service indicated in a database such as the search system database 1920 (FIG. 19). Responsive to the ‘Accept’ user acceptance message 3540, the ‘ChaCha’ search system 3510 may send the ‘Accept Offer #N’ system acceptance message 3542 to the ‘Vendor N’ vendor system 3520. The ‘ChaCha’ search system 3510 may process information included in a user acceptance message in order to prepare the system acceptance message 3542. For example, confirmation of user order may require information provided in the ‘Accept’ user acceptance message 3540 and/or information indicated in a user redacted information record 3100 (FIG. 31), and/or other information indicated in the search system database 1920 (FIG. 19) to be provided. Responsive to the ‘Accept Offer #N’ system acceptance message 3542 the ‘Vendor N’ vendor system 3520 may send the ‘Confirm #N’ vendor confirmation message 3544. Responsive to the ‘Confirm #N’ vendor confirmation message 3544, the ‘ChaCha’ search system 3510 may send the ‘Confirm’ system confirmation message 3546 to the user system 3505. The ‘ChaCha’ search system 3510 may process information included in a database such as the search system database 1920 (FIG. 19) and/or information indicated in a vendor confirmation message in order to prepare the system confirmation message 3546.

While the message flows have been illustrated with a single message, it will be immediately obvious to one of ordinary skill in the relevant art that multiple messages may be exchanged between the systems as part of a message(s). For example, an advocate(s) selected by the ‘ChaCha’ search system 3510 may communicate with a user and/or a vendor using any number of messages mediated by the ‘ChaCha’ search system 3510 in order to facilitate a transaction. As information of a transaction is mediated by the search system, and payment is facilitated by the search system, a user may not know any explicit information regarding a transaction except that which is provided in a system message(s) such as the ‘ChaCha Offer’ system offer message 3535 and the ‘Confirm’ system confirmation message 3546.

Communication information required to communicate with a user(s), a vendor(s), and/or an advocate(s) may not be made available to any of the other parties, except as required to make and fulfill an accepted offer. In at least one embodiment, a vendor(s) may provide access to a non-public resource(s) associated with the vendor(s), as previously described herein. Such a resource may include an API which may provide information obtained from the resource to an advocate, a guide, a user, etc. without revealing a source of the information.

The search system 1930 (FIG. 19) may utilize a human assistant such as a guide(s) and/or an advocate(s) who may interact with a user and/or a vendor(s) as described herein to facilitate a transaction. Use of a human assistant who is familiar with an item(s) and/or service(s) may allow a user to make a purchase from a vendor(s) without the need to know specific information of the vendor and/or the item(s) and/or service(s). Likewise, an advocate may communicate with a user(s) and/or a vendor(s) regarding a transaction without knowing identifying information of the vendor(s), and a vendor(s) may complete a transaction without knowing information of a user(s) except the information required to fulfill a request.

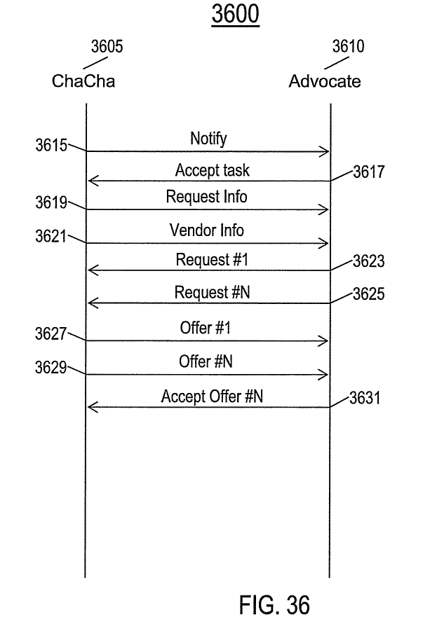

An exemplary message flow 3600 for utilizing an advocate, who may be a guide, to facilitate a transaction is illustrated in FIG. 36. The ‘ChaCha’ search system 3605 may send the ‘Notify’ system notification message 3615 to the advocate system 3610. If an advocate accepts a request indicated in the ‘Notify’ system notification message 3615 the advocate system 3610 may send the ‘Accept task’ advocate acceptance message 3617 to the ‘ChaCha’ search system 3605. Responsive to the ‘Accept task’ advocate acceptance message 3617, the ‘ChaCha’ search system 3605 may send the ‘Request info’ system request message 3619, and/or the ‘Vendor info’ system message 3621. A system message may include information which may allow an advocate to communicate with a user(s) and/or a vendor(s), but may not include specific information of a user(s) and/or a vendor(s). Responsive to the ‘Request info’ system message 3619, and/or the ‘Vendor info’ system message 3621, the advocate system 3610 may send the ‘Request #1’ advocate request message 3623 and/or the ‘Request #N’ advocate request message 3625. Responsive to the ‘Request #1’ advocate message 3623 the ‘ChaCha’ search system 3605 may send the ‘Offer #1’ system offer message 3627. Responsive to the ‘Request #N’ advocate message 3625 the ‘ChaCha’ search system 3605 may send the ‘Offer #N’ system offer message 3629. An advocate may review information indicated in a system offer message(s) in order to select an offer which may be accepted responsive to a system request message(s). Responsive to one or more system offer messages such as the system offer messages 3627, 3629, the advocate system 3610 may send the ‘Accept offer N’ advocate acceptance message 3613.

Using the message flow 3600 (FIG. 36) communication may be established between an advocate(s), a user(s) and/or a vendor(s) without revealing specific information of a user(s) and/or a vendor(s) to an advocate(s). This may allow an advocate(s) to act on behalf of a user(s) without being aware of information of the user(s). Likewise an advocate(s) may contact a vendor(s) without being aware of specific information of with the vendor(s). As the message flows take place only between the search system and the advocate system, the advocate is not required to know how the information provided by the search system is obtained. An advocate may for example receive a request for a product to be obtained, and information of a vendor inventory. An advocate may select one or more product options which are provided to a vendor for quotation. Information of the quotations may be provided by the search system, and an advocate may determine which offer is to be accepted. An advocate might be directly communicating with a user, or might communicate with a user via the ‘ChaCha’ search system 3605.

An embodiment wherein communication is controlled by the search system 1930 (FIG. 19) may allow an advocate(s) to conduct a communication session(s) with the search system 1930 which is not associated with a request(s) by a user(s). An advocate may be utilized to compare offers for similar products from various vendors without a specific request for the product being received by the search system 1930. For example, if an item(s) and/or service(s) have been frequently purchased by a user(s) a search for a best offer for such a product may be conducted by an advocate and a ranking(s) and/or rating(s) of a vendor(s) may be based on information obtained during the search process. An advocate(s) might be trained using a previous request(s) and/or stored information of a previous request(s).

An embodiment wherein communication is conducted via a search system such as the ‘ChaCha’ search system 3510 (FIG. 35) may require vendors to accept orders from a proxy. Not every vendor may accept this and thus it may be preferred to allow direct contact between an advocate(s) and a vendor(s). As a consequence an alternate embodiment wherein an advocate may readily identify a vendor, and may use any public resource provided by any vendor in order to obtain an offer(s) may be implemented.

In at least one embodiment, any or all information associated with a vendor(s) may be available to an advocate(s). For example, an advocate system(s) may establish contact directly with a vendor system(s), and may select an offer for a product(s) and/or service(s) by interacting with a resource(s) associated with a vendor(s). A transaction may not be completed by an advocate, but information of an offer(s) may be communicated by an advocate to the search system 1930 (FIG. 19), which may include information of a vendor(s). Information of one or more offers provided by an advocate may be provided to a user(s) by the search system. If an offer is accepted, an advocate(s) who may for example be able to access private information associated with a user may complete a transaction with a vendor(s) identified by an advocate who may be a different advocate than the advocate who provided the offer. Compensation of an advocate may for example be based at least in part on completion of a task, acceptance of an offer(s) by a user(s), completion of a purchase, and/or value of a purchase completed.

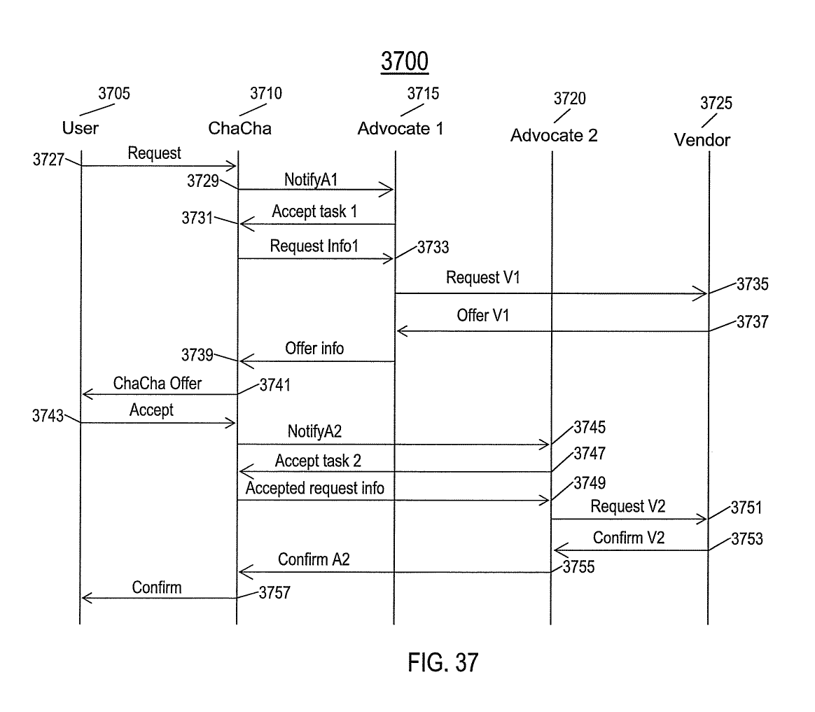

An exemplary message flow 3700 for an embodiment wherein an advocate system(s) may communicate directly with a vendor system(s) is illustrated in FIG. 37. In such an instance, an advocate(s) may be provided with an ‘add-in’ or helper application as is well known in the relevant art which may be utilized in a browser functionality of an advocate system(s) which may be used to identify a URL and/or other information which may be associated with an offer. Information of an offer may be may be provided to an advocate(s) during a subsequent communication session using an add-in or extension of for example a browser application.

A user system 3705 may send the ‘Request’ user request message 3727 to the ‘ChaCha’ search system 3710, which may indicate information of a user request to purchase an item(s) and/or service(s). Responsive to the ‘Request’ user request message 3727 the ‘ChaCha’ search system 3710 may send the ‘Notify A1’ system request message 3729 to the ‘Advocate 1’ advocate system 3715. If the advocate ‘Advocate 1’ accepts a task indicated in the ‘Notify A1’ system request 3729, the ‘Advocate 1’ advocate system 3715 may send the ‘Accept task 1’ advocate system message 3731. While a single advocate is illustrated as being notified in FIG. 37, any number of advocates may be notified of a task, as described herein.

Responsive to the ‘Accept task 1’ advocate system message 3731 the ‘ChaCha’ search system 3710 may send the ‘Request info 1’ system request message 3733 to the ‘Advocate 1’ advocate system 3715 which may include information of a request, but may not provide identifying information of a user(s) associated with the request. Responsive to the ‘Request info1’ system request message 3733 the ‘Advocate 1’ advocate system 3715 may send the ‘Request V1’ advocate request message 3735 to the ‘Vendor’ vendor system 3725. Responsive to the ‘Request V1’ advocate request message 3735 the ‘Vendor’ vendor system 3725 may send the ‘Offer V1’ vendor offer message 3737. Responsive to the ‘Offer V1’ vendor offer message 3737 the ‘Advocate 1’ advocate system 3715 may send the ‘Offer info’ advocate offer message 3739. While a single vendor system, a single advocate request message, a single vendor offer message, and a single advocate offer message are used for the purposes of illustration, any number of messages may be sent, and any number of vendor systems may be queried by an advocate system. In at least one embodiment, information of a number of vendors may be provided to an advocate based on a rating(s) and/or ranking(s) associated with the vendors by the ‘ChaCha’ search system 3710. An advocate offer message such as the advocate offer message 3739 may include information of a resource(s) associated with an offer, a description of an offer, etc.

Responsive to the ‘Offer info’ advocate offer message 3739 the ‘ChaCha’ search system 3710 may send the ‘ChaCha Offer’ system offer message 3741. If the user at the user system 3705 determines that an offer is acceptable, the user system 3705 may transmit the ‘Accept’ user acceptance message 3743. Responsive to the ‘Accept’ user acceptance message 3743 the ‘ChaCha’ search system 3710 may send the ‘Notify A2’ system request message 3745 to the ‘Advocate 2’ advocate system 3720. If the advocate ‘Advocate 2’ accepts a task indicated in the ‘Notify A2’ system request 3745, the ‘Advocate 2’ advocate system 3720 may send the ‘Accept task 2’ advocate system message 3747. While a single advocate is illustrated as being notified in FIG. 37, any number of advocates may be notified of a task, as described herein. Responsive to the ‘Accept task 2’ advocate system message 3747 the ‘ChaCha’ search system 3710 may send the ‘Accepted request info’ message 3749. Responsive to the ‘Accepted request info’ message 3749 the ‘Advocate 2’ advocate system 3720 may send the ‘Request V2’ advocate system message 3751. The ‘Request V2’ advocate system message 3751 may include information indicated in the ‘Offer info’ advocate offer message 3739, which may allow an advocate operating the ‘Advocate 2’ advocate system 3720 to more efficiently respond to a user request. For example, a URL associated with a vendor, and/or a product(s) might be provided to the ‘Advocate 2’ advocate system 3720 which may have been identified by an advocate operating the ‘Advocate 1’ advocate system 3715. Such information may allow an advocate to more rapidly complete activity relating to a user request. For example, if an advocate operating the ‘Advocate 2’ advocate system 3720 has access privileges to information provided by a user to complete a transaction, the advocate may complete a transaction initiated by the ‘Advocate 1’ advocate system 3715.

Responsive to the ‘Request V2’ advocate system message 3751 the ‘Vendor’ vendor system 3725 may send the ‘Confirm V2’ vendor confirmation message 3753. Responsive to the ‘Confirm V2’ vendor confirmation message 3753 the ‘Advocate 2’ advocate system 3720 may transmit the ‘Confirm A2’ advocate confirmation message 3755. Responsive to the ‘Confirm A2’ advocate confirmation message 3755 the ‘ChaCha’ search system 3710 may send the ‘Confirm’ system confirmation message 3757, which may include confirmation information provided to a user by the ‘Vendor’ vendor system 3725. While a few advocate systems and messages have been used in FIG. 37 for the purposes of illustration, any number of advocate systems and/or messages may be exchanged. A record of a request such as the request record 2400 (FIG. 24) may be use to determine compensation for an advocate(s) and/or a search system such as the search system 1930 (FIG. 19). Compensation may be based on various factors, and may not necessarily be paid directly by a user(s). For example, a vendor(s) may pay a fee to the search system based on information indicated in a request record such as the request record 2400 (FIG. 24).

In at least one embodiment, it may be that a user may not be able to communicate directly with a vendor(s) until a transaction has occurred in order that a record of the transaction may be indicated in a database such as the search system database 1920 (FIG. 19). Systems wherein a transaction is facilitated in a networked environment are practiced by eBay®, Amazon®, Priceline® and others wherein user information is provided to a vendor and/or vice versa, and a user payment occurs when a transaction is completed. Likewise many vendors provide an on-line store and/or other forms of network based purchasing facilities which may allow a vendor to make an offer and a user to accept the offer. Such facilities may allow a user to obtain information regarding offers made by a particular vendor. However a user may be required to expend considerable time and effort to determine an optimal offer and/or vendor for an item(s) and/or service(s). Use of a human assistant or ‘advocate’ may improve usability of such resources, and a user and/or a vendor may accept to pay for the services of an advocate in lieu of spending time and effort to locate a user(s), a vendor(s), an item(s), and/or a service(s). By making available information of prior requests and associated search activities, a transaction may be facilitated by a human assistant or advocate who may have relevant knowledge relating to a user request. An advocate may be provided with information of resources associated with a category(ies) and/or keyword(s) associated with a request. Historical information of a request may be provided to an advocate(s) in order that any number of advocates may process a request without the need for previous information to be provided by a user(s). An advocate(s) may be preferentially notified of a request based on a ranking of advocates.

By providing an expert to assist with any purchase request on any topic, the new system allows a user to have a single point of contact in lieu of the need to know information of multiple resources which might be used for a particular transaction. As many communication systems may be associated with a vendor(s), a user(s), and/or an advocate(s), the use of a human assistant(s) familiar with a vendor(s) may improve accessibility of a vendor(s) to a user(s). The system may provide information of previous requests and/or associated search results which may allow an audit functionality which may be used to ensure service quality and/or to rate an advocate. As an advocate may not be specifically associated with a vendor(s), a more efficient use of advocates may be made. Instead of a vendor(s) providing purchase assistance resources, a central pool of advocates may be made available which may provide a greater capacity ‘on demand’. A vendor(s) may provide information (e.g., training and/or other content) to an advocate(s) associated with a category(ies) and/or keyword(s) which may improve the knowledge and/or skills of an advocate(s) relevant to a product(s). A vendor may elect to provide an advocate(s) who is associated with the vendor. For example, a vendor(s) might provide an advocate(s) who is compensated by the vendor, but is made available to a user(s) via the search system.

An advocate(s) may complete a purchase transaction based on acceptance of a binding offer from a vendor(s) by a user(s). An advocate(s) may be bonded and certified, or may have other credentials which may be required for an advocate to serve a need of a user. Likewise any information required to complete a purchase contract may be obtained from and/or by any participants to the transaction from and/or by a search system which may facilitate a transaction. As a database of previous purchases by users is maintained, if a user is interested to make a purchase which has been made by other users, a request may be fulfilled more rapidly and efficiently. A network of advocates who are provided ‘on demand’ may eliminate the redundant efforts of users with similar interests, and may allow access to services and/or products to be more efficient and easier.

In general search engines are keyword driven systems. Keywords are generated from a user request and matched to target documents, advertisements, etc. This practice is generally established by such services as Google® or Dogpile®. The use of keywords allows a search engine to produce relevant items by using various methods of ranking items, etc. An algorithm is applied to the content of each item and a ranking is assigned to the item. When a query is entered by a user, the search system analyzes the query to extract keywords contained in the query and presents items such as web pages and/or advertisements in an order related to the ranking.

In the case of an automated search, the algorithm used to determine relevance may be generalized in order to search various types of documents. The algorithm used is designed to approximate human judgment. Such systems have enjoyed commercial success.

In a human-assisted search engine, human judgment may be used to determine relevance of a result or resource. This methodology is utilized by open directory projects such as DMOZ and human edited search systems such as About.com® and Mahalo. Such systems may be constrained by the need to have a large number of human editors. For example, DMOZ had 75,000 editors, 500,000 categories, and 4,800,000 websites in its index. Additionally, as the number of documents in an index increases, the number of sites returned responsive to a keyword based request may be unmanageably large.

A human-assisted search system may be effective at selecting relevant results, however, the allocation of editors, and the available vocabulary of such as system may be misaligned with user interests. The misalignment problem is particularly aggravated when a human assistant is to be selected in order to obtain a relevant search result for a user(s). Systems which match a researcher, also called a guide or human searcher, with user queries may have limited ability to match a searcher to a request. The limited number of experts associated with a query may cause a slow response to the user query, a poor quality response, and/or other issues which may negatively affect a user experience and/or cost to serve a user. In order to overcome this problem, guides may be associated with an index which may associate information of a user request to information associated with guides. However, the association of guides with an index may have similar problems to those encountered by a human-edited index (i.e., the number of queries about a topic exceeds the number of guides associated with the topic). Guide selection may be ineffective as keywords selected by guides in association with an index may be poorly correlated to relevant user queries.

The scalability of algorithmic search is desirable, but it is difficult to achieve the relevance of a human assisted search algorithmically. It is possible for guides to be assigned to categories of a taxonomy, such as the DMOZ taxonomy, but a user may not submit a query which readily matches with a taxonomy or index associated with a group of human guides. Resources associated with a taxonomy may be selected which are relevant, which may provide information to a user and/or a guide, but may not be well associated with a taxonomy.

A method and system are disclosed to improve the selection of human searchers or guides and/or other information and media responsive to a user request. A user may be provided with relevant search categories, resources, and other content which may enable a user to perform a search without the assistance of a human.

An index is created and guides are associated with the index. The index may be a hierarchical data structure or taxonomy, a flat data structure or ‘folksonomy’, or any other type of index. A guide may be associated with a node(s) of an index in various ways, which may include a direct association with a categorization or node, an association with one or more keywords or ‘interests’ which may be associated with a node, an association with geographic, demographic, personality, affiliation, historical or other types of ‘profile’ information which may be indicated in the index. Information such as search resources, advertisements, content, etc. may be associated with an index, and may be selected based on the association of information with the index and a request.

A guide or other information may be preferentially selected based on an association between a request or search request or query, information indicated in an index, and information associated with a guide(s). A guide may be registered with a search system, which may cause the guide to be associated with one or more nodes indicated in an index. A guide may elect to be associated with one or more keywords or ‘interests’ which are associated with a database or index which is accessible to the search system. A guide may be associated with a keyword(s) in various ways, which may associate a guide with one or more categories or nodes indicated in the index. Keywords may be associated with an index based on a recommendation and/or review which may be conducted at least in part automatically and/or with the assistance of one or more guides. A keyword may be associated with an index without the assistance of a guide based on content of a user request. A keyword(s) may have rating and/or ranking information associated with the keyword(s) and a category(ies) and/or other information.

A user query is received, and may be compared to a database of requests or queries. If a matching request is located, a response based on stored information associated with the request may be provided to a user. A request may be processed in order to identify a keyword(s), a category(ies), an advertisement(s), a location(s), a user(s), and/or other information which may be associated with the request. If a keyword(s) indicated in a search request is not found to be associated with one or more indices utilized for associating a guide(s), a category(ies), etc. with a query a search of one or more resource(s) may be conducted in order to associate a keyword(s) and/or other information of a query with the index, and may further be used to determine rating and/or ranking information which may be associated with the index and/or the keyword(s) and/or other information.

A system and method is provided which allows a user or InfoSeeker™ who may be any person to submit a search request or search query or request to a search service and receive a response to the search request. A search system which allows communication to occur between a user(s), a searcher(s) or guide(s), a resource(s), and/or the search system allows queries to be processed. A database comprising information regarding a user(s), a guide(s), a resource(s), an advertisement(s), a category(ies), a keyword(s), a tag(s), content, a request(s), a search method(s), and/or other information is provided.

A search request or query submitted by a user, which may include a keyword(s), a category(ies), a fully formed question(s), a statement(s), any type of media, implicit data such as information associated with a user identifier(s) and/or device(s), which may request a response, may receive a response which is produced automatically and/or utilizing the assistance of one or more human searchers or guides or providers. In at least one embodiment a search request submitted by a user is compared to a database of search requests in order to determine if a matching search request is found in the database. If a matching request is found, a search result(s) associated with the matching search request(s) may be presented to a user(s) responsive to a search request(s).

If multiple search result(s) are associated with a search request(s) the search result(s) may be ranked to determine an order in which the search result(s) will be presented to a user(s). A ranking of a search result(s) may be based on any type of information associated with the search result or result(s). A search request is identified and may be assigned a unique identifier, and information such as a category(ies), geographic information and/or a profile(s) may be selected to be associated with the search request. A request and/or any information associated with the request may be presented to a searcher or guide. An indicator of items such as a category(ies), keyword(s) or keyphrase(s) or ‘interests’, geographic information, time information, previous activities or other information associated with a request may be provided to a guide selected to respond to the request. A guide(s) may be selected based on association of a guide with any or all information associated with a reference item. A guide may be provided with information one or more types of items, such as a category(ies), a keyword(s), a tag(s), an advertisement(s), a profile(s), or any sort of content, which a guide may elect to associate with a request and/or to transmit to a user(s). An ‘interest’ or keyword is any type of information which may be associated with a request and/or other information for the purposes of this disclosure. While text-based searching may use words, phrases or other elements, other forms of information might also be utilized in a search. For example, if a request indicated visual, audio, or other types of media which may be compared to any elements of a resource, such elements or ‘atoms’ might be used individually and/or in combination to rank and/or rate an item(s).

A guide, who may be any person, may be associated with one or more keywords, or topics or categories. A guide may be associated with any information required by a search system in order that a guide may be identified and may be associated with one or more keywords, categories, or topics. In at least one embodiment, a guide may be required to establish a login account and/or provide information which may be used to establish communication with the guide. A guide who is associated with a category may be provided with access to a resource(s) which may include content and/or other information which may be indexed in order that it may be searched to obtain a search result(s) utilizing a resource(s). Content and/or resource(s) indicated in a database associated with a category(ies) may be compared to keywords and/or other information associated with a request in order to rank a category(ies) which may be presented to a user(s) and/or a guide in order to assist in obtaining a search result(s). Likewise, content associated with a request may be used to determine whether a matching request exists, which may be presented to a user(s) and/or may be used to provide a result(s) or response(s) to the user(s).

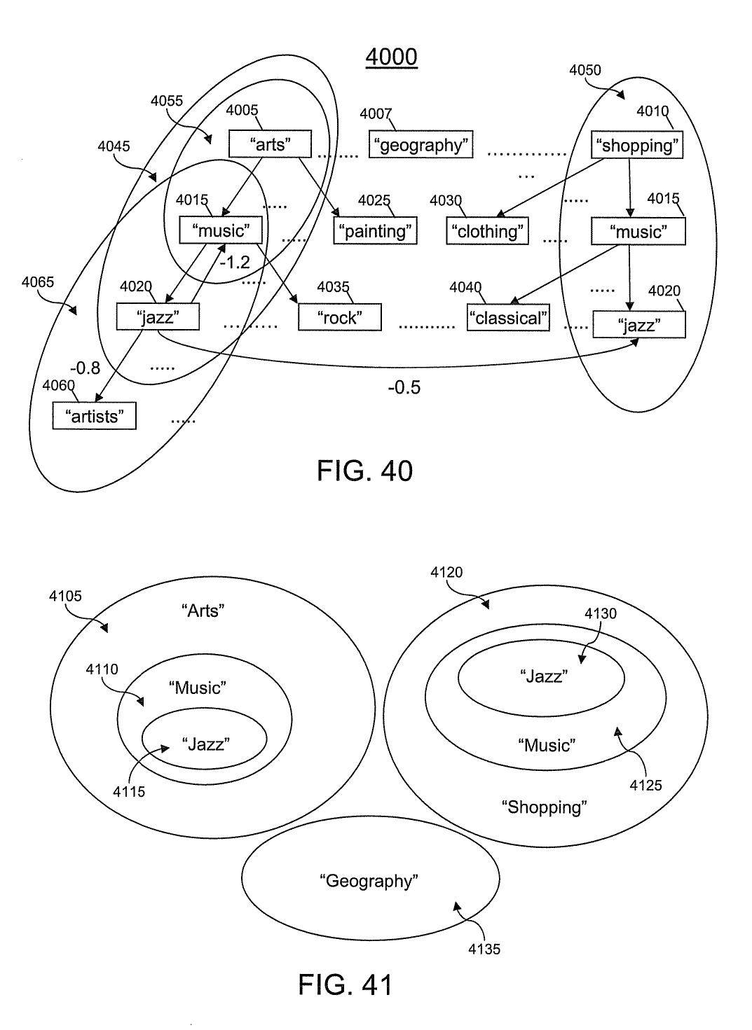

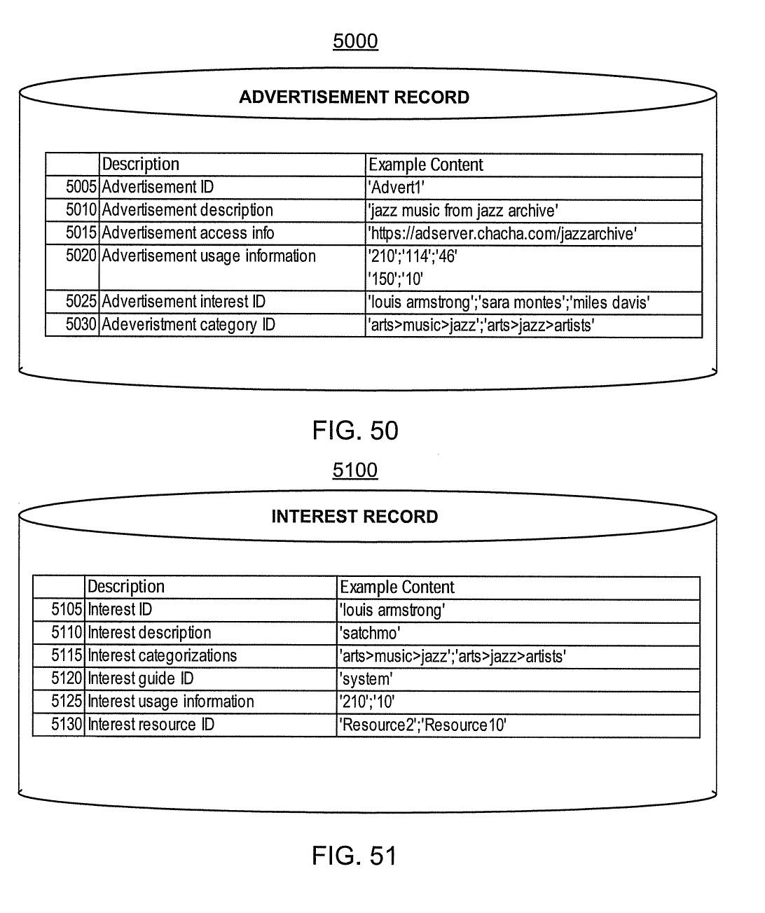

The database of information associated with a category(ies) or topic(s) and/or a keyword(s) may be created using various methods. A database may be created and/or modified by a human editor or taxonomist, who may be able to create associations between categories as further described herein with respect to FIG. 39 and FIG. 40. A database of information associated with a category(ies) may be created and/or modified based on information obtained from a database such as DMOZ, or any database(s) which may include and/or indicate resources which may be included in the database. A database of information associated with a category(ies) may be created and/or modified based on information indicated in a search session log(s) such as that described herein below with respect to FIG. 51. A guide(s) and/or a user(s) may be able to associate information with a category(ies). For example, a ‘wiki’ of any sort may be associated with a category(ies). A guide(s) and/or user(s) may have various rights to add, remove, and/or review information which may be associated with a category(ies) or node defined within a database, which may be based on information associated with a guide(s) and/or user(s) such as rating or ranking information.

A search facility may be associated with a category(ies). For example, a custom search engine may be associated with a category(ies) which may be customized by a person(s), who may be a guide(s), which may be used to locate information related to the category(ies). A search facility may be dynamically updated in order to search any or all information associated with any or all category(ies) indicated in a database. A database may be created and/or modified which may be used to modify the performance of a custom search tool(s).

A user request is received and may be compared to a database of queries. If an exact match and/or an indexed exact match is identified, a result(s) associated with the matching query(ies) may be returned to a user. If a suitable match is not identified, a guide may be selected. Any or all information associated with a query may be compared to information associated with an index. For example, keywords of a request may be compared to keywords or ‘interests’ associated with an index of categories. Likewise, geographic information associated with a request, such as an area code, zip code, street address, or GPS coordinates, etc. may be compared to a database of locations which may include names of places which are ranked according to proximity to the information. If there is not a suitable match to information associated with a query with information in a selection index, and in at least one embodiment universally, a search may be conducted of resources in order to obtain information of a keyword(s) such as a rating(s) or ranking(s) and/or other information which may be associated with the index.

Multiple types of search may be conducted. Resources associated with an index might be scanned to determine whether a resource(s) associated with the index contain a keyword(s) and/or reference the keyword(s) which may include phrases and/or a number of complete sentences. A rating or ranking may be associated with a keyword(s) and a node of an index which is associated with a resource(s). Alternately, a resource which is indexed in some manner, such as a telephone directory, or a news resource, or a mapping resource might be queried in order to determine if a keyword(s) or other information might be associated with a selection index based on an index of the resource. For example, a telephone look-up resource might be passed a name indicated in a search request, and might return a category associated with the name, a street address associated with the name, a phone number(s) associated with the name, etc. Information provided by the telephone look-up resource might be used to associate a name with a search system index. For example, if a restaurant name (e.g., “Italianheaven”) is associated with a street address (e.g., “120 West Washington, Indianapolis”) which is associated with the name of a town (i.e., “Indianapolis”) and a category (e.g., “Restaurants>Italian”) by the directory resource, a system might associate the restaurant name (“Italianheaven”) with the category “Dining>Indianapolis>Italian”. Thus a guide associated with the node “Dining>Italian>Indianapolis” might be able to register to accept queries associated with the keyword (“Italianheaven”), and a query containing the keyword “Italianheaven”, which was not associated with the selection index previously might be used to associate a query containing the keyword with a relevant node of the index. If a new keyword is associated with a system index of guides, a guide may be presented with information of a list of a keyword(s).

A resources of any type may be indexed and may be used to establish a rating and/or ranking associated with any node within a selection index. For example, news information, blog websites, or other resources, which may be indexed by for example URL content, may be searched for a matching keyword(s), and the keyword(s) associated with a node in an index based on content of the resource and a URL. Various types of ranking and weighting may be applied. Actions of a human taxonomist, a guide(s), and/or a user(s) may be incorporated into a ranking and/or rating process of keywords in association with information indicated in an index.

Information associated with an index may be provided for any purpose. For example, an advertiser(s) might be presented with information of keywords and/or associated categories in order to more precisely target ads, or guides might be shown traffic information or ‘hits’ associated with a keyword(s) for which, for example, no guides are registered. Information provided might be used to allow guides to modify their associations and/or to find categories which are associated with an area of expertise, or to provide resources which might be relevant, etc. Information of hits to categories and/or hits to specific keywords might be used to solicit guides who are associated with the category to undergo training, demonstrate proficiency, or otherwise associate information with the index based on information provided. A taxonomist may be provided with information of an index in order to determine if a new node(s) might be created. If a node has a large number of highly rated keyword(s), a taxonomist may elect to create a more specific category(ies). Information associated with a category(ies) may be assigned to more specific category(ies) using suitable processing which may include automated and/or human-assisted activities.

A guide(s) may be used to create and/or modify a method which may be associated with indexing of a resource. For example, a guide(s) may locate information in a resource(s), and may associate the information with a search request which has been categorized by a guide(s) (who may be a different guide). In such a case, a modified algorithmic search may for example be applied, which may utilize a rating(s) which have been determined based at least in part on actions of a guide(s). In such an embodiment, a relevance ranking of a resource(s) and/or a keyword(s) with respect to a node or category may be adjusted responsive to system information and/or conditions.

The terms voice and speech are used interchangeably herein. A user, a resource, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail or any other type of communication. A connection or communication session(s) may be established using any device which is capable of utilizing a communication service. For example, a wireless device such as a cell phone, PDA, smart phone, etc. might be used to establish a communication session using voice, SMS, IM, email and/or internet protocols. A desktop, laptop or server system might be used to establish a communication session. A landline phone, a specialized communication terminal, or any other communication device might be used to establish a communication session.

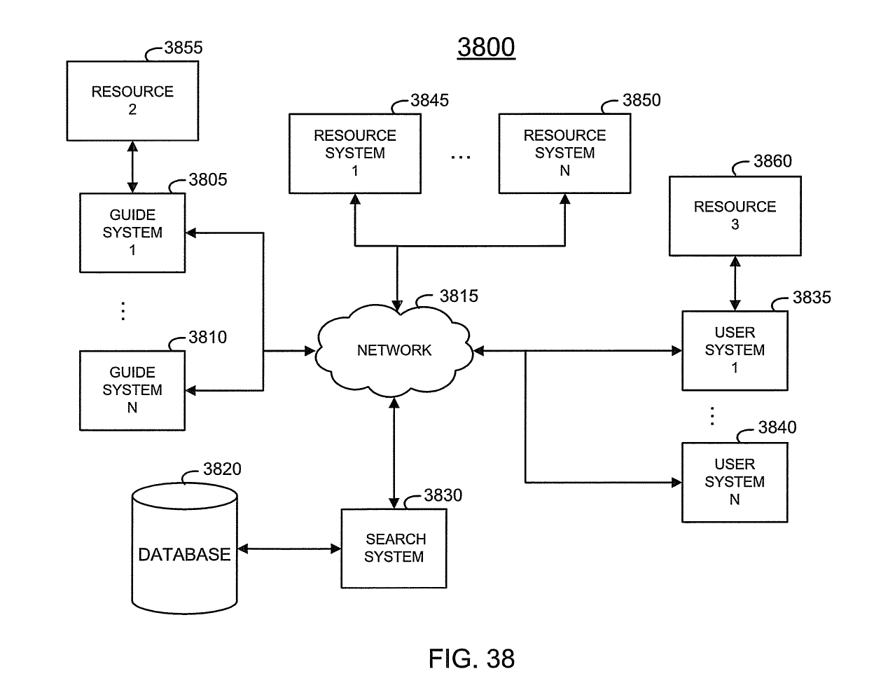

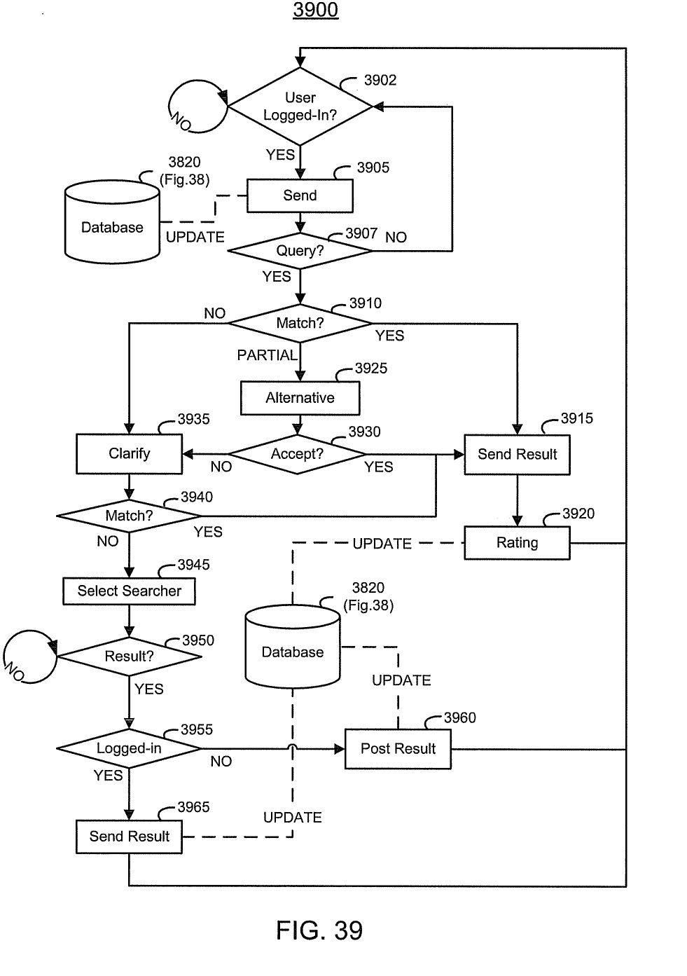

Communication between a guide, a user, a resource and/or a search system may include conversion of text to speech and speech to text. Any type of conversion and/or other processing of information which may facilitate communication between a user(s), a guide(s), a resource(s) and/or a search system(s) may be performed by an element(s) of the system 3800 (FIG. 38). Any type of media which can be sent and/or received using a communication system may be part of a communication session. A communication session may be conducted using any or all communication service(s) associated with a user, a resource and/or a guide. Any communication session may include communication via multiple service(s) and/or device(s). For example, a request may be submitted as a voice query, which might indicate an image located on a resource(s) accessible to a user(s) and/or a guide(s), the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions between a user, a guide and/or a search system. A resource, a guide, and/or an advertisement may be rated. Rating information may be obtained from a user, a guide(s), a resource(s) and/or a search system. Rating information may be used to select a resource(s), a guide(s), an advertisement(s) and/or any item(s) based on information associated with an item(s) indicated in a database. A search service may be compensated by advertising revenue. Advertising or content may be delivered to a user(s), and/or guide(s) using any service(s) associated with a user(s) and/or guide(s)

As illustrated in FIG. 38, system 3800 includes guide system(s) 3805, 3810, a network 3815 such as the Internet, a search system 3830, user system(s) or information seeker system(s) 3835, 3840, a database 3820, which may comprise various records, a resource 3855, and resource systems 3845, 3850, and a resource 3860.

While only a limited number of systems associated with a guide (also referred to as a human searcher or human assistant), resource (also referred to as a search resource), user (also referred to as an information seeker or requester) and as a search system are depicted in FIG. 38, it is within the scope of the disclosure for multiple systems for guide, resource, information seeker and search systems to be utilized.

Any user system (e.g., the user systems 3835, 3840) can be operated by an information seeker, who may be any person, to submit a search request to the search system 3830 and/or receive a search result(s) and/or other information. Any guide system (e.g., the guide systems 3805, 3810) can be operated by a human searcher to obtain a search result(s) responsive to a request which may have been submitted by an information seeker located at a user system (e.g., the user systems 3835, 3840). Any resource system (e.g., the resource systems 3845, 3850) may be operated by a human provider of information and/or may be an automated system which may provide a search result(s) and/or other information to a guide and/or a user, such as a search engine, a database, a local information source of a guide system such as a disk or removable memory, etc. A resource may not be accessible using the network 3815. For example, a resource such as the resource 3855 may be accessible to a guide operating a guide system such as the guide system 3805, or a resource such as the resource 3860 ‘Resource 3’ may be accessible to a user operating the user system 3835. A resource might include printed materials, images, video, and/or audio information, a software application(s), any information accessible to a guide(s), a user(s), a database(s), a system(s) and/or any combination thereof.

The network 3815 (FIG. 38) may be a global public network of networks (the Internet) and/or consist in whole or in part of one or more private networks and communicatively couples the guide systems 3805, 3810, the resource systems 3845, 3850 and the user systems 3835, 3840 with the other components of the system such as the search system 3830, and the database 3820. The network 3815 may include one or more wireless networks which may enable wireless communication between the various elements of the system 3800. For example, a mobile phone carrier network might be used to connect a user device to the search system 3830.

The search system 3830 allows interaction to occur among the guide systems 3805, 3810, the resource systems 3845, 3850 and the user systems 3835, 3840. For example, an information search query(ies) can be transmitted from the user systems 3835, 3840 to the search system 3830, where a search query(ies) can be accessed by the guide systems 3805, 3810 and/or the resource systems 3845, 3850. Similarly, a search result(s) or response produced from the resource systems 3845, 3850 using the guide systems 3805, 3810 in response to a search query(ies) submitted by the user systems 3835, 3840 may be transmitted to the search system 3830, where it may be stored by the search system 3830 and/or may be transmitted to the user systems 3835, 3840. Any type of communication between a user(s), a guide(s), and a resource(s) may be mediated and/or facilitated by the search system 3830, and/or other elements of the system 3800.

The search system 3830 is communicatively coupled with the database 3820. As will be described herein in further detail below, the database 3820 includes data that is processed in association with operation(s) of the embodiments. Although FIG. 38 illustrates the database 3820 as a separate component of the system, the database 3820 may be integrated with the search system 3830. Further, the records maintained in the database 3820 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the database 3820 may reside in any suitable elements of the system 3800. Any or all elements of the system 3800 may include any or all of the database 3820.

The user systems 3835, 3840, the guide systems 3805, 3810, the search system 3830 and the resource systems 3845, 3850 may include equipment, software, systems and personnel required to send and/or receive messages between a user system, a guide system, a resource system and/or the search system using the network 3815. The database 3820 includes information which may allow the search system 3830 to establish communication between any or all of the elements of the system 3800.

A user system, a guide system, and/or a resource may be a desktop or mobile PC or Mac®, a mobile phone, a smart phone, a PDA, a server system, a landline phone, a specialized communication terminal, a terminal connected to a mainframe, or any other communication device and/or system. The search system 3830 may include one or more servers, computers, etc. For example, servers such as the PowerEdge® 2900 by Dell, or the BladeCenterJS22 by IBM, or equivalent systems might be used to implement elements of the search system 3830. The search system 3830 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as user systems, guide systems, resources, and/or to implement the search system 3830.

A guide may be required to register with the search system 3830. As part of a registration process, at least one communication method is associated with a guide. In at least one embodiment, a guide may register with the search system 3830 and establish a username and password which are associated with the guide. A guide may login to the search system 3830 using a web browser functionality of guide system 3805, 3810 in order to communicate with the search system 3830. Multiple communication services may be associated with a guide and may allow a communication session to be established between a guide system such as the guide system 3805 and a user system, a resource system and/or the search system 3830. Multiple identifiers of a guide may be associated with each other. Information such as IM credential(s), an email address(es), a phone number(s), a URL, a username, etc. of a guide may be identified which may allow the search system 3830 to establish a communication session between a guide system and a user system, a resource system, and/or the search system 3830.

When a guide registers with the search system 3830 the guide may be associated with one or more keywords, categories, and/or other information. For example a keyword(s) or category(ies) may be selected by a guide, or may be associated with a guide based on a test(s) administered to a guide and/or other information provided during and/or after a registration process. Information associated with a guide may be stored in the database 3820 and may be used for purposes such as matching a guide to a user request, determining and/or providing compensation for a guide, communicating with a guide, etc. as will be described further herein below.

A user may be identified by the search system 3830. When a user system such as the user system 3835 establishes a communication session with the search system 3830, an identifier of a user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 3835 and a guide system, a resource system and/or the search system 3830. Information such as a keyword(s), a category(ies), a user profile(s), a previous search request(s), a search result(s), etc. may be associated with a user. Information of a user may be stored in the database 3820.

A resource, which may be a person(s), an entity(ies), a search engine, a database, a software application, a corpus of one or more types of media such as text or printed information, images, audio, video, etc. or a combination thereof, may be identified by the search system 3830. Any source of information may be a resource within the context of the disclosure herein. Information of at least one method of communication is associated with a resource system which allows a communication session to be established between the search system 3830, a user system 3835, 3840, and/or a guide system 3805, 3810 and a resource system such as the resource systems 3845, 3850. An identifier of a resource system may be associated with other information regarding a resource. A resource system may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource system such as the resource system 3845 and a user system, a guide system, and/or the search system 3830. Information such as a keyword(s), a category(ies), a profile(s), or other information may be associated with a resource. Information of a resource may be stored in the database 3820.

A resource such as the resources 3855 and/or resources accessible via the resource systems 3845, 3850 may include any system(s), software, hardware, personnel and/or other facility(ies) which may provide information to a guide(s), a user(s), and/or the search system 3830. For example, a resource may be a search engine, a database system, a library, a personal hard drive and/or other local storage, printed materials, recordings of any sort, a software program(s), a person or person(s), an organization, etc. A resource may be freely accessible to any user(s) and/or guide(s) and/or may be available on a restricted basis. The resource system(s) 3845, 3850 may include resource(s) which are available on an unrestricted and/or restricted basis. A resource may not be accessible using the network 3815, but may be accessible to selected guide(s). For example, a resource such as the resource 3855 may be accessible to one or more guide(s) operating a guide system(s) such as the guide system 3805 using any type of communication. For example, a guide(s) may obtain information of an event(s) to provide a search result(s). Information in any form, such as printed media, audio and/or visual information, software, hardware, etc. which may be accessible to a guide(s), a user(s) and/or an operator(s) of a resource system(s) may be a resource.

The search system 3830 may establish a communication session between any user system(s), guide system(s), or resource system(s) using information indicated in the database 3820. For example, the user system 3835 may establish a voice communication session with the search system 3830, the search system 3830 may establish a voice communication session between the user system 3835 and the guide system 3805, and the search system 3830 may establish a voice communication session between the user system 3835 and the resource system 3845. While a voice communication session is used in this example, any type of communication session using one or more services such as SMS, EMS, MMS, email, IM, chat, web based communication, etc. may be established between any user system(s), guide system(s), and/or resource system(s) and/or the search system 3830.

Information associated with a user(s), a guide(s) and/or a resource(s) may be obtained in various ways. For example, a registration process may be performed using a web form(s) provided by the search system 3830, and/or information may be obtained from an external database, and/or information may be obtained based on analysis of information indicated by a user, a guide, and/or a resource. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device(s), service(s), transaction(s) and/or any information which might be associated with a user(s) and/or a guide(s).

As illustrated in FIG. 39, a process 3900 for performing an information search is provided.

In operation 3902 (FIG. 39), a determination is made as to whether a user is logged into the search system 3830 (FIG. 38). If it is determined in operation 3902 that a user is not logged-in control remains at operation 3902 and process 3900 continues to wait. If it is determined in operation 3902 that a user is logged-in, control is passed to operation 3905 and process 3900 continues.

The determination in operation 3902 may be made based on various criteria. A user may be determined to be logged into a search system based on presence information associated with any or all communication services and/or devices of the user. For example, a user may be determined to be logged-in when a device associated with a user is accessible using a communication service(s) of a user. For example, if a user may receive an SMS message, it may be determined that a user is logged in to the search system.

In operation 3905, any pending previous search result(s) is presented to a user, user rating information may be obtained, and the database 3820 (FIG. 38) is updated. An advertisement(s) and/or other information may be presented to a user before, during and/or after any or all search results are presented to a user. A user may be presented with information in any format(s) which is suitable for a device(s) associated with a user. A result(s) and/or an advertisement(s) may be presented using one or more devices. The same or different information may be presented to a user at different times, based on conditions such as the device(s) accessible to the user and/or the search system 3830. For example, a user may be presented with an SMS message relating to a search result, and may subsequently be presented with a URL associated with a search result(s) when accessing the search system using a browser functionality of a user device. Control is passed to operation 3907 and process 3900 continues.

In operation 3907 (FIG. 39), a determination is made as to whether a search query or search request is received. If it is determined in operation 3907 that a search query is not received, control is passed to operation 3902 and process 3900 continues. If it is determined in operation 3907 that a search query is received, control is passed to operation 3910 and process 3900 continues.

In operation 3910, a determination is made as to whether a search query matches an existing query. If it is determined in operation 3910 that a query exactly matches an existing query, control is passed to operation 3915 and process 3900 continues. If it is determined in operation 3910 that a partial match is found to an existing query control is passed to operation 3925 and process 3900 continues. If it is determined in operation 3910 that no match is found to an existing query control is passed to operation 3935 and process 3900 continues.

The determination in operation 3910 may be made based on various criteria. In at least one embodiment, a query may be compared to a database of existing queries indicated in the database 3820 (FIG. 38). For example, semantic analysis, stemming, keyword matching, etc. may be used to determine if a query matches an existing query.

In operation 3915, the user ID and/or other information associated with a user entering a query is associated with a query. A result(s) may be presented to a user. An order of presentation of a result(s) may be determined based on rating data associated with the search result(s). Control is passed to operation 3920 and process 3900 continues.

In operation 3920 a rating(s) of a search result(s) may be obtained and information of the process 3900 is recorded. The database 3820 (FIG. 38) may be updated. Usage information of a search result(s), an advertisement(s), etc. may be recorded. Control is passed to operation 3902 and process 3900 continues.

In operation 3925 a search result(s) and/or a query(ies) associated with a query(ies) determined to partially match a query submitted by a user may be presented to the user and/or a guide(s). Any number of queries and/or search results may be provided. For example, a user may be presented with a closest matching query and a result. Similarly a guide may be presented with a query(ies) and/or a search result(s), which a guide may select to send to a user. Control is passed to operation 3930 and process 3900 continues.

In operation 230 a determination is made as to whether a query is accepted. If in operation 3930 it is determined that a query is accepted, control is passed to operation 3915 and process 3900 continues. If in operation 3930 it is determined that a query is not accepted, control is passed to operation 3935 and process 3900 continues.

The determination in operation 3930 may be made based on various criteria. For example if a user actively accepts a recommended query, or if a guide selects a query, or if a user does not reject a response to a query, it may be determined that a query is accepted.

In operation 3935, a query is clarified. A parsing operation may be performed to extract a keyword(s) and/or category(ies) associated with the query. In at least one embodiment the parsing and categorization may be done by the search system 3830 (FIG. 38). In at least one embodiment the parsing and categorization may be performed by a human guide. Interaction between a guide and an information seeker may occur to clarify the intent of a query. For example, a first guide may respond to a query with a request for clarification, and a different guide may determine a clarified request. In operation 3935 (FIG. 39) a categorized and/or rephrased query is preferably obtained and a category(ies) and/or keyword(s) may be associated with a query. In a preferred embodiment, a categorization and/or a keyword(s) selected by a human guide is compared to that algorithmically selected by the search system 3830 to provide feedback to the algorithmic selection. Control is passed to operation 3940 and process 3900 continues.

In operation 3940, a determination is made as to whether a clarified query matches an existing query in the database 3820 (FIG. 38). If in operation 3940 it is determined that a query matches an existing query, control is passed to operation 3915 and process 3900 continues. If in operation 3940 it is determined that a query does not match an existing query, control is passed to operation 3945 and process 3900 continues.

In operation 3945 a guide is selected. A guide may be selected based on various criteria. In at least one embodiment, a guide is selected based at least in part on a ranking of a guide(s) associated with a category(ies) associated with a query or request. Control is passed to operation 3950 and process 3900 continues.

In operation 3950 a determination is made as to whether a search result is returned. If in operation 3950 it is determined that a search result is not returned, control remains at operation 3950 and process 3900 continues. If in operation 3950 it is determined that a search result is returned, control is passed to operation 3955 and process 3900 continues. The determination in operation 3950 may be made based on various criteria. In at least one embodiment, if a message is received by the search system 3830 from a guide system indicating a search result, it may be determined that a search result is returned. In at least one embodiment, if a search result is not received within a predetermined time period, a query may be submitted to an automated search resource, and it may be determined that a search result is returned. Any suitable criteria may be used to determine if a search result is returned.

In operation 3955, a determination is made as to whether a user is logged-in to the search system 3830 (FIG. 38). If it is determined in operation 3955 that a user is not logged-in, control is passed to operation 3960 and process 3900 continues. If it is determined in operation 3955 that a user is logged-in control is passed to operation 3965 and process 3900 continues.

In operation 3965, a search result(s) is transmitted to a user. User rating information may be obtained and recorded. In at least one embodiment, the database 3820 (FIG. 38) is updated. Control is passed to operation 3902 and process 3900 continues.

In operation 3960, a search result(s) associated with a query and a user(s) are posted to a storage associated with a user. For example, a result may be stored in the database 3820 (FIG. 38) with an indicator that the search result(s) are pending transmission to a user(s). Control is passed to operation 3902 and process 3900 continues.

An index 4000 is illustrated in FIG. 40. Top-level elements or nodes of the index tree (also referred to as ‘path root terms’) represent broad categories of information which are intended to encompass as much information as possible without overlapping each other. Path root terms such as the path root terms “arts” 4005, “geography” 4007 and “shopping” 4010 may be a limited set of words and/or phrases which may be used to classify or categorize information such as a search request, a guide, an advertisement, a search result, etc.

A word(s) or phrase(s) associated with lower-level nodes may appear in multiple locations within an index or database. Such words and/or phrases may be referred to as ‘topics’. For example, words and/or phrases such as the path terms “music” 4015, “jazz” 4020, “painting” 4025, “clothing” 4030, “rock” 4035, “classical” 4040, “artists” 4060 and/or others may be utilized in any path defined in the index 4000. A subset of information is defined by specifying ‘path terms’ which may follow a subset relationship (i.e., an added word and/or phrase defines a more specific set of information which is contained within the preceding set of information). An example of this relationship is designated by the notation “arts>music>jazz” indicating that “jazz” is a subset of “music” which is a subset of “arts”. This may for example designate the path “arts>music>jazz” 4045. Such a subset relationship is represented in FIG. 41. The selected subset of information is contained within a perimeter of the set 4115. A guide and/or item associated with a more specific subject, which may correspond to a longer path (e.g., the path “arts>music>jazz” 4045 (FIG. 40)) may be more likely to be relevant to a query associated with the path than a guide and/or information associated with a shorter path (e.g., the path “arts>music” 4055). For example, if a query is associated with the category “arts>music>jazz” and a guide associated with “arts>music>jazz” has a rating which is equal to that of a guide associated with “arts>music”, the guide associated with “arts>music>jazz” would be ranked higher.

A path which begins with a path root term, such as the path “arts>music” 4055, or the path “shopping>music>jazz” 4050 may be referred to as a “proper path”. A path which does not begin with a path root term such as the path “music>jazz>artists” 4065 may be referred to as a ‘path snippet’. A path snippet may occur in multiple locations within an index such as the index 4000. The presence of such a path snippet may indicate that proper paths which contain identical path snippets may be related.

As illustrated in FIG. 41, an overlap in relevant information associated within any given set(s) of information defined by a path root term may exist. For example, the information included in the root term set “arts” 4105, and the topic subset “music” 4110, and the topic subset “jazz” 4115 (i.e., associated with the path “arts>music>jazz” 4045 (FIG. 40)) may also be relevant to the information included in the root term set “shopping” 4120, and the topic subset “music” 4125, and the topic subset “jazz” 4130 (i.e., associated with the path “shopping>music>jazz” 4050 (FIG. 40)). If a hierarchical approach is used to rank guide(s), associated with the index 4000 it is unlikely that a guide(s) or item(s) associated with the category “shopping>music>jazz” will be ranked highly when selecting a guide(s) and/or item(s) to respond to a search request or other item(s) associated with the category “arts>music>jazz”. In a hierarchical ranking, a guide associated with the category “arts>music” would be more likely to be highly ranked for a query associated with “arts>music>jazz” than a guide associated with “shopping>music>jazz”.

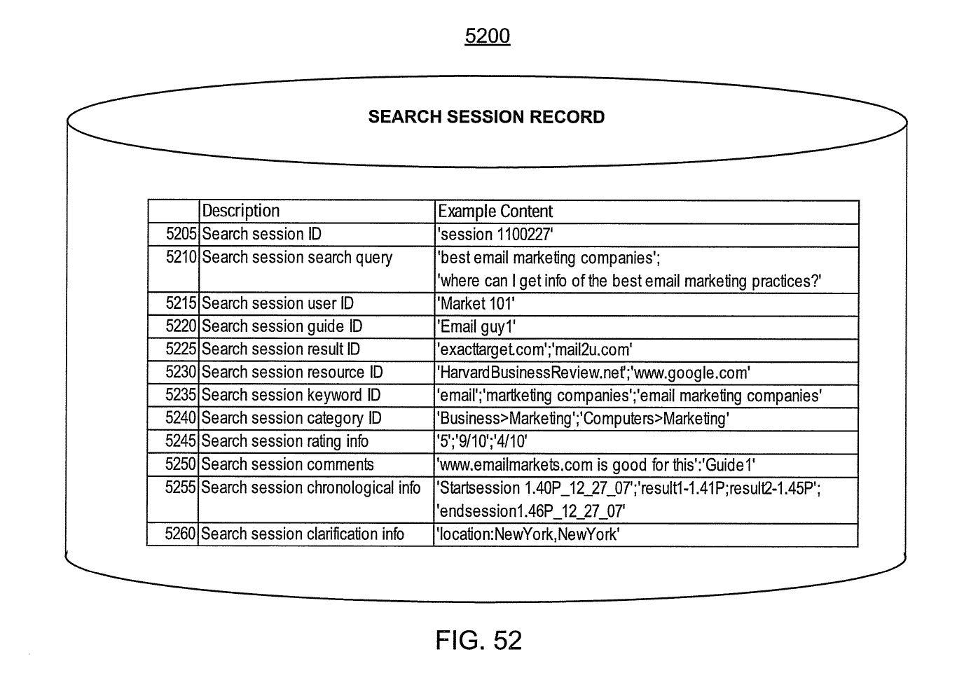

The presence of a shared path snippet (e.g., “music>jazz”) may be identified by the system 5200 (FIG. 52). In order to improve effectiveness of a categorization index, a link may be established between proper paths. For example, a link may be established between the proper path “arts>music>jazz” 4045 (FIG. 40) and the proper path “shopping>music>jazz” 4050. Such a link may be established based on automatic detection of a relationship between the paths by the search system 5230 (FIG. 52) and/or may be based on a judgment of a human taxonomist operating a taxonomist system such as the taxonomist systems 5245, 5250. Such a link may be unidirectional (i.e., “arts>music>jazz” is equivalent to “shopping>music>jazz”, but “shopping>music>jazz” is not equivalent to “arts>music>jazz”), or bidirectional (i.e., “arts>music>jazz” is equivalent to “shopping>music>jazz” and vice-versa). A method and system for creating and maintaining linkages between proper paths is described further herein below.

While the index 4000 (FIG. 40) is illustrated with only a few levels (i.e., short paths), any number of levels and/or length of paths may exist within the index 4000. It is possible that paths which contain multiple path terms in common may exist. For example, the proper path “arts>music>jazz>artists>1960” and the proper path “arts>music>jazz>1960>artists” might exist. Such a condition may be identified, and a human taxonomist and/or the search system 5230 (FIG. 52) may determine that one or more proper paths are equivalent. The search system 5230 may determine an association between paths based on a similarity of information identifying the nodes. In such a case, a linkage may be established which associates guides and/or information associated with a proper path with any equivalent proper path. Using a different example, a proper path such as “arts>music>songwriters>baby boomers” might exist. Such a path might be determined to be strongly related to a path such as “arts>music>artists>1960s” because the first path terms are common, and the path snippet “songwriters>baby boomers” is related to the snippet “artists>1960s”. A taxonomist and/or other elements of the system 5200 may determine if a linkage should be established between proper paths.

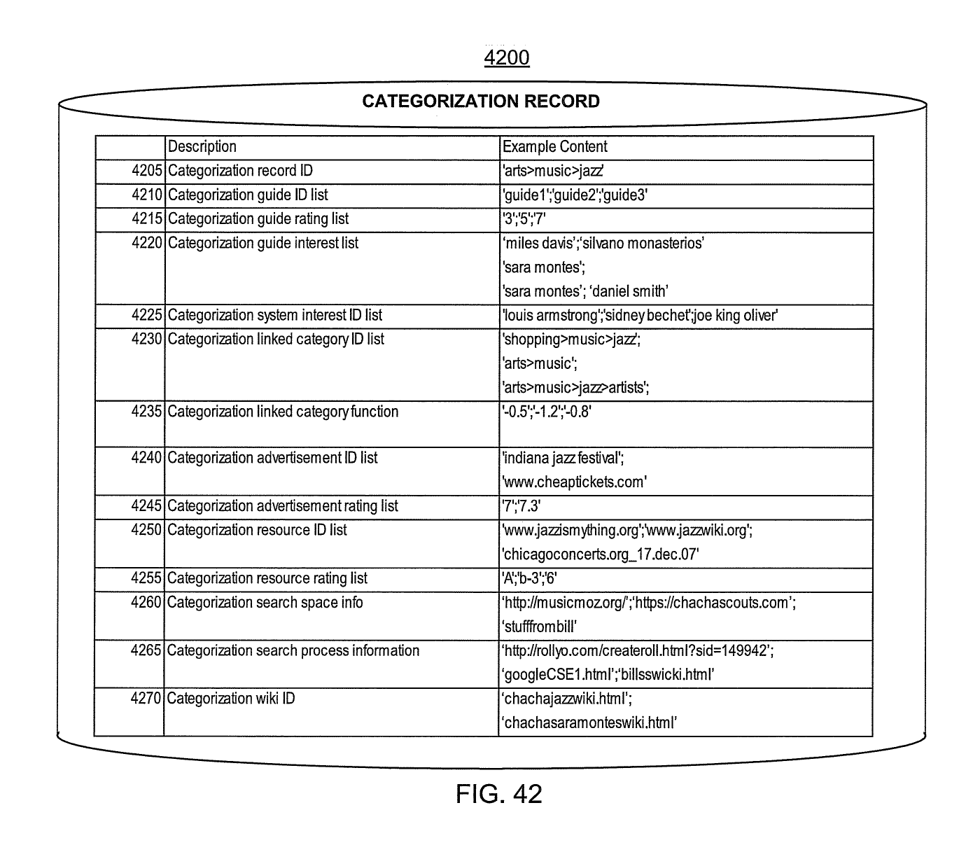

Various types of information may be associated with any proper path within the index 4000 (FIG. 40). Any proper path designates a unique element within the index 4000. Using the example in FIG. 40, the node designated by the proper path “arts>music” 4055 is different than the node designated by the proper path “arts>music>jazz” 4045 and the node designated by the proper path “shopping>music>jazz” 4050. Any element within the index 4000 may be associated with one or more records such as the categorization record 4200 illustrated in FIG. 42.

As illustrated in FIG. 42, an exemplary categorization record 4200 is provided, of which one or more may be associated with or resident in the search database 3820 (FIG. 38). The categorization record 4200 may include a categorization record ID field 4205, a categorization guide identifier list field 4210, a categorization guide rating list field 4215, a categorization guide interest list field 4220, a categorization system interest list field 4225, a categorization linked category ID list field 4230, a categorization linked category function field 4235, a categorization advertisement ID list field 4240, a categorization advertisement rating list field 4245, a categorization resource ID list field 4250, a categorization resource rating list field 4255, a categorization search space info field 4260, a categorization search process information field 4265, and a categorization wiki ID field 4270.

The categorization record ID field 4205 contains an identifier of a categorization, which is preferably unique and preferably used consistently. For example, in at least one embodiment, the categorization record ID field 4205 can include a randomly generated numerical code and/or a character string indicating a categorization. A categorization record ID serves to distinguish a categorization record associated with a categorization from a categorization record associated with other categorization(s). Although particular examples of identifiers are described herein, other types of identifiers uniquely indicating a categorization(s) may be utilized without departing from the spirit and scope of the embodiments herein. In at least one embodiment, a description of a proper path may be included in the content of the categorization record ID field 4205. A categorization record ID may include a categorization description, a random numeric code, and/or any other information uniquely identifying an element within a data structure. Using the example in FIG. 42, ‘arts>music>jazz’ is the categorization record ID associated with the categorization record 4200.

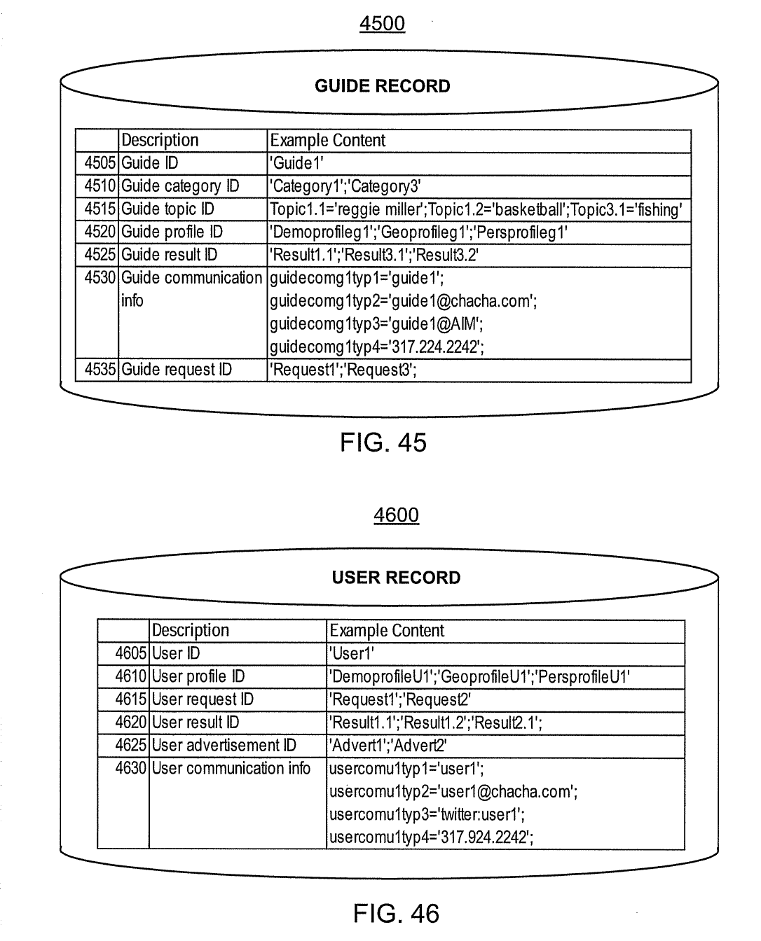

The categorization guide ID list field 4210 may include one or more identifiers associated with a guide(s). The categorization guide ID list 4210 may include one or more identifiers of a guide(s) which may be used to obtain further information of a guide using a record such as the guide record 4500 illustrated FIG. 45. Using the example in FIG. 42, the guide IDs ‘guide1’, ‘guide2’ and ‘guide3’ have been associated with the categorization record 4200. While only a few guide identifiers have been illustrated in FIG. 42, any number of guide identifiers may be associated with a categorization. Association of a guide ID with a categorization may indicate that a guide has registered to respond to requests associate with the categorization, or that a guide may associate, review, edit and/or otherwise associate information with a categorization.

The categorization guide rating list field 4215 may include information of one or more ratings associated with a guide(s). For example, the categorization guide rating list field 4215 may include a rating of a guide(s) based on search result(s) produced by a guide responsive to search request(s) associated with the categorization identified in the categorization record ID field 4205. In at least one embodiment, the categorization guide ID list field 4210 and the categorization guide rating list field 4215 may be linked by, for example, a pointer. Using the example illustrated in FIG. 42, the rating ‘3’ has been associated with the guide ‘guide1’, the rating ‘5’ has been associated with the guide ‘guide2’ and the rating ‘7’ has been associated with the guide ‘guide3’. This may indicate that the guide ‘guide3’ has the highest rating and might be selected first to respond to a search request associated with the category ‘arts>music>jazz’. A rating(s) of a guide(s) may be determined based on any information indicated in the database 3820 (FIG. 38).

The categorization guide interest list field 4220 may include information of one or more interest associated with a guide associated with the categorization indicated in the categorization record ID field 4205. The information indicated in the categorization guide interest list field 4220 may be compared to information indicated in a search request which is associated with the categorization identified in the categorization record ID field 4205. A match between information associated with a search request and information indicated in the categorization guide interest list field 4220 may modify the ranking of a guide when selecting a guide to respond to a search request or request. In at least one embodiment, the categorization guide ID list field 4210 and the categorization guide interest list field 4220 may be linked by for example a pointer. Using the example illustrated in FIG. 42, the interests ‘miles davis’ and ‘silvano monasteries’ have been associated with the guide ‘guide1’, the interest ‘sara montes’ has been associated with the guide ‘guide2’ and the interests ‘sara montes’ and ‘daniel smith’ have been associated with the guide ‘guide3’. This may indicate that ‘guide1’ would be more likely to be selected to respond to a search request associated with the category ‘arts>jazz>music’ which contained the information ‘miles davis’ even though the rating of ‘guide1’ is lower than the rating of ‘guide2’ and ‘guide3’ when responding to a search request associated with the category ‘arts>music>jazz’. Continuing with the example in FIG. 42, if a search request categorized as associated with the category ‘arts>music>jazz’ which contained the information ‘sara montes’ is received, ‘guide3’ might be selected to respond to the request, as both ‘guide2’ and ‘guide3’ are associated with the interest ‘sara montes’ and ‘guide3’ has a higher rating associated with the category ‘arts>music>jazz’.

The categorization system interest list field 4225 may include information of one or more ‘interests’ or keywords associated with the categorization indicated in the categorization record ID field 4205. Information indicated in the categorization system interest list field 4225 may be compared to information indicated in a search request which is associated with the categorization identified in the categorization record ID field 4205. Information indicated in the categorization system interest list field may be obtained from a search of a resource(s) and/or other information. For example, if a resource is associated with a category, the resource may be indexed and high ranking keywords of the resource may be indicated in the categorization system interest field. A match between information associated with a search request and information indicated in the categorization system interest list field 4225 may modify the ranking of a categorization associated with a request. For example, if a keyword indicated in the categorization system interest list field 4225 is highly ranked for the categorization, and is present in content of a request, the categorization may be highly ranked for the request. Using the example illustrated in FIG. 42, the interests ‘louis armstrong’, ‘sidney bechet’, and ‘joe king oliver’ have been associated with the category ‘arts>jazz>music’.

The categorization linked category ID list field 4230 may include information of categorizations which are associated with a categorization identified in the categorization record ID field 4205. The information included in the categorization linked category ID list field 4230 may be used to identify categorization records which may be associated with a guide and/or information which may be selected responsive to a search request. For example, a list of related categorization record ID's may be used to identify a categorization record(s) which may include information of a guide(s) who may have relevant knowledge regarding a user search request which is associated with the category ‘arts>music>jazz’. Using the example in FIG. 42, the category IDs ‘shopping>music>jazz’, ‘arts>music’ and ‘arts>music>jazz>artists’ have been associated with the categorization record 4200. This may indicate that a guide and/or information associated with the categorization ‘shopping>music>jazz’, ‘arts>music’ and ‘arts>music>jazz>artists’ may be ranked responsive to a search request associated with the categorization ‘arts>music>jazz’.

The categorization linked category function field 4235 may include information of a function or other information associated with a linkage between a category listed in the categorization linked category ID list field 4230 and a category indicated in the categorization record ID field 4205. Information indicated in the categorization linked category function field 4235 may be used to modify a rating(s) and/or ranking(s) of a guide(s) associated with a category indicated in the categorization linked category ID list field 4230, for example, when selecting a guide or other information to be associated with a search request determined to be associated with a categorization identified in the categorization record ID field 4205. In at least one embodiment, the categorization linked category ID list field 4230 and the categorization linked category function field 4235 may be linked by, for example, a pointer. Using the example in FIG. 42, the function ‘−0.5’ has been associated with the categorization ‘shopping>music>jazz’. This may indicate that a rating of a guide associated with the categorization ‘shopping>music>jazz’ should be reduced by 0.5 when ranking guides to respond to a search request associated with the categorization ‘arts>music>jazz’. Likewise, the function ‘−1.2’ and ‘−0.8’ have been associated with the categories ‘arts>music’ and ‘arts>music>jazz>artists’, respectively. This may indicate that a rating(s) of a guide(s) associated with the category ‘arts>music’ may be reduced by 1.2, and that the rating(s) of a guide(s) associated with the category ‘arts>music>jazz>artists’ may be reduced by 0.8 when ranking guides to be selected responsive to a search request associated with the categorization ‘arts>music>jazz’. While only a few categorization IDs are illustrated in FIG. 42, multiple categorization ID's with various linked category functions may be utilized within the scope of the embodiments herein.

Information indicated in the categorization linked category ID list field 4230 and the categorization linked category function field 4235 may be produced in various ways. In at least one embodiment a human taxonomist may identify linked categorizations, and may assign a strength value. Algorithmic techniques may be used in combination with human judgment to determine linked categorizations. For example, an algorithmic search may identify proper paths which may share one or more path terms, and may present the identified proper paths for consideration by a human taxonomist and/or automatically add a proper path(s) to the categorization linked category ID list field 4230. Information indicated in the categorization linked category function field 4235 may be modified based on rating(s) of a search result(s) provided by a guide(s) selected using the information indicated in a linked category ID list field. For example, a higher success rate by a guide(s) associated with a categorization identified in the categorization linked category ID list field 4230 may decrease a difference in ratings for guides associated with the categorization. A human taxonomist may be presented with various types of information to assist in modification and/or addition of links and/or paths within a selection index or data structure, as will be described further herein below.

The categorization advertisement ID list field 4240 may include one or more identifiers associated with an advertisement(s). The categorization advertisement ID list field 4240 may include one or more identifiers of an advertisement(s) which may be associated with a categorization. Using the example in FIG. 42, the advertisement IDs ‘indiana jazz festival’ and ‘www.cheaptickets.com’ have been associated with the categorization record 4200, which may indicate that the advertisements ‘indiana jazz festival’ and ‘www.cheaptickets.com’ may be presented to a guide(s) and/or a user(s) responsive to a request or search request associated with the category ‘arts>music>jazz’. While only a few advertisement identifiers have been illustrated in FIG. 42, any number of advertisement identifiers may be associated with a categorization.

The categorization advertisement rating list field 4245 may include information of one or more ratings associated with an advertisement(s). For example, the categorization advertisement rating list field 4245 may include a rating of an advertisement(s) based at least in part on frequency of selection of an advertisement by a guide(s) responsive to search request(s) associated with the categorization identified in the categorization record ID field 4205. In at least one embodiment, the categorization advertisement ID list field 4240 and the categorization advertisement rating list field 4245 may be linked by, for example, a pointer. Using the example illustrated in FIG. 42, the rating ‘7’ has been associated with the advertisement ‘indiana jazz festival’ and the rating ‘7.3’ has been associated with the advertisement ‘www.cheaptickets.com’. This may indicate that the advertisement ‘www.cheaptickets.com’ has the highest rating and might be more likely to be selected responsive to a search request associated with the category ‘arts>music>jazz’.

The categorization resource ID list field 4250 may include one or more identifiers of a resource(s) which may be associated with a categorization. Using the example in FIG. 42, the resource IDs ‘www.jazzismything.org’, ‘www.jazzwiki.org’ and ‘chicagoconcerts.org_{—}17.dec.07’ have been associated with the categorization record 4200. While only a few resource identifiers have been illustrated in FIG. 42, any number of resource identifiers may be associated with a categorization. A resource may be any source of information which may be utilized to respond to a request.

The categorization resource rating list field 4255 may include information of one or more ratings associated with a resource(s). For example, the categorization resource rating list field 4255 may include a rating of a resource(s) based at least in part on frequency of use of a resource(s) by a guide(s) responsive to search request(s) associated with the categorization identified in the categorization record ID field 4205. A rating of a resource(s) may be based on any information indicated in the database 3820 (FIG. 38). In at least one embodiment, the categorization resource ID list field 4250 and the categorization resource rating list field 4255 may be linked by, for example, a pointer. Using the example illustrated in FIG. 42, the rating ‘A’ has been associated with the resource ‘www.jazzismything.org’, the rating ‘b-3’ has been associated with the resource ‘www.jazzwiki.org’ and the rating ‘6’ has been associated with the resource ‘chicagoconcerts.org_{—}17.dec.07’. Any type of rating information may be included in a rating field(s) such as the categorization resource rating field 4255.

The categorization search space info field 4260 may include one or more identifiers of resources, media, content, systems, or other information which may be associated with a categorization. Using the example in FIG. 42, the search space indicated in ‘http://musicmoz.org/’, ‘https://chachascouts.com’ and ‘stufffrombill’ have been associated with the categorization record 4200. This may indicate that information indicated in ‘http://musicmoz.org/’, ‘https://chachascouts.com’ and ‘stufffrombill’ may be included in a search space for a query or request associated with the categorization ‘arts>music>jazz’. While only a few search space identifiers have been illustrated in FIG. 42, any number of search space identifiers may be associated with a categorization. A search space identifier may indicate any type of information and may include information which may allow a guide(s), user(s), a resource(s) and/or the search system 3830 (FIG. 38) to access information. In at least one embodiment, a search space indicator may be used to access a list of URLs which have been edited by one or more human editors, such as a DMOZ directory list, however information such as a collection of any sort any corpus of documents, images, and/or other media may be indicated in the categorization search space info field 4260.

The categorization search process information field 4265 may include one or more identifiers of information which may be associated with a categorization, which may be used to define parameters associated with a search process which may be applied to information indicated in a categorization search space info field(s). For example, search strategy information might indicate that a search be conducted on one or more lists of URL's, and that a number of results from each search be combined, similar to the meta-search concept. Alternately, a search strategy might specify parametric information, which might be used by an algorithmic search such as a Google® which might be applied to any or all information indicated by information in a categorization search space field(s). In at least one embodiment, the categorization search space info field 4260 and the categorization search process information field 4265 may be linked by for example a pointer. Using the example illustrated in FIG. 42, the URL ‘http://rollyo.com/createroll.html?sid=149942’, the file ‘googleCSE1.html’ and the file ‘billsswicki.html’ have been associated with the categorization ‘arts>music>jazz’. This may indicate that a Rollyo™ search algorithm may be applied to the URLs indicated at ‘http://musicmoz.org/’, that a Google® CSE may be applied to the collection ‘https://chachascouts.com’ and that the swicki search ‘billsswicki.html’ is to be applied to the collection ‘stufffrombill’. Further processes may be indicated in the categorization search process information field 4265, such as a weighting or number of results, or any other processing which might be applied to a result(s) obtained from processing of a search. Information of indexing associated with one or more resources may be include in the categorization search process information field 4265, which may be utilized to identify, rate and/or rank interests and/or other information associated with a resource(s).

The categorization wiki ID field 4270 may include one or more identifiers of wikis which may be associated with a categorization. For example, information indicated in one or more wikis associated with a guide(s) associated with a categorization may be indicated in the categorization wiki ID field. In at least one embodiment, a wiki which is editable by any and/or guides associated with a categorization may be indicated in the categorization wiki ID field. In at least one embodiment, a wiki(s) associated with any guide indicated in a categorization guide ID list field may be associated with the categorization. Using the example illustrated in FIG. 42, the wiki ‘chachajazzwiki.html’ and ‘chachasaramonteswiki.html’ are associated with the categorization ‘arts>music>jazz’, which may indicate that any or all information indicated in the wikis ‘may be searched in order to provide information to a guide(s), a user(s), a resource(s) and/or the search system 3830 (FIG. 38) responsive to a request.

As previously noted, herein information associated with categorizations indicated in the categorization linked category ID list may be utilized in order to provide information responsive to a request. In order to enrich a vocabulary associated with a taxonomy, it may be desirable to add vocabulary to content of the categorization system interest ID field 4225 associated with a category(ies). Likewise, it may be desirable to determine if a keyword indicated in the categorization guide interest field 4220 is located in resources associated with categories in the categorization linked category ID field 4230. For example, if the interest ‘sara montes’ is highly ranked when associated with the linked categorization, ‘shopping>music>jazz’, ‘sara montes’ might be added to the categorization system interest ID field 4225 of the categorization ‘shopping>music>jazz’, and resources associated with ‘shopping>music>jazz’ might be indexed to determine interests associated with ‘arts>music>jazz’.

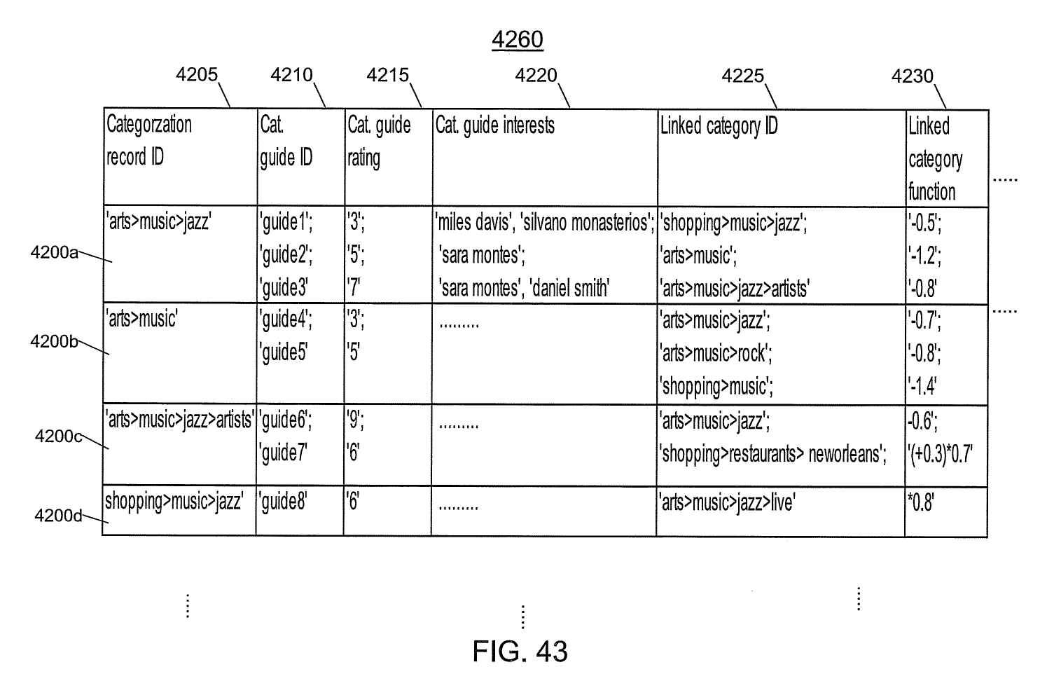

A categorization record table 4260 of which one or more may be associated with or resident in the search database 3820 (FIG. 38) is illustrated in FIG. 43. The categorization record table 4260 may be composed of one or more categorization records such as the categorization records 4200a, 4200b, 4200c, and 4200d as illustrated in FIG. 43.

In order to select a guide(s) to respond to a search request associated with the categorization ‘arts>music>jazz’ it may be desirable to rank available guides including those who may not be associated with the categorization ‘arts>music>jazz’, as this may produce a more relevant response to a search request. Information indicated in a categorization record table such as the categorization record table 4260 may be used to select a guide(s) and/or other information responsive to a search request. For example, a ranking of guide(s) based on information associated with a search request associated with the category ‘arts>music>jazz’ may be performed using information indicated in the categorization record table 4260.

As indicated in the categorization guide ID field 4210 of the categorization record 4200a, the guides ‘guide1’, ‘guide2’ and ‘guide3’ are associated with the categorization ‘arts>music>jazz’. As indicated in the categorization guide ID field 4210 of the categorization record 4200b, the guides ‘guide4’ and ‘guide5’ are associated with the categorization ‘arts>music’. As indicated in the categorization guide ID field 4210 of the categorization record 4200c, the guides ‘guide6’ and ‘guide7’ are associated with the categorization ‘arts>music>jazz>artists’. As indicated in the categorization guide ID field 4210 of the categorization record 4200d, the guide ‘guide8’ is associated with the categorization ‘shopping>music>jazz’.

In order to select a guide to respond to a user search request associated with the categorization ‘arts>music>jazz’, guides associated with the categorization ‘arts>music’ may be included in a ranking. A guide rating(s) associated with the categorization ‘arts>music’ may be based on various factors. For example, a guide might be rated based on a search result(s) produced by the guide(s) which are associated with any proper path which includes the proper path ‘arts>music’, and/or the guide might be rated based on search results associated with search requests categorized as ‘arts>music’, etc. An adjustment to a guide rating(s) indicated in the linked category function field 4230 may be applied to a guide rating(s) associated with a categorization associated with a shorter proper path. For example, a guide rating associated with the categorization ‘arts>music’ might be reduced by 1.2 when ranking guides to respond to a search request associated with the categorization ‘arts>music>jazz’.

In order to select a guide to respond to a user search request associated with the categorization ‘arts>music>jazz’, guides associated with the categorization ‘arts>music>jazz>artists’ may be included in a ranking. A guide rating associated with the categorization ‘arts>music>jazz>artists’ may be based on various factors. For example, a guide might be rated based on a search result(s) produced by a guide(s) which are associated with the proper path ‘arts>music>jazz>artists’, etc. An adjustment to a guide rating(s) indicated in the linked category function field 4230 may be applied to a guide rating(s) associated with a categorization associated with a longer proper path. For example, a guide rating associated with the categorization ‘arts>music>jazz>artists’ might be reduced by 0.8 when ranking guides to respond to a search request associated with the categorization ‘arts>music>jazz’.

In order to select a guide to respond to a user search request associated with the categorization ‘arts>music>jazz’, guides associated with the categorization ‘shopping>music>jazz’ as indicated in the linked category ID field 4225 of the category record 4200a may be included in a ranking. A guide rating associated with the categorization ‘shopping>music>jazz’ may be based on various factors. For example, a guide might be rated based on a search result(s) produced by the guide(s) which are associated with the proper path ‘shopping>music>jazz’ and/or the guide might be rated based on search results produced by a guide(s) which are associated with any proper path which includes the proper path ‘shopping>music>jazz’, etc. An adjustment to a guide rating(s) indicated in the linked category function field 4230 of the category record 4200a may be applied to a guide rating(s) associated with the linked categorization ‘shopping>music>jazz’. For example, a guide rating associated with the categorization ‘shopping>music>jazz’ might be reduced by 0.5 when ranking guides to respond to a search request associated with the categorization ‘arts>music>jazz’.

Continuing with the example illustrated in FIG. 43, the guides ‘guide1’, ‘guide2’, ‘guide3’, ‘guide4’, ‘guide5’, ‘guide6’, ‘guide7’, and ‘guide8’ may be ranked in order to select a guide(s) to respond to a search request associated with the categorization ‘arts>music>jazz’. The ratings of the guides ‘guide1’, ‘guide2’, and ‘guide3’ are not adjusted, the ratings of ‘guide4’ and ‘guide5’ are reduced by 1.2 (i.e., ‘guide4’ has a rating of 1.8, and ‘guide5’ has a rating of 3.8) as the rating are associated with the categorization ‘arts>music’, the ratings of ‘guide6’ and ‘guide7’ are reduced by 0.8 (i.e., ‘guide6’ has a rating 8.2, and ‘guide7’ has a rating 5.2), and the rating of ‘guide8’ is reduced by 0.5 (i.e., ‘guide8’ has a rating 5.5). If guides are ranked from highest rating to lowest rating, ‘guide6’ would be ranked first, ‘guide3’ would be ranked second, ‘guide7’ would be ranked third, ‘guide8’ would be ranked fourth, ‘guide2’ would be ranked fifth, ‘guide5’ would be ranked sixth, ‘guide1’ would be ranked seventh, and ‘guide4’ would be ranked eighth.

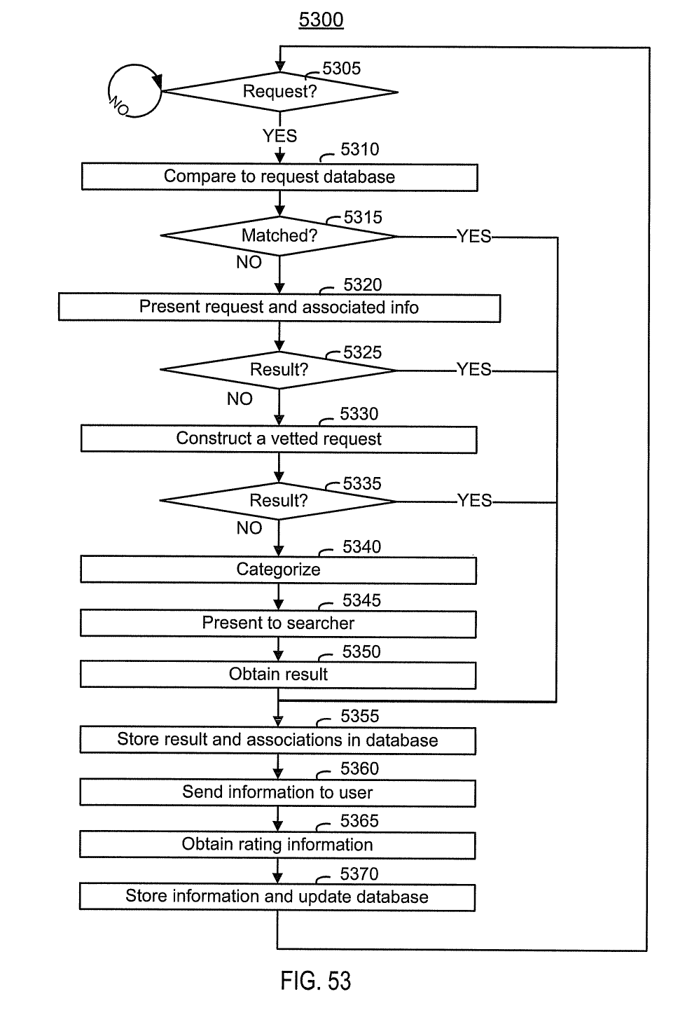

While the rating and ranking of guides has been described using numeric ratings and subtractive modifications, other types of ranking and adjustment factors will immediately occur to one of ordinary skill in the relevant art after being presented with the disclosure herein. For example, the rating(s) of a guide(s) and/or item(s) when associated with a search request and a categorization may be considered in terms of ‘distance’ from the node or categorization. A rating(s) of a guide(s) may be adjusted by the distance between a categorization associated with a search request and a categorization associated with the guide. A path link within a selection data structure or index is associated with a function which may be used to modify a rating(s) of a guide(s) associated with a linked proper path when ranking guides to respond to a search request associated with a different proper path. Using the example illustrated in FIG. 53 and FIG. 43, the ‘distance’ from the node “arts>music>jazz” to the node “arts>music” is 1.2, the ‘distance’ from the node “arts>music>jazz” to the node “arts>music>jazz>artists” is 0.8, and the ‘distance’ from the node “arts>music>jazz” to the node “shopping>music>jazz” is 0.5. The function associated with each node link in the example is subtraction, but any function(s) may be used to modify a rating(s) of a guide and/or information associated with a selection index. A distance function may be defined in various ways, which may allow the distance between any proper path and any other proper path to be computed. As previously mentioned, the functional relationships between proper paths or nodes may be bidirectional or unidirectional. For example, the distance from the node ‘arts>music’ to the node ‘arts>music>jazz’ may be different than the distance from the node ‘arts>music>jazz’ to the node ‘arts>music’.

The examples used herein above with respect to FIGS. 40, 4, 5 and 6 have been illustrated using a limited number of records, categorization levels, topics, proper paths and guides for the purposes of illustration, any number of records, categorization levels, topics, proper paths and guides required to operate the embodiments may be utilized. While the example of selection of a guide(s) to be associated with a search request based on information associated with a categorization associated with the search request and the guide(s) has been used for the purposes of illustration, no limitation is implied thereby. Any type of item(s) might be selected to be associated with a target item(s) based on information associated with a categorization and/or other information associated with the target item(s) and the selected item(s). While several types of items have been illustrated as being associated with the same index in the categorization record 4100 (FIG. 41), it is envisioned that multiple indexes may be used for different types of items which may be related using linkages such as those defined herein.

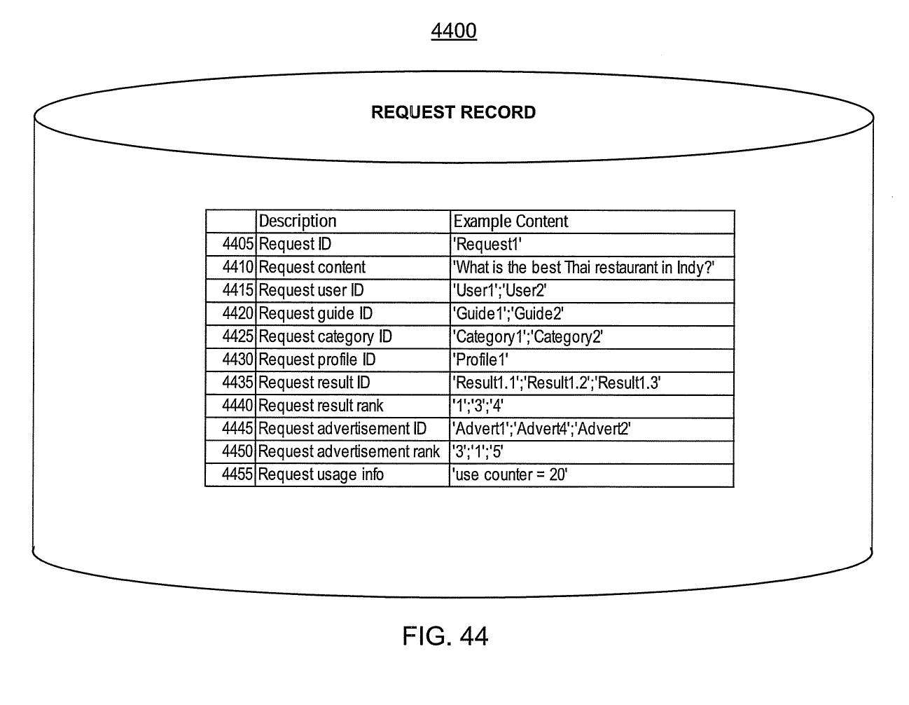

As illustrated in FIG. 44, an exemplary request record 4400 is provided, of which one or more may be associated with or resident in the search database 3820 (FIG. 38). The request record 4400 may include a request ID field 4405, a request content field 4410, a request user ID field 4415, a request guide ID field 4420, a request category ID field 4425, a request profile ID field 4430, a request result ID field 4435, a request result rank field 4440, a request advertisement ID field 4445, a request advertisement rank field 4450 and a request usage info field ID 4455.

A request record may be created responsive to various activities. For example, a guided search session, an interactive training session, a non-interactive training session, submission of a request by a user, and/or other types of activity may cause a request record to be created and/or modified. A request record may be imported from an external resource(s), a database, and/or any media accessible to the search system 3830.

The request ID field 4405 preferably contains a unique identifier of a request, which is preferably used consistently. For example, in at least one embodiment, the request ID field 4405 can include a randomly generated numerical code, and/or a text string indicating the content of a request. A request ID serves to distinguish the request record associated with a request from a request record associated with other requests. Other unique identifiers of a request may be utilized without departing from the spirit and scope of the embodiments.

A unique identifier may be assigned to a request when it is received. A request may include information that is not explicitly provided by a user. For example, location information, profile information, etc. may be associated with a request. As illustrated in FIG. 44, ‘Request1’ is the request ID associated with the request record 4400 (FIG. 44).

The request content field 4410 may include information regarding content of a request. For example, text associated with a query submitted by a user may be indicated in the request content field 4410. Content of the request content field 4410 may be processed in order to associate a keyword(s) and/or category(ies) and/or other information with a request. In at least one embodiment, a structured query which conforms to a specific context may be indicated in the request content field 4410. User requests which are associated with a structured query which may have been submitted by a number of users may be indicated in the request content field 4410. Information such as audio recordings, images, etc. which are associated with a request may be indicated in the request content field 4410. Using the example illustrated in FIG. 44, the query ‘What is the best That restaurant in Indy?.mp3’ is the content associated with the request record 4400. This may indicate that the query ‘What is the best That restaurant in Indy?.mp3’ may be processed in order to respond to ‘Request1’. Information indicated in the request content field 4410 may be used to determine which information associated with an index may be provided responsive to a request. For example, keywords associated with a transcription of the request ‘What is the best That restaurant in Indy?.mp3’ may compared to interests or keywords associated with an index to determine a number of categories associated with the request ‘Request1’.

The request user ID field 4415 may include information of a user(s) that submitted a query. The request user ID field 4415 may be used to associate any number of users with a query. In at least one embodiment, each request is uniquely associated with a single user. In at least one embodiment, if a request submitted by a user is equivalent to a previous request, multiple users may be associated with a request. In at least one embodiment, an individual user may submit a request which is associated with a group(s) of one or more users. A result(s) and/or other item(s) associated with a request may be presented responsive to a request in an order based at least in part on a ranking of the item(s) associated with the request. Information indicated in the request user ID field 4415 may be used to obtain information of a user(s) using a record(s) such as the user record 4600 illustrated in FIG. 46. Using the example illustrated in FIG. 44 ‘User1’ and ‘User2’ are associated with ‘Request1’.

The request guide ID field 4420 may include information of a number of guides associated with a request. For example, if a guide obtains a search result(s) responsive to ‘Request1’, an identifier of the guide may be indicated in the request guide ID field 4420. Likewise, if a guide was selected to respond to a request, an identifier of the guide may be indicated in the request guide ID field 4420. Information indicated in the request guide ID field 4420 may be used to obtain information associated with a guide using a record(s) such as the guide record 4500 illustrated in FIG. 45. A guide may be associated with a request if the guide has reviewed information associated with a request. Using the example illustrated in FIG. 44 the guides ‘Guide1’ and ‘Guide2’ have been associated with ‘Request1’.

The request category ID field 4425 may include information of a number of categorizations and/or keywords associated with a request. Content of the request category ID field 4425 may be modified by an automated classification of a request. A human may select a category(ies) and/or keyword(s) associated with a request. A categorization may be associated with a resource(s), a guide(s), an advertisement(s), training information, etc. An item(s) associated with a category may be presented to a guide(s) and/or a user(s) if a request associated with a category is submitted. An item(s) associated with a category and/or other information may be presented for review by a person(s). Association of a category with a request may be used to select items such as an advertisement(s) associated with the category to be presented responsive to a request. Association of a category with a request may be used to select a guide(s) associated with the category to vote regarding an item associated with the request. A category may be associated with a request based on any type of information associated with the request. Using the example illustrated in FIG. 44, the categories ‘Category1’ and ‘Category2’ are associated with ‘Request1’.

The request profile ID field 4430 may include information of a number of profiles associated with a request. For example, a profile may be associated with a request based at least in part on a profile(s) associated with a user(s) associated with a request. For example, a geographic profile which is common to a number of users associated with a request may be associated with a request, or a guide may determine that a profile is to be associated with a request based on content and/or subject matter of a request(s) associated with a user(s), etc. A guide selected to respond to a request may be selected based at least in part on a profile(s) associated with the request. A reviewer(s) may be selected to review an item(s) associated with a request based at least in part on a profile(s) associated with a request. Using the example illustrated in FIG. 44, ‘Profile1’ is associated with ‘Request1’.

The request result ID field 4435 may include information of a result(s) which is associated with a request. For example, a search result may be associated with a request when a guide obtains the search result responsive to the request. For example, if a request is submitted to the search system 3830 (FIG. 38), a guide may be selected, and the guide may provide a result(s) responsive to the request. Alternately, a result(s) may be associated with a request if the request is submitted to a resource such as a search engine, database or other resource system. Any number of search results may be associated with a request. Using the example illustrated in FIG. 44, ‘Result1.1’, ‘Result1.2’, and ‘Result1.3’ have been associated with ‘Request1’.

The request result rank field 4440 may include information regarding a ranking of a result(s) associated with a request. In at least one embodiment, the request result ID field 4435 and the request result rank field 4440 are linked by for example a pointer. Using the example illustrated in FIG. 44, ‘Result1.1’ has a ranking of ‘1’, ‘Result1.2’ has a ranking of ‘3’, and ‘Result1.3’ has a ranking of ‘4’. Content of the request result ID field 4435 and the request result rank field 4440 may be used at least in part to determine an order in which a search result(s) are presented to a user(s) responsive to a request. Using the example illustrated in FIG. 44, ‘Result1.1’ might be preferentially presented to a user(s) responsive to ‘Request1’. A ranking of a result may be determined based on criteria such as keyword ranking, guide ratings, etc. which may include automated and/or human assisted rating and/or ranking.

The request advertisement ID field 4445 may include information of an advertisement(s) which is associated with a request. For example, an advertisement may be associated with a request when a guide selects the advertisement to be presented to a user responsive to the request. For example, if a request is submitted to the search system 3830 (FIG. 38), a guide may be selected, and the guide may provide an advertisement(s) responsive to the request. Alternately, an advertisement(s) may be associated with a request automatically such as when a category(ies) and/or a keyword(s) is associated with the request. Any number of advertisements may be associated with a request. Using the example illustrated in FIG. 44, ‘Advert1’, ‘Advert4’, and ‘Advert2’ have been associated with ‘Request1’.

The request advertisement rank field 4450 may include information regarding a ranking of an advertisement(s) associated with a request. In at least one embodiment, the request advertisement ID field 4445 and the request advertisement rank field 4450 are linked by for example a pointer. Using the example illustrated in FIG. 44, ‘Advert1’ has a ranking of ‘3’, ‘Advert4’ has a ranking of ‘1’, and ‘Advert2’ has a ranking of ‘5’. Content of the request advertisement ID field 4445 and the request advertisement rank field 4450 may be used at least in part to determine an order in which an advertisement(s) are presented responsive to a request. Using the example illustrated in FIG. 44, ‘Advert4’ might be preferentially presented to a user(s) responsive to ‘Request1’.

The request usage info field 4455 may include information of usage of a request. For example, if multiple users submit a request which is equivalent to ‘Request1’ the request usage info field may be incremented. Content of the request usage info field 4455 may be used for various purposes. For example, if a request receives high usage, it may be determined that a review of information associated with the request may be performed, or if a request receives high usage, a guide who has produced a highest ranked result associated with the request may receive recognition or compensation, etc. Using the example in FIG. 44, the usage indicator ‘use counter=20’ is associated with ‘Request1’.

As illustrated in FIG. 45, an exemplary guide record 4500 is provided, of which one or more may be associated with or resident in the search database 3820 (FIG. 38). The guide record 4500 may include a guide ID field 4505, a guide category ID field 4510, a guide topic ID field 4515, a guide profile ID field 4520, a guide result ID field 4525, a guide communication info field 4530, and a guide request ID field 4535.

The guide ID field 4505 preferably contains a unique identifier of a guide, which is preferably used consistently. For example, in at least one embodiment, the guide ID field 4505 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 45, ‘Guide1’ is the guide ID associated with the guide record 4500.

The guide category ID field 4510 may include information of a number of categories associated with a guide. Content of the guide category ID field 4510 may be modified based on an action(s) of a guide. A category(ies) may be associated with a guide based on one or more types of information processing. For example, the category ‘translate English to Spanish’, or ‘transcribe spoken queries’ or ‘Sports’ might be associated with a guide to indicate a skill or expertise associated with the guide. Such an association may be used in part to rate or rank a guide(s) and/or to select a guide(s). A person may select a category(ies) and/or keyword(s) which is associated with a guide. A category may be associated with a guide based on testing of a guide(s). A category may be associated with a guide based on an affiliate group associated with the guide. For example, if a guide has chosen to be affiliated with affiliate groups associated with a type of food, a category associated with the type of food might be associated with the guide. A category may signify any type of skill or expertise which may be used to match a guide to a task. A category(ies) associated with a guide may be used to select an item(s) which is to be presented to a guide. A guide(s) may be selected to review an item(s) based on the association of a guide with a category(ies). For example, a guide may be selected to review and/or provide information such as resources, media, search results, etc. based on a category associated with the guide. Using the example illustrated in FIG. 45, ‘Category1’ and ‘Category3’ are associated with ‘Guide1’.

The guide topic ID field 4515 may include information of a number of topics associated with a guide. Content of the guide topic ID field 4515 may be modified based on an action(s) of a guide. A person may select a topic which is associated with a guide. For example, a guide may select a topic(s) to be associated with the guide during a registration process. A topic may be associated with a guide based on testing of a guide(s). For example, a guide may be required to demonstrate knowledge of a category and/or topic(s) in order to be associated with the topic(s). Content of the guide topic ID field 4515 may be compared to content of a request in order to determine a ranking of a guide(s) for responding to a request. For example, if a topic indicated in the guide topic ID field is associated with content of a request, the guide may be more likely to be selected to respond to the request. Using the example illustrated in FIG. 45, the topics ‘reggie miller’, ‘basketball’ and ‘fishing’ are associated with ‘Guide1’. This may indicate that ‘Guide1’ has indicated an interest in ‘reggie miller’, ‘basketball’ and ‘fishing’.

The guide profile ID field 4520 may include information of a number of profiles associated with a guide. Content of the guide profile ID field 4520 may be modified based on action(s) of a guide. A person may select a profile which is associated with a guide. For example, a guide may select a profile(s) to be associated with the guide during a registration process. A profile may be associated with a guide based on testing of a guide(s). For example, a guide may be required to demonstrate knowledge relevant to a profile(s) in order to be associated with the profile(s), or a guide may take a test which is used to generate a profile, or a guide may provide information such as demographic, geographic, personality or other information which may be indicated in a profile(s) associated with the guide. Information indicated in a guide profile may be obtained from an external database. Information indicated in the content of the guide profile ID field 4520 may be compared to information indicated in the content of a profile(s) associated with a request in order to determine a ranking of a guide(s) for responding to a request. Likewise, a profile(s) associated with a guide(s) may be used to select and/or rank a guide(s). Using the example illustrated in FIG. 45, ‘Demoprofileg1’, ‘Geoprofileg1’ and ‘Persprofileg1’ are associated with ‘Guide1’. This may indicate that ‘Guide1’ has indicated and/or generated ‘Demoprofileg1’ which may be a demographic profile, ‘Geoprofileg1’ which may be a geographic profile and ‘Persprofileg1’ which might indicate personality information regarding ‘Guide1’. Any or all information indicated in a profile(s) associated with a guide may be used to determine a rating and/or ranking of a guide.

The guide result ID field 4525 may include information of a result(s) associated with a guide. Content of the guide result ID field 4525 may be modified based on an action(s) of a guide. If a guide produces a search result(s) responsive to a request(s), an identifier of the search result(s) may be included in the guide result ID field 4525. A rating(s) and/or ranking(s) associated with a search result(s) associated with a guide may affect compensation for a guide. Likewise a usage indicator associated with a search result(s) provided by a guide may affect a rating(s) and/or ranking(s) associated with a guide. Using the example illustrated in FIG. 45, ‘Result1.1’, ‘Result3.1’ and ‘Result3.2’ are associated with ‘Guide1’. This may indicate that ‘Guide1’ has provided and/or reviewed ‘Result1.1’, ‘Result3.1’, and ‘Result3.2’.

The guide communication info field 4530 may include information of a device(s) and/or service(s) associated with a guide. Content of the guide communication info field 4530 may be modified based on an action(s) of a guide. If a guide establishes communications using a device(s) and/or service(s), information regarding the device(s) and/or service(s) may be included in the guide communication info field 4530. Any type of communication service(s) and/or system(s) may be indicated in the guide communication info field 4530. For example, a username and/or password associated with a guide may be indicated in the guide communication info field 4530. Communication services such as IM, e-mail, SMS, MMS, EMS, telephone, wireless or wired communication, etc. may be indicated in the guide communication info field 4530. A telephone number, an email address, an IM provider and login ID, a keyword(s) associated with a service, etc. may be indicated in the guide communication info field 4530. Using the example illustrated in FIG. 45, the login ‘guide1’, the email ‘guide1@chacha.com’, the IM credential ‘guide1@AIM’ and the phone number ‘317.224.2242’ are associated with ‘Guide1’. This may indicate that ‘Guide1’ may be contacted using the login ID ‘guide1’, via email at ‘guide1@chacha.com’, via IM as ‘guide1@AIM’ and/or via voice, text, and/or other service(s) associated with the phone number ‘317.224.2242’.

The guide request ID field 4535 may include information of a request(s) associated with a guide. Content of the guide request ID field 4535 may be modified based on an action(s) of a guide. If a guide produces a search result(s) responsive to a request(s), an identifier of the request(s) may be included in the guide request ID field 4535. A rating(s) and/or ranking(s) associated with a request(s) associated with a guide may affect compensation for a guide. Likewise a usage indicator associated with a request(s) and a guide may affect a rating(s) and/or ranking(s) associated with the guide. A request may be associated with a guide based on a vote(s) cast by a guide regarding items associated with the request. Using the example illustrated in FIG. 45, ‘Request1’, and ‘Request3’ are associated with ‘Guide1’. This may indicate that ‘Guide1’ has responded to, been selected to respond to, and/or has reviewed one or more item(s) associated with ‘Request1’, and ‘Request3’.

As illustrated in FIG. 46, an exemplary a user record 4600 is provided, of which one or more may be associated with or resident in the search database 3820 (FIG. 38). The user record 4600 may include a user ID field 4605, a user profile ID field 4610, a user request ID field 4615, a user result ID field 4620, a user advertisement ID field 4625, and a user communication info field 4630.

The user ID field 4605 preferably contains a unique identifier of a user, which is preferably used consistently. For example, in at least one embodiment, the user ID field 4605 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 46, ‘User1’ is the user ID associated with the user record 4600.

The user profile ID field 4610 may include information of a profile(s) associated with a user. Content of the user profile ID field 4610 may be modified based on an action(s) of a user. A person may select a profile which is associated with a user. For example, a user may select a profile(s) to be associated with the user during a registration process. A profile may be associated with a user based on testing of a user(s) and/or information from users. For example, a user may be required to demonstrate knowledge relevant to a profile(s) in order to be associated with the profile(s), or a user may take a test which is used to generate a profile, or a user may provide information such as demographic, geographic, personality or other information which may be indicated in a profile(s) associated with the user. Historical information such as a request(s) and/or result(s) associated with a user may be used to determine profile information. Information indicated in a user profile may be obtained from an external database. A profile(s) associated with a user(s) may be used to select and/or rank a user(s) for voting. Using the example illustrated in FIG. 46, ‘DemoprofileU1’, ‘GeoprofileU1’ and ‘PersprofileU1’ are associated with the user ‘User1’. This may indicate that ‘User1’ has indicated and/or generated ‘DemoprofileU1’ which may be a demographic profile, ‘GeoprofileU1’ which may be a geographic profile and ‘PersprofileU1’ which might indicate personality information regarding ‘User1’.

The user request ID field 4615 may include information of a request(s) associated with a user. Content of the user request ID field 4615 may be modified based on an action(s) of a user. If a user submits a request an identifier of the request may be included in the user request ID field 4615. Using the example illustrated in FIG. 46, ‘Request1’ and ‘Request2’ are associated with ‘User1’ which may indicate that ‘User1’ has submitted ‘Request1’ and ‘Request2’.

The user result ID field 4620 may include information of a result(s) associated with a user. Content of the user result ID field 4620 may be modified based on an action(s) of a user and/or a guide(s). If a user receives a result(s) responsive to a request(s), an identifier of the result(s) may be included in the user result ID field 4620. A usage indicator associated with a result(s) provided to a user(s) may affect a rating(s) and/or ranking(s) associated with a guide. Using the example illustrated in FIG. 46, ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’.

The user advertisement ID field 4625 may include information of an advertisement(s) associated with a user. Content of the user advertisement ID field 4625 may be modified based on an action(s) of a user. If a user receives an advertisement(s), an identifier of the advertisement(s) may be included in the user advertisement ID field 4625. A usage indicator associated with an advertisement(s) provided to a user(s) may affect a rating(s) and/or ranking(s) associated with a guide, compensation for the search system, and/or rating(s) and/or ranking(s) of an advertisement(s). Using the example illustrated in FIG. 46, ‘Advert1’ and ‘Advert2’ are associated with ‘User1’. This may indicate that ‘User1’ has been presented with ‘Advert1’, and ‘Advert2’.

The user communication info field 4630 may include information of a device(s) and/or service(s) associated with a user. Content of the user communication info field 4630 may be modified based on an action(s) of a user. If a user establishes communications using a device(s) and/or service(s), information regarding the device(s) and/or service(s) may be included in the user communication info field 4630. Any type of communication service(s) and/or system(s) may be indicated in the user communication info field 4630. For example, a username and/or password associated with a user may be indicated in the user communication info field 4630. Communication services such as IM, e-mail, SMS, MMS, EMS, telephone, wireless or wired communication, etc. may be indicated in the user communication info field 4630. A telephone number, an email address, an IM provider and login ID, a keyword(s) associated with a service, etc. may be indicated in the user communication info field 4630. Using the example illustrated in FIG. 46, the login ‘user1’, the email ‘user1@chacha.com’, the Twitter™ service account ‘twitter:user1’ and the phone number ‘317.924.2242’ are associated with ‘User1’. This may indicate that ‘User1’ may be contacted using the login ID ‘user1’, via email at ‘user1@chacha.com’, via Twitter as ‘user1’ and/or via voice, text, and/or other service(s) associated with the phone number ‘317.924.2242’.

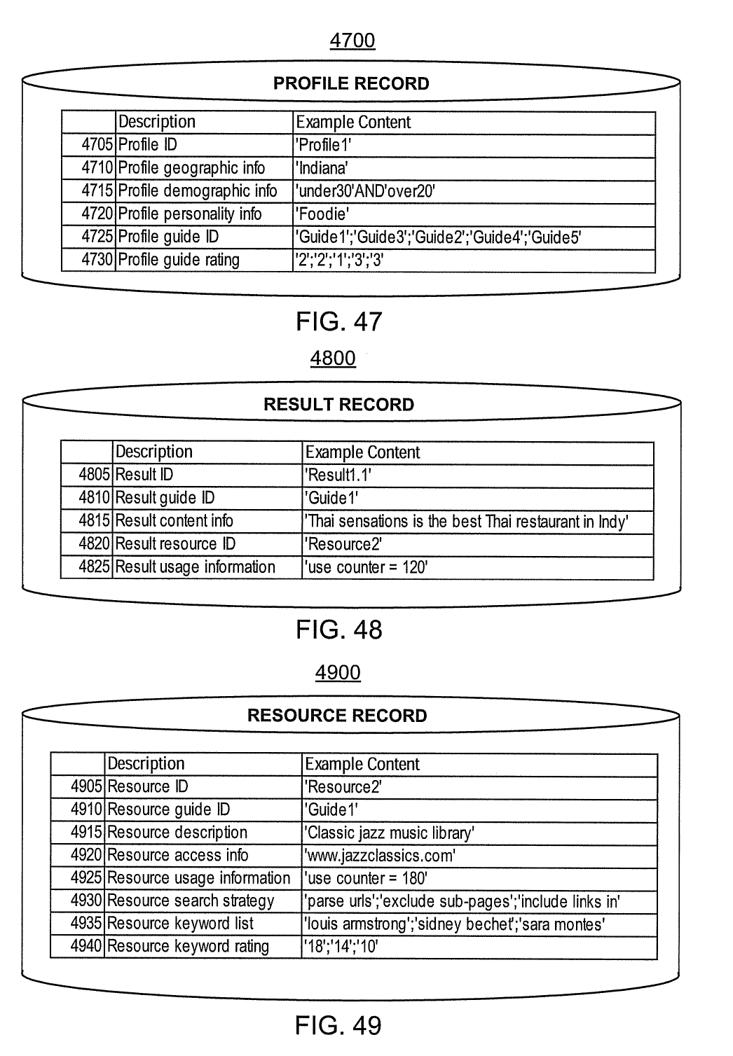

As illustrated in FIG. 47, an exemplary a profile record 4700 is provided, of which one or more may be associated with or resident in the database 3820 (FIG. 38). The profile record 4700 may include a profile ID field 4705, a profile geographic info field 4710, a profile demographic info field 4715, a profile personality info field 4720, a profile guide ID field 4725, and a profile guide rating field 4730.

The profile ID field 4705 preferably contains a unique identifier of a profile, which is preferably used consistently. For example, in at least one embodiment, the profile ID field 4705 can include a randomly generated numerical code, and/or a text string indicating a name associated with a profile. A profile ID serves to distinguish a profile record associated with a profile from a profile record associated with other profiles. Other unique identifiers of a profile may be utilized without departing from the spirit and scope of the embodiments. In at least one embodiment, a profile ID may include a description associated with a profile. Using the example illustrated in FIG. 47, ‘Profile1’ is the profile ID associated with the profile record 4700.

The profile geographic info field 4710 may include geographic information associated with a profile. Any type of geographic information may be indicated in the profile geographic info field 4710. For example, GPS coordinates, a street address, a neighborhood name, a postal code, a city name, a state name, etc. could be indicated in the profile geographic info field 4710. Using the example illustrated in FIG. 47, the geographic information ‘Indiana’ is associated with ‘Profile1’. This may indicate for example that a person with a home address in and/or other profile information associated with geographic information of the state of ‘Indiana’ may match ‘Profile1’, or may receive a higher rating(s) and/or ranking(s) associated with ‘Profile1’.

The profile demographic info field 4715 may include demographic information associated with a profile. Any type of demographic information may be indicated in the profile demographic info field 4715. For example, date of birth, sex, race, political affiliation, income, number of children, marital status, membership in organizations, etc. could be indicated in the profile demographic info field 4715. Using the example illustrated in FIG. 47, the demographic information ‘under30’AND‘over20’ is associated with ‘Profile1’. This may indicate that a person aged greater than 20 years and less than 30 years may receive a higher rating(s) and/or ranking(s) associated with ‘Profile1’.

The profile personality info field 4720 may include personality information associated with a profile. Any type of personality information may be indicated in the profile personality info field 4720. For example, information of personality traits such as aggressiveness, curiosity, friendliness, intelligence, honesty, food preference, music preference, political affiliation, etc. could be indicated in the profile personality info field 4720. Using the example illustrated in FIG. 47, the characteristic ‘Foodie’ is associated with ‘Profile1’. This may indicate that persons with an interest in food and/or restaurants may receive a higher rating(s) and/or ranking(s) associated with ‘Profile1’.

The profile guide ID field 4725 may include information of a guide(s) who are associated with a profile. For example, if a guide elects to receive requests associated with ‘Profile1’, or if profile information of a guide matches a profile, an identifier of the guide may be indicated in the profile guide ID field 4725 Information indicated in the profile guide ID field 4725 may be used to obtain information associated with a guide using a record(s) such as the guide record 4500 (FIG. 45). Using the example illustrated in FIG. 47 ‘Guide1’, ‘Guide3’, ‘Guide2’, ‘Guide4’ and ‘Guide5’ have been associated with ‘Profile1’.

The profile guide rating field 4730 may include information regarding a rating of a guide(s) associated with a profile. In at least one embodiment, the profile guide ID field 4725 and the profile guide rating field 4730 are linked by for example a pointer. Using the example illustrated in FIG. 47, ‘Guide1’ has a rating of ‘2’, ‘Guide3’ has a rating of ‘2’, ‘Guide2’ has a rating of ‘1’, ‘Guide4’ has a rating of ‘3’ and ‘Guide5’ has a rating of ‘3’. Content of the profile guide ID field 4725 and the profile guide rating field 4730 may be used at least in part to determine an order in which a guide(s) are notified responsive to a request, a voting activity, a review activity, or other types of tasks and/or activities associated with a profile(s). Using the example illustrated in FIG. 47, ‘Guide2’ might be preferentially notified of a request associated with ‘Profile1’. Any number of guides may be associated with a profile(s).

As illustrated in FIG. 48, an exemplary result record 4800 is provided, of which one or more may be associated with or resident in the search database 3820 (FIG. 38) The result record 4800 may include a result ID field 4805, a result guide ID field 4810, a result content info field 4815, a result resource ID field 4820 and a result usage information field 4825.

The result ID field 4805 preferably contains a unique identifier of a result, which is preferably used consistently. For example, in at least one embodiment, the result ID field 4805 can include a randomly generated numerical code, and/or a text string indicating a name associated with a result. A result ID serves to distinguish the result record associated with a result from a result record associated with other results. Other unique identifiers of a result may be utilized without departing from the spirit and scope of the embodiments. In at least one embodiment, a result ID may include a description associated with a result. Using the example illustrated in FIG. 48, ‘Result1.1’ is the result ID associated with the result record 4800.

The result guide ID field 4810 may include information of a guide(s) associated with a result. For example, a guide who obtained a result may be indicated in the result guide ID field 4810. In at least one embodiment a guide ID associated with a guide(s) who have voted on a result may be indicated in the result guide ID field 4810. Information contained in the result guide ID field 4810 may be used to obtain information regarding a guide associated with a search result based on records such as the guide record 4500 (FIG. 45). Using the example illustrated in FIG. 48, ‘Guide1’ is associated with ‘Result1.1’ which may indicate that ‘Guide1’ has provided ‘Result1.1’.

The result content info field 4815 may include information of content of a result. For example, a text snippet associated with a result may be indicated in the result content info field 4815. A URL or other information associated with a result may be indicated in the result content info field 4815. Information contained in the result content info field 4815 may be used to provide information of a result to a user(s) and/or a guide(s). For example, text indicated in the result content info field may be sent to a user as an SMS message. Using the example illustrated in FIG. 48, the text snippet ‘That sensations is the best That restaurant in Indy’ is associated with ‘Result1.1’. This may indicate that ‘That sensations is the best That restaurant in Indy’ may be provided if ‘Result1.1’ is selected to be presented.

The result resource ID field 4820 may include information of a resource associated with a result. For example, a URL associated with a web page from which a text snippet was obtained may be indicated in the result resource ID field 4820. A URL and/or other information such as a search query and/or a macro instruction(s) associated with a resource may be indicated in the result resource ID field 4820. Information contained in the result resource ID field 4820 may be used to provide access to a resource(s) for a guide(s), users(s) and/or the search system 3830 (FIG. 38). Using the example illustrated in FIG. 48, ‘Resource2’ is the resource ID associated with the result ‘Result1.1’. This may indicate that ‘Resource2’ was used to obtain ‘Result1.1’.

The result usage information field 4825 may include information regarding the use of a result. For example, a number of times that a result has been presented may be indicated in the result usage information field 4825. Using the example illustrated in FIG. 48, the indicator ‘use counter=120’ is associated with ‘Result1.1’. This may indicate that ‘Result1.1’ has been presented one hundred twenty times. Information in the result usage information field 4825 may be utilized to determine whether a result is to be reviewed.

As illustrated in FIG. 49, an exemplary resource record 4900 is provided, of which one or more may be associated with or resident in the search database 3820 (FIG. 38). The resource record 4900 may include a resource ID field 4905, a resource guide ID field 4910, a resource description field 4915, a resource access info field 4920, a resource usage information field 4925, a resource search strategy field 4930, a resource keyword(s) list field 4935, and a resource keyword rating field 4940.

The resource ID field 4905 preferably contains a unique identifier of a resource, which is preferably used consistently. For example, in at least one embodiment, the resource ID field 4905 can include a randomly generated numerical code, and/or a text string indicating a name associated with a resource. A resource ID serves to distinguish the resource record associated with a resource from a resource record associated with other resources. Other unique identifiers of a resource may be utilized without departing from the spirit and scope of the embodiments. In at least one embodiment, a resource ID may include a description associated with a resource. Using the example illustrated in FIG. 49, ‘Resource2’ is the resource ID associated with the resource record 4900.

The resource guide ID field 4910 may include information of a guide(s) associated with a resource. For example, a guide(s) who utilized a search resource may be indicated in the resource guide ID field 4910. In at least one embodiment a guide ID associated with a guide(s) who have voted on a resource may be indicated in the resource guide ID field 4910. Information contained in the resource guide ID field 4910 may be used to obtain information regarding a guide associated with a search resource based on records such as the guide record 4500 (FIG. 45). Using the example illustrated in FIG. 49, the guide ID ‘Guide1’ is associated with the resource ‘Resource2’ which may indicate that the guide ‘Guide1’ has administrative access to the search resource ‘Resource2’.

The resource description field 4915 may include information of a description of a search resource. For example, a text snippet associated with a search resource may be indicated in the resource description field 4915. A URL or other information associated with a search resource may be indicated in the resource description field 4915. Information contained in the resource description field 4915 may be used to provide a description of search resource to a user(s) and/or a guide(s). Using the example illustrated in FIG. 49, the text snippet ‘Classic jazz music library’ is associated with ‘Resource2’.

The resource access info field 4920 may include access information associated with a search resource. For example, a URL associated with a web page may be indicated in the resource access info field 4920. A password, a login ID, a template for submitting a search query, an API for submitting and receiving information or any other information which may be utilized to access a search resource may be indicated in the resource access info field 4920. Information contained in the resource access info field 4920 may be used to provide access to a search resource(s) for a guide(s) and/or the search system 3830 (FIG. 38). Using the example illustrated in FIG. 49, the URL ‘www.jazzclassics.com’ is the access information associated with the resource ‘Resource2’. This may for example indicate that a search result(s) may be obtained using the resources found at “www.jazzclassics.com’.

The resource usage information field 4925 may include information regarding the use of a search resource. For example, a number of times that a search resource has been utilized by a guide(s) may be indicated in the resource usage information field 4925. Using the example illustrated in FIG. 49, the indicator ‘use counter=180’ is associated with ‘Resource2’. This may indicate that ‘Resource2’ has been utilized by a guide(s) one hundred eighty times. Information in the resource usage information field 4925 may be utilized to determine whether a search resource is to be reviewed.

The resource search strategy field 4930 may include information regarding a search to be conducted. For example, a set of annotations, keywords, ratings, rankings, URLS, rules, guide(s), user(s) or any other information which may be used to perform identify and/or rank a keyword(s) or interest which may be associated with a resource may be indicated. Using the example illustrated in FIG. 49, the information ‘parse urls’, ‘exclude sub-pages’, and ‘include links in’ is associated with ‘Resource2’. This may indicate for example that ‘Resource2’ may be subjected to a search strategy which parse the content of a URL associated with a resource, may exclude areas of a resource such as ‘child URLs’, and may apply a weighting to a number of pages which link to the resource. While a few examples of search strategy information are described, other types of information might be indicated, such as whether a persons(s) may review a result(s), etc. which will readily occur to one of ordinary skill in the relevant art. Information in the resource search strategy field 4930 may be utilized to identify and/or rank a keyword(s) or other item(s) identified as a result of a search.

The resource keyword list field 4935 may include information regarding a keyword(s) or other item(s). For example, a keyword(s) which may have been identified, and/or sought and/or ranked and/or rated might be indicated in the resource keyword list field 4935. Using the example illustrated in FIG. 49, the information ‘louis armstrong’, ‘sidney bechet’, and ‘sara montes’ is associated with the resource ‘Resource2’. This may indicate for example that ‘Resource2’ may be processed to obtain information regarding ‘louis armstrong’, ‘sidney bechet’, and ‘sara montes’, such as for example a rating(s), a ranking(s), a frequency of use, commonality of use, etc, and/or that the item(s) may have been obtained originally from ‘Resource 2’, and/or that a guide(s) associated with ‘Resource 2’ may be associated with ‘louis armstrong’, ‘sidney bechet’, and ‘sara montes’, etc. While a few examples of items which might be associated with a resource are illustrated in FIG. 49, any type or number of items might be indicated in the resource keyword list field 4935. Information in the resource keyword list field 4935 may be utilized for various purposes, which may include selecting an item(s) such as a guide(s), a user(s), a search result(s), an advertisement(s), a persons(s), a profile(s), etc.

The resource keyword rating field 4940 may include information regarding a rating(s) or ranking(s). For example, a rating of any sort such as numeric, percentage, alphanumeric, ranking, and/or other form of rating data may be indicated in the resource keyword rating field 4935. In at least one embodiment, the resource keyword list field 4935 and the resource keyword rating field 4940 may be linked by for example a pointer. Using the example illustrated in FIG. 49, the information ‘18’, ‘14’ and ‘10’ have been associated with ‘Resource 2’. This may indicate for example that the keyword ‘louis armstrong’ has a rating of ‘18’ the keyword ‘sidney bechet’, has a rating of ‘14’ and the keyword ‘sara montes’ has a rating of ‘10’, which may be associated with information obtained from and/or utilized with ‘Resource 2’. In at least one embodiment, a keyword may be added to the categorization system interest ID field 4225 of a categorization.

As illustrated in FIG. 50, an exemplary advertisement record 5000 is provided, of which one or more may be associated with or resident in the search database 3820 (FIG. 38). The advertisement record 5000 may include an advertisement ID field 5005, an advertisement description field 5010, an advertisement access info field 5015, an advertisement usage information field 5020, an advertisement interest ID field 5025, and an advertisement category ID field 5030. An advertisement may include any type of content, which may be sponsored in any way.

The advertisement ID field 5005 preferably contains a unique identifier of an advertisement, which is preferably used consistently. For example, in at least one embodiment, the advertisement ID field 5005 can include a randomly generated numerical code, and/or a text string indicating a name associated with an advertisement. An advertisement ID serves to distinguish the advertisement record associated with an advertisement from an advertisement record associated with other advertisements. Other unique identifiers of an advertisement may be utilized without departing from the spirit and scope of the embodiments. In at least one embodiment, an advertisement ID may include a description associated with an advertisement. Using the example illustrated in FIG. 50, ‘Advert1’ is the advertisement ID associated with the advertisement record 5000.

The advertisement description field 5010 may include information of a description associated with an advertisement. For example, a description of an advertisement may be presented to a guide(s) in order that a guide may select an advertisement to be associated with a search request. Using the example illustrated in FIG. 50, ‘jazz music from the jazz archive’ is the advertisement description associated with the advertisement ‘Advert1’. Any type of information such as text, audio, video, images, etc. may be indicated in the advertisement description field 5010.

The advertisement access info field 5015 may include access information associated with an advertisement. For example, a URL associated with a web page may be indicated in the advertisement access info field 5015. Information contained in the advertisement access info field 5015 may for example be used to provide access to an advertisement(s) for a guide(s) and/or the search system 3830 (FIG. 38). Using the example illustrated in FIG. 50, the URL ‘https://adserver.chacha.com/jazzarchive’ is the access information associated with the advertisement ‘Advert1’. This may for example indicate that the advertisement ‘Advert1’ may be delivered to a user using content accessed at ‘https://adserver.chacha.com/jazzarchive’. Advertisement access information may indicate a resource(s) associated with an advertisement(s).

The advertisement usage information field 5020 may include information regarding the use of an advertisement. For example, a number of times that an advertisement has been delivered to a user(s) may be indicated in the advertisement usage information field 5020. Using the example illustrated in FIG. 50, the indicators ‘210’, ‘114’, ‘46’, ‘150’ and ‘10’ are associated with the advertisement ‘Advert1’. This may indicate usage of ‘Advert1’ for any purpose. Information in the advertisement usage information field 5020 may be utilized to determine whether an advertisement is to be reviewed, and may be utilized to determine compensation for a guide(s) and/or the provider of the search system 3830 (FIG. 38).

The advertisement interest ID field 5025 may include information of one or more interests or keywords which may be associated with an advertisement. In at least one embodiment, the advertisement interest ID field 5025 and the advertisement usage information field 5020 may be linked by for example a pointer. Using the example illustrated in FIG. 50, the interests ‘louis armstrong’, ‘sara montes’, and ‘miles davis’ are associated with the advertisement ‘Advert1’. This may for example indicate that the advertisement ‘Advert1’ is associated with the keywords ‘louis armstrong’, ‘sara montes’, and ‘miles davis’, and/or that ‘Advert1’ has been selected and/or presented ‘210’, ‘114’, and ‘46’ times in association with the keywords ‘louis armstrong’, ‘sara montes’, and ‘miles davis’. Any item(s) may be indicated in the advertisement interest ID field 5025, including but not limited to any or all of a word(s), phrase(s), sentence(s), image(s), audio, video, etc.

The advertisement category ID field 5030 may include information of one or more categories or nodes within an index which may be associated with an advertisement. In at least one embodiment, the advertisement category ID field 5030 and the advertisement usage information field 5020 may be linked by for example a pointer. Using the example illustrated in FIG. 50, the categories ‘arts>music>jazz’ and ‘arts>jazz>artists’ are associated with the advertisement ‘Advert1’. This may for example indicate that the advertisement ‘Advert1’ is associated with the categories ‘arts>music>jazz’ and ‘arts>jazz>artists’ and/or that the advertisement ‘Advert1’ has been selected and/or presented ‘150’, and ‘10’ times in association with the categories ‘arts>music>jazz’ and ‘arts>jazz>artists’.

As illustrated in FIG. 51, an exemplary interest record 5100 is provided, of which one or more may be associated with or resident in the search database 3820 (FIG. 38). The interest record 5100 may include an interest ID field 5105, an interest description field 5110, an interest categorization ID field 5115, an interest usage information field 5120, an interest usage information field 5125, and an interest category ID field 5130.

The interest ID field 5105 preferably contains a unique identifier of an interest, which is preferably used consistently. For example, in at least one embodiment, the interest ID field 5105 can include a randomly generated numerical code, and/or a text string indicating a name associated with an interest. An interest ID serves to distinguish the interest record associated with an interest from an interest record associated with other interests. Other unique identifiers of an interest may be utilized without departing from the spirit and scope of the embodiments. In at least one embodiment, an interest ID may include a description associated with an interest. Using the example illustrated in FIG. 51, ‘louis armstrong’ is the interest ID associated with the interest record 5100.

The interest description field 5110 may include information of a description associated with an interest. For example, a description of an interest may be presented to a guide(s) in order that a guide may select an interest to be associated with a search request. Using the example illustrated in FIG. 51, ‘satchmo’ is the interest description associated with the interest ‘louis armstrong’. Any type of information such as text, audio, video, images, etc. may be indicated in the interest description field 5110.

The interest categorization ID field 5115 may include information of a categorization associated with an interest. For example, a categorization ID may be indicated in the interest categorization ID field 5115. Information contained in the interest categorization ID field 5115 may be used to indicate a categorizations associated with an interest. Using the example illustrated in FIG. 51, the categorizations ‘arts>music>jazz’ and ‘arts>jazz>artists’ are associated with the interest ‘louis armstrong’. This may for example indicate that the interest ‘louis armstrong’ may be used to associate the categories ‘arts>music>jazz’ and ‘arts>jazz>artists’ with a request. Any type of information may be used to indicate a categorization in the interest categorization field 5115.

The interest guide ID field 5120 may include information of one or more guides which may be associated with an interest. In at least one embodiment, the interest guide ID field 5120 and the interest usage information field 5120 may be linked by for example a pointer. Using the example illustrated in FIG. 51, the guide ‘system’ is associated with the interest ‘louis armstrong’. This may for example indicate that the interest ‘louis armstrong’ is associated with the guide ‘system’, which may indicate that no guide is currently associated with the interest ‘louis armstrong’, and/or that the ‘system’ has associated ‘220’ (i.e., 210+10) requests with the interest ‘louis armstrong’. A system interest may be an interest or keyword which has been obtained by processing of a resource(s), an advertisement(s), a search request, etc. a ranking of a keyword or interest may be based on various factors. Association of a guide(s) with an interest may be used for purposes such as ranking a guide(s), determining compensation for a guide(s), ranking items(s), etc.

The interest usage information field 5125 may include information regarding the use of an interest. For example, a number of times that an interest has been identified in a request(s) may be indicated in the interest usage information field 5125. Using the example illustrated in FIG. 51, the indicators ‘210’ and ‘10’ are associated with the interest ‘louis armstrong’. This may indicate usage of ‘louis armstrong’ for various purposes. Information in the interest usage information field 5125 may be utilized to determine whether an interest is to be reviewed, and may be utilized to determine if a guide(s) may be associated with an interest(s). For example, the interest ‘louis armstrong’ may have been detected ‘210’ times in requests associated with the category ‘arts>music>jazz’, which may indicate that a guide associated with ‘arts>music>jazz’ may be notified to consider being associated with ‘louis armstrong’.

The interest resource ID field 5130 may include information of one or more resources which may be associated with an interest. In at least one embodiment, the interest resource ID field 5130 and the interest usage information field 5120 may be linked by for example a pointer. Using the example illustrated in FIG. 51, the resources ‘Resource2’ and ‘Resource10’ are associated with the interest ‘louis armstrong’. This may for example indicate that the interest ‘louis armstrong’ that the resources ‘Resource2’ and ‘Resource10’ may include information relevant to ‘louis armstrong’ and/or that the interest ‘louis armstrong’ has been located and/or utilized ‘150’, and ‘10’ times in association with the resources ‘Resource2’ and ‘Resource10’.

As illustrated in FIG. 52, an exemplary search session record 5200 is provided, of which one or more may be associated with or resident in the search database 3820 (FIG. 38). The search session record 5200 may include a search session ID field 5205, search session search query field 5210, a search session user ID field 5215, a search session guide ID field 5220, a search session result ID field 5225, a search session resource ID field 5230, a search session keyword ID field 5235, a search session category ID field 5240, a search session rating info field 5245, a search session comments field 5250, a search session chronological info field 5255, and a search session clarification info field 5260. A search session record may be created in various ways. In at least one embodiment, a process such as the process 3900 (FIG. 39) may cause a search session record to be created. Similarly a process such as the process 5300 (FIG. 53) may cause a search session record to be created. A training session, a review session, and/or other activities of a user, a guide, a system administrator, etc. may cause a search session record to be created. A search session record may be processed in order to associate vocabulary with an index. For example a resource(s) may be ranked based on usage of the resource(s) identified in a search session record(s) in order to determine whether a resource is to be processed to obtain keywords or interests which may be associated with a category, interests, etc.

The search session ID field 5205 contains a unique identifier of a search session. The content of the search session ID field serves to identify a search session record associated with one search session from the search session record associated with other search sessions. A search session ID may include any type of information which may uniquely identify a search session.

The search session search query field 5210 may include information of a query submitted by a user. The search session search query filed 5210 may include modified query information, such as a structured query, which may have been created as part of a search session(s). Using the example illustrated in FIG. 52, the query ‘best email marketing companies’, and the query ‘where can I get info of the best email marketing companies?’ have been associated with the search session ‘session 1100227’, which may indicate for example that the query ‘best email marketing companies’ was received from a user, and that the structured query ‘where can I get info of the best email marketing companies?’ was associated with the search session by a guide.

The search session user ID field 5215 may include information identifying a user(s) associated with a search session (i.e., ‘Market101’). Information indicated in the search session user ID field 5215 may be used to ‘look up’ information of a user(s) using records such as the user record 4600 (FIG. 46).

The search session guide ID field 5220 may include information identifying a guide(s) associated with a search session (i.e., ‘Email guy1’). Any number of guides may be associated with a search session. For example, a guide may receive information of a user request which may be processed by a guide, may construct a structured query and/or categorize a user request, may perform a search associated with a search session, may produce a search result(s) responsive to a search request associated with a search session, etc. A different guide(s) may perform any process associated with a request, which may be reflected in the search session guide ID field 5220. Information indicated in the search session guide ID field 5220 may be used to ‘look up’ information of a guide using a record(s) such as the guide record 4500 (FIG. 45).

The search session result ID field 5225 may include information of a search result(s) provided responsive to a search request (e.g., ‘exacttarget.com’, ‘mail2u.com’). The search session result ID field may indicate information included in a record(s) such as the result record 4800 (FIG. 48). A search result may be ranked and/or rated based on information indicated in a search session record(s). For example, a rating(s), ranking(s), comments, etc. indicated in a search session record(s) may be used to rank a search result(s).

The search session resource ID field 5230 may include information of a resource(s) utilized by a searcher(s) in a search session. It may contain data such as a URL (i.e., ‘HarvardBusinessReview.net’, ‘www.google.com’) or other information of a resource utilized by a searcher to obtain a search result(s). For example, a URL associated with a web page which has been indicated by a searcher as including a search result(s) may be indicated in the search session resource ID field 5230, or a resource such as a custom search engine which may have been used to obtain information as part of a search session may be indicated in the search session resource ID field 5230. Information indicated in the search session resource ID field 5230 may indicate information included in a record such as the resource record 4900 (FIG. 49).

The search session keyword ID field 5235 may include information of a keyword(s) or interest(s) associated with a query as part of a search session, (e.g., ‘email’, ‘marketing companies’, ‘email marketing companies’). Information associated with a request may be processed automatically and/or using the assistance of a guide(s) and/or a user(s) in order to associate a keyword(s) with the request. For example, the search system 3830 (FIG. 38) may parse a query in order to extract one or more keywords from the query, or a guide(s) may be presented with a list of keywords which might be associated with a search request and may select a keyword(s) to be associated with the search request, or a spoken query might be automatically associated with a keyword(s). Information indicated in the search session keyword ID field may be used for various purposes. For example, a guide(s), an advertisement(s), a categorization(s), a resource(s), a search result(s), and/or other information may be ranked based on information associated with a keyword(s) indicated in the search session keyword ID field 5235.

The search session category(ies) field 5240 may include information of a category(ies) associated with a query as part of a search session, (i.e., ‘Business>Marketing’, ‘Computers>Marketing’). A category(ies) or categorization(s) may be associated with a search query and/or a search session automatically, and/or using the assistance of a guide(s) and/or a user(s). For example, a keyword(s) associated with a search session may be used to identify one or more categories which may be associated with a search request.

The search session rating info field 5245 may include information of ratings associated with a search session. The rating field may contain ratings of various items indicated in a search session log which are associated with an item via for example a pointer. For example, a rating may be associated with a result associated with a query, a rating may be associated with a searcher for the search session (e.g., example a user rating, or a trainer rating for a search session), a rating may be associated with a search resource based on review by a guide(s) of a search session record(s), etc. Any type of ratings may be associated with any information indicated in the search session record or log.

The search session comments field 5250 may include information of comments or annotations which may be annotations of the search session record 5200. For example, a trainer may review a search session record and may add comments regarding alternate resources, ratings of a searcher, etc. Such information may include information of a person who performed an annotation. Using the example illustrated in FIG. 52, the comment ‘www.emailmarkets.com is good for this’ may have been added to the search log ‘session 11002277’ by ‘Guide1’. Any type of annotation information may be indicated in the search session comments field 5250.

The search session chronological info field 5255 may include time-related information regarding a search session. For example, a time stamp may indicate when a query is submitted (e.g., ‘startsession 1.40P_{—}12_{—}27_{—}07’), a time stamp might be included indicating when a particular search result(s) is returned to a user(s) (e.g., ‘result1-1.41 P’, ‘result2-1.45P’), when a session was concluded (e.g., ‘end session 1.46P_{—}12_{—}27_{—}07’), etc. Any sort of chronological information associated with a search session, which may include time information associated with annotations, ratings, etc. may be indicated

The search session clarification info field 5260 may include information of any or all interaction between a searcher and an information seeker which may have been used to clarify the content of an original query. For example, information from a previous communication, information from a real-time chat session, location information, etc. which may clarify a user request may be indicated in the search session clarification info field 5260. In at least one embodiment, information associated with an interactive chat session between a user and a guide(s) may be indicated in the search session clarification info field 5260.

Information indicated in a search session record(s) may be included in a ‘wiki’ associated with a guide(s) and/or a categorization. For example, a search session(s) associated with a highly ranked guide(s) which is associated with a categorization might be used to determine any or all of a search space associated with a categorization, or information in a search session log or record might be used to tune parameters associated with an automated search of information associated with a categorization, etc.

As illustrated in FIG. 53, a process 5300 for performing an information search is provided. The process 5300 may be operative on a server associated with the search system 3830 (FIG. 38).

In operation 5305 (FIG. 53) a determination is made as to whether a request is received. For example, if a search query is submitted via voice, or SMS to a server, or an email is received at an email address, or if an IM is received at a IM service account associated with the search system 3830 (FIG. 38), it may be determined that a search query or request is received. If it is determined in operation 5305 that a request is not received, control remains at operation 5305 and process 5300 continues. If it is determined in operation 5305 that a request is received, control is passed to operation 5310 and process 5300 continues.

In operation 5310 a request is compared to a database. The database may include information of requests. A database may include previous request(s) and/or result(s), advertisement(s), resource(s) and/or any data processed in association with operation(s) of the system 3800 (FIG. 38), any or all of which may be compared with a request. A request may be processed in order to generate alternate forms of the request which may be compared to a database including other requests. For example, a request may be automatically analyzed and/or parsed, and a set of equivalence rules may be applied, etc. Control is passed to operation 5315 and process 5300 continues.

In operation 5315 a determination is made as to whether a match to a request is found. If in operation 5315 it is determined that a match to a request is not found, control is passed to operation 5320 and process 5300 continues. If in operation 5315 it is determined that a match to a request is found, control is passed to operation 5355 and process 5300 continues.

In at least one embodiment, an exact match of a request to a request or search query indicated in the database is used to determine whether a match to a request is found. An exact match may be determined to be found based on a modified version of a request. For example, an original search query might be deconstructed and element(s) of the deconstructed query might be combined with other information in order to produce a search query which matches a search query indicated in the search system database 3820 (FIG. 38). An exact match may be determined to be found based on equivalence tables of any elements of a search query. In at least one embodiment, a calculated probability of a match between a request and a request indicated in the database exceeding a value may be used to determine that a match to a request is found. In at least one embodiment, the determination in operation 5315 may be made based on user acceptance of a result(s) and/or a search query provided to a user by the search system 3830 responsive to a request. In at least one embodiment, a result(s) or answer(s) may be provided responsive to a user request using an automated resource(s) based on automatic processing of a request. For example, if a user request conforms to a grammar construct such as ‘quote xxxx’ wherein ‘xxxx’ is a ticker symbol for a security, or if a user response matches a template in the database 3820, an automated system may deliver a response without the assistance of a guide.

In operation 5320 a request and information associated with the request are presented to a guide or searcher. Information associated with a request may include information which may have been obtained regarding a request, such as geographic, demographic, and/or other information which is associated with a user(s) and/or system(s) submitting a request. Information associated with a request may include a number of items which may have been associated with a request based on processing of a request, such as keywords, categories, advertisements, structured queries, searchers, results, historical information, etc. Information may be associated with a request based on content of a raw query and/or other information indicated in a request. For example, content of a raw query may be compared to a database of categories and/or structured queries or “succinct queries” which may allow items associated with a database of queries and/or categories to be ranked based at least in part on content of the raw query. Control is passed to operation 5325 and process 5300 continues.

In operation 5325 a determination is made as to whether a result is found. If in operation 5325 it is determined that a result is not found, control is passed to operation 5330 and process 5300 continues. If in operation 5325 it is determined that a result is found, control is passed to operation 5355 and process 5300 continues.

The determination in operation 5325 may be made based on various criteria. In at least one embodiment, a searcher may select one or more suggested structured query(ies), and if a result(s) are associated with the structured query(ies) it may be determined that a result is found. For example, a structured query may be associated with a resource, which may produce a result based on submitting a request based at least in part on the structured query to a resource(s), which may associate a result(s) with the structured query. Alternately, a searcher may select other information which may determine that a result is found. For example, a searcher may associate a category(ies), keyword(s), resource(s), advertisement(s) and/or other item(s) with a request which may cause a result to be associated with a request, which may determine that a result is found. In at least one embodiment, the determination in operation 5325 may be made based on user acceptance of a result(s) previously provided to a user.

In operation 5330 a vetted request (query) is constructed. A process for construction of a vetted query is further described herein below with respect to FIG. 52. Control is passed to operation 5335 and process 5300 continues.

In operation 5335 a determination is made as to whether a result is found. If in operation 5335 it is determined that a result is not found, control is passed to operation 5340 and process 5300 continues. If in operation 5335 it is determined that a result is found, control is passed to operation 5355 and process 5300 continues.

The determination in operation 5335 may be made based on various criteria. In at least one embodiment, a result may be automatically selected and/or created based on a vetted query constructed by a guide. For example, a query structure may be associated with a resource, which may produce a result for a request based at least in part on the query structure and content of the request, which may associate a result(s) with the structured query. Alternately, a structured query may be associated with one or more results which have been produced by a guide(s). For example, a guide(s) may have performed a search and obtained a result(s) responsive to an unstructured or ‘raw’ query which has been associated with a vetted query constructed by a guide(s) in operation 5330. In at least one embodiment, the determination in operation 5335 may be made based on user acceptance of a result(s) provided to a user. If a response to a request is not available, other information selected based at least in part on information of a request may be provided to a user(s), such as advertisement(s), a game, audio and/or video information, etc.

In operation 5340 a request is categorized. A guide may categorize a request, or a category may be automatically associated with a request by the system 3800 (FIG. 38). A category(ies) may be associated with a request based on a keyword(s) included in a request and/or a structured query associated with a request. A category and/or keyword may be used to select a number of items to be associated with a request, such as guides, results, advertisements, resources, etc. Control is passed to operation 5345 and process 5300 continues.

In operation 5345 a vetted query or vetted request is provided to a searcher (a number of guides). A vetted query or vetted request is a request which has been associated with a structured query and a category. An ambassador guide may continue processing a request and/or the request may be transmitted to a number of other guides who may perform an information search responsive to the request. A guide constructing a structured query at operation 5330 and a guide presented with the query at operation 5345 may or may not be the same person. A searcher(s) may be selected automatically and/or may be selected by a guide(s). In at least one embodiment, a guide(s) are notified of a request in an order determined by a ranking of guides associated with a category(ies), keyword(s), profile(s), geographic information, and/or other information associated with a request. A guide(s) may be allowed to decline a request. A guide receiving a vetted query may construct a different vetted query. Control is passed to operation 5350 and process 5300 continues.

In operation 5350 a result(s) is obtained responsive to a request associated with a structured query. A result(s) may be obtained by one or more guides. A result(s) is associated with a request(s) and/or a structured query, which may be associated with other information such as a category(ies), keyword(s), advertisement(s), a user(s), a searcher(s), a resource(s), etc. Control is passed to operation 5355 and process 5300 continues.

In operation 5355 information of the process 5300 is recorded. For example, information of a request, a structured query, a vetted query, a result(s), and/or other items and their associations is recorded and/or updated. For example, information of a raw query and/or a request(s) which has been associated with a structured query, information of an advertisement(s) which has been associated with a request(s) and/or a structured query, information of usage and/or ratings of items such as a result(s), a resource(s), a guide(s), an advertisement(s), etc. may be recorded. Control is passed to operation 5360 and process 5300 continues.

In operation 5360 a user(s) is provided with information. A result(s) may be provided using any or all device(s) and/or service(s) which may be associated with a user(s). Information such as an advertisement(s), a result(s), etc. may be provided to a user(s) in any sequence. Control is passed to operation 5365 and process 5300 continues.

In operation 5365 rating(s) and/or information which may be used to compute a rating(s) of information presented to a user(s) is obtained. For example, a user may rate a result(s), information of usage of a coupon included with a result(s) might be obtained, a review by a guide(s) and/or administrator might be performed, and/or other information which may be used to determine a rating(s) may be obtained. Control is passed to operation 5370 and process 5300 continues.

In operation 5370 information of the process 5300 is recorded. Information associated with a user(s), such as result(s), advertisements, guide(s), profile(s), etc. may be recorded. Rating(s) of a result(s), a guide(s), an advertisement(s) and/or associated items such as a resource(s), a structured query(ies), etc. may be recorded and/or updated. In at least one embodiment, information is recorded in the search database 3820 (FIG. 38). Control is passed to operation 5305 and process 5300 continues.

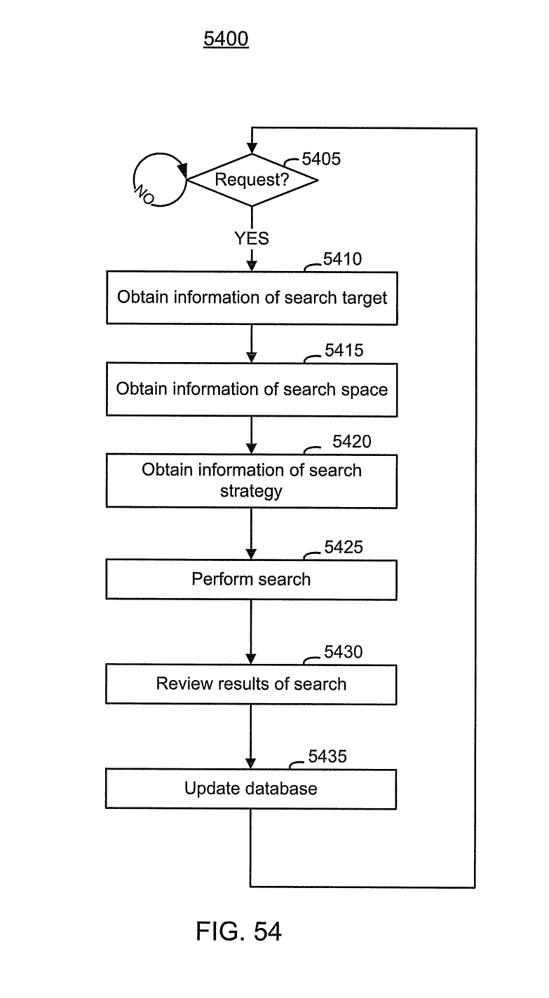

As illustrated in FIG. 54, a process 5400 for obtaining information related to an interest, which may be a keyword(s) and/or other item(s) is provided. The process 5400 may for example be operative on a server associated with the search system 3830 (FIG. 1). Information of an interest may be obtained for various purposes. For example, if an interest has occurred in a number of search requests, but is not associated with a category, a ranking of the interest may be obtained based on indexing of a resource(s) associated with the category. Likewise, if an interest has had low usage in search requests, a ranking of search resources based on the ranking of the interest associated with the resource may be performed.

In operation 5405 a determination is made as to whether a request to obtain information of an interest(s) is received. If it is determined in operation 5405 that a request to obtain information of an interest(s) is not received, control remains at operation 5405 and process 5400 continues. If it is determined in operation 5405 that a request to obtain information of an interest(s) is received, control is passed to operation 5410 and process 5400 continues.

The determination in operation 5405 may be made based on various criteria. For example, a request to obtain information of an interest may be receive via an API such as a SOAP request, or if a search request is received by the search system 3830 (FIG. 38) which includes an interest which is not indicated in the database 3820, it may be determined that a request to obtain information of an interest is received. Any suitable criteria may be used to determine if a request to obtain information of an interest is received.

In operation 5410 information of an interest or ‘search target’ is obtained. A ‘search target’ is any item(s) which may be recognized in a search process. For example, a keyword(s), an image, an audio file, and/or other information which is to be compared to and/or used to evaluate and/or process information associated with a search is obtained. In at least one embodiment, a guide and/or a user(s) may indicate that information associated with a request is to be utilized as a search target. Control is passed to operation 5415 and process 5400 continues.

In operation 5415 information of a ‘search space’ is obtained. A ‘search space’ is a definition of a corpus of items which is to be searched and/or processed. For example, a URL(s), a document(s), any form of content, an image(s), access information and/or instructions, a guide ID, a user ID, etc. associated with a search space is obtained. In at least one embodiment, information associated with a categorization(s) may indicate a search space. Control is passed to operation 5420 and process 5400 continues.

In operation 5420 Information of a search strategy is obtained. A ‘search strategy’ is a definition of any algorithm which may be used to search and/or otherwise process elements of a search space. Search strategy information may be used to obtain, rate and/or rank a search target and/or elements of a search space. Control is passed to operation 5425 and process 5400 continues.

In at least one embodiment, if a query indicates a keyword(s), phrase(s), sentence(s), location(s) and/or other information which is not associated with an index indicated in the database 3820 (FIG. 38), a search may be performed utilizing the keyword(s), phrase(s), sentence(s), location(s), etc. as the search target, using resources which may at least in part be selected by a guide(s), who may be associated with one or more categorizations, which may result in a rating(s) and/or a ranking of an interest being associated with a number of categorizations. A search strategy may define a ranking and/or rating factors, a reviewer(s), selection criteria, a time frame, and other parameters which may be used by automated and/or human-assisted search systems.

In operation 5425 a search is performed. A search target may be ranked based on processing of a search space based on a search strategy. In at least one embodiment, a resource(s) associated with a category is indexed to obtain a ranking of an unknown keyword(s) based at least in part on use of the keyword in the resource(s), and/or a related resource(s). While a keyword is used for the purposes of simplicity, any item(s) which may be an interest may be located and/or ranked. Control is passed to operation 5425 and process 5400 continues.

In operation 5430 a review is conducted of the result(s) obtained in operation 5430. A review may include any number of actions. For example, information of interests which may have been highly rated and/or ranked in association with a categorization may be provided to a guide(s), or other person(s) and/or entity(ies) associated with the categorization, or information of interests which are associated with a categorization, which may have a low rating(s) and/or ranking(s) based on a search may be presented to a guide(s) associated with a categorization, or interests may be presented to a generalist guide with information of a categorization(s) which may be based at least in part on a rating(s) and/or ranking(s) obtained during a search. A review process may include automated and/or human assisted review. For example, if an interest is identified by an automated search process which is ambiguous, a human reviewer may be presented with information of the interest and the associated element(s) of an index. Control is passed to operation 5435 and process 5400 continues.

In operation 5435 information of the process 5400 is recorded. In at least one embodiment, the database 3820 (FIG. 38) is updated. Information associated with any item(s) indicated in the database 3820 may be recorded and/or modified. Rating(s) of a search result(s), a user(s), a guide(s), an advertisement(s), an interest(s) and/or associated items such as resource(s), a structured query(ies), a categorization(s) and/or an index(es) etc. may be recorded and/or updated. Control is passed to operation 5405 and process 5400 continues.

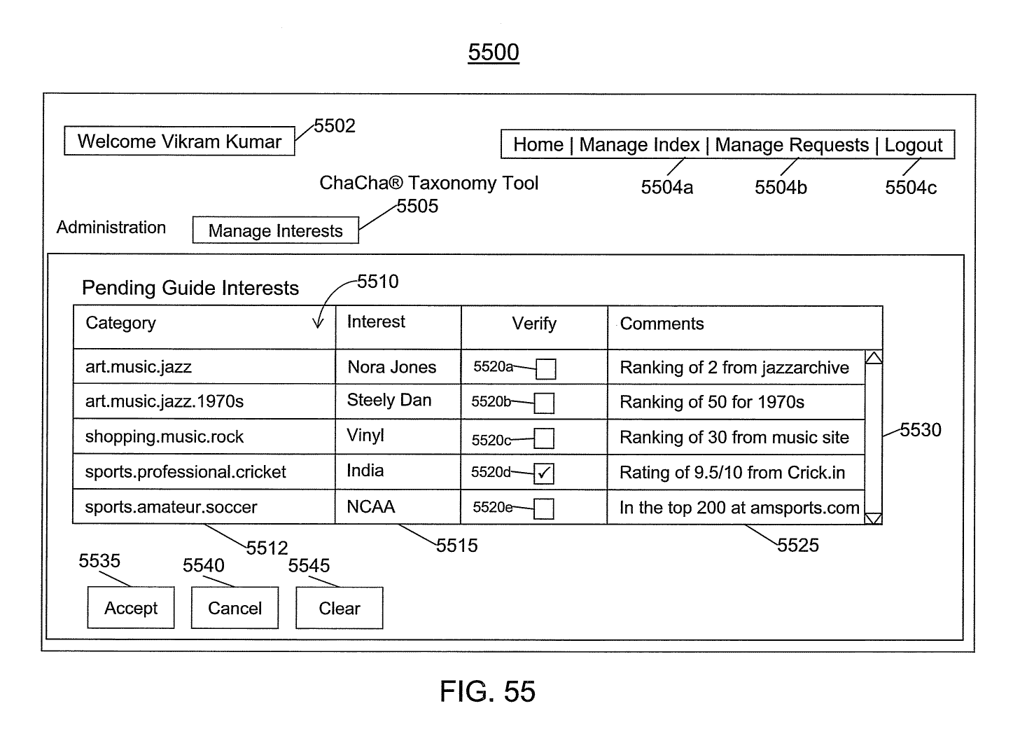

An exemplary graphical user interface 5500 for review of interests associated with a category is illustrated in FIG. 55. The GUI 5500 may be used to view and/or modify information associated with an index. The GUI 5500 may for example be used by an administrator of the search system 3830 (FIG. 38) to review interests which have been identified to be associated with a node(s) of an index.

The GUI 5500 may include a user identifier 5502, navigation controls 5504, an activity indicator 5505, an interest display window 5510, category indicators 5512, interest indicators 5515, opinion indicators 5520, a comment indicator 5525, viewing controls 5530, an ‘Accept’ button 5535, a ‘Cancel’ button 5540, and a ‘Clear’ button 5545.

The user identifier 5502 may include information associated with a user of the GUI 5500. For example a login ID or other information associated with a user of the GUI 5500 may be displayed in the user identifier 5502.

The navigation controls 5504 may allow a user of the GUI 5500 to logon or logoff of the search system 3830 (FIG. 38). Activation of the login control 5504a may toggle between logged in and logged out of the system. In order to login, a user of the GUI 5500 may be required to enter security information, etc. The navigation controls 5504 allow a user to navigate to other GUIs from the GUI 5500. For example, activation of the ‘Manage Index’ navigation control 5504c causes the GUI 5500 to be presented, and activation of the ‘Manage Requests’ navigation control 5504b causes the GUI 5500 to be presented.

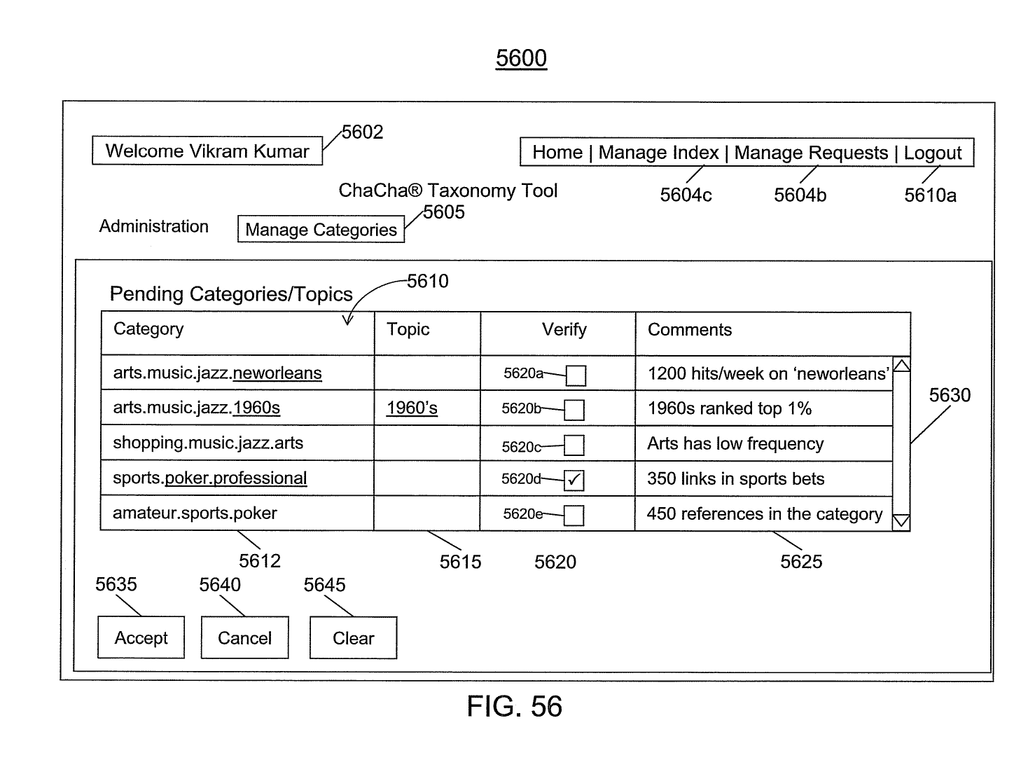

The activity indicator 5505 indicates an activity currently being performed using the GUI 5500. The activity indicator 5505 may allow selection of additional activities using for example a drop-down list, which may allow navigation to other GUIs such as the GUI 5600 (FIG. 56).

The interest display window 5510 presents information associated with interests which are to be reviewed to be associated with a category. The category indicators 5512 indicate a category associated with an interest indicated in the interest indicators 5515. The opinion indicators 5520 allow information of an opinion regarding an interest to be indicated. For example the interest ‘India’ has been verified to be associated with the category ‘sports.professional.cricket’ as indicated by the presence of a ‘check’ in the checkbox of the opinion indicator 5520d. The opinion indicators may be toggled by for example ‘clicking’ on the opinion indicator 5520. The comment indicators 5525 may contain information regarding a process which was used to determine if an interest is to be associated with a category.

The ‘Clear’ button 5545 clears the opinion indicators 5520 when activated. The ‘Accept’ button 5535 records information obtained using the GUI 5500 when activated. The ‘Cancel’ button 5540 discards any information obtained using the GUI 5500 without recording it when activated. The viewing controls 5530 allow viewing of items in the interest display window 5510.

An exemplary graphical user interface 5600 to review categories and/or ‘topics’ is illustrated in FIG. 56. The GUI 5600 may be used to view and modify information of an index, which may be indicated in the database 3820 (FIG. 38). In at least one embodiment, a modification to an index may be determined based on an automated process.

As illustrated in FIG. 56, the GUI 5600 may include a taxonomist/user identifier 5602, navigation controls 5604, an activity indicator 5605, a category/topic display window 5610, category indicators 5612, topic indicators 5615, opinion indicators 5620, comment indicators 5625, viewing controls 5630, an ‘Accept’ button 5635, a ‘Cancel’ button 5640, and a ‘Clear’ button 5645.

The user identifier 5602 may include information associated with a user of the GUI 5600. For example, a login ID or other information associated with a user of the GUI 5600 may be displayed in the taxonomist/user identifier 5602.

The navigation controls 5604 may allow a user of the GUI 5600 to logon or logoff of the search system 3830 (FIG. 38). Activation of the login control 5604a may toggle between logged in and logged out of the system. In order to login, a user of the GUI 5600 may be required to enter security information, etc. The navigation controls 5604 allow a user to navigate to other GUIs from the GUI 5600. For example, activation of the ‘Manage Index’ navigation control 5604c causes the GUI 5500 to be presented, and activation of the ‘Manage Requests’ navigation control 5504b causes the GUI 5500 to be presented.

The activity indicator 5605 indicates an activity currently being performed using the GUI 5600. The activity indicator 5605 may allow selection of additional activities using for example a drop-down list, which may allow navigation to other GUIs such as the GUI 5500 (FIG. 55).

The category/topic display window 5610 presents information associated with categories and/or topics which are to be reviewed. The category indicators 5612 indicate a category(ies). The topic indicators 5615 indicate a topic(s). The opinion indicators 5620 allow information of an opinion regarding a topic and/or category addition. For example the category ‘sports.poker.professional’ has been verified to be added to an index as indicated by the presence of a ‘check’ in the checkbox of the opinion indicator 5620d. The opinion indicators 5620 may be toggled by for example ‘clicking’ on the opinion indicators 5620. The comment indicators 5625 may contain information which has been used to determine if a new node is to be added to an index. The ‘Clear’ button 5645 clears the opinion indicators 5620 when activated. Any combination of new topics and/or categorizations may be indicated in the category/topic display window 5610. Using the example in FIG. 56, the underline in the category indicators 5612 indicates existing topic terms which are added to a category to form a new category. The topic indicator 5615 indicates a new topic term which is to be added to the index.

The ‘Accept’ button 5635 records information obtained using the GUI 5600 when activated. The ‘Cancel’ button 5640 discards any information obtained using the GUI 5600 without recording it when activated. The viewing controls 5630 allow viewing of items in the category/topic display window 5610.

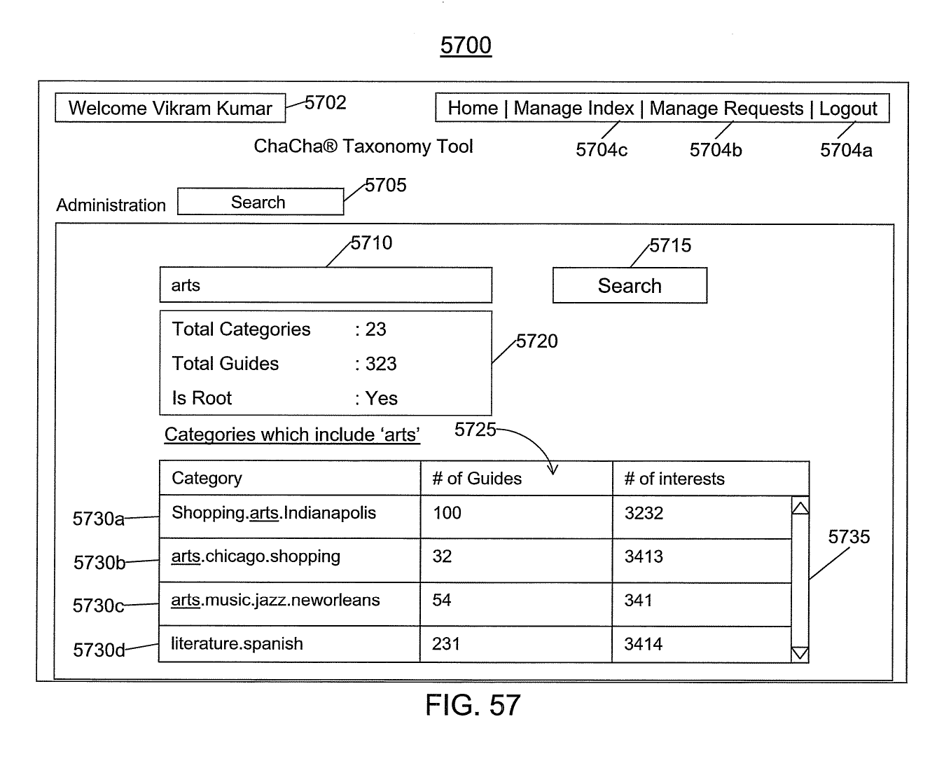

An exemplary graphical user interface 5700 to locate topic terms interests is illustrated in FIG. 57. The GUI 5700 may be used to locate information included in the database 3820 (FIG. 38). The GUI 5700 may be presented if the activity indicator 5705 is set to ‘Search’.

The GUI 5700 may include a user identifier 5702, navigation controls 5704, an activity indicator 5705, a search box 5710, a search button 5715, an index statistics window 5720, a category display window 5725, a category indicator controls 5730 and viewing controls 5735.

The taxonomist/user identifier 5702 may include information associated with a user of the GUI 5700. For example, a login ID or other information associated with a user of the GUI 5700 may be displayed in the taxonomist/user identifier 5702.

The navigation controls 5704 may allow a user of the GUI 5700 to logon or logoff of the search system 3830 (FIG. 38). Activation of the login control 5704a may toggle between logged in and logged out of the system. In order to login, a user of the GUI 5700 may be required to enter security information, etc. The navigation controls 5704 allow a user to navigate to other GUIs from the GUI 5700. For example, activation of the ‘Manage Index’ navigation control 5704c causes the GUI 5500 to be presented, and activation of the ‘Manage Requests’ navigation control 5704b causes the GUI 5500 to be presented.

The activity indicator 5705 indicates an activity currently being performed using the GUI 5700. The activity indicator 5705 allows selection of additional activities using for example a drop-down list, which may allow navigation to other GUIs such as the GUI 5500 (FIG. 55).

The search box 5710 allows entry of a search string which is to be located in an index which may be indicated in the database 3820 (FIG. 38). The search button 5715 initiates a search for the string indicated in the search box 5710 when activated. The index statistics window 5720 indicates information regarding categories which may be associated with the results of a search for a string entered in the search box 5710. Using the example in FIG. 57, information of a number of guides and a number of categories and whether a term is a path root term related to the search string ‘arts’ are displayed. Other types of information, such as a number of guide topics, etc. may also be displayed in the index statistics window 5720.

The category display window 5725 presents information regarding categories located as a result of a search for information entered in search box 5710. The category display window 5725 indicates a number of guides and a number of interests associated with any categories displayed.

The category indicator controls 5730 indicate information regarding how a category was located. For example, a topic term may be underlined, bold, colored, or otherwise indicated. If a search string is matched to an interest, the absence of an indication of a topic term in a category indicates that the search string has matched an interest associated with the category indicated in the category indicator controls 5730. For example, the category indicators 5730a, 5730b and 5730c contain the word ‘arts’ as indicated by underline, while the category indicator 5730d indicates that ‘arts’ is an interest associated with the category ‘literature.spanish’. Activation of a category indicator control 5730 may cause a GUI (not shown) which may present further information of the category to be presented. The GUI 5700 may for example be used to review information associated with an index to determine if an interest and/or node is to be added to an index.

While the GUI 5700 has been illustrated using a search of an index of interests, a similar search might be conducted to locate other information associated with an index such as advertisements, guides, resources, profiles, etc.

Using the methods and systems described herein information of interest, which may be keywords, images, audio information, video, software and/or other media may be associated with an index. A system for providing a search result responsive to a request is provided. If a request is received, content associated with the request may be compared to interests indicated in a database. If information associated with the request matches interests associated with an index, information associated with the index may be selected and/or provided responsive to the request.

In order to expand the extent of interests associated with an index(es), information associated with the index may be processed in order to obtain interests which may be associated with the index(es). A search target(s), such as an interest which is not indicated in the database, is identified. A search space which may include a number of resources, advertisements, profiles, guides, users, etc. which are associated with a node of an index may be identified for processing to rank a search target(s). A search strategy is defined, which may be customized to an index(es) and/or node(s) of an index(es). A search target is evaluated based on a search space and a search strategy. Results of a search process for ranking and obtaining interests may be presented to a human assistant for review and/or may automatically be added to a vocabulary of interests associated with an index.

The new method may enable acquisition of interests which may be used to select a guide(s), an advertisement(s), a search result(s), a category(ies), a resource(s), and/or other items more effectively. A new interest may be obtained at least in part due to use of the interest in requests from users of a search service. If a guide obtains a search result for a request which may include a particular interest, a resource(s) associated with request may be associated with a category associated with the request. If an interest is highly ranked with respect to a resource associated with a category, it may be that the category will be highly ranked for a request including the interest. A taxonomy may be expanded and/or ranking of interests associated with the category may be modified based on processing of any type of information which may be associated with the taxonomy.

Nodes associated with an index may be added and/or removed based on information obtained by procession of resources, and/or items associated with the index. For example, if an interest has a high ranking, it may be that the interest is suggested to become an extension of a taxonomy, or a tag, etc. An automated and/or human-assisted review of changes to an index may be performed.

A method and system of selecting search result(s) is disclosed herein. As described above, one or more items may be selected independent of compensation related information. According to an embodiment, a selection technique provides control such that compensation information is excluded from consideration. Such exclusion of certain result(s) enables variable influence. For example, advertisement(s) above a certain value may be excluded, while those below that value level are included.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a computer-readable storage medium such as a CD-ROM, etc., or using one or more specialized terminals, devices or systems that is enabled to execute operation(s) described herein. The storage or recording medium used in an the embodiment can be selected from among various computer-readable media including, a disk, a DVD, an internal storage device (memory such as RAM or ROM) in a computer, etc.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of selecting a search result, comprising:
associating a commercial value with a search result;
presenting the search result to a first person;
obtaining an opinion of the first person which is influenced by the commercial value; and
providing the search result to a second person based on the opinion and the commercial value.

2. The method of claim 1, wherein the first person is different from the second person further comprising:
associating a keyword with the search result; and
selecting the first person based at least in part on the keyword.

3. The method of claim 1, further comprising:
presenting information of the commercial value to the first person.

4. The method of claim 1, wherein the search result is an advertisement.

5. The method of claim 1, wherein the presenting is based at least in part on the commercial value.

6. The method of claim 1, further comprising:
associating the commercial value with a resource;
providing the resource to the first person based on the commercial value; and
obtaining by the first person the search result using the resource.

7. The method of claim 3, wherein the first person is compensated based on use of the search result by the second person.

8. The method of claim 1, further comprising:
receiving a query from the second person;
identifying a category associated with the query;
selecting the first user based on the category;
obtaining the search result from a resource associated with the category;
presenting a compensation associated with the search result to the first person; and
providing a second result to the second person wherein the second result is not based on a commercial value associated with the second result.

9. The method of claim 1, further comprising;
receiving a query from the second person;
determining a keyword, a category, a location and a profile associated with the query;
selecting the first user based on the keyword, the category, the location, the profile and an advertiser associated with the search result; and
providing a compensation value to the first user based on the advertiser.

10. A system, comprising:
a search system receiving a request, and a search result, and providing information of the search result and the request;
a resource providing the search result;
a guide device receiving information of the search result;
a database including information of the request, the guide, the resource, the search results.

11. The system of claim 10, further comprising:
a user device submitting the request and receiving the search result; and
an advertiser device providing a search result which is associated with a commercial value.

12. A computer readable medium storing therein a program for causing a computer to execute an operation including selection of search results, comprising:
selecting a first guide;
providing unbiased information to the first guide;
selecting a second guide;
providing biased information to the second guide; and
ranking an item based on an opinion of the first guide and an opinion of the second guide.

13. The computer readable medium of claim 12, wherein the first guide identifies a search result using the unbiased information.

14. The computer readable medium of claim 12, wherein the second guide identifies a search result using the biased information.

15. The computer readable medium of claim 12, wherein at least one of the unbiased and biased information is an indicator of a resource and a search result is obtained from the resource.

16. The computer readable medium of claim 13, wherein at least one of the unbiased and biased information is an advertisement and the bias is a value associated with acceptance of the advertisement.

17. The computer readable medium of claim 16, wherein at least a portion of the bias information is explicitly revealed to the second guide.

18. The computer readable medium of claim 12, wherein at least one of the unbiased and biased information is a search result and the operation further comprises:
receiving a query from a user;
associating a category with the query;
ranking the search results based on the category and the opinion; and
providing the search results to the user in an order determined by the ranking.

19. A computer implemented method, comprising:
dynamically determining a keyword of a request received from a first user; and
associating the keyword with an item selected by a second user processing the request and displaying the item to the first user as a result to the request.

20. The computer implemented method of claim 19, wherein said item is selected from among multiple items and the item is an information or a service specific to a provider.
